(19) United States
(12) Patent Application Publication
(10) Pub. No.: US 2026/0246648 A1
(43) Pub. Date: Aug. 20, 2026

(54) Systems and Methods for Blockchain Enhancement, Data Usage, and Quantum Security

(71) Applicant: Artema Labs, Inc, Los Angeles, CA (US)

(72) Inventors: Bjorn Markus Jakobsson, New York, NY (US); Keir Finlow-Bates, Eura (FI); Hossein Siadati, Wilmington, NC (US)

(73) Assignee: Artema Labs, Inc, Los Angeles, CA (US)

(21) Appl. No.: 19/546,243

(22) Filed: Feb. 20, 2026

Related U.S. Application Data
(60) Provisional application No. 63/761,119, filed on Feb. 20, 2025.
(60) Provisional application No. 63/800,305, filed on May 5, 2025.
(60) Provisional application No. 63/843,845, filed on Jul. 14, 2025.
(60) Provisional application No. 63/844,639, filed on Jul. 15, 2025.
(60) Provisional application No. 63/857,323, filed on Aug. 4, 2025.
(60) Provisional application No. 63/881,040, filed on Sep. 12, 2025.
(60) Provisional application No. 63/899,096, filed on Oct. 14, 2025.
(60) Provisional application No. 63/929,602, filed on Dec. 2, 2025.

(51) Int. Cl. H04L 9/32

(52) U.S. Cl. CPC H04L 9/3236

(57) ABSTRACT

Systems and methods for performing quantum-secure blockchain operations in accordance with various embodiments of the invention are illustrated. One embodiment includes a method that conveys a hash of a randomly-generated first pre-image value to an initiating party of a proposed action that concerns cryptographic tokens. The method receives, from the initiating party, a second pre-image value, wherein the second pre-image value is received after a transaction from the initiating party is included in a block on a blockchain. The transaction from the initiating party references a locking script based on a concatenation of the hash of the first pre-image value and the second pre-image value. The method generates an unlocking script including the hash. The method submits the proposed action to the blockchain, wherein the proposed action includes a reference to the unlocking script, and wherein the unlocking script is validated against the locking script to initiate the proposed action.

### CROSS-REFERENCE TO RELATED APPLICATIONS

The current application claims the benefit of and priority under 35 U.S.C. § 119(e) to U.S. Provisional Patent Application No. 63/761,119 entitled “Determination of AI Input Data Usage” filed Feb. 20, 2025; U.S. Provisional Patent Application No. 63/800,305 entitled “Selectively Modifiable Blockchain Records” filed May 5, 2025; U.S. Provisional Patent Application No. 63/843,845 entitled “Blockchain Enhancement Technologies with Application to Commerce” filed Jul. 14, 2025; U.S. Provisional Patent Application No. 63/844,639 entitled “Using KYC, Escrow, Tracking, Risk Scoring and Recourse to Secure Transactions” filed Jul. 15, 2025; U.S. Provisional Patent Application No. 63/857,323 entitled “Recourse and Quantum Security Integration Framework” filed Aug. 4, 2025; U.S. Provisional Patent Application No. 63/881,040 entitled “Blockchain Enhancement Technologies with Application to Quantum Security” filed Sep. 12, 2025; U.S. Provisional Patent Application No. 63/899,096 entitled “Identity Anchor with Watchful Processing, and Efficiency Enhancements” filed Oct. 14, 2025; and U.S. Provisional Patent Application No. 63/899,096 entitled “Identity Anchor with Watchful Processing, and Efficiency Enhancements” filed Oct. 14, 2025, the disclosures of which are hereby incorporated by reference in their entireties for all purposes.

### FIELD OF THE INVENTION

The present invention generally relates to blockchain technology and, more specifically, quantum security within blockchain operations.

### BACKGROUND

Cryptography can be used to provide security, privacy and authenticity for transactions and can be used to create immutable ledgers such as (but not limited to) blockchains. Web 3.0 (or Web3) refers to a large-scale restructuring of the World Wide Web that includes open-source applications maintained by blockchain and operating in a way that is decentralized yet interconnected. The term contrasts Web 1.0 (the earliest version of the internet where individuals could create web pages digested by wide variety of consumers) and Web 2.0 (which expanded capabilities towards user-generated content and user-participation).

Blockchain technology is implemented on Web 3.0 in a manner which instantiates digital assets with clearly defined ownership. The blockchain functions as a ledger recording ownership that restricts the movement of digital assets from one party to another based on identity and access management encoded in the blockchain. As such, blockchains (and software running on those blockchains in the form of smart contracts) can address and process digital assets as held commodities. Blockchain and smart contracts thereby facilitate transactions between parties, with the blockchain itself acting as a distributed ledger providing a public record.

Under web3 systems, digital assets in the form of tokens (instantiated through smart contracts) are registered against one or more owners on blockchains. Such tokens may be registered on the blockchains against blockchain addresses by relying on asymmetric key cryptography, thus indicating ownership of the digital assets by entities with private keys. In a traditional blockchain-based transaction, a transferor receives a public key from a transferee and generates a digital signature on a message that includes the received public key. This enables the holder of the associated private key, namely the transferee, to use the generated digital signature and the private key associated with the signed public key to make additional transferors according to the same technique as the transferor used.

### SUMMARY OF THE INVENTION

Systems and methods for performing quantum-secure blockchain operations in accordance with various embodiments of the invention are illustrated. One embodiment includes a method for performing quantum-secure blockchain operations. The method generates a first pre-image value, wherein the first pre-image value is randomly-generated. The method conveys a hash of the first pre-image value to an initiating party of a proposed action, wherein the proposed action concerns a set of one or more cryptographic tokens. The method receives, from the initiating party, a second pre-image value, wherein the second pre-image value is received after a transaction from the initiating party is included in a block on a blockchain. The transaction from the initiating party is distinct from the proposed action and references a locking script that includes an output generated by a specific one-way function based on a concatenation of the hash of the first pre-image value and the second pre-image value. The method generates an unlocking script including the hash of the first pre-image value concatenated with the second pre-image value. The method submits the proposed action to the blockchain, wherein the proposed action includes a reference to the unlocking script, and wherein the unlocking script is validated against the locking script to initiate the proposed action.

In a further embodiment, the specific one-way function includes a quantum-secure cryptographic hash function.

In another embodiment, the set of one or more cryptographic tokens includes cryptocurrency.

In a still further embodiment, the first pre-image value is generated using a pseudo-random generator.

In another embodiment, conveying the hash of the first pre-image value to the initiating party is performed using a secure out-of-band communication channel.

In a further embodiment, the proposed action submitted to the blockchain transfers at least some of the set of one or more cryptographic tokens. Further, the method is performed by a recipient of transferring the at least some of the set of one or more cryptographic tokens.

In another embodiment, the method further includes receiving, from a subsequent recipient party, a hash of a third pre-image value. The method generates a second locking script including an output generated by a second one-way function of a concatenation of the hash of the third pre-image value and the first pre-image value. The method creates a subsequent transaction including the second locking script, wherein the subsequent transaction transfers the set of one or more cryptographic tokens to the subsequent recipient party.

One embodiment includes a non-transitory machine-readable medium including instructions that, when executed, are configured to cause a processor to perform a process for performing quantum-secure blockchain operations. The process generates a first pre-image value, wherein the first pre-image value is randomly-generated. The process conveys a hash of the first pre-image value to an initiating party of a proposed action, wherein the proposed action concerns a set of one or more cryptographic tokens. The process receives, from the initiating party, a second pre-image value, wherein the second pre-image value is received after a transaction from the initiating party is included in a block on a blockchain. The transaction from the initiating party is distinct from the proposed action and references a locking script that includes an output generated by a specific one-way function based on a concatenation of the hash of the first pre-image value and the second pre-image value. The process generates an unlocking script including the hash of the first pre-image value concatenated with the second pre-image value. The process submits the proposed action to the blockchain, wherein the proposed action includes a reference to the unlocking script, and wherein the unlocking script is validated against the locking script to initiate the proposed action.

In a further embodiment, the specific one-way function includes a quantum-secure cryptographic hash function.

In another embodiment, the set of one or more cryptographic tokens includes cryptocurrency.

In a still further embodiment, the first pre-image value is generated using a pseudo-random generator.

In another embodiment, conveying the hash of the first pre-image value to the initiating party is performed using a secure out-of-band communication channel.

In a further embodiment, the proposed action submitted to the blockchain transfers at least some of the set of one or more cryptographic tokens. Further, the process is performed by a recipient of transferring the at least some of the set of one or more cryptographic tokens.

In another embodiment, the process further includes receiving, from a subsequent recipient party, a hash of a third pre-image value. The process generates a second locking script including an output generated by a second one-way function of a concatenation of the hash of the third pre-image value and the first pre-image value. The process creates a subsequent transaction including the second locking script, wherein the subsequent transaction transfers the set of one or more cryptographic tokens to the subsequent recipient party.

One embodiment includes a distributed system for implementing digital access rights. The distributed system includes at least one network interface, memory storing instructions, and at least one processor configured to communicate data with the at least one network interface and the memory. The processor is further configured to execute the instructions to implement a process for generating a first pre-image value, wherein the first pre-image value is randomly-generated. The process conveys, with the at least one network interface, a hash of the first pre-image value to an initiating party of a proposed action, wherein the proposed action concerns a set of one or more cryptographic tokens. The process receives, from the initiating party, and using the at least one network interface, a second pre-image value, wherein the second pre-image value is received after a transaction from the initiating party is included in a block on a blockchain. The transaction from the initiating party is distinct from the proposed action and references a locking script that includes an output generated by a specific one-way function based on a concatenation of the hash of the first pre-image value and the second pre-image value. The process generates an unlocking script including the hash of the first pre-image value concatenated with the second pre-image value. The process submits, with the at least one network interface, the proposed action to the blockchain, wherein the proposed action includes a reference to the unlocking script, and wherein the unlocking script is validated against the locking script to initiate the proposed action.

In a further embodiment, the specific one-way function includes a quantum-secure cryptographic hash function. Further, the set of one or more cryptographic tokens includes cryptocurrency.

In another embodiment, the first pre-image value is generated using a pseudo-random generator.

In a still further embodiment, conveying the hash of the first pre-image value to the initiating party is performed using a secure out-of-band communication channel.

In another embodiment, the proposed action submitted to the blockchain transfers at least some of the set of one or more cryptographic tokens. Further, the process is performed by a recipient of transferring the at least some of the set of one or more cryptographic tokens.

In a further embodiment, the process further includes receiving, from a subsequent recipient party, a hash of a third pre-image value. The process generates a second locking script including an output generated by a second one-way function of a concatenation of the hash of the third pre-image value and the first pre-image value. The process creates a subsequent transaction including the second locking script, wherein the subsequent transaction transfers the set of one or more cryptographic tokens to the subsequent recipient party.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which form a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with some embodiments of the invention.

FIG. 2 is a network architecture diagram of an NFT platform in accordance with numerous embodiments of the invention.

FIG. 3 is a conceptual diagram of a permissioned blockchain in accordance with multiple embodiments of the invention.

FIG. 4 is a conceptual diagram of a permissionless blockchain in accordance with many embodiments of the invention.

FIGS. 5A-5B are diagrams of a dual blockchain in accordance with a number of embodiments of the invention.

FIG. 6 conceptually illustrates a process followed by a Proof of Work consensus mechanism in accordance with some embodiments of the invention.

FIG. 7 conceptually illustrates a process followed by a Proof of Space consensus mechanism in accordance with a number of embodiments of the invention.

FIG. 8 illustrates a dual proof consensus mechanism configured in accordance with certain embodiments of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with several embodiments of the invention.

FIGS. 14A-14C depicts user interfaces of various media wallet applications in accordance with a number of embodiments of the invention.

FIG. 15 illustrates an NFT ledger entry corresponding to an NFT identifier in accordance with certain embodiments of the invention.

FIGS. 16A-16B illustrate an NFT arrangement relationship with corresponding physical content in accordance with many embodiments of the invention.

FIG. 17 illustrates a process for establishing a relationship between an NFT and corresponding physical content in accordance with some embodiments of the invention.

FIG. 18 illustrates a process for incorporating assurances into a commit-reveal signature scheme in accordance with various embodiments of the invention.

FIG. 19 illustrates a process from the perspective of a miner associated with a blockchain for verifying and processing commit requests with assurance values in accordance with several embodiments of the invention.

FIG. 20 illustrates a process from the perspective of a certificate authority for certifying public keys and resolving complaints related to assurance values in accordance with many embodiments of the invention.

FIG. 21 illustrates a quantum-secure transaction technique implemented in accordance with certain embodiments of the invention.

FIG. 22 illustrates a block diagram illustrating sequences of steps for sending and receiving cryptocurrencies using quantum-secure techniques in accordance with various embodiments of the invention.

FIG. 23 illustrates a block diagram illustrating a paymaster smart contract implementation using a quantum-secure signature scheme in accordance with numerous embodiments of the invention.

FIG. 24 illustrates a possible embodiment of a method for providing provenance data for an AI output to an auditor.

FIG. 25 illustrates a block diagram illustrating a possible standardized file system structure for storing code samples as training data for an AI.

FIG. 26 illustrates a block diagram detailing a prompt database billing system in accordance with an embodiment of the invention.

FIG. 27 illustrates an embodiment of the invention detailing a collection of smart contracts for processing billing for AI prompts.

FIG. 28 illustrates a block diagram of a proof of provenance method performed in accordance with an embodiment of the invention.

FIG. 29 illustrates a flow chart of a method for auditing an AI-generated program performed in accordance with an embodiment of the invention.

FIG. 30 illustrates a flow chart presenting a possible embodiment of an NFT-enabled allowlist for permitting or blocking transactions.

FIG. 31 illustrates a block diagram illustrating an embodiment of a “that did not happen” (TDNH) implementation for a blockchain in which TDNH assertions are recorded on the same blockchain as entries to be overridden.

FIG. 32 illustrates a block diagram illustrating an alternate embodiment to that presented in FIG. 31, in which two blockchains are used to implement TDNH assertions on a second blockchain for rescinding transactions on a first blockchain.

FIG. 33 illustrates a block diagram illustrating a multi-chain blockchain distributing functionality across a plurality of chains.

FIG. 34 illustrates a sequence diagram illustrating a possible embodiment of a method for a piggy-back transfer of an amount of a fungible token using an existing bridging mechanism for a fungible token.

FIG. 35 illustrates a sequence diagram illustrating a possible embodiment of a method for a piggy-back transfer of a non-fungible token using an existing bridging mechanism for a fungible token.

FIG. 36 illustrates a block diagram illustrating a system for bridging value using a token bridge that does not support metadata for specifying a final recipient of the bridged token.

FIG. 37 illustrates a block diagram illustrating a system for transmitting data from one blockchain to another using an existing token bridge as a proxy.

FIG. 38 illustrates a block diagram illustrating a possible embodiment for a calling smart contract on a first blockchain making a remote function call to a receiving smart contract on a second blockchain.

FIG. 39 illustrates an illustrative example of an encoding scheme for a cross-chain remote procedure call.

FIG. 40 illustrates a block diagram illustrating a possible embodiment of a throttled bridge, presented for illustrative purposes only, and is not meant to be limiting in any way.

FIG. 41 illustrates a block diagram illustrating a dual node transferring information from a first smart contract on a first blockchain to a second smart contract on a second blockchain.

FIG. 42 illustrates a flowchart illustrating a possible embodiment of a method for transferring a digital asset in a trustworthy manner without a transaction.

FIG. 43 illustrates a block diagram illustrating an embodiment of a vault of non-transferable vault tokens contract allowing a transfer of non-transferable vault tokens from a first party to a second party.

FIG. 44 illustrates a block diagram illustrating an embodiment of a fractional reserve banded DEX.

FIG. 45 illustrates a block diagram of an embodiment illustrating how multiple DEX smart contracts may use a token vault for fractional reserve liquidity.

FIG. 46 illustrates a possible embodiment of a method for assessing high-risk transactions.

FIG. 47 illustrates a possible embodiment of a method for an application of a plurality of security policies by a plurality of reviewers.

FIG. 48 illustrates a block diagram illustrating an application of location enforced policies.

FIG. 49 illustrates an embodiment of a directory node in accordance with an embodiment of the invention.

FIG. 50 illustrates a transfer of a token using a helper-token in accordance with an embodiment of the invention.

FIG. 51 illustrates a transfer of a token using a CR scheme in accordance with an embodiment of the invention.

FIG. 52 illustrates a possible format for a transfer request in accordance with an embodiment of the invention.

FIG. 53 illustrates the handshake process used to achieve trustless bridging in accordance with an embodiment of the invention.

FIG. 54 shows an example mapping between logical and physical anchors in accordance with an embodiment of the invention.

FIG. 55 shows an example embodiment of an ERC-4337 implementation of a quantum-secure commit/reveal authorized token using account abstraction.

FIG. 56 conceptually illustrates a process for credit tokens based on wallets in accordance with an embodiment of the invention.

FIG. 57 conceptually illustrates credit tokens based on assets in accordance with an embodiment of the invention.

FIG. 58 conceptually illustrates a process for lending/leasing a remotely controllable device using a blockchain in accordance with an embodiment of the invention.

FIG. 59 conceptually illustrates a process for marking a token as collateral in accordance with an embodiment of the invention.

FIG. 60 conceptually illustrates a process for collateral being conditionally blocked from being spent in accordance with an embodiment of the invention.

FIG. 61 conceptually illustrates a process for the release of a token as collateral in accordance with an embodiment of the invention.

FIG. 62 conceptually illustrates a process for the establishment of an identity-based address in accordance with an embodiment of the invention.

FIG. 63 conceptually illustrates a process for the transfer of a token to an identity-based address from a sender of the token in accordance with an embodiment of the invention.

FIG. 64 conceptually illustrates a process for the transfer of a token from an identity-based address to a recipient of the token in accordance with an embodiment of the invention.

FIG. 65 conceptually illustrates the use of a summary smart contract to enable users to spot malicious transfers in a phishing attempt in accordance with an embodiment of the invention.

FIG. 66 conceptually illustrates a flow chart illustrating the transfer of assets locked down due to a quantum threat, and the unlocking of the same by the entity possessing the assets in accordance with an embodiment of the invention.

### DETAILED DESCRIPTION

Systems and methods for incorporating recourse mechanisms and quantum-secure transaction functionalities into blockchain platforms, in accordance with many embodiments of the invention, are described herein. Such functionality may include, but is not limited to, detector units for abuse detection and transaction monitoring, wallet protector services, jurisdictional penalty systems for stolen tokens, assurance mechanisms for gas fee guarantees, paymaster smart contracts for quantum-secure gas payments, and quantum-secure wrapped tokens.

In order to circumvent the dangers posed by quantum computing in brute-forcing digital signature private keys, configurations including, but not limited to, commit-assurance-reveal (CAR) signature schemes may be utilized. Systems and methods in accordance with multiple embodiments of the invention may incorporate assurance values that accompany commit requests, wherein the assurance values comprise quantum-secure digital signatures (such as Merkle signatures) that guarantee gas fee payments will be made. These assurances may be certified by certificate authorities and linked to identifiers including KYC records, anchor tokens, and escrowed funds, thereby enabling miners to accept commit requests with confidence that they will be compensated even if the reveal is not performed.

Additionally, systems and methods in accordance with various embodiments of the invention may provide recourse mechanisms through detector units that obtain feeds of inputs comprising publicly accessible transaction records, high-risk recipient addresses, timing data, and optional reporting data. Such detector units may determine events, probabilities of events, types of risk, and security actions including, but not limited to, initiating recourse transactions, applying penalties to tokens, and modifying reputation scores. Integration methods may combine two or more techniques across KYC, escrow, staking, and quantum-security to provide comprehensive protection for blockchain transactions.

While various applications are discussed above, security-based functionalities that may be utilized within NFT platforms in accordance with various embodiments of the invention are also discussed further below.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

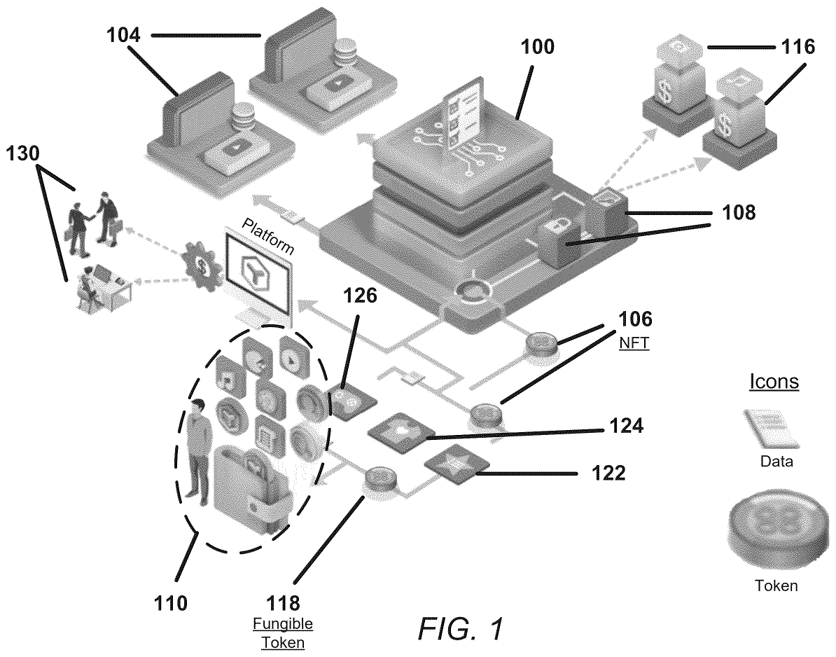

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users 128. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

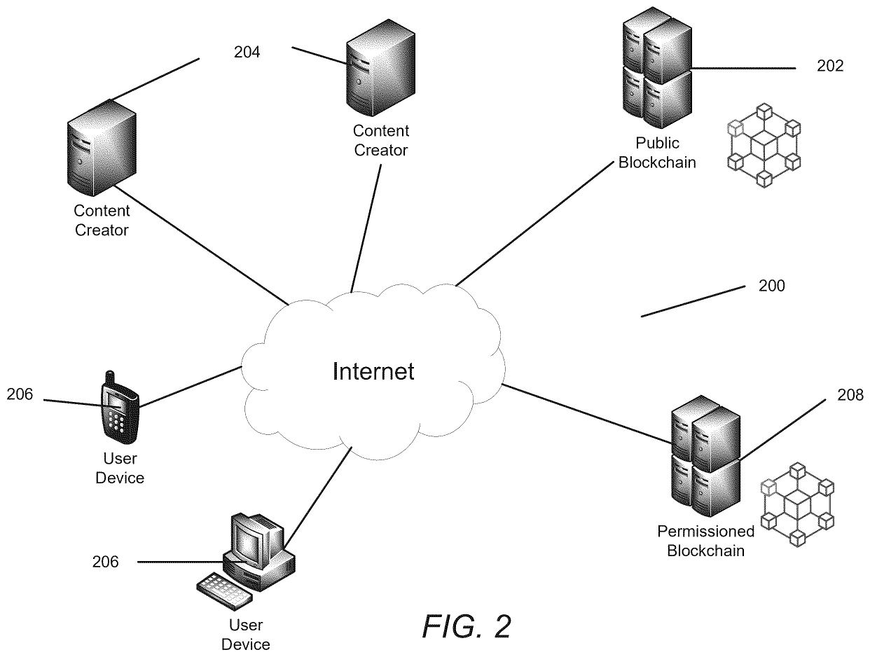

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards-based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform, are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable, and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains, and the particular approach is largely determined by the requirements of particular applications. As such, computer systems in accordance with various embodiments of the invention can have the capacity to create verified NFT entries written to permissioned blockchains.

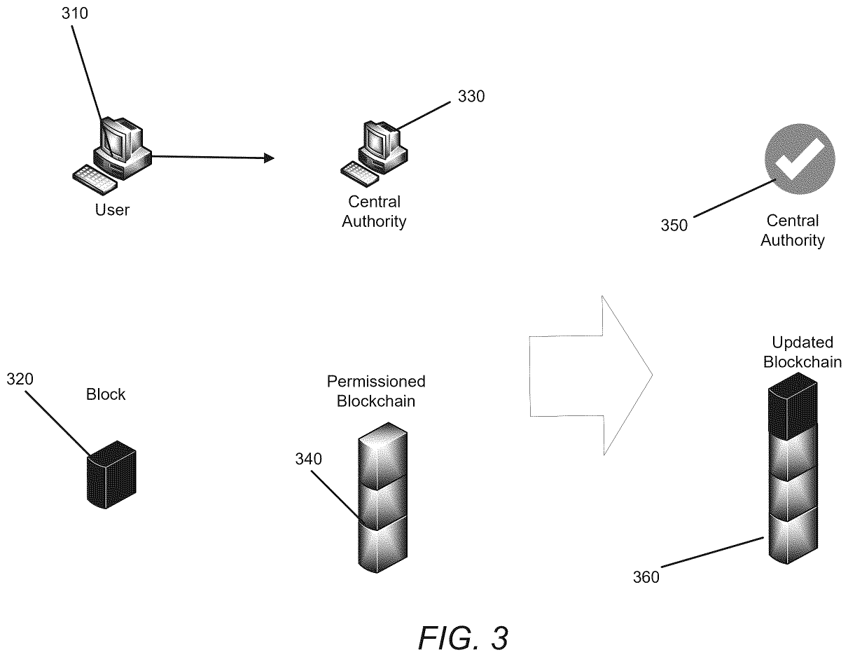

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

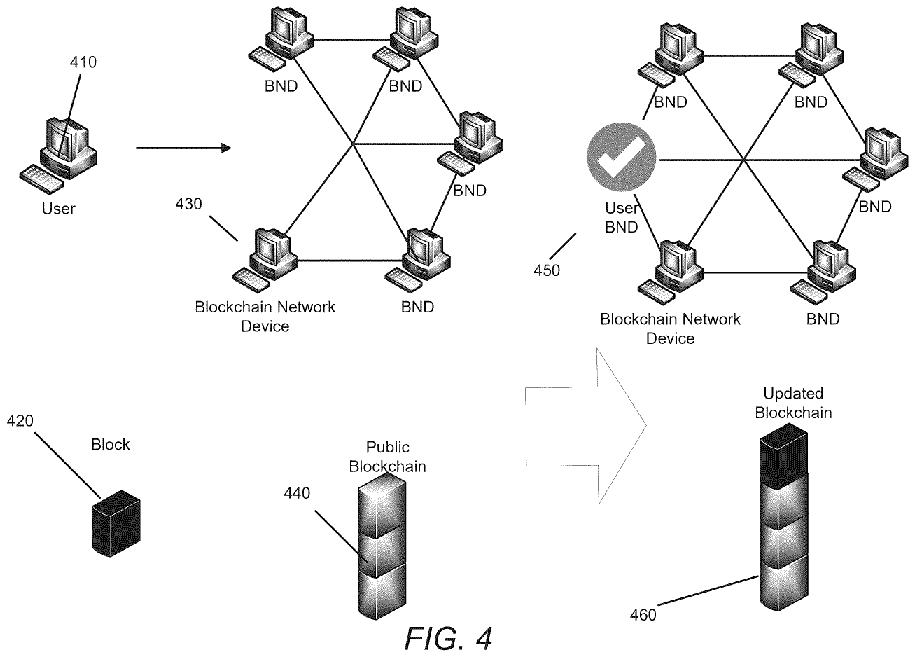

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, which preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

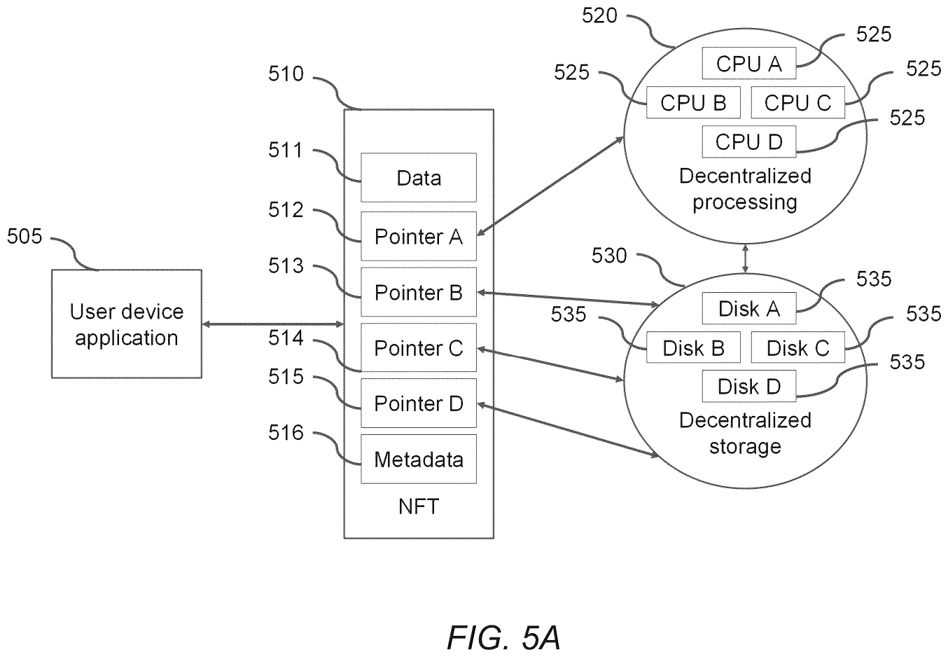

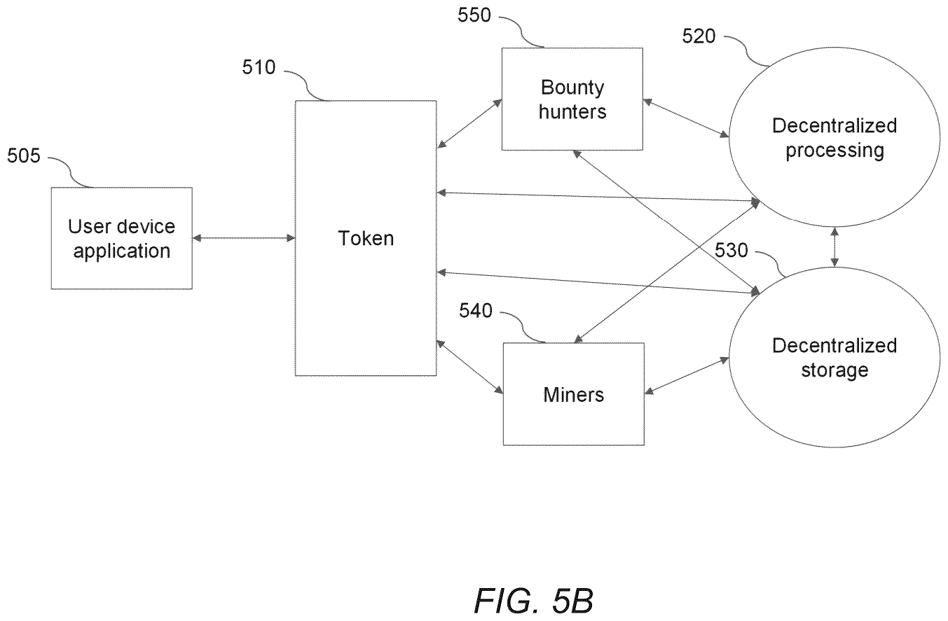

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g., URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separated. Pointer B 513 may point to one or more decentralized storage networks 530 for the purposes of maintaining an off-chain log file of token activity and requests. Pointer C 514 may point to executable code within one or more decentralized storage networks 530. Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that has proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (POS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

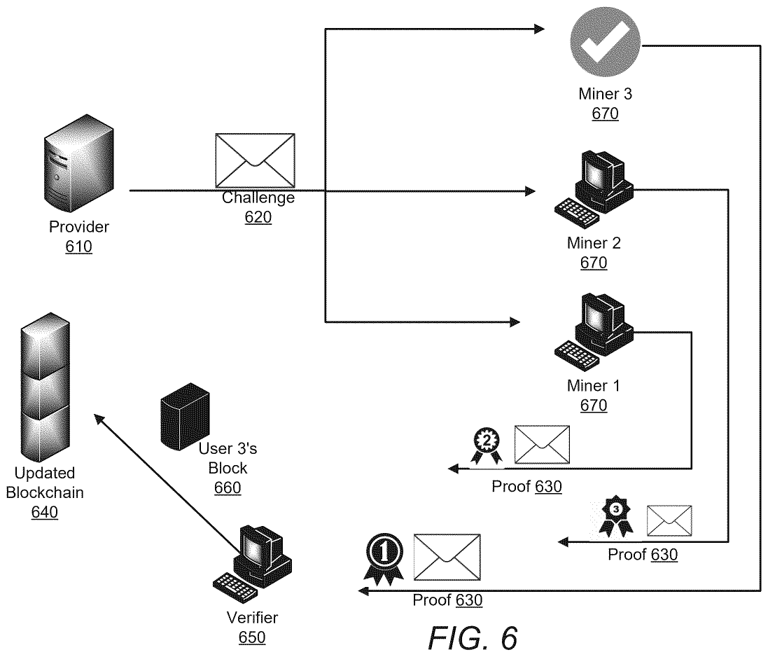

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party/provider 660 presents a complex problem (“challenge”) 610 and another party must broadcast a valid answer (“proof”) 620 to have clearance to add a block 650 to the decentralized ledger that makes up the blockchain 630. As a number of miners 670 may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 (i.e., the block corresponding to the winning proof 620) to the blockchain 630. As such, under a Proof of Work consensus mechanism, each miner 670 involved can have a success probability proportional to the computational effort expended.

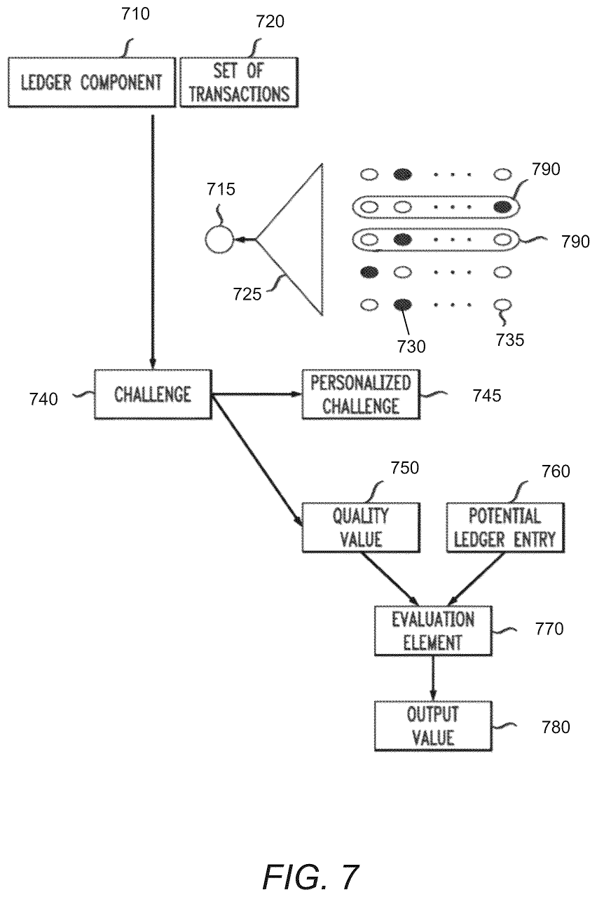

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

The miner may process challenges 740 to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

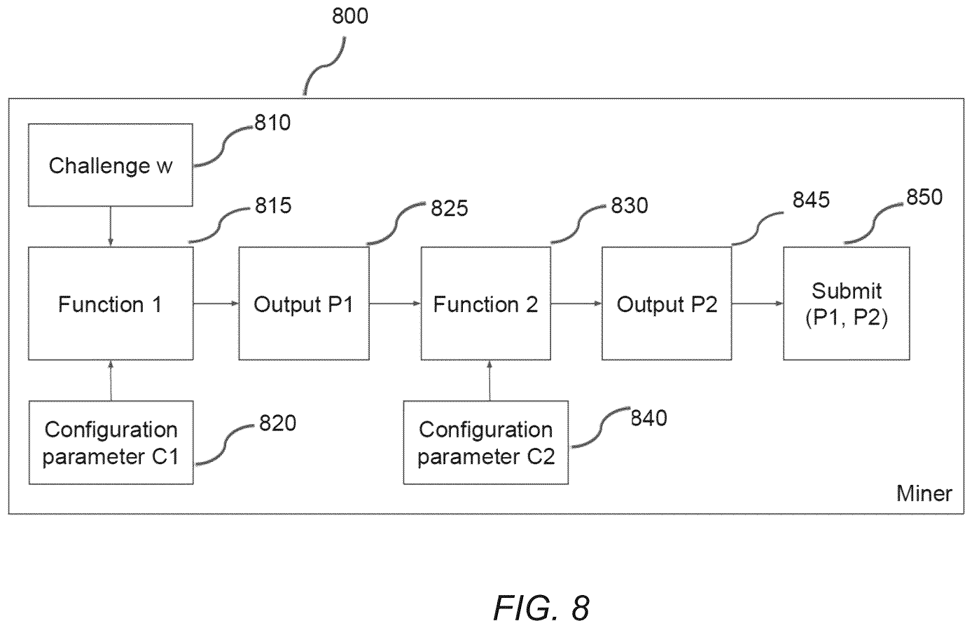

Dual proof configurations in accordance with a number of embodiments of the invention are illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditionally on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

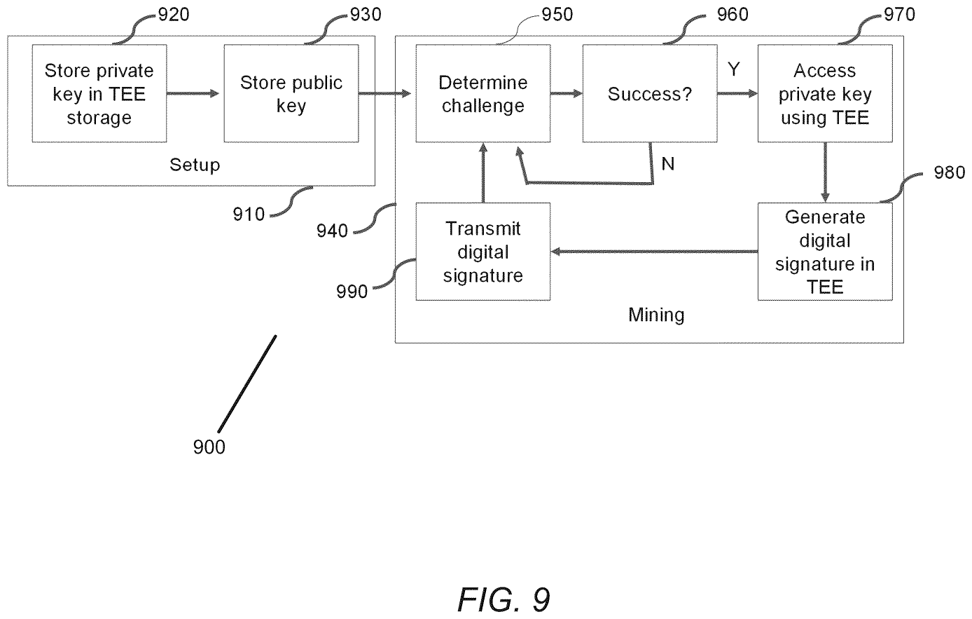

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e., storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determining (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the process can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

While specific processes for consensus mechanism operations are described above with respect to FIG. 9, any of a variety of processes can be utilized to approve transactions as appropriate to the requirements of specific applications in accordance with various embodiments of the invention. In several embodiments, steps may be executed or performed in any order or sequence not limited to the order and sequence shown and described. In numerous embodiments, some of the above steps may be executed or performed substantially simultaneously where appropriate or in parallel to reduce latency and processing times. In some embodiments, one or more of the above steps may be omitted.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

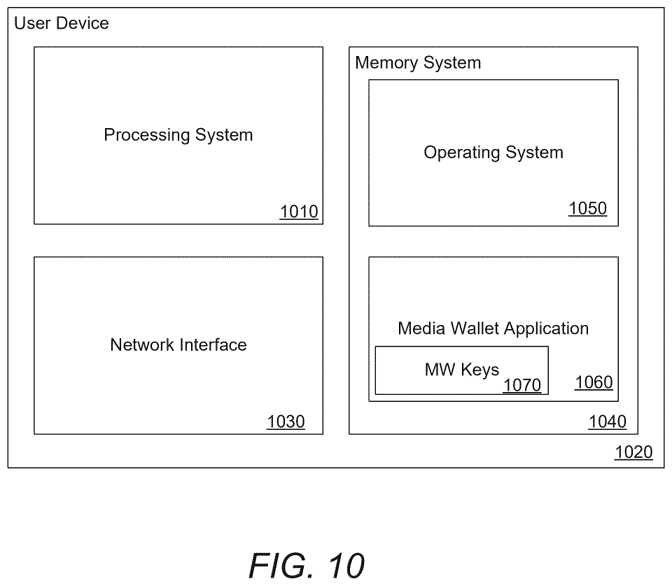

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention. In accordance with many embodiments, user devices may include at least one processor, which may be configured to process input data according to instructions stored in memory. The memory may be a tangible, non-transitory, computer-readable medium configured to store instructions that are executable by the processor. For example, the memory may be data storage that can be loaded with software code that is executable by the processor to achieve certain functions.

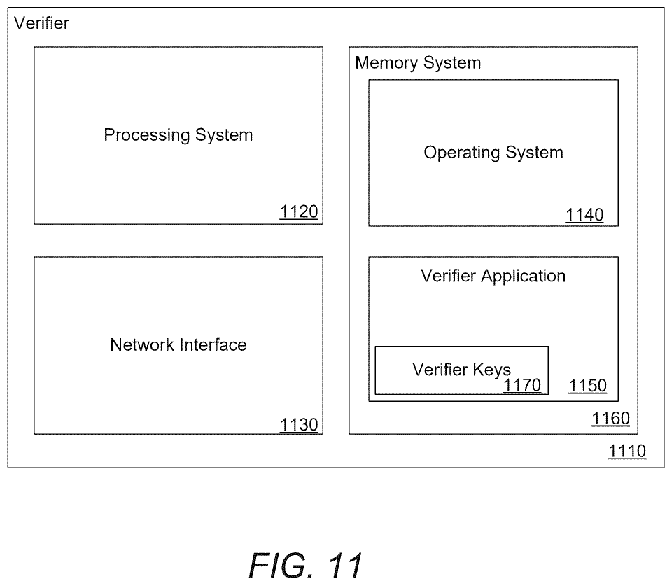

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

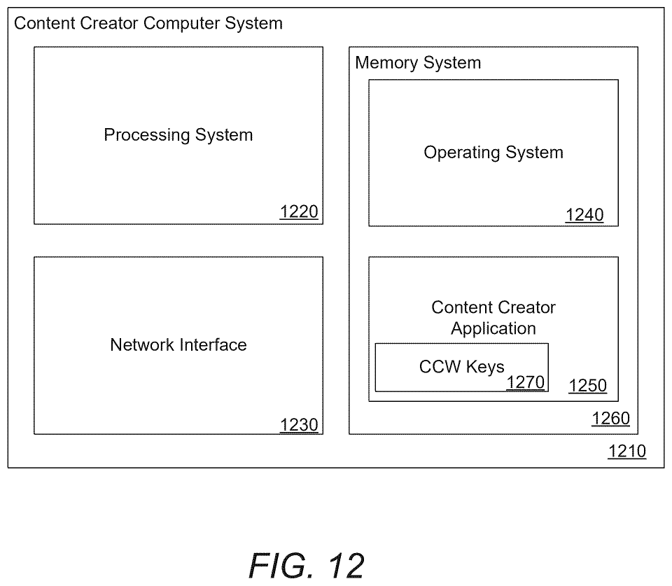

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

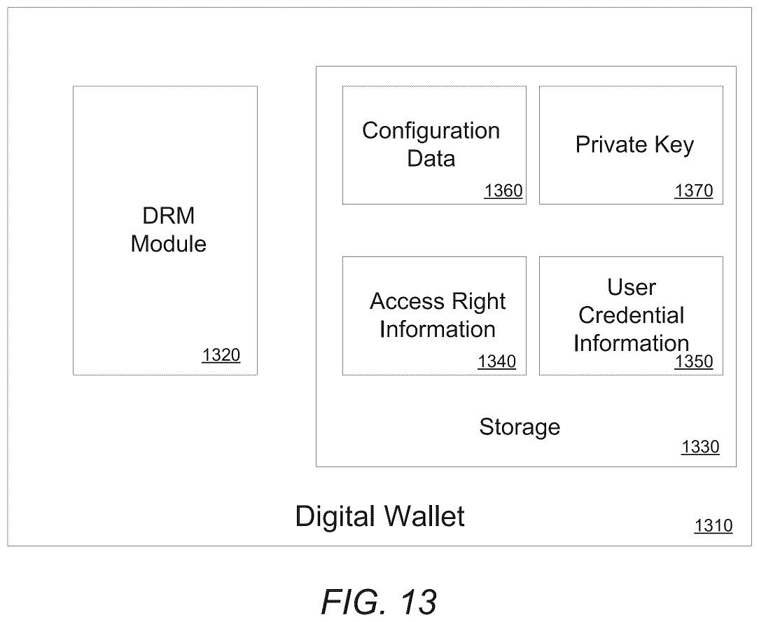

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

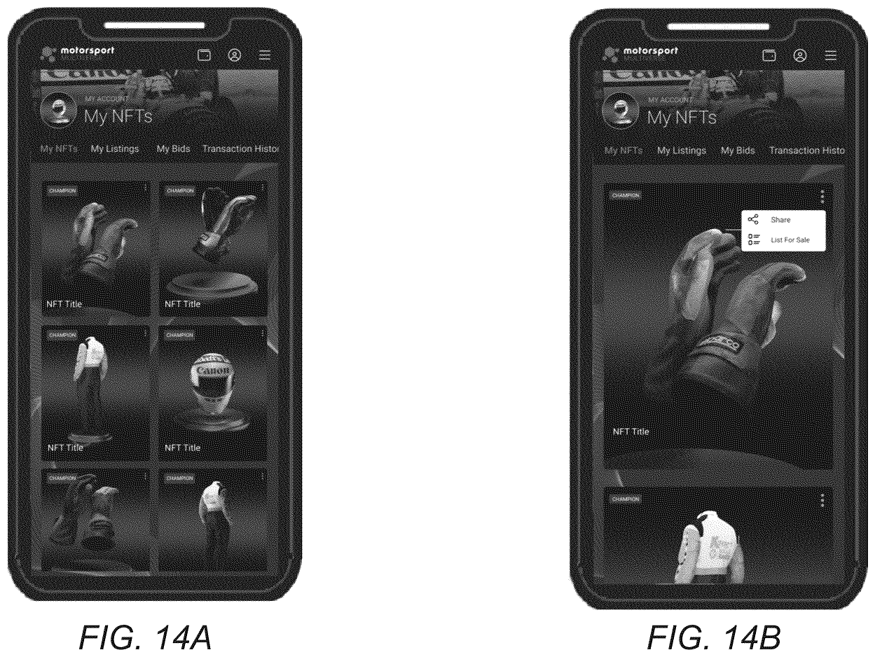

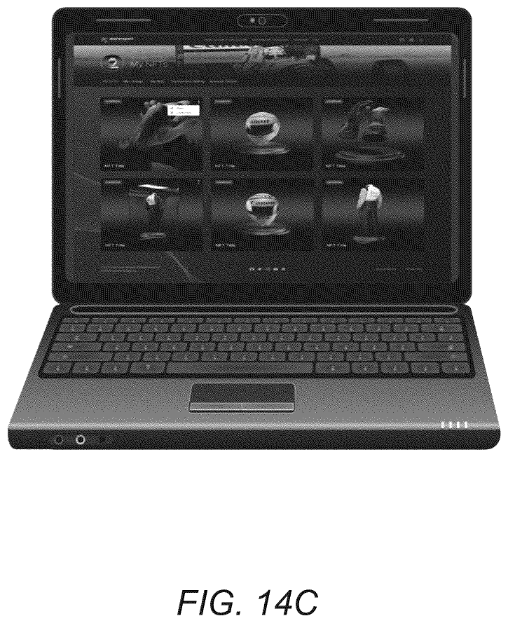

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the IOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet including the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertising data pertains. Elements describing advertisement data may be automatically placed in their associated partitions, after permission has been given by the user. This partition may be visible to the user. Visibility may also depend on a direct request to see “system partitions.” A first partition may correspond to material associated with a first set of public keys, a second partition to material associated with a second set of public keys not overlapping with the first set of public keys, wherein such material may include tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that also in-game capabilities are should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicate the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views in particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

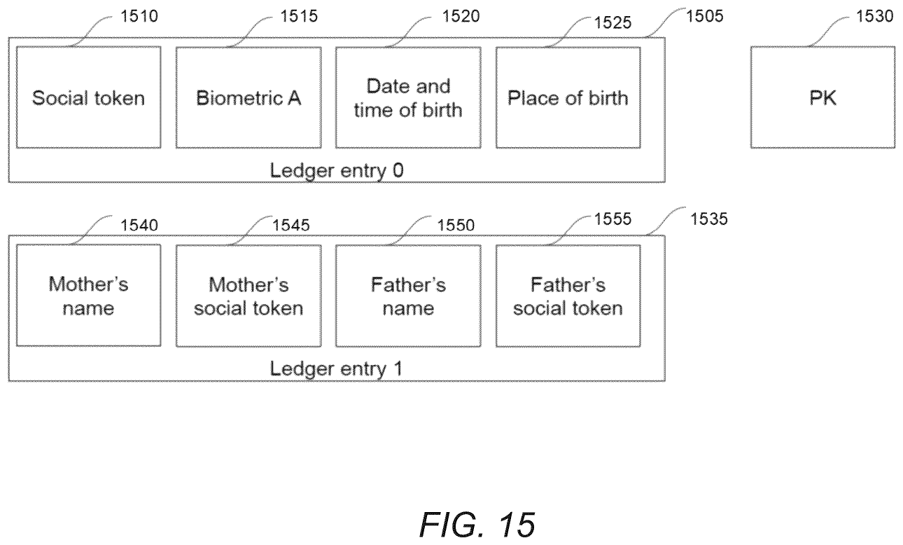

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race, gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may include policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may include audio-visual information describing how input text is presented, along with the input text that provides the material to be presented. It may also include what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

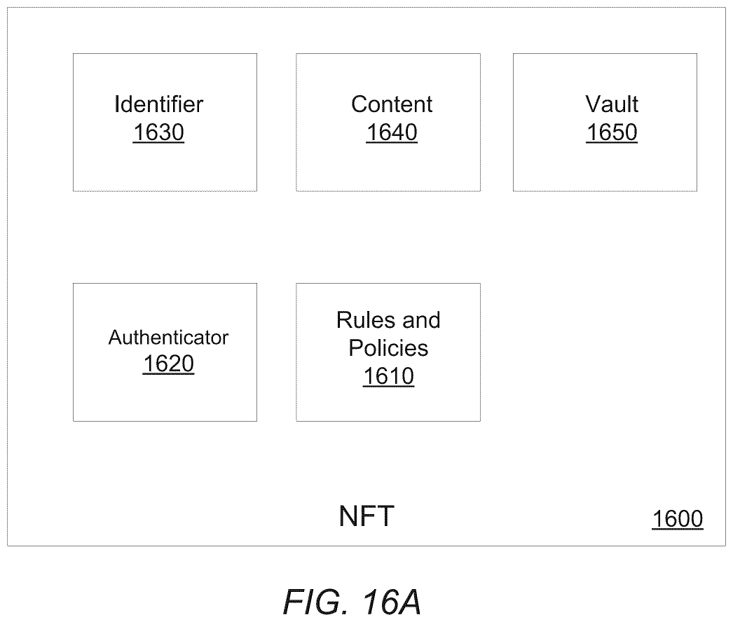

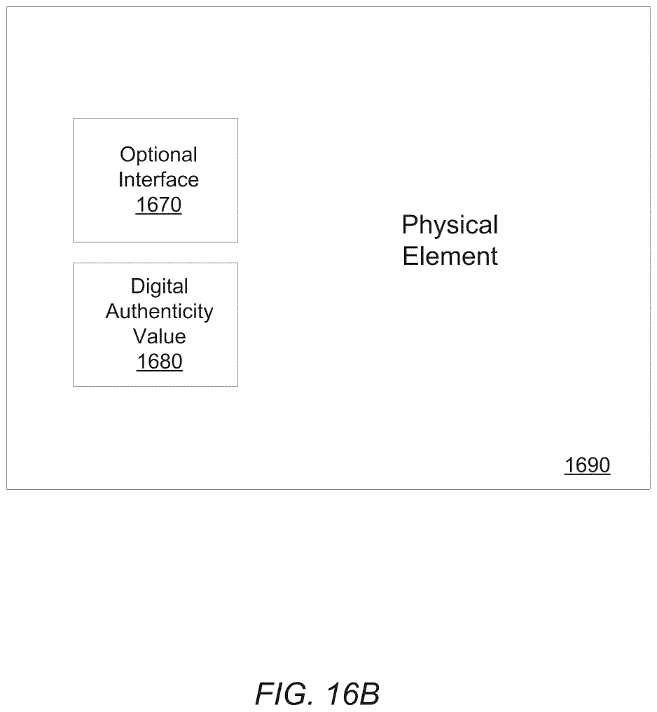

An example NFT which may be associated with specific content in accordance with several embodiments of the invention is illustrated in FIG. 16A. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

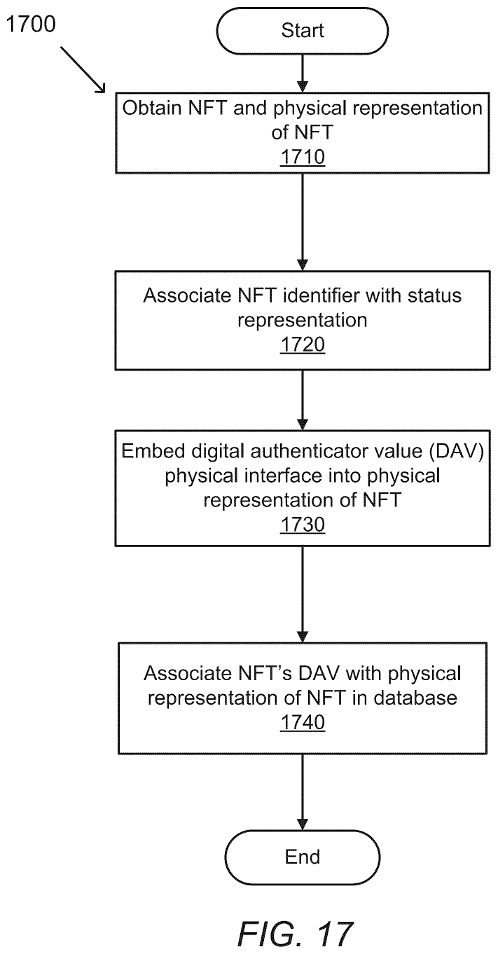

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. In many embodiments, steps may be executed or performed in any order or sequence not limited to the order and sequence shown and described. In numerous embodiments, some of the above steps may be executed or performed substantially simultaneously where appropriate or in parallel to reduce latency and processing times. In some embodiments, one or more of the above steps may be omitted. Additionally, the specific manner in which NFTs can be utilized within NFT platforms in accordance with various embodiments of the invention is largely dependent upon the requirements of a given application.

### NFT Platform Recourse and Quantum Security Integration Framework

Systems and methods in accordance with various embodiments of the invention may be directed to mitigating the risk and occurrence of illegitimate transfers with respect to blockchain transfers. Such transfers may correspond to schemes including but not limited to heists, large-scale hacks, malware-based theft, phishing-initiated theft, blackmail, abusive smart contracts, credential guessing and theft, payments for services and merchandise never received, etc.

In accordance with several embodiments of the invention, methods may be provided to efficiently and practically determine when recourse actions should be taken to address/modify undesirable transfers. Such determinations may include, but are not limited to, assessing what actions may be appropriate and what transactions should be modified. Modifications performed in accordance with some embodiments of the invention may include, but are not limited to, transfer reversal, as described herein. Potential recourse mechanisms may be desirable to reverse undesirable transfers, including but not limited to implementing watchful bridges, using watchful consensus mechanisms, using smart contracts, and/or using combinations of such techniques and variants thereof.

Additionally or alternatively, in accordance with certain embodiments, techniques may be provided for performing gas payments for quantum secure transfers without a bloated blockchain. This can be of significant value to streamline implementations in future quantum-secure transactions. In accordance with numerous embodiments, integration methods may combine two or more techniques across KYC, escrow, staking, and/or quantum security.

### I. Watchful Methods for Recourse

In accordance with many embodiments, the initiation of a recourse action may result from triggers including but not limited to complaints, reports of abuse, and detections that an abuse policy has been triggered. Examples of techniques of relevance to the implementation of recourse mechanisms have been disclosed in co-pending applications U.S. patent application Ser. No. 18/839,701, titled “Systems and Methods for Abuse Safeguards in NFT-Directed Environments,” filed on Feb. 17, 2023; U.S. patent application Ser. No. 18/176,920, titled “Partitioned Address Spaces in Blockchain Wallets,” filed Mar. 1, 2023; U.S. patent application Ser. No. 18/777,298, titled “Systems and Methods for Token Use and Protection Using Blockchain,” filed Jul. 18, 2024; U.S. patent application Ser. No. 18/343,630, titled “Systems and Methods for Node Facilitation, Communication, and Maintenance,” filed Jun. 28, 2023; U.S. patent application Ser. No. 19/038,599, titled “Systems and Methods for Performing Secure Transactions on Blockchain,” filed Jan. 27, 2025; and “Balanced Wallet Technology” by Markus Jakobsson and Keir Finlow-Bates, the disclosures of which are incorporated by reference in their entirety. In accordance with several embodiments, detection of triggered abuse policies may be performed by detector units that may include, but are not limited to, artificial intelligence (AI) and machine learning (ML) modules. Detector units may be configured to evaluate abuses based on feeds of inputs, including, but not limited to, sets of publicly accessible transaction records, one or more high-risk recipient addresses, timing data, and/or optional reporting data. The recipient addresses may include wallet addresses, public keys, IP addresses associated with transactions, blacklisted entities (such as known mix networks and/or known VPNs/proxies), and/or combinations of such information. Additionally or alternatively, timing data may indicate (but is not limited to) the times of one or more public transaction records, one or more Internet transmissions, one or more accesses to Domain Name System (DNS) servers, audit data from anti-virus software, audit data from mail servers, activity information associated with user devices, and/or time stamping data recorded by digital rights management (DRM) modules.

Detection units may, additionally or alternatively, take optional reporting data as input, including, but not limited to, reputations associated with user devices and/or user accounts, reporting histories of user devices and/or user accounts, and/or transaction histories of user devices and/or user accounts. In some embodiments, the optional reporting data may (additionally or alternatively) include user-reported information, including, but not limited to, text in free form, one or more selections and/or classifications, one or more URLs and/or emails, and/or activity information reported by users.

Detector units configured in accordance with certain embodiments may be configured to initiate response and/or recourse actions in the form of (but not limited to) indicators of an (abuse) event, indicators of (abuse) event probabilities, risk assessments, security actions, and/or fees (e.g., associated with escalated administrator analysis). Example security actions may include, but are not limited to, remedial actions such as initiating recourse transactions, notifying transaction originators and/or recipients, and generating log entries indicating risk assessments. Log entries may include data indicative of the situation, including, but not limited to, signatures classifying the context, patterns of observations, and/or one or more classifications and/or references to such.

In accordance with various embodiments of the invention, detector units may be incorporated into and/or associated with virtual storage entities, including but not limited to (e.g., digital) wallets. Detector units may, in some embodiments, be operated by and/or communicate with third-party entities (e.g., such as system administrators). For example, detector units may be:
operated by crypto service providers and/or security service providers;
associated with miners and/or validators;
related to entities including, but not limited to, insurers, marketplaces, and/or escrow authorities (e.g., selected by initiators of transactions, user wallets, financial institutions, consumer ombudsmen, employers of users, etc.);
configured to perform services for subscribers and/or insured parties;
contracted for individual events, e.g., to resolve, arbitrate, investigate, and/or otherwise address abuse complaints; and/or
engaged by service providers, including, but not limited to, marketplaces allowing the listing of and selling of goods, services, and/or cryptographic tokens.

In accordance with several embodiments, some users may pay insurance and/or other service fees to have all transactions from and/or to their wallets and/or accounts be scrutinized by detector units, which may be referred to as wallet protectors. Detector units may be granted the capability to block and/or undo transactions that are determined to be high risk, and to resolve the resulting situation, including undoing other related transactions. Detector units may be required to proactively approve any outgoing transaction from protected users, which can be achieved using techniques including, but not limited to, multi-signatures and/or adaptor signatures. Detectors may also scrutinize transactions that are inbound with respect to protected users, determining that the associated tokens do not utilize and/or be associated with malicious code, including high-risk smart contracts; are not for amounts below specified thresholds; are not from low-reputation senders; and/or are not from senders that the recipient users have not previously transacted with and/or otherwise approved.

In accordance with many embodiments, some jurisdictions may use mandates that detector units scan transactions and block, undo, and/or modify transactions that do not satisfy respective policies required by the jurisdiction. Example policies may include, but are not limited to, the logging of and/or referencing of KYC data, which may include escrowed identity data and/or anchor token references; determining that transactions requiring the payment of sales taxes, royalties, and/or other fees honor such requirements; and determining that only approved smart contract (and/or associated templates) are utilized. Special requirements may apply to cross-jurisdictional transfers, and detector units may be engaged to verify that transactions are properly formed. When improperly formed, detector units may be configured to report, block, augment, and/or delay the transactions and/or transaction requests.

In accordance with certain embodiments, security actions may be carried out in a delayed manner (e.g., several transfers after the suspect transfers that triggered the security actions). As such, in addition or in alternative to users receiving such transfers, users indirectly targeted by such transfers may need to consider the risk of security actions being taken (e.g., especially those affecting the completion of requested transactions requested by such users). In this disclosure, users may also refer to user-associated agents (e.g., incorporated in the users' wallets and/or executing on external computational nodes). Under the above configurations, users may desire to obtain risk assessments for incoming tokens being transferred to them, as this carries the capacity to reject tokens whose associated risk exceeds thresholds set by the users (and/or user agents).

In accordance with certain embodiments, users may be caught by phishing attacks (tricking users into entering PINs and/or pass phrases in interfaces reminiscent of their wallets, for instance). In doing so, attackers may create duplicate wallets and configure them with the stolen pass phrases, followed by transfers of all of the users' tokens to wallets owned by the attackers.

In accordance with many embodiments of the invention, users may prepare reports indicating abuse attempts. In these reports, users may upload data, including but not limited to, the mediums used (e.g., emails that they received asking them to log in to their wallets to confirm their passphrases); wallet/device information; and recent legitimate transactions that have been initiated.

From this information, detector units configured in accordance with multiple embodiments may extrapolate supplemental information, including, but not limited to, the types of wallets being used, the IP addresses associated with the users, and the transfer histories associated with the wallets.

Detector units may establish that the reported transfers are anomalous based on factors including, but not limited to, the types and sizes of transactions. For example, detector units may be configured to determine that the underlying transactions came from wallets of different types associated with IP addresses other than those in the users' histories.

Detector units may, additionally or alternatively, possess verification capabilities. For example, detector units may verify whether the emails are known and/or plausible phishing emails. They may look up web access and/or browser requests for the wallet devices for the time periods during which the users indicated they were tricked. Detector units may assign probability scores to particular (abuse) events (e.g., the reporting users were tricked by these phishing attacks, the money was stolen by the attackers). In accordance with some embodiments, probability evaluations may be contrasted with alternative scenarios, such as the reporting users lying and transferring the money to new accounts of their own.

In some embodiments, detector units may request that users install applications on their wallet devices and/or connected devices, including, but not limited to, gateways and/or laptop computers. Users may execute these applications to generate logs of events, where these events can be compared with the reported events to confirm and/or identify discrepancies. Detector units may, additionally or alternatively, verify the reporting histories of the users and the outcomes in previous reports to determine the likelihood that the reporting users are attempting to abuse the system. Detector units may further verify (e.g., Know Your Customer/KYC) records associated with reporting users. Doing so may verify that the records are not associated with criminal actions and/or other events, indicating attempted deception.

Based on this information, detector units may make decisions regarding what actions to initiate. Such actions may include, but are not limited to, initiating recourse, tracking the transfers of the tokens from the receiving parties, and/or modifying reputation scores associated with either the reporting users and/or the receiving users. Detector units may, additionally or alternatively, generate legal reports related to either of these entities and submit these to authorities.

In accordance with several embodiments, marketplaces (e.g., eBay, Amazon) may operate detector units that receive information, including, but not limited to, purchase information, delivery information, and complaint information. These detector units may receive and/or maintain reputation information for users. In some cases, reputation information may be derived independently of whether these users have operated on the marketplaces or not. In the latter case, the reputation information may be received from sources including, but not limited to, other marketplaces, insurers, and/or public records.

In determining security actions, detector units may identify transactions according to predetermined standards (e.g., where risk exceeds thresholds, where policies indicate that security actions should be taken). Additional/alternative information used by detector units may include, but is not limited to, zip-code-based risk assessments, product-based risk scores, and vendor-based information.

Security actions may include (in several embodiments) temporarily freezing transfers. These freezes may be performed proactively as they are requested and/or retroactively after being performed. The latter may include reversing the transactions to put them on hold; additionally or alternatively, retroactive freezes may involve placing the content (e.g., token) identifiers on freeze lists that are consulted before transactions are allowed on such tokens. The freezes may be overcome by escalations, e.g., by insurers that step in to guarantee the funds.

Additionally or alternatively, security actions may include placing affected tokens in escrow, requiring verifications before they are released. Such verifications may include, but are not limited to, submission and verification of KYC data, payment of royalties and/or sales taxes, and submission of proof of compliance with regulatory requirements.

In accordance with multiple embodiments, security actions may depend on the locations of the sending and receiving entities, including, but not limited to, where they are registered to be domiciled, where they are registered to do business, and/or where they appear to be located (e.g., based on geographic IP address information, based on request timestamps/timing data for initial filings and/or responses). Such techniques may also apply on a jurisdictional basis. For example, based on cross-jurisdictional transfer requests, determinations may be made regarding whether particular security actions need to be initiated. Such actions may include, but are not limited to, the payment of taxes, fees, and/or tariffs; the generation of and/or verification of KYC information; and the verification of business licenses and/or export licenses.

In accordance with various embodiments, detector units may be controlled by one or more administrators with varying duties. Different security actions may require different quorums for the requested actions to be performed. The specifications of the quorums may take the form of, but is not limited to, access control lists, thresholds, and/or combinations thereof. These specifications may be implemented using techniques including, but not limited to, multi-signatures, threshold signatures, and/or associated authorization controls.

Detector units may include component entities, including but not limited to, artificial intelligence (AI), rule-based engines, and/or one or more admins. These different participants may be asked to select security actions based on partial analysis by other such participants. Disagreement between different participants can be resolved using escalation methods in which larger and/or more time-consuming sets of analysis are applied.

In accordance with certain embodiments, security actions that can be applied, e.g., in one or more jurisdictions, may include applying penalties to tokens. For example, if 2 ETH tokens have been stolen, detector units may be authorized to associate penalties with the tokens. Penalties may be reductions of a certain percentage (e.g., 75%) or a flat fee (e.g., $1000) of the initial value. In some cases, penalties may be statements that are made public, indicating the token identities and the types and sizes of penalties. Penalties may also, explicitly and/or implicitly, be associated with one or more specific jurisdictions and/or other areas of use. In such cases, the penalties and/or associated security actions may be taken if/when the tokens are transferred to such jurisdictions and/or areas. These actions may include providing value to victims of abuse, such as entities from which the tokens were previously stolen.

For the sake of a concrete example, say that one or more tokens are associated with a penalty in jurisdiction A. This may be done while or after the token has been transferred to a different jurisdiction B. In jurisdiction B, there may be no requirement to abide by the rules of penalties associated with jurisdiction A. However, any user belonging to jurisdiction B may know that if he wishes to trade the token(s) to an entity belonging to jurisdiction A, then the penalty may apply, and the value of the token(s) may be reduced according to the penalty. If the user wishes to engage with the entity, that can make the tokens less valuable. In fact, the value reduction may be exactly the same as what is stated in the penalty.

When the user wishes instead to engage with a second entity in jurisdiction C, but the second entity later wants to engage with the first entity from jurisdiction A, the second entity may still discount the token(s) according to the value remaining after the penalty is applied. Therefore, the penalty, in spite of not being enforced outside jurisdiction A, may still apply in such areas, at least as long as jurisdiction A includes a sufficient number of users that others may wish to engage with.

Once the tokens are returned to jurisdiction A, their associated penalties may be disassociated from the tokens after payments of amounts corresponding to the penalties. These do not have to be the very same amounts; in some cases, penalty amounts could be reduced in order to provide incentives for return. This can be particularly useful when the token is an NFT, e.g., corresponding to resources that are non-fungible, such as art pieces and ownership of physical resources. At the same time, before being disassociated from the tokens, penalties may be used as deterrents against abuses, such as theft. This is because the parties who acquire them after the abusive transfers stand to see reductions in value as penalty reductions are applied.

In accordance with various embodiments, penalties may be recorded by placing records describing information, including but not limited to the penalties/tokens involved, jurisdiction information, and other relevant information. The records may be authenticated by trusted parties such as detector units and recorded on blockchains and/or other public databases. In accordance with many embodiments, additional authentication may be required, e.g., by trusted third parties. Different detection units may be authorized to generate different kinds of penalties (e.g., different severity, different associated policies, different underlying abuse reasons, etc.). The authorizations to apply penalties may be certified, with the certificates and/or references thereto incorporated in the penalty records.

In accordance with several embodiments, entities with KYC records may be punished for abuse by applying penalties (not only to specific tokens involved in detected abuses, but additionally/alternatively) to any tokens transferred to and/or from the entities to be punished. This can be a burden to such attackers, especially when there are significant drawbacks to not having KYC records and/or to only having KYC records that have been certified by entities that are not considered sufficiently trustworthy. That may require the attackers to obtain new KYC identities, which may be severe. Any tokens transferred from such penalized entities could be listed as having penalties. Additionally or alternatively, token-specific penalties can be inferred by anyone tracing tokens back to the punished entities, provided the tokens were in these parties' possession after the penalties were applied. This can reduce the value of any tokens transferred from such attackers to other users.

As demonstrated herein, there can be significant benefits associated with integrating blockchain signature mechanisms (such as quantum-secure CR signatures) with technologies including, but not limited to, KYC technologies, escrow technologies, and staking mechanisms. A person of skill in the art will recognize the benefits of such functionality, included in co-pending applications U.S. patent application Ser. No. 19/038,599, titled “Systems and Methods for Performing Secure Transactions on Blockchain,” filed Jan. 27, 2025; U.S. patent application Ser. No. 18/179,884, titled “Systems and Methods for the Facilitation of Blockchains,” filed Mar. 7, 2023; U.S. patent application Ser. No. 18/176,920, titled “Partitioned Address Spaces in Blockchain Wallets,” filed Mar. 1, 2023; U.S. patent application Ser. No. 17/821,444, titled “Systems and Methods for Management of Token Interactions,” filed Aug. 21, 2021; and U.S. patent application Ser. No. 18/179,884, titled “Systems and Methods for the Facilitation of Blockchains,” filed Mar. 7, 2023, the disclosures of which are incorporated by reference in their entirety.

### II. CAR Signatures: Paying Quantum Gas Fees

Quantum-secure systems configured in accordance with many embodiments may be implemented to optimize security against quantum attacks. Such systems may utilize quantum protection of token transfers and/or fees, including but not limited to gas fees. Traditional solutions to quantum attacks may include the use of signature schemes, including, but not limited to, Lamport, Merkle, and/or Winternitz signatures. However, all of these, and variants of such, can impose dramatic overhead on the use of blockchains. Most notably, the quantity of storage required may increase significantly, as each record submitted to ledgers may balloon in size when one of these signatures is included.

More efficient systems, relying on two-stage commit/release protocols, were disclosed in co-pending U.S. patent application Ser. No. 19/038,599, titled “Systems and Methods for Performing Secure Transactions on Blockchain,” filed Jan. 27, 2025, incorporated by reference in its entirety. Moreover, such methods are described in more detail below.

The essence of the commit-release approach, as disclosed therein, may be as follows. First parties wishing to transfer tokens to one or more second parties may use message authentication codes keyed using secret keys whose hash images are associated with the tokens. This may be accomplished by publishing, on blockchains, commitments (“commits”) to transactions, wherein the transactions associate the tokens (and/or specified fractions thereof) with the recipient(s), as identified by the respective hash images of their secret keys. By later decommitting, after having verified that the commitments were properly recorded on the blockchains, the token ownerships may be modified according to the specifications in the commitments. Associated schemes may be referred to as “CR signatures,” where CR is short for Commit Release. One or more of the second parties could be the one or more miners associated with the logging of the commit requests and/or the release requests.

In accordance with various embodiments of the invention, forms of assurance of payment can be associated with either commit requests alone and/or both commit and reveal requests. Assurances may include data that is tied to the requests in question, and optionally also to the identities of the blockchains and the approximate times the requests are made. These ties can make the reuse of assurances not possible, whether for the parties legitimately granted the ability to issue the assurances and/or for other parties performing front-running and/or replay attacks.

Assurances may take the form of traditional quantum secure signatures, e.g., Merkle signatures, on the data to which the assurances are tied and to statements indicating the sizes of the gas fees. Additionally or alternatively, the sizes of the gas fees may be implicit in the Merkle signatures, e.g., by associating one Merkle root with one gas fee size and another root with another gas fee size.

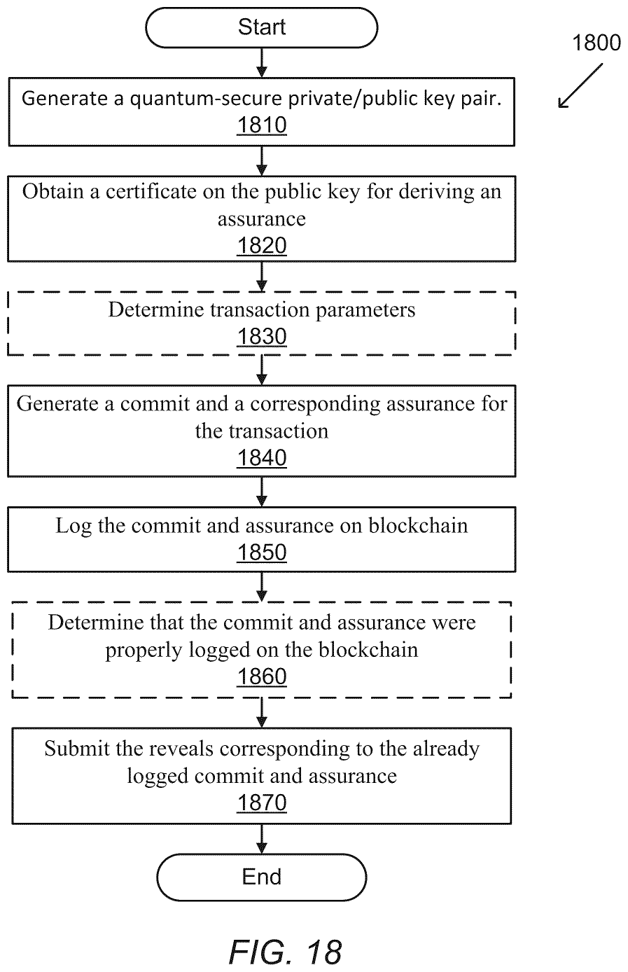

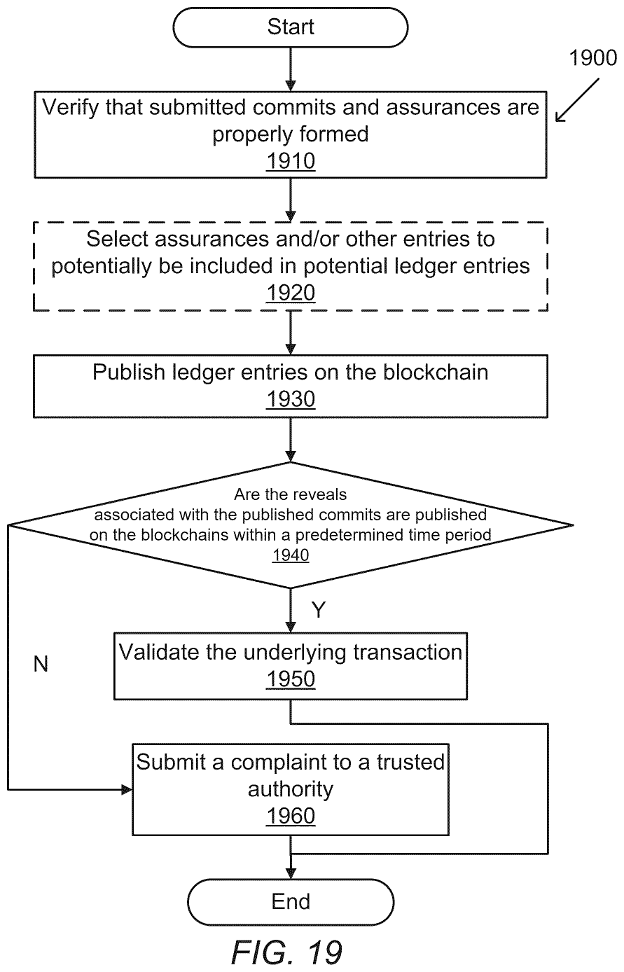

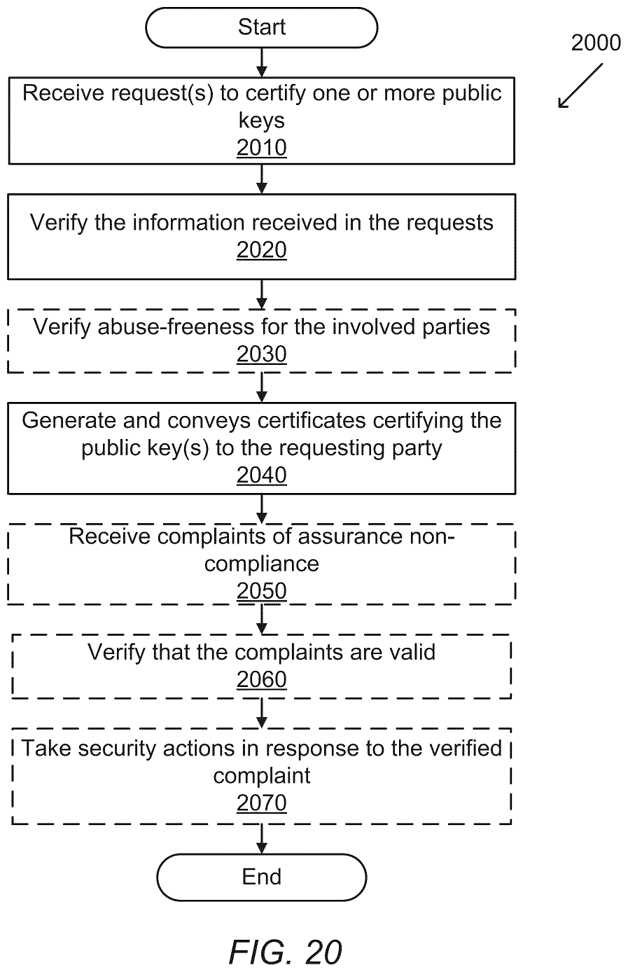

Processes for incorporating assurances into CR signature schemes in accordance with certain embodiments are illustrated in FIGS. 18-20. The process 1800 of FIG. 18 is an example that may be performed by particular parties to transactions, while the process 1900 of FIG. 19 may be considered from the perspective of miners, and the process 2000 of FIG. 20 may be considered from the perspective of certificate authorities. Process 1800 generates (1810) a quantum secure private/public key pair. In generating the private keys PRIV_A and corresponding public keys PUBL_A, (PRIV_A, PUBL_A) the pairs may correspond to quantum secure digital signature schemes, including, but not limited to, Merkle signature schemes and/or more efficient variants thereof. Process 1800 may submit the public keys PUBL_A to certificate authorities, along with optional material including, but not limited to, KYC data, escrowed identifiers, and funds for staking.

Process 1800 obtains (1820) a certificate on the public key for deriving an assurance. The certificates may specify information including, but not limited to, expiration dates, reputation scores associated with the party performing the process 1800, and amounts of funds staked. Process 1800 may store the certificate along with the key-pairs (PRIV_A, PUBL_A). These values may be used for the assurance described in the next few steps.

Process 1800 may determine (1830) transaction parameters. These may include, but are not limited to, information about one or more tokens, and party identifiers; for representation purposes, this may include private identifiers corresponding to a party B, represented as x_{B}, and/or public identifiers, h(x_{B}) based on the above private identifiers. In some cases, the private identifiers may be pre-existing. Moreover, as suggested above, the public identifiers may be calculated from cryptographic hash functions (i.e., h( )), such as SHA-256. The transaction parameters may, additionally or alternatively, include information about gas fee amounts offered and/or policies stating one or more conditions for the transfers of the tokens to B.

Process 1800 generates (1840) a commit and a corresponding assurance for the transaction. The assurance may include associated assurance values, which may include but are not limited to information about PUBL_A, information about the certificates, and digital signatures generated using PRIV_A on the input commits. Process 1800 logs (1850) the commit and assurance on blockchain. In several embodiments, logging this information may be done using mempools.

Process 1800 may, at some point in the future, determine (1860) that the commit and assurance were properly logged on the blockchain. This may entail waiting for some amount of time and/or some number of new ledger blocks being generated after the information first appears on the blockchains. This can reduce the risk of accidental removal due to forks.

Process 1800 submits (1870) the reveals corresponding to the already logged commit and assurance. In many cases, this submission may similarly involve logging the reveal on a blockchain (potentially, but not exclusively, the same blockchain used to log the commit and/or assurance. In accordance with some embodiments of the invention, the commit may be generated to include gas fee information used in logging (1850) the commit and assurance and/or used for submitting (1870) logging of the subsequent reveal. In such cases, corresponding assurance values may not be needed for the submission of the reveal.

As mentioned above, the process 1900 of FIG. 19 may be considered from the perspective of miners associated with blockchains used for transactions (including but not limited to transactions performed using the process of FIG. 18). These may include but are not limited to proof of work miners, as in Bitcoin implementations, and/or miners that rely on staking, as in the context of Ethereum.

In accordance with many embodiments, miners may only accept inputs as valid if the outputs contain conditions defined in the inputs. This can facilitate the indexing of transactions, enabling the collection of related transcripts and requests. At the same time, this example approach may keep the script evaluations to the transactions in question, with the external inputs already being indexed. A person of skill in the art will recognize that this may be only one possible implementation, though, and will be able to create many variants that can be applied instead and/or in addition.

Miners who mine blocks may get paid through transaction fees and also get rewards for mining the blocks themselves. Miners may pay themselves by creating Coinbase transactions that are the summations of all leftovers of transactions and the block mining itself.

FIG. 19 illustrates a process related to FIG. 18, from the perspective of miners associated with blockchains, in accordance with several embodiments of the invention. These may be proof-of-work miners, as in Bitcoin implementations, and/or they may rely on staking, as in the context of Ethereum. Process 1900 verifies (1910) that submitted commits and assurances are properly formed. Verifying (1910) proper form may include, but is not limited to obtaining confirmation that assurances include valid signatures on commits and that the signatures correspond to public keys that have been properly certified. Process 1900 may verify the assurances using mempools corresponding to underlying blockchains. Additionally or alternatively, process 1900 may verify other aspects, including, but not limited to, the expiration dates of the certificates; and/or that the staked funds meet a specific threshold (e.g., which may depend on the promised gas fees of the commits).

Process 1900 may optionally select (1920) assurances and/or other entries to potentially be included in potential ledger entries. Miners may select assurances to be included in the open ledger entries. Note that commits may not need to be recorded on the blockchains but may simply be temporarily stored by the miners until they know whether they have been paid the gas fees promised in commits.

Process 1900 publishes (1930) the ledger entries on the blockchain. In doing so, the new ledger entries may be added to the blockchain and made public. Additionally or alternatively, miners may have the capacity to observe new ledger entries added to the blockchains. Process 1900 determines (1940) whether the reveals associated with the published commits are published on the blockchain within a predetermined time period. The predetermined time periods may include, but are not limited to, time periods promised in commits and/or otherwise determined by common protocol parameters known by the miners. When the reveals are published within the predetermined time period, process 1900 validates (1950) the underlying transaction.

When the reveals are missing for commits, that can mean that the gas fees promised in commits were not paid by the parties submitting commits and/or assurances. In essence, the assurances were not honored by the submitting parties. Process 1900 submits (1960) a complaint to a trusted authority, which may include but is not limited to certificate authorities and/or other trusted parties. The complaints may include assurances and/or references to the assurance(s) and/or section(s) of the blockchain(s), which may include the associated commits and continue with consecutive blocks until the cutoff times were reached, i.e., the times before which the reveal needed to be published.

FIG. 20 illustrates a process related to FIGS. 18 and 19, as seen from the perspective of certificate authorities, in accordance with some embodiments. Process 2000 receives (2010) request(s) to certify one or more public keys (i.e., validate that the public keys=PUBL_A). These requests may include additional information, including, but not limited to, information related to the identities of the requesting parties, information related to funds to be staked and/or otherwise placed in escrow, and/or information about the requested certificates, such as their expirations.

Process 2000 verifies (2020) the information received in the requests. This may include, but is not limited to, steps for verifying: the validity and/or authenticity of KYC records, that there are no entries on blocklists corresponding to such KYC data, and that the funds staked and/or escrowed are unencumbered. Process 2000 may, in various embodiments, verify (2030) abuse-freeness for the involved parties. This may entail verifying that there are no outstanding complaints against the parties indicated in the KYC records. For example, certificate authorities may refuse to certify public keys for parties that have repeatedly failed to follow the required guidelines and/or that have been found to have engaged in forbidden behaviors. Such behaviors may include, but are not limited to, cheating, abusing the system, publishing illegal information, and spreading dangerous data such as malware. Process 2000 generates (2040) and conveys certificates certifying the public key(s) to the requesting party, which in this example may be party A.

Process 2000 may potentially receive (2050) complaints of assurance non-compliance for the request(s). Such complaints may, for example, correspond to the complaints submitted in step 1906. Process 2000 verifies (2060) that the complaints are valid. This may include, but is not limited to, verifying that the claimed entry commits exist in the indicated blockchain entries, that the claimed assurances are value assurances associated with commits and their recording on the blockchains at the times they were, and that assurances are correctly generated and certified (whether by the receiving certificate authorities and/or other such certificate authorities). Verifying the validity may, additionally or alternatively, include checking blocklists and/or allowlists for the subject(s) of the complaint. Process 2000 takes (2070) security actions in response to the verified complaints. These may correspond to actions including, but not limited to, ignoring the complaints, blocklisting the parties associated with the assurances in the complaints, paying the miners filing the complaints compensatory amounts, determining the identities of the users generating the assurances in the complaints, modifying reputation values associated with the miners, modifying reputation values associated with the parties generating the assurance values, and/or combinations of these and/or related actions.

While specific processes for implementing quantum-secure systems are described above, any of a variety of processes can be utilized to implement transactions as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to CR signature schemes the techniques disclosed herein may be used in any type of transactions.

### III. Use of Assurances to Express Policies, Conditions and Gas Promises

In accordance with various embodiments, commit requests may, by themselves, not be possible for recipients to verify before the corresponding reveals are performed. In such cases, commit requests can be accompanied by various pieces of auxiliary data, where some auxiliary data may be logged on the blockchains and others may not be. For example, the auxiliary data to be logged may include conditions for when first tokens should be transferred in first transfers from the senders (such as party A) to the indicated recipients (such as party B), e.g., provided that recipient party B initiates additional transfers of second tokens to specified recipients, such as party C.

Examples of auxiliary data that could be implemented in accordance with certain embodiments may be promises of the gas fees offered. These may be broken down in terms of the promised gas fees for the logging of the commit requests and/or for the logging of the reveal requests. These two gas promises may not be of the same size, and the reveals may, for example, be larger to guarantee that the reveals are performed within the desired times after being submitted to the mempools. It can be practical if the gas fees for the commit requests correspond to auxiliary data that is not logged, whereas the gas fees for the associated reveals, which in this example may be decided prior to the commits being done, is logged.

In accordance with various embodiments, commit requests may, by themselves, not be possible for recipients to verify before the corresponding reveals are performed. In such cases, commit requests can be accompanied by various pieces of auxiliary data, where some auxiliary data may be logged on the blockchains, and others may not be. For example, the auxiliary data to be logged may include conditions for when first tokens should be transferred in first transfers from the senders (such as party A) to the indicated recipients (such as party B), e.g., provided that recipient party B initiates additional transfers of second tokens to specified recipients, such as party C. A person of skill in the art will recognize that transfers may involve more than one party and one or more miners collecting gas fees, and may be made to n parties in specified fractions that may be expressed in the auxiliary data to be logged, for example.

Examples of auxiliary data that could be implemented in accordance with certain embodiments may be promises of the gas fees offered. These may be broken down in terms of the promised gas fees for the logging of the commit requests and/or for the logging of the reveal requests. These two gas promises may not be of the same size, and the reveals may, for example, be larger to guarantee that the reveals are performed within the desired times after being submitted to the mempools. This can be practical if the gas fees for the commit requests correspond to auxiliary data that is not logged, whereas the gas fees for the associated reveals, which in this example may be decided prior to the commits being done, is logged.

In original protocols, the commit requests may simply be in the form of hash functions of (x_{A}, h(x_{B})) where x_{A} may be the keys of the senders and x_{B} may be the keys of the receivers, and wherein the senders know h(x_{B}) (e.g., public keys) but not x_{B} (e.g., private keys). To add the auxiliary data to the protocols, one way may be to instead of setting the commit requests to h(x_{A},h(x_{B})) to set them to C=h(x_{A},h(x_{B}),aux\_log) where aux may represent the auxiliary data to be logged. The associated assurances A may be digital signatures on (C, aux\_log, aux\_nolog), where aux\_nolog may be the auxiliary data not to be logged.

Traditionally, hash functions may be considered atomic and not possible to compute in a distributed manner. In accordance with numerous embodiments, it may be demonstrated that it can be possible, and practical, to compute hash functions in distributed manners, protecting the inputs of different participants from each other. In accordance with some embodiments of the invention, hash functions initialized using initialization vectors may receive inputs in various manners. Specifically, in some cases, inputs may be processed in a distributed manner via smaller chunks. One can think of it as x=x_1|x₂ where | represents concatenation. This perspective may show how to make the computations distributed:
(1) Recover the state (“state1”) of a hash function having processed the IVs.
(2) Feed a first sub-input (x₁) to the hash having state1, causing the state to be updated to state2, reflecting the state of the hash function having processed the IVs and x₁.
(3) Feed x₂ to the hash having state2, potentially causing the state to be updated to state3, which may be the state of the hash functions having processed the IVs and x₂.
   Using this process, the distributed hash may be performed, for example, through having a first user compute a state (with x₁), which can be sent to a second user to initiate a second hash (with x₂), generating the final result. In many cases, both users may perform this process while being prevented from learning the inputs provided by the other. A person of skill in the art will recognize that this may also generalize to multiple users, and that the described steps can be iterated if there are multiple processing rounds.

A number of implementations have been described. Nevertheless, it will be understood that various modifications may be made without departing from the spirit and scope of the disclosure. Accordingly, other implementations are within the scope of the following claims.

The payers (in this example, party A) may submit (C, A, aux\_log, aux\_nolog) to the mempools. Miners may verify that A are valid signatures on (C, aux\_log, aux\_nolog) and reject any requests for which this is not so. Miners may select what requests to add to the ledger entries based on the gas offers, which may be included in one of aux\_log and/or aux\_nolog. Miners may know that if the reveals are not performed and/or contain lesser gas fees for them than promised in the commit requests, then the miners can file complaints to get reimbursed, causing the payers to be punished. When the reveal requests are later submitted to the mempools, anybody can verify that the sizes of the promised gas payments were indeed paid.

By letting the transfers depend on conditions, such as actions taken by other parties, the determinations of where to transfer the tokens associated with the commits and reveals may be determined once the reveals have been made, e.g., by miners and/or validators. It can be practical for two parties wishing to exchange tokens to agree on the terms first, followed by one of them (party A) performing the first transfer. This transfer may be made to the second party (party B) when the second party performs a transfer of a resource to the first party (party A) within some period of time. When the second party does not, then the transfer of the resource may instead be made to the first party, who now has paid himself (minus the gas fees) and therefore avoided transferring his token to the second party. The period of time here may be a protocol parameter (including, but not limited to, “ten minutes” and/or “within twenty blocks”) and/or may be specified by the parties involved, e.g., in the auxiliary data.

As an alternative to letting assurances related to auxiliary data express gas fee promises, it may also be possible to let the gas fee promises be implicit in the types of signatures used. For example, users may have one public key associated with 5-cent gas fee payments (e.g., as expressed in the certificates) and another that is associated with 2-cent gas fee payments.

In accordance with certain embodiments, it can be beneficial for the auxiliary data to encode, in publicly accessible and unencrypted manners, what the transfers being committed to are. For example, if the transfers are of v₁, portions of the input bitcoin values V of tokens T from party A to party B, where v₁<V and where A's public identifiers for the transactions are h(x_{A}) and where B's public identifiers are h(x_{B}), then the auxiliary data can take the form of encodings of direction “v₁ of T from h(x_{A}) to h(x_{B}).” When parties lie in promised transactions—for example, when A cheats and promises transfers v₁ of T (and/or parts thereof) to B, but then in fact commits to transfers of T to C, using the identifier h(x_{C}), where A and C may even belong to the same entities; and/or when A transfers only v₂ of T to B (where v₂<v₁), then B can file complaints. These complaints may show that the auxiliary data does not match the commitments C, where the assurance values are digital signatures on both the auxiliary data and the commitments C. Cheaters cannot modify the auxiliary data to falsely accuse A since the cheaters cannot modify the assurance values, those being digital signatures.

Additionally or alternatively, transactions may be considered valid (e.g., exclusively) when the commitment inputs match the release data, and/or when both match the auxiliary data. Such illegal transfers may be reported, placed in escrow, and/or automatically rerouted to the appropriate recipients based on the digitally signed auxiliary data. These overrides may be performed using watchful mechanisms such as those disclosed herein and in related applications. That is, recourse mechanisms can automatically override transfers that are malformed, blocking cheaters from stealing tokens, causing chaos, and/or otherwise deviating from the protocols. Cheaters can be punished by having their certificates related to the assurance mechanisms change status with respect to (e.g., blockchain-associated) lists—for example, being placed on blocklists and/or removed from whitelists.

A person of skill in the art will recognize that the augmentations described above can be used to add other functionality, and that the functionality of conditional transfers and gas fee promises are just illustrative and non-limiting examples of the use of this powerful technique.

In accordance with numerous embodiments, assurance root values may preferably be certified, e.g., signed by trusted parties and/or otherwise associated with identifiers including, but not limited to, KYC records, anchor tokens, bank accounts, and/or other identifiers of users and/or organizations.

In accordance with many embodiments, the payments of gas fees may be performed in the decommit phases of the CR schemes with which the disclosed assurance techniques are combined. As long as proper decommits (and/or releases) are posted within specified times and/or numbers of blocks from the associated commit requests, the payments of the gas fees may be performed using the same mechanisms as those in which the token transfers of the CR signatures are transferred.

However, when the users posting the commit requests with assurances (henceforth: the CA, short for Commit Assurance) do not post the associated and properly formed releases within the specified times, the miners affected by the loss of gas fees can take the CA requests, along with evidence that no associated reveal (R) was posted, to authorities that take security actions. These security actions may be taken after making verifications, ensuring, but not limited to, that the assurance elements are properly formed in relation to the commit data, that the commit data was indeed posted on the blockchains, and that associated releases were not posted on the same blockchains within the specified amounts of time and/or blocks.

The security actions could include, but are not limited to, revealing the identities of the users associated with the assurances and/or imposing financial penalties, e.g., by making payments to the miners corresponding to the gas fees and withdrawing the corresponding amounts, plus optional punitive amounts, from escrowed amounts associated with the users. Additionally or alternatively, security actions may include blacklisting the Merkle roots of the defaulting users. Such actions may also be taken as escalation actions, e.g., after users have failed to properly pay gas fees some specified number of times.

Note that the assurance values may not need to be logged on the blockchains, as they become moot after valid releases have been made, since the releases may include the payments of gas fees for both the CA requests and the R (release) requests. Similarly, auxiliary data not to be logged, as its name suggests, may not be logged on the blockchains and may, in some cases, only be stored until the miners processing the commit requests have collected their promised gas fees (which may be done in the associated reveal requests as these are posted on the blockchains). If the miners do not receive the promised gas fees, the miners can file complaints (including the assurances, the commitments, the auxiliary data, as well as other data as described before).

In accordance with several embodiments, users may be associated with multiple certified Merkle roots and/or other equivalent capabilities to generate certified signatures that are quantum secure. These may be generated by the same certifying entities and/or different ones, and they may be associated by the certifiers to one and the same and/or to different identifiers.

For example, one identifier may be an escrowed KYC record stating the user's name and address. Another identifier may be a KYC record that is accessible to the public and which may not be encrypted, and which may include an anchor token (also known as a soulbound token) and/or a reference to one. Yet another identifier may not be associated with any data identifying the user, but rather, data identifying an account where the user has escrowed funds. This may be done in the form of staking, where slashing may be used to penalize parties who generate assurances without following up with associated gas payments. Additionally or alternatively, it may be done in the form of cryptographic tokens with smart contracts that allow the tokens to be spent to pay for gas fees and optional penalties, should it be determined that the users have failed to pay gas fees in release requests. Combinations of such tools may also be implemented, where records may include both references to escrowed funds and KYC elements that may be used to identify the users.

### IV. Example Signature Schemes to Express Assurances

In accordance with many embodiments, instead of using traditional Merkle signatures, modified versions may be used. Examples of such modifications include, but are not limited to, those disclosed in “Merkle Tree Ladder Mode: Reducing the Size Impact of NIST PQC Signature Algorithms in Practice” by Andrew Fregly, Joseph Harvey, Burton S. Kaliski Jr., and Swapneel Sheth, available at https://eprint.iacr.org/2022/1730; “Leighton-Micali Hash-Based Signatures” by McGrew, Curcio, Fluhrer (see RFC 8554, IETF (2019), https://doi.org/10.17487/RFC8554); and “XMSS: extended Merkle Signature Scheme” by Huelsing, Butin, Gazdag, Rijneveld, and Mohaisen (RFC8391, IETF (2018), https://doi.org/10.17487/RFC8391), the disclosures of which are incorporated by reference. A person of skill in the art will recognize that there are a variety of suitable variants of signature schemes (e.g., Merkle signatures, Lamport signatures, and Winternitz signatures) that can be utilized for the purpose of generating and verifying the assurances, and certifications of the verification structures, in accordance with some embodiments of the invention.

The disclosed approach, which may be referred to as CAR signatures (Commit Assurance Reveal), can be used in the context of blockchain approaches including, but not limited to, proof-of-work and staking-based blockchains, as well as any other blockchain approach requiring quantum security, as will be recognized by skilled artisans.

Assurances may express abilities to generate digital signatures using quantum-secure schemes, where the assurances correspond to digital signatures verified using public keys, said public keys having been certified and/or otherwise approved by trusted parties. Examples of certification may include but are not limited to the use of quantum-secure digital signature schemes, such that these can be verified using certificate authority public keys that have either been certified, in turn, and/or which are included in roots of trust.

If certificate authorities wish to revoke certificates, they can add the public keys corresponding to the assurances to blocklists and/or respond negatively to inquiries about those keys. Additionally or alternatively, the public keys corresponding to the assurances may be included in whitelists as long as they remain approved, at which time they may either be removed from the whitelists and/or also added to blocklists. Both whitelists and blocklists can be implemented as publicly accessible and/or queryable databases, including blockchains.

In accordance with various embodiments, the public keys of assurances may be linked to identifiers, which may be encrypted. Examples of this may include, but are not limited to, using identifiers implemented using KYC records, escrow techniques, and/or escrowed user identifiers, as disclosed herein. The public keys of the assurances may, additionally or alternatively, be linked to accounts corresponding to funds received and/or held by the certification authorities and/or associated parties as part of the processes of certifying the public keys.

Once legitimate complaints are filed, the associated funds may be used to pay for the gas fees and for other fees. In this example, the public keys may simply be linked to account records including remaining amounts. The public keys may also be associated with staked resources.

As an alternative to using assurances, and/or in addition to this, one gas fee payment can be initiated at the time of releases (R) requests by piggybacking commitments to these payments with the reveals of the previous transactions. To bootstrap, initial gas fee payments can be initiated using assurances, as disclosed herein. In accordance with many embodiments, first users may include commits for gas payments in the release requests of other parties, whether routinely and/or as bootstrap mechanisms.

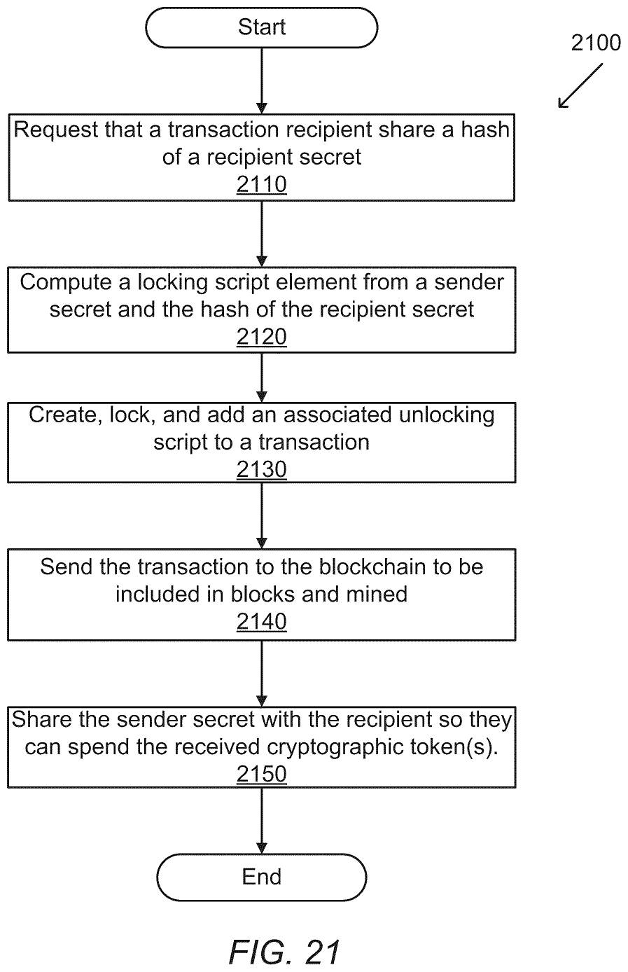

A process illustrating sequences of steps for sending and receiving cryptographic tokens in accordance with miscellaneous embodiments of the invention is illustrated in FIG. 21. Process 2100 may be performed by one party (party A) to a transaction. Process 2100 requests (2110) that a transaction recipient share a hash of a recipient secret (i.e., A requests B as a recipient to share h(x_{B})). Process 2100 computes (2120) a locking script element from their own (i.e., sender) secret and the hash of the recipient secret (i.e., A computes element <H>=H(h(x_{B})|x_{A}))). Process 2100 creates (2130) locks, and adds an associated unlocking script to a transaction. The transaction may be locked using the locking script element. Additionally or alternatively, the unlocking script may similarly be derived from the secrets for the transaction. An unlocking script may also be referred to as an unlock script in this disclosure.

Process 2100 sends (2140) the transaction to the blockchain to be included in blocks and mined. In several embodiments, process 2100 may not have shared the secret x_{A} with recipient B (yet). In such cases, when the payment transactions mature, process 2100 shares (2150) their (i.e., the sender) secret (x_{A}) with the recipient so they can spend the received cryptographic token(s). To use the token(s), B may create transactions and use the sending party's secret to unlock them. The cycles may repeat this time for C, the new receivers of the cryptographic token(s).

While specific processes for implementing quantum-secure systems are described above, any of a variety of processes can be utilized to distribute transactions as appropriate to the requirements of specific applications. In many embodiments, steps may be executed or performed in any order or sequence not limited to the order and sequence shown and described. In some embodiments, some of the above steps may be executed or performed substantially simultaneously where appropriate or in parallel to reduce latency and processing times. In multiple embodiments, one or more of the above steps may be omitted. Although the above embodiments of the invention are described in reference to cryptographic tokens, the techniques disclosed herein may be used in several types of transactions.

In the following example, Bitcoin implementations of quantum-secure transfers may be detailed in accordance with certain embodiments of the invention. Aspects of the invention can make Bitcoin quantum-secure, using previously disclosed CR signature technology, without having to modify the native Bitcoin consensus algorithm and/or how the transaction fees are paid. In accordance with several embodiments, scripts referred to as p2dwh (short for “pay to double wrapped hash”) may be utilized that lock and unlock transactions using two pre-images. One of these pre-images may be related to the senders of the transactions in one step, and the second pre-image may be related to the receivers of bitcoins and may be used when needed to transfer those bitcoins to recipients.

For an illustrative example, assume that party B has digital coins received from party A, where the coins are locked to B by the following locking scripts, also known as redeem Scripts. These may also be referred to as the “right-side scripts” [S1] at some point:
OP_SHA256<H1> OP_EQUALVERIFY OP_SPLIT OP_SHA256 H(xA) OP_EQUALVERIFY OP_CHECKOUTPUT AND
   The above is a Bitcoin script corresponding to the following pseudocode steps:
1. OP_SHA256<H1> OP_EQUALVERIFY: Check a unified pre-image (p1) against <H1>
2. OP_SPLIT OP_SHA256 H(x_{A}) OP_EQUALVERIFY: Checks the first pre-image (x_{A}) against the H(x_{A})
3. OP_CHECKOUTPUT: Checks the integrity of the transaction by qualifying the lock script (i.e., that the hash of the pre-image is in the output.
4. AND: which checks that both results from the end of step 2 and step 3 are met

### Where:

1. x_{A} is a pre-image (i.e., random secret) generated by entity A
2. x_{B} is a pre-image (i.e., random secret) generated by entity B
3. <H1>=H(H(x_{B})|x_{A}) is the originally provided hash of the concatenation of the secrets, where H may be a secure hash function that is quantum secure, such as SHA256—i.e., a locking script
4. OP_SHA256 hashes the concatenation of the input (secrets)
5. OP_EQUALVERIFY terminates if two values are not equal
6. OP_SPLIT divides a single data operand into two separate parts
7. OP_CHECKOUTPUT is an operation code configured to verify a specific output
   Here, a value being random may mean that it is generated using means including but not limited to a true random generator, a pseudo-random generator, a generator approximating either of these, or a combination of such generators.

It is worth noting that this script is a stack machine and runs from left to right. The operands are pushed to the stack, and operators pop the required number of items from the stack and push the result back to the stack. This machine is already implemented in bitcoin and this invention does not require any change with respect to how the machine runs the script.

When B decides to spend this token, they may need to unlock the unspent transaction output (UTXO) by providing the following unlocking script, also known as sigScript. These may also be referred to as the “left-side scripts” [S2]:

$$H ( {x}_{B} ) \vert {x}_{A}$$

Here, H(x_{B}) is a quantum secure hash of x_{B} and x_{A} is a pre-image generated by A, but transferred to B in their chosen secure manner out of band (OOB), potentially using means including, but not limited to, using QR codes, file transfers, near-field communication (NFC), emails, Bluetooth, and/or the Internet.

By providing the unlocking script and creating a new transaction that specifies who B wants to pay his tokens to, all nodes can verify that B is the owner of this token. The mining process over this verified transaction happens the way proof of work operates without any change.

In other words, the scripts may make sure that before B can receive tokens from A, they should be created collaboratively by A and B. In one form, B may create x_{B} independently, A may create x_{A} independently, and then B may exchange x_{B} with A securely. A may then create the locking script <H1>=H(H(x_{B})|x_{A}). A may then broadcast transactions to the network to be mined as part of the next block.

To use the tokens, these unlocking scripts may require B to reveal the pre-images for <H1>=H(H(x_{B})|x_{A}). At this point, A may reveal x_{A}, and knowing x_{B}, B can create H(H(x_{B})|x_{A}).

At the time that B wants to send their money to C, they may need to create a new (e.g., bitcoin) transaction as usual. He needs to provide inputs and outputs of transactions. In the input of the transaction, B has to provide an unlocking script (i.e., sigScript) that shows they are the owner of these tokens. The following unlocking script is what B will provide as unlocking script of the transaction [S2]:

$$H ( {x}_{B} ) \vert {x}_{A}$$

Here, the parties A and B may be wallets or other computational entities representing the user(s), where a user may refer to an individual, a collective, an enterprise, a government organization, a service provider, etc.

The unlocking script/sigScript confirms to miners that the input transaction can be spent, and the result of running the unlocking script will be True. A person of skill in the art will recognize that miners concatenate the <left-side script> to <right-side script>, run it and verify if the final result is True on the script stack machine. In other words, they run the following script to verify the unlocking script:

```
    SHA256(x_{B})|x_{A} OP_SHA256 <H1> OP_EQUALVERIFY OP_SPLIT
OP_SHA256 H(x_{A}) OP_EQUALVERIFY OP_CHECKOUTPUT AND
  □ sigScript
```

| | |
|---|---|
| SHA256(x_{B})\|x_{A} | provides the hash of the next secret and the past secret |

□ redeemScript

| | |
|---|---|
| OP_SHA256 | hash the concatenation of the secrets |
| <H1> | this is the originally provided hash of the concatenation of |
| | the secrets |
| OP_EQUALVERIFY | terminates if not equal |
| OP_SPLIT | split the secrets so stack contains <SHA256(x_{B})><x_{A}> |
| OP_SHA256 | stack is now <SHA256(x_{B})> <x_{A}> <SHA256(x_{A})> |
| OP_EQUALVERIFY | terminates if not equal |
| OP_CHECKOUTPUT | verifies that the hash of x_{A} is in the output |
| AND | (Note: this term may, in some embodiments, be folded into |
| | OP_CHECKOUTPUT) |

The right side of the above script is a lock script corresponding to the same pseudocode as [S1] and the left side is the unlock script [S2]. These two together form a whole script and can run. If this returns True, it implies that the transaction is valid and the money can be spent by B, to the person who knows the pre-image of the H(xB).

As suggested earlier, in the above script, OP_CHECKOUTPUT is a new operator, part of this invention. This operator checks some criteria of the output script that makes this bitcoin spendable to the next person, C. One non-limiting example of how to implement OP_CHECKOUTPUT is as follows: OP_CHECKOUTPUT can check whether “OP_SHA256 H(x_{B}) OP_EQUALVERIFY” subscript exists in the locking script of the transaction output to be sent to the next person C.

To show how a valid locking script works, imagine B decides to pay bitcoin to C. Similar to the interaction that happened between A and B, this time B and C may coordinate to build an <H2>=H(H(x_{C})|x_{B}). By this means, B creates a valid lock script as follow for example:
OP_SHA256<H2> OP_EQUALVERIFY OP_SPLIT OP_SHA256 H(x_{B}) OP_EQUALVERIFY OP_CHECKOUTPUT AND

This will appear in the output transaction that B creates to pay to C. When the “OP_CHECKOUTPUT” portion of the unlocking script runs by miners, this returns valid as the subscript “OP_SHA256 H(x_{B}) OP_EQUALVERIFY” has appeared in the locking script of the output transaction. It is worth noting that sharing a secret (i.e., pre-images x_{B}) with C can happen in many different ways, including but not limited to secure OOB communications.

In several cases, transactions, including but not limited to bitcoin transactions, may follow the same formats as mentioned earlier, with the exception that the miners now create both of the pre-images. Later, the miners can use the pre-images to use their bitcoins. To protect the integrity of the transaction amounts, the values might as well include the values to be paid, and operators such as OP\_CHECKINPUT can check at the time of unlocking the scripts the values being spent against the locked values in the transactions. It may be worth noting that sharing secrets (i.e., pre-images x_{B}) with C can happen in many different ways including, but not limited to, secure OOB communications.

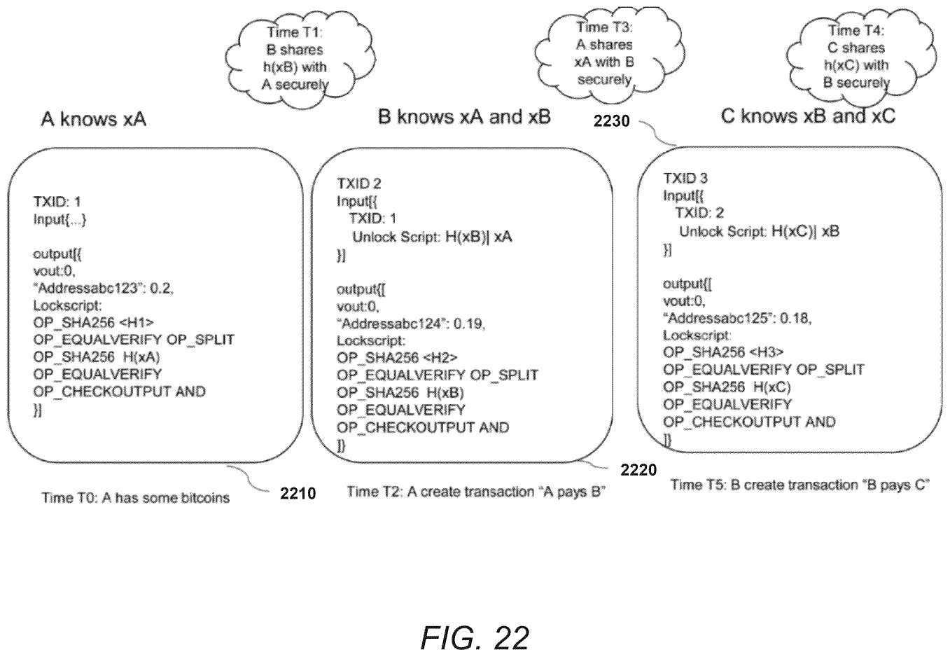

An example of the above quantum-secure technique, implemented in accordance with several embodiments of the invention, is illustrated in FIG. 22. The illustrative diagram demonstrates how the commit-reveal quantum-secure signature scheme may be integrated into existing scripting systems (e.g., Bitcoin), where each transaction requires knowledge of both the sender's secret and the hash of the recipient's secret to unlock funds, providing quantum resistance through the use of hash-based authentication rather than traditional public key cryptography. Quantum-secure techniques may use combinations of script operators (including but not limited to native Bitcoin script operators) and/or novel operators for checking the validity of output scripts, in accordance with many embodiments of the invention. These techniques may be performed based on various scripts 2210, 2220, 2230 executed at miscellaneous steps. At time t₀, party A, the owner of various bitcoins, may have access to information including but not limited to the value of x_{A} and know how to unlock a first locking script 2210 to transfer/pay at least one bitcoin to B. At time t₁, A may request that B convey h(x_{B}) to A, allowing for party A to create a transaction paying party B at time t₂. In accordance with numerous embodiments, A may incorporate locking scripts 2220 (H(h(x_{B})|x_{A})) in the transactions used for sending bitcoins to B.

After the transactions are matured in the blockchains, A may transfer x_{A} securely to B at time t₃, allowing them to spend the conveyed bitcoin via unlocking script. Spending the bitcoin may be preceded by commitments that may, in some cases, be functions of h(x_{B}), the images/hashes of party B's secret x_{B}. Further, at time t₃, the secret would not be known by anybody but party B. Specifically, in some cases, by time t₂, party B may know both x_{A} and x_{B}, as a result of associated reveals associated with the payment step. Nevertheless, having both x_{A} and x_{B} at this point, party B can now run an unlock script 2230.

For future transactions, party B may similarly lock the tokens for party C, i.e., perform locks analogous to the ones shown in step 1820, but using h(x_{C}) as the recipient information instead of h(x_{B}), and using x_{B} as the originator information instead of x_{A}. At time t₄, parties C may thereby securely convey h(x_{C}) to party B. This approach may combine the commit-reveal steps disclosed in 1840-1860 of FIG. 18. This would allow party B to create a transaction paying party C at time t₅.

### V. Smart Contract Directed Gas Payments

In accordance with certain embodiments, it may be possible to implement gas payments using smart contracts, including but not limited to those disclosed in Ethereum Request for Comment 4337 (ERC-4337). Such techniques may be compatible with the technologies disclosed herein.

In accordance with several embodiments, presented for illustrative purposes only and not meant to be limiting, smart contracts on the Ethereum blockchain and/or Ethereum Virtual Machine-compatible blockchains, for example, ERC-4337 paymaster contracts, may hold native cryptocurrencies of the blockchains used for paying gas fees, such as Ether. As paymaster contracts may be smart contracts, they may not have private keys to Elliptic Curve Digital Signature Algorithm (ECDSA) public keys and may therefore, in principle, be resistant to quantum computing attacks, provided methods for calling functionality of the paymaster contracts are quantum-resistant.

In accordance with many embodiments, the paymaster contracts may accept quantum-secured tokens as disclosed in co-pending U.S. patent application Ser. No. 19/038,599, titled “Secure and efficient Quantum-resistant digital signing method for blockchains,” by Keir Finlow-Bates and Markus Jakobsson, filed on Jan. 27, 2025, incorporated by reference in its entirety. Such quantum-secured tokens may represent the native cryptocurrencies of the blockchains, and the paymaster contracts may accept amounts of the quantum-secured tokens and may, in response, make payments in the native cryptocurrencies of the blockchains for processing associated transactions.

Through this, use of the quantum-insecure native cryptocurrencies may be sandboxed by the paymaster contracts, and manipulation of the quantum-insecure native cryptocurrencies may only occur through quantum-secure transactions submitted with appropriate fees denominated in the quantum-secured tokens but paid by the paymaster contracts using quantum-insecure native cryptocurrencies. In accordance with various embodiments, the paymaster contracts may accept the native cryptocurrencies through conventional ECDSA-signed transactions and may issue quantum-secured tokens corresponding to the native cryptocurrencies to quantum-secured addresses. Additionally or alternatively, in accordance with many embodiments, the paymaster contracts may be coupled with validators and may accept transaction fees and block rewards in the quantum-insecure native cryptocurrencies. They may issue equivalent amounts of quantum-secured tokens to quantum-secure addresses, which may be specified by deployers of the validators. Quantum-secure paymaster contracts may be designed to execute arbitrary calls to arbitrary smart contracts on behalf of users.

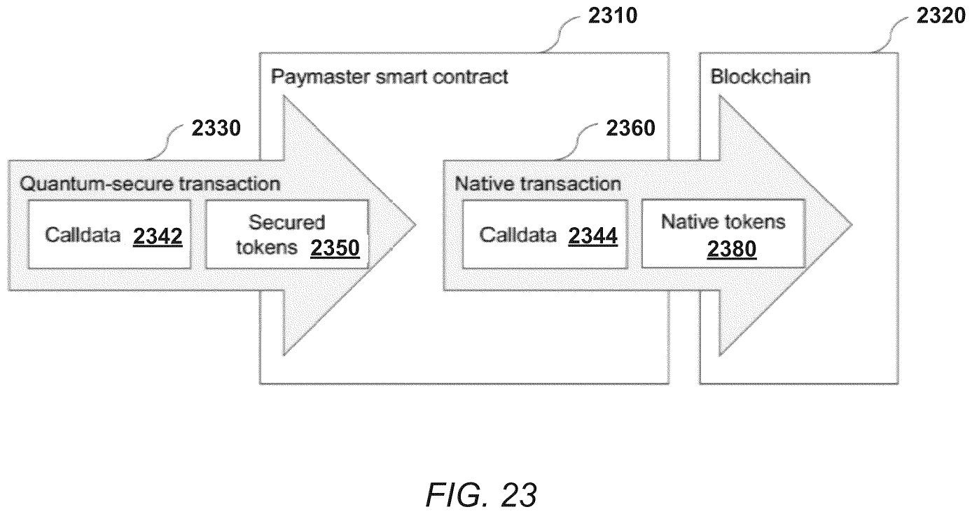

An example of a paymaster smart contract used for proxying quantum-secure transactions in accordance with several embodiments of the invention is illustrated in FIG. 23. The paymaster smart contracts 2310 may receive quantum-secure transactions 2330, with the quantum-secure transactions including calldata 2342 and amounts of secured tokens 2350 representing “wrapped” versions of native tokens of blockchains 2320, and proxy these transactions to native transactions 2360.

Paymaster smart contracts 2310 may be configured to inspect the quantum-secure transactions 2330 and make validations, including but not limited to: that the calldata 2342 includes valid blockchain transactions and that the amounts of secured tokens 2350 are sufficient to cover execution costs (also known as the gas fees) for transactions represented by the calldata 2342. When the quantum-secure transactions 2330 are deemed valid by the paymaster smart contracts 2310, the paymaster smart contracts 2310 may construct native transactions 2360 including copies of the call data 2344 and amounts of native tokens 2380 for covering executing costs at native levels of the blockchains 2320. The paymaster contracts may then submit the native transactions 2360 on the blockchains 2320.

Those skilled in the art will now appreciate that through the above disclosure, payment of transactions through quantum-insecure native cryptocurrencies, for example, ether on the Ethereum blockchain, may be sandboxed and/or quarantined to smart contracts only, with transactions and function calls proxied by the paymaster smart contracts. The paymaster smart contracts may only accept transactions authorized through quantum-secure digital signatures and/or other quantum-secure identity and access management schemes.

The above disclosure may be extended to quantum-secure previously deployed quantum-insecure smart contracts and hence quantum-insecure tokens such as ERC-20 tokens. The paymaster smart contracts may hold the quantum-insecure tokens on users' behalf and may, in accordance with many embodiments, only move them to new owners, for example, other paymaster smart contracts, on receipt of quantum-secure transactions from the users.

Additionally or alternatively, the paymaster smart contracts may hold the quantum-insecure tokens on the users' behalf and may issue corresponding quantum-secure tokens directly to the users. These quantum-secure tokens may then be directly transferred by the users to other parties, said other parties then able to redeem the underlying quantum-insecure tokens using the quantum-secure tokens. The quantum-secure tokens may thus function as quantum-secure wrapped tokens for the underlying quantum-insecure tokens.

### Determination of AI Input Data Usage

There are a collection of security-related problems, ranging from anti-piracy and royalty attribution to protection against malware, where the disclosed invention enables a verification of the security posture of an artifact, such as an image, a movie, a song, a software element such as an app or a smart contract, or an AI model. The instant invention discloses methods for one or more provers to convince one or more verifiers of the security posture of an artifact, or portions thereof. The method can be applied recursively, e.g., to software generating software, and as such, is not limited to proving the security posture of human-directed artifact generation.

Generative artificial intelligence (AI) typically uses a large body of training data to produce new output data generated from a compressed representation and transformation of the training data, and an input, the input often based on a natural language prompt.

Such training data, generally speaking, includes large quantities of material protected by copyright. Unfortunately, after processing through the AI training period, the training data is not stored within the AI in a manner that currently allows a clear determination as to what training data is used in the subsequent generation of an output, or in what proportion. Thus billing and creator compensation based on the use of copyright materials is presently precluded.

In the present invention, we disclose systems and methods for assessing the levels of contribution of subsets of input training data in generative AI outputs. The disclosure further provides approaches for validating the quality of computer code produced as an output from a generative AI trained on computer code training data for the creation of new software.

Through tokenization of the input data on a blockchain, the invention may be extended to derive provenance metadata for outputs, and to improve efficiencies in billing systems for data usage during the process.

In an aspect of the present disclosure, a generative AI may include a categorized training data set, a transformer-based deep neural network, and an optional randomization seed for a pseudo-random number generator (PRNG) that adjusts the probability distribution from which the generative AI model picks sequences of elements for its response. Re-runs using the same data set and randomization seed will produce the same response, as the model is deterministic.

The security provenance of an artifact can be proved, using the disclosed technology.

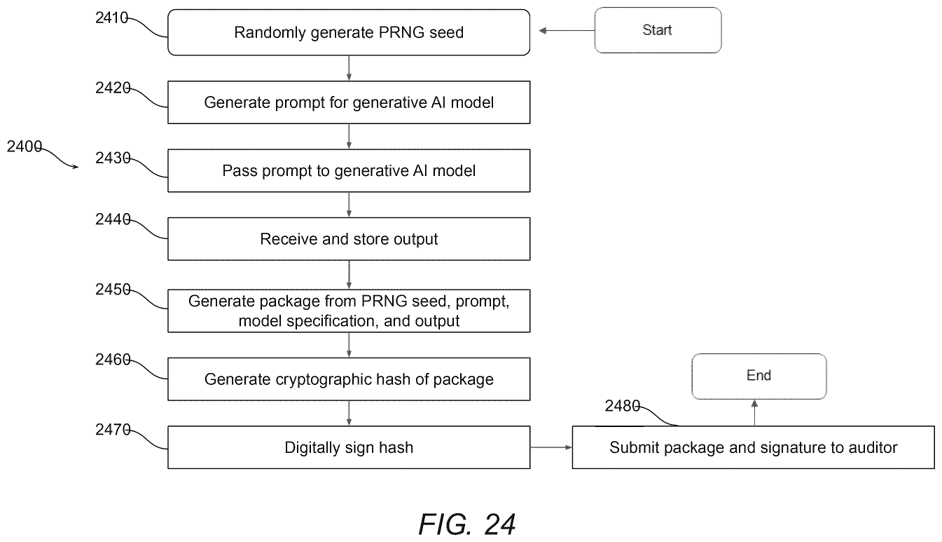

In an embodiment of the present disclosure, as illustrated in FIG. 24 by flow chart 2400, actions may commence with a generation of a random PRNG seed, as shown in step 2410.

Actions may then proceed to step 2420, in which a prompt is generated for a generative AI model. In some embodiments the prompt may be generated by a human being, whereas in other embodiments, the prompt may be generated automatically through, for example but not limited to, a selective recombination of prompts from a database of former prompts.

Actions may then proceed to step 2430, in which the prompt may be passed to the generative AI model. In some embodiments the prompt may be encapsulated in a wrapper prompt, for example but not limited to, a wrapper prompt that ensures that the prompt is processed by the generative in a specific expert context, such as a medical context, a software programming context, a legal context, an engineering context, and/or some other context.

Actions may proceed to step 2440, in which output from the generative AI triggered by the prompt may be received and stored.

Actions may then proceed to step 2450, in which a package may be generated from the random PRNG seed, the prompt, a model specification, and the output. In some embodiments the package may further include: a timestamp, a unique identifier of the party providing the prompt, the wrapper prompt, and/or other metadata relevant to the present disclosure.

Actions may then proceed to step 2460, in which a cryptographic hash of the package may be generated, for example but not limited to, by optionally encoding the package and providing the encoding of the package as an input to a cryptographic hash function, and receiving a message digest and/or hash as an output from the cryptographic hash function.

Actions may then proceed to step 2470, in which the hash may be digitally signed. In some embodiments the hash may be digitally signed by one or more parties, for example, by the party providing the prompt, an AI model provider, an auditor, a compute instance provider, and/or other parties.

Finally, actions may then proceed to step 2480, in which the package, digitally signed, may be provided to an auditor, for example but not limited to, for categorization, storage, and/or review.

### I. Source Selection.

One aspect of the disclosed technology is one or more standardized source file directories, each including training material. For example, presented for illustrative purposes only, a source file directory can include audio files, image files, text, and/or code snippets with corresponding indications of the function of the code snippets.

One directory may include audio files corresponding to different voices, classified, for example, based on age, gender, geographical area, likability, etc. It can also contain information related to specific individuals, allowing the generation of voice outputs sounding like a specified person. Another audio directory may include sounds of animals, along with classification of the sounds; and a third may include sheet music, music audio data, along with information indicating style, meaning, usage suggestions, keywords associated with various elements, etc.

A directory may include image files corresponding to different objects, classified, for example, based on elements present in the images, such as specific animals, buildings, landscapes, materials, natural objects, man-made objects, and so on.

A directory may include files storing bodies of text, for example, novels, manuals, news reports, poetry, encyclopedias, etc. The files may, for example, be sorted by author, subject, language.

A code source file directory may be language specific, e.g., only include ruby on rails code, and/or it may be algorithm-centric and include code descriptions for common functions, where descriptions can be translated to a variety of computer languages. Code elements may be labeled based on their asymptotic computational complexity, the extent to which the code is known to have vulnerabilities, the results of penetration testing of the code, whether the code has any associated assurances, e.g., having been certified to comply with a given standard, etc.

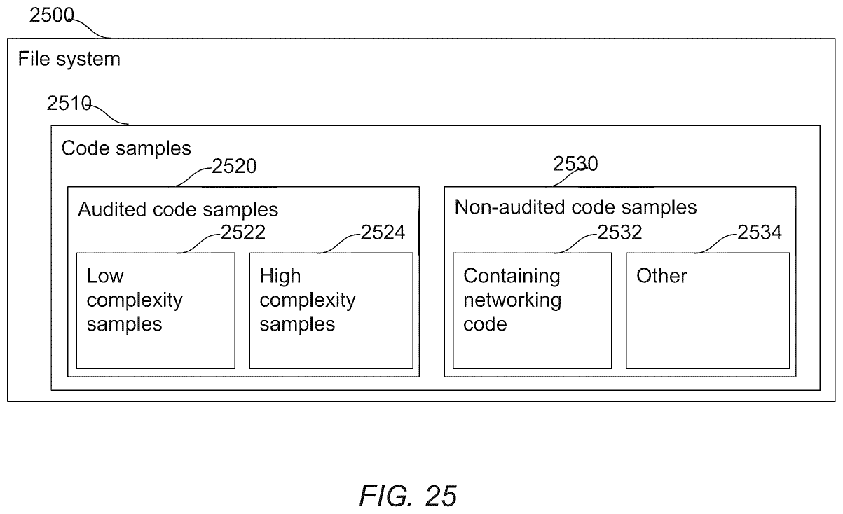

In FIG. 25, presented for illustrative purposes only, and not meant to be limiting, a block diagram illustrating a possible standardized file system structure for storing code samples as training data for an AI is presented. A file system (2500) may include a folder for code samples (2510). The folder for code samples (2510) may include a folder for audited code samples (2520) and a folder for non-audited code samples (2530). The folder for audited code samples (2520) may include a low complexity samples folder (2522) and a high complexity samples folder (2524). The folder for non-audited code samples (2530) may include a folder for code samples including networking code (2532) and a folder for other code samples (2534).

### II. State Information

Another aspect of the disclosed technology is state information, which in some embodiments may include one or more of: a seed for a PRNG, an identifier such as a public key of an entity generating the artifact and/or parts thereof, or a set of input prompts to provide to an AI.

### III. Commands

A third aspect of the disclosed technology is a series of commands, also known as prompts, provided as input to a generator, where the generator may correspond to a Generative Adversarial Network (GAN) and/or other AI used to produce an artifact or a portion thereof. Since the generational process commonly may be iterative, and potentially be performed by a multiplicity of collaborating entities, the entire sequence of commands influencing the final output is preferably provided. For example, if some command was used but the resulting artifact version was not approved (whether by the GAN and/or its operator), then this command may be excluded for the series of commands. Similarly, if multiple iterations using the same inputs was performed, each using a different counter that is combined with the seed of the PRNG, the series may include all commands for each iteration (allowing verification of the non-approved outputs as well as the approved output artifact); alternatively, only the ‘selected’ sequence of commands, along with the corresponding counter and other state information, may be recorded in the series of commands.

In some embodiments, prompts may be stored in a database for re-use by an original prompt producer and/or by subsequent users. Prompts may be chained, nested, and/or partially and/or completely combined through some other method. Use of prompts by users may be logged and optionally billed.

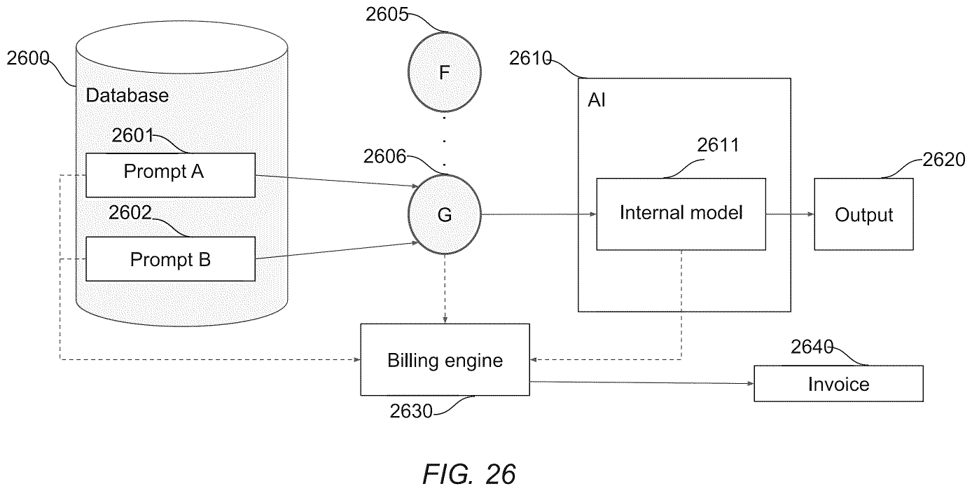

In FIG. 26, presented for illustrative purposes only and not meant to be limiting in any way, a block diagram detailing a prompt database billing system is shown. A database (2600) may store previously used prompts to an AI. The database (2600) may include a plurality of prompts, and further prompts may be added to the database (2600) as they are produced by users, and optionally tagged with billing metadata. Without loss of generality a workflow for a use of two prompts is shown, as those skilled in the art will appreciate in light of the following disclosure that the method disclosed is equally applicable to one, or more than two prompts.

A prompt A (2601) and a prompt B (2602) may be selected by a user, and billing information for both prompts may be submitted to a billing engine (2630). The user may then select a combination function, in this case function G (2606) from a plurality of options of combination functions F (2605) through G (2606), and/or even a composition of two or more prompt combination functions for combining selected prompt A (2601) and prompt B (2602), producing a prompt output that is passed to an AI (2610). Billing information from the one or more selected prompt combination functions may also be passed to the billing engine (2630). The AI (2610) through an internal model (2611) may process or act on the prompt output producing an output (2620). The AI may also pass billing information to the billing engine (2630). The billing engine may take some or all billing inputs and generate an invoice (2640) for use of the system. In some embodiments, the output (2620) may not be released to the user until payment of the invoice (2640) is complete.

In some embodiments, instead of metadata, recording billing information for prompts, prompt combination functions, and AI models within a central database, a blockchain may be used to instantiate tokens representing the metadata, and smart contracts may automate the billing and payment workflow, with payment being made in cryptocurrency and/or tokens.

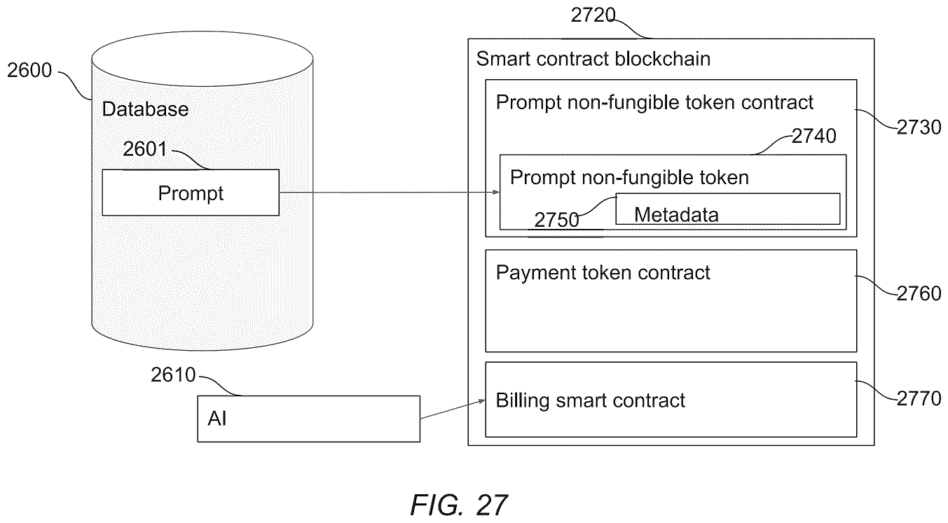

In FIG. 27, presented for illustrative purposes only and not meant to be limiting in any way, a possible embodiment of a collection of smart contracts for processing billing for AI prompts is shown. A smart contract blockchain (2720) may include a prompt non-fungible token contract (2730) instantiating non-fungible tokens (NFTs) representing previously used and/or designed prompts for an AI system. A prompt non-fungible token (2740) may record details concerning a prompt (2601) stored in a prompt database (2600) through metadata (2750).

The metadata (2750) may include billing information for the prompt (2602), for example, a fee, possibly denominated in cryptocurrency and/or tokens for using the prompt (2601). An index of the prompt non-fungible token (2740) may be generated by applying a cryptographic hash function to a string of the prompt (2601).

In one embodiment of the present invention, pricing and payment for use of the prompt (2601) may be established through a token instantiated by a payment token contract (2760). Use of the prompt (2601) may require payment in the form of an amount of the token, said payment processed through a billing smart contract (2770). An AI (2610) may query the billing smart contract (2770) to confirm payment before running the prompt.

### IV. Proof of Provenance.

A proof of provenance (which we will also simply refer to as a ‘proof’ herein) includes indications of what directories were selected; information related to state; and information related to the commands used to produce the artifact. In addition, the proof of provenance may include authentication data such as a digital signature related to the one or more public keys of the parties generating the artifact. The digital signature, in one embodiment, is computed on an input message that corresponds to at least one of the indications of directories, information related to state, and information related to commands; in another embodiment, it is computed on a characterization of the artifact, i.e., information describing the artifact that was generated. Examples of such characterizations include but are not limited to: the artifact file, a hash of the artifact file, or an input that is descriptive of the artifact file. The latter may be information that has a fuzzy aspect, e.g., for which minor modifications of the artifact does not change the corresponding description, such as a Fast Fourier Transform (FFT) of an audio file, or a perceptual hash of an image file.

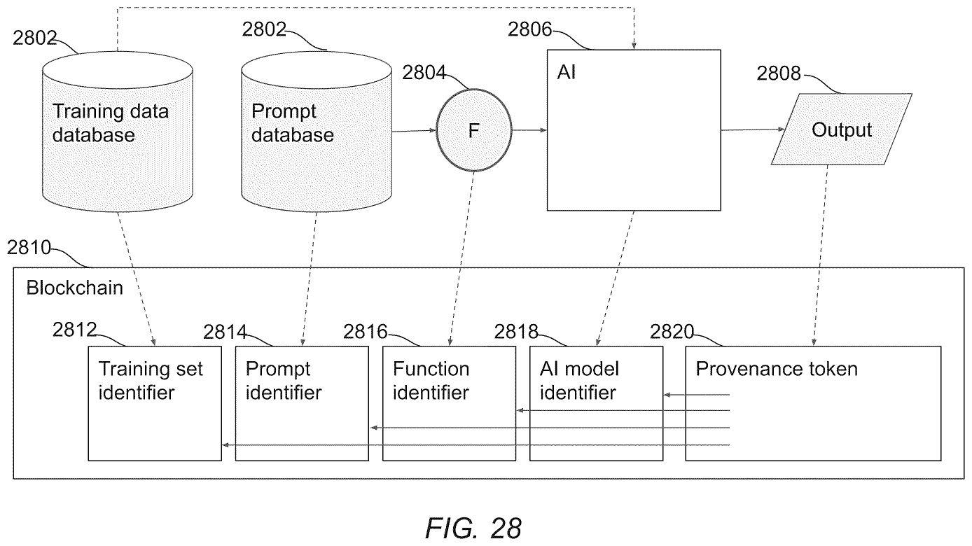

In FIG. 28, presented for illustrative purposes only and not meant to be limiting in any way, a block diagram of a possible embodiment of a proof of provenance method is shown. A training data (2802) may be used to train an AI (2806). A prompt (2804) may be passed to the AI (2806), which may generate an output (2808). A blockchain (2810) may be used to record a training set identifier (2812), a prompt identifier (2814), a function identifier (2816), an AI model identifier (2818), and a provenance token (2820).

### V. Auditing.

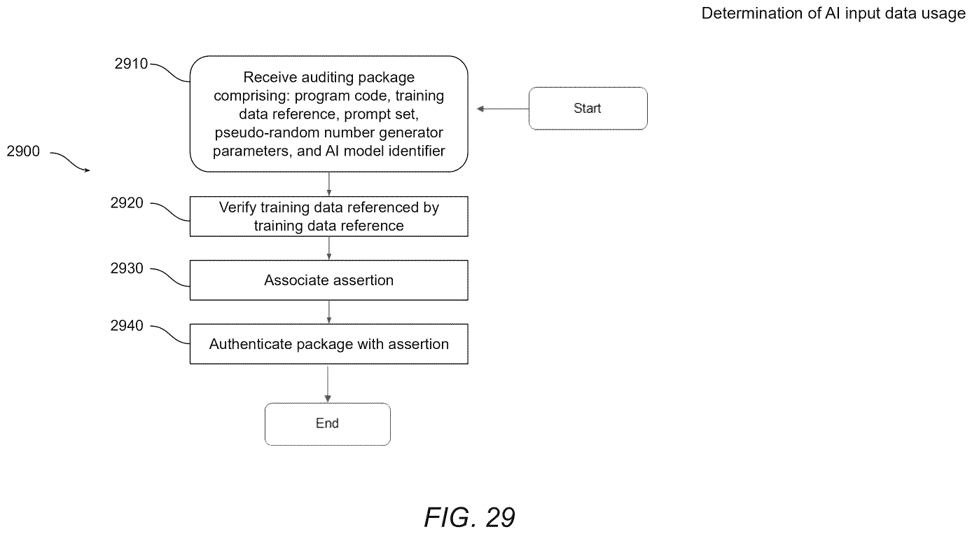

In FIG. 29, presented for illustrative purposes only and not meant to be limiting in any way, a flow chart of a method for auditing an AI-generated program is shown. In step 2910, an auditing package is received, where the auditing package includes program code, a training data reference, a prompt set, pseudo-random number generator parameters, and an AI model identifier. In step 2920, the training data referenced by the training data reference is verified. In step 2930, an assertion is associated with the auditing package. In step 2940, the package is authenticated with the assertion.

### VI. Certified AIs.

As another example proof, which also applies to other forms of content, a creator may utilize an AI that has been certified to correspond to a given set of training material. A third party may produce and/or certify an AI by verifying (or knowing) the selection of the training material, along with any commands given during the training, where such commands may include iteration with new training material, parameters indicating how many rounds to train, etc. The certified AI can then be used by a content creator, who provides input parameters (such as a request, and any random and/or pseudo-random seed values) to the certified AI. The creator, or a representative of the creator, can then generate a proof based on an indication of what certified AI was used, along with any input provided by the creator, thereby enabling a verifier to recreate the output. In some instances, the output may have been manually modified by the creator after being generated, resulting in the media content; a log of these modifications can be provided to enable verification. Alternatively, an approximate comparison can be performed on the recreated content and the manually modified content. In cases where the “manual” modification is performed using an automated tool, an indication of what tool and what input it was provided can be used to perform the verification.

In some situations, a certified AI may be trained further, whether by the same party/parties who trained it at first, and/or by another party and/or parties. We refer to this as iterated training. A new certified AI version can be produced from this. The certification may indicate the previous AI version (i.e., the certified AI before it was trained the last iteration) along with what training material was used to create the new certified AI.

### VII. Certification of Multiple Building Blocks.

The certification of AIs can be performed to building blocks including individual AI components, as well as other components such as the tools described above, and a composite AI-based element can be created from these building blocks, where each component may be individually and/or collectively certified, and the connections between the components may be certified as well, creating a computational unit (which may be open source) for which the components are certified. To the extent that a given computational unit is included of building blocks that have not been certified, these can be individually and/or collectively scrutinized, e.g., using static and dynamic code analysis, and/or other methods conforming to the type of content being generated, and certification of such units may be generated. A certification is associated with the party who performs the certification, and different parties may have different reputation, and/or be seen as authoritative to different verifiers. Accordingly, a building block or a generative AI may be simultaneously certified by multiple certifying entities, each one of which may be associated with a different level of trust to a given verifier of proofs.

### VIII. Example of Approximate Attribution of Weights.

In many situations involving AI-based creation of media content, it is difficult to say with any precision what exact inputs were critical for the creation of a given output. This can be addressed using a technique related to that which is disclosed above. Consider an example in which a jingle is generated from a set of audio or audio transcriptions (such as sheet music), using an AI, and wherein the creators of the audio that was used for training are owed a royalty. To begin with, it is helpful to incentivize the creator of the jingle to identify the smallest possible set of relevant audio used, and to keep this training set as small as possible to help make the attribution as precise as possible. The creator may have to pay a royalty that is based on the size of the identified training set, wherein a smaller set results in a lower cost. This incentivizes the jingle creator to use the smallest possible training set that gives sufficiently good results. This in turn can be achieved by the creator being given options of what training sets to use, and for different configurations (which may be selected based on genre, artist, time period, etc., or a combination of such predicates), the AI would generate tentative outputs. The creator can then select which one he and/or she prefers, where the size of the training set determines the cost, and wherein different configurations (which may correspond to directories of inputs, such as audio) may have differing costs from each other as well. A creator that does not attribute any set would pay a very big royalty, to be distributed according to some formula (such as general popularity according to some measure such as number of plays per month on Spotify™) between all relevant artists, whereas a creator that performs attribution (which will then be verified, as described above) will pay a lower royalty that will be shared only among the artists in the attributed sets. A verifier would receive, from the creator, an attribution, along with all other inputs used by the AI used by the creator, and would be able to deterministically regenerate the very same output. To the extent that the AI would generate a large array of suggested outputs, the creator may indicate which one was finally selected. The verifier can then determine that the jingle generated by the creator's AI was indeed generated using the claimed attributed training sets, and the associated artists would then be paid a royalty that depends on the size of the training set, along with other relevant aspects such as the number of times the jingle was played, where and when it was played, and based on optional payment requirements associated with the attributed training set(s).

As will be appreciated by a person of skill in the art, the principles behind the above example of jingles generated from audio sources is not limited to jingles and audio, but can be applied to any form of training set, including movies, voice data, photographs, architectural blueprints, computer software code, VLSI layouts, etc. The outputs, generated by the AI of the creator, would be media files and/or other data files that can be generated from the applicable training set data.

As a special case, these techniques may also be applied to machine learning algorithms and Als, where different such instances may have different tradeoffs when it comes to accuracy, execution time, royalty requirements, and more. The output of the creator AI in this example would be software code performing tasks related to an AI.

### IX. Non-Revealing Proofs.

In some instances, a user may wish to generate a proof that a given element (such as a piece of media content, or an executable component) was created from a specified training set, but without disclosing the query, without disclosing the random seed, and/or without disclosing some other parameter of relevance for the creation of the element. In this instance, the content creator may either provide the full input to a trusted third party which then verifies the correct generation, and produces a certificate vouching for that. This certificate may be a digital signature on the given element, along with additional descriptions, if desirable. The certificate can then be verified by parties with a need to determine that the element was generated according to a specified process, from a specified training set, from a specified type of query, etc. Alternatively, the user may generate a zero-knowledge proof of the generation, i.e., a proof that there exists an input that causes the given element to be output from a given process. This can be done using general multi-party computation, using encrypted circuits, or a combination thereof.

### X. Multi-Layered Approach.

In one embodiment, one or more data sets are generated using a first generative AI, using training sets and input parameters that the party developing the one or more data sets does not want to reveal to the public. The one or more data sets are certified by a trusted third party, as described above, wherein the exact input resulting in these data sets is not revealed in the certificate. The one or more data sets are then used to generate a final output, which can be proven to correspond to the one or more data sets, whose creation is attested to by the certificates associated with these. This approach maintains secrecy of the initial datasets, and the manner in which they were generated. The output data sets may be of the same type as the training data, and/or they may correspond to a description of the AI that was trained from the training sets. In some embodiments a tree of data sets is created by different parties, where each element in the tree may be certified. The certifying parties may encrypt information about the sensitive information and cause this to be escrowed in case it is later needed to audit the process of generation and certification.

### XI. TEE/DRM-Supported Certification.

In one embodiment, a Trusted Execution Environment (TEE) such as a secure enclave, is used for certification. Alternatively, and/or in addition, a Digital Rights Management (DRM) module is used for this. The TEE and/or DRM may perform at least part of the certification process. This may involve identifying all inputs to an AI that is being trained, and where the AI may reside, at least in part, in the TEE/DRM protected area. Such a secure environment may exist on client computers where the training takes place, and/or may be used in servers that perform certification as a service, and/or both. The secure environment is associated with a public key and a private key, the latter used to generate a digital signature on assertions of provenance, training parameters, etc.

XII. Example with a Publicly Accessible Generative AI.

In one example embodiment, an AI that is publicly accessible is used to generate an output. This is done based on a request, which typically includes a statement or a reference to a statement specifying what output is desired. The request may include a seed, and may also include a profile (or reference to a profile) specific to the requester, where this profile includes information about the preferences, historical selections, and other parameters related to the requester. The input to the AI includes the request, but may also include other input data selected by the service provider managing the AI. The resulting output can be accompanied by a proof, e.g., a string identifying at least one of (a) the inputs, (b) the request, (c) a session number from which the inputs and/or the request can be looked up from a database accessible from an optionally managed by the service provider. Alternatively and/or in addition, the proof may include a digital signature by the service provider, referencing the request or aspects thereof, and optionally, including a certificate that indicates that the AI was trained using a specified input dataset. The proof can be provided along with the output (which may be a media file, a software element, etc.), for third parties to verify the provenance of the output, e.g., based on their trust in the service provider. The service provider, in turn, can be audited to verify that the assertions (such as the proofs) it generates are legitimate; this verification is performed by demanding to obtain all the inputs to the AI, and locally verify that it produces the outputs previously certified by the service provider to be valid. This verification can be done using a randomly selected sample of requests and associated certified outputs, and/or it can be done selectively based on particular requests and associated certified outputs.

### XIII. Second-Order Verification.

In one example use of the disclosed technology, a developer provides guidance, in the form of one or more human-readable prompts, to an AI, such as ChatGPT, where the prompts includes a description of functionality in a natural language, such English, and a selection of programming language for the output. ChatGPT generates output code. The developer may iterate on the development by modifying the prompt to clarify aspects (such as what type of search algorithm to use), and may also make modifications by hand to the output code; such modified code may be provided as another input to the AI, which then generates a new output.

The set of prompts, the set of selections, and the various modifications made by hand are provided as a witness to the code. Using the witness, it is possible to regenerate the code; alternatively, a verification algorithm can determine whether an input code block could possibly correspond to the witness, e.g., by identifying code elements that should not be part to code of the specified functionality. The witness can be used to audit the code. A third-party verification entity may perform this verification, and then certify the code (assuming it passes the tests) by generating a digital signature on the code. This digital signature can later be verified by a party wishing to validate the code. Alternatively, this party may perform the verification using the witness itself. However, the security of the code still depends on the security of the underlying AI, which in this demonstrative example is ChatGPT. It is desirable for a verifier to use the same version and/or configuration for the verification as was used in the generation, as false positives may otherwise arise; a false positive here is a false alarm indicating that an output that is actually properly generated is not properly generated. Also, if the AI is open source, it is beneficial to verify that all components of the AI are valid, e.g., has not been maliciously modified. This can be performed by performing a verification of said components, using witnesses for the said components. Alternatively, a trusted party may perform tests on the AI to assess the likelihood of risk, and then certify the AI and/or its modules, e.g., using one or more digital signatures. Alternatively, individual components and/or entire software libraries can be certified as being valid by a trusted entity (such as a company generating the code, or auditing it for security risks.) Anti-virus companies may generate certificates indicating that some analyzed code has passed a verification by them, where this verification may correspond simply to whether the analyzed code passes their malware detection tests. Yet other entities may perform dynamic verification and/or static verification of code and validate code that passes the tests. Thus, a verifier may assess a generated element (such as some software code) based on one or more witnesses, and one or more digital signatures. To the extent that the certifying entities are not known by the verifier, they may have to provide assurances in form of certifications they have received from trusted entities, where these assurances may indicate the manner of verification, the reputation of the certifier, the public key(s) of the certifier, and references to bonds and/or other financial documents the certifier may have put up as assurance.

### XIV. Non-Witness Embodiments.

In several embodiments, described above, a first party generates a proof and sends this to a second party, the proof including at least one witness, where this may be included of one or more inputs to a generative AI, and may also include one or more edits to the output of the generative AI. In addition, the witness may include indications of common libraries used, and/or indications of what code elements were used to train the AI.

This proof is relative to a generated element. The disclosed invention therefore associates a proof with a generated element, where the generated element may correspond to media content (such as music, movie segments, text, etch); of code, whether executable and/or compliable; and/or other forms of content, as will be understood by a person of skill in the art.

In other embodiments, the proof does not include a witness, but instead an assertion, by the first party or a collaborating trusted entity, that the element satisfies one or more requirements, where these requirements may indicate the type of inputs were used, what type of training data was used to train the AI, whether manual edits were made and if so whether they were scrutinized by a certified authority. Other requirements can be used, as will be understood by a person of skill in the art. The assertion may include a digital signature that is based on the element, and on the one or more requirements, as listed above. In some embodiments, the assertion may simply include a reference to the generated element, and not to any requirements. The proof, which includes an assertion, is associated to the one or more trusted parties (and which together include the “first party”) generating the assertion, e.g., by digitally signing the generated element.

An assertion can be verified to be valid by verifying the one or more digital signatures associated with the proof, along with information (such as certificates and reputation data) related to the first party, which generated the assertion. An assertion can be audited by requesting, from the first party, all the information used for the security determination underlying the assertion, and then determining that the element can be generated from the information, not counting manually modified components which will be indicated to the verifier for the verifier to analyze, along with any documentation of what these modifications are used for. To the extent that the modification replaced an AI-generated segment with another segment, the AI generated segment may be provided to the verifier for comparison with the segment replacing it. An auditor may, after performing such a verification, generate an assertion that can be verified by a third party; this assertion may either replace and/or be added to the other assertion(s) of the element, and may be produced using a digital signature and/or other authentication method, including symmetric authentication methods such as message authentication codes (MACs).

### XV. Directed Proofs.

A proof may be encrypted with a recipient's key, and/or otherwise made only verifiable by a specified recipient, e.g., using symmetric-key authentication and/or designated verifier proofs. This way, only paying subscribers and/or otherwise authorized entities may verify the validity of an element. This applies both to proofs including witnesses and proofs not including witnesses. We refer to this as directed proofs. Directed proofs enable billing for software libraries and media libraries, where the elements can only be verified to be valid to authorized parties, e.g., subscribers.

### XVI. Self-Modifying Generative AI.

In one embodiment, an AI may generate updates of itself, e.g., guided by detection of errors, bugs, disruptions, and reductions of self-assessed accuracy, where the latter may use one or more metrics determining the precision of sample results generated by the AI, for example. Here, a first version of the AI (or parts thereof) is the input to the operation, along with one or more sources of metrics, which may be based on real-time observations of data source. Example data sources may include stock market data, data indicating trust and reputation, externally provided lists indicative of errors, bugs and/or vulnerabilities. The output may include an updated version of an AI, and/or part thereof. An AI can cause the updating of another, as well as of itself. When an AI causes the generation of a new version of itself, the old and the new version can be operated concurrently for a period of time, and/or until some event is observed, during which the operation of and outputs of the two (or more) AI versions may be compared, whether by the AIs themselves and/or by a hypervisor element observing and controlling the operation of the AI versions, where such control may include the selection of what AI(s) should be operating at any point in time, and what AI(s) should be relied on to control an external process. The control of the external process may be based on one of the AI versions and/or based on a weighted combination of two or more control signals from the competing Als. The collection of AI versions, and/or one of these, may make up the hypervisor, and/or the hypervisor could be a distinct process that cannot be modified by the Als.

### Selectively Modifiable Blockchain Records

Watchfulness has been proposed as a technique to impose a filtering action on selected blockchain transactions. This can be performed in a bridge or in the consensus mechanism, for example. Watchfulness was disclosed in co-pending application Ser. No. 63/368,218 titled “Watchful Consensus Mechanism”, by Markus Jakobsson and filed on Jul. 12, 2022, and Ser. No. 63/368,218 titled “Using Watchful Bridging for Blockchain Fraud Prevention” by Markus Jakobsson and filed on Jun. 6, 2022. The previously disclosed techniques primarily apply to tokens in motion, e.g., as they are transferred from one party to another. The techniques of these two disclosures are incorporated by reference in their entirety and are compatible with the techniques disclosed herein.

The instant invention discloses an alternative watchfulness approach that can apply to any blockchain information, i.e., both tokens and other recorded data, and where the instant invention applies both to transfers and to data at rest. Whereas the instant invention does not erase information from the blockchain, it implements an override mechanism that implements a policy-based semantic modification of the blockchain contents. For example, and as will be detailed herein, if it is determined that a given token was transferred in an illegitimate manner (e.g., as part of a heist, breach, etc.) then the data corresponding to this particular transfer can be selectively overridden, making the associated token return to the pre-attack ownership.

The override operation can be associated with a policy, which we will refer to as the override policy herein. An example policy may be associated with one or more tokens held by a wallet, whether custodial or non-custodial. Other example policies may specify a jurisdiction, a corporation, a recipient type, a maximum amount that can be transferred per time unit without the triggering of the policy, etc. Yet other policies may specify what entities may initiate an override operation, and under what conditions.

For example, a first government entity collaborating with a second government entity and a consumer watchdog organization from a list of three possible consumer watchdog organizations may perform override operation to a selected token or token type, but only when within a specified duration of time of a triggering event, where an example triggering event may be the transfer of the token from a specified custodial wallet, where the custodial wallet indicates, using Know Your Customer (KYC) records, that the token belongs to a user for which the organizations initiating the override have jurisdiction.

One policy could prevent any transaction involving a protected token where the transaction corresponds to the transfer to a mixer. There could be one specified time interval during which such a policy may apply, and another specified time interval for another policy. Thus, different policies may be associated with different time periods; this may be part of the formulation of a specific policy or be associated with the type of policy.

In one embodiment, a policy may implement a banlist or an allowlist. The banlist may include externally owned account (EOA) blockchain addresses, smart contract addresses, and/or more complicated constructs, for example, an array of addresses that may not transact with each other. The allowlist may include an actual list, for example a list of approved addresses, or it may be implemented in a more abstract manner, for example, the list may include a set of non-fungible tokens (NFTs) that permit transactions and EOAs or smart contracts that own one or more of the NFTs in the allowlist may be permitted to transact.

KYC-policies may be implemented using the technology disclosed in co-pending application titled “Blockchain enhancement technologies with applications to commerce” by Keir Finlow Bates and Markus Jakobsson, which is incorporated by reference in its entirety. Such technologies can also be implemented using the technology disclosed in co-pending application titled “Balanced Wallet Technology” by Markus Jakobsson and Keir Finlow-Bates”, which is incorporated by reference in its entirety.

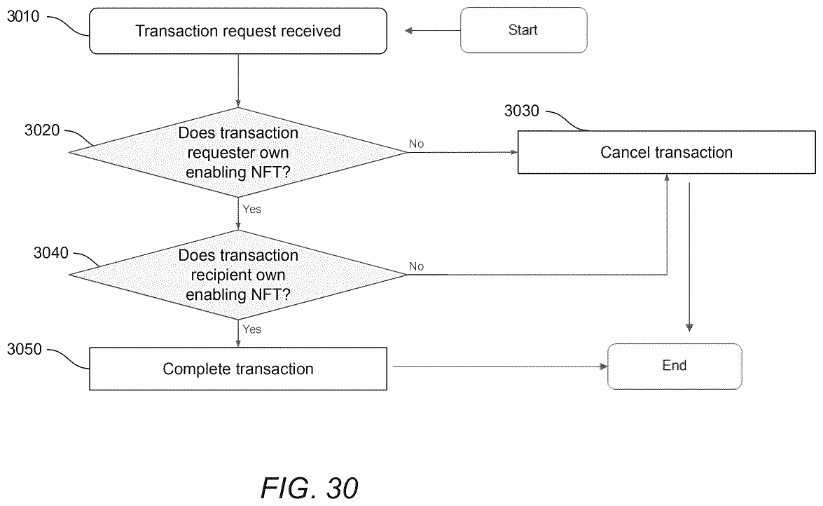

In FIG. 30, a flow chart presenting a possible embodiment of an NFT-enabled allowlist for permitting or blocking a transaction is presented. In some embodiments, the transaction may include a call to a smart contract function. In other embodiments, the transaction may include a blockchain native transaction, that is, the transaction may affect state changes at the blockchain protocol level.

Actions may commence with a transaction request being received, as shown in step 3010, for example, but not limited to, a request to transfer an amount of tokens from a sender to a receiver, or a request to add data to or remove data from a data structure on the blockchain.

Actions may then proceed to step 3020, in which it may be determined whether the transaction requester owns an enabling NFT. In some embodiments, the transaction requester may be the sender of tokens, an initiator of the transaction, or an authorizer of the transaction. In some embodiments, the determination may be made by a smart contract, a blockchain protocol implemented and enforced by blockchain nodes, or through approval by a third party that may be an external account, a smart contract, or a software component external to the blockchain.

If it is determined that the transaction requester owns an enabling NFT, actions may proceed to step 3040. Otherwise, actions may proceed to step 3030, in which the transaction request may be denied and the transaction may be cancelled.

In step 3040, it may be determined whether the transaction recipient owns an enabling NFT. In some embodiments, the transaction recipient may be a receiver of tokens or a blockchain address affected by the transaction. For example, presented for illustrative purposes only and not meant to be limiting in any way, in some embodiments, the transaction recipient may include a blockchain address that is added to a data structure in a smart contract, making the blockchain address an owner of the smart contract. In some embodiments, the determination may be made by a smart contract, a blockchain protocol implemented and enforced by blockchain nodes, or through approval by a third party that may be an external account, a smart contract, or a software component external to the blockchain.

If it is determined that the transaction recipient owns an enabling NFT, actions may proceed to step 3050. Otherwise, actions may proceed to step 3030, in which the transaction request may be denied and the transaction may be cancelled.

In step 3050, the transaction specified by the transaction request may be completed.

Those skilled in the art will appreciate that steps presented in FIG. 30 are presented for illustrative purposes, and may be executed in a differing order from the order presented, and that in some embodiments, steps may be omitted.

We refer to the entities that can initiate an override operation for a given token transaction as the “watchful agents”. Some watchful agents may be appointed by a token owner, and may be a community of token owners to which the token owner belongs, a trusted third party, or even the token owner themself.

Depending on the identity of the watchful agent and the conditions under which the override policy allows for an override, the value of a token is affected in the mind of a tentative recipient. Thus, it is in the best interest of token owners to appoint generally accepted entities to be their watchful agents, or the value of their tokens may be adversely affected or even make their tokens undesirable.

Similarly, the selection of policies, to the extent to which this is done by the token owner, affects the perceived value, which is likely to lead to a standardization of policies from which a token owner or custodial wallet organization may select one or more of a small number of such standardized policies that are commonly approved.

Policies may state maximum durations after which a transaction cannot be overridden, e.g., to avoid uncertainty among users as to which the recipient of the token wishes to transfer the token or parts thereof. Otherwise, such uncertainty can severely affect the value of tokens, as prospective recipients would have to fear that they might lose the ownership rights through an override operation. However, to the extent that users wish to transact before the time horizon of override operations, there could be insurers that investigate the transfer history of the token to determine whether there is a significant risk of overrides, and then purchase the affected token at a discount related to the perceived risk. Similarly, insurers may determine risk based on parameters other than time, e.g., previous ownership, transfer velocity, patterns of token movements, inquiries with previous owners, etc.

In some instances, a transaction may result in two sets of tokens being bartered for each other. In such a situation, the override agents associated with the first set may request from the override agents associated with the second set that both these teams of override agents perform a “mutual” override of the transfers. Alternatively, if the override agents of the first set of tokens initiate an override, this may trigger the override agents of the second set to automatically initiate a matching override.

In some instances, a sequence of dependent transactions may occur, commencing with an initial transfer or exchange of tokens that may subsequently be desirable to revert. In one embodiment of the present disclosure, subsequent transactions may inherit a maximum duration after which the sequence of transactions may not be reverted. For example, if token A with a reversal duration of 1 hour is exchanged for token B with a reversal duration of 2 hours, and subsequently, token B is exchanged immediately for token C with a reversal duration of 3 hours, both transactions (swapping A for B, and swapping B for C) may be reversible for 3 hours. In other embodiments of the present disclosure, subsequent transactions may inherit a minimum duration after which the sequence of transactions may not be reverted. Revisiting the example case of swapping A for B and then swapping B for C, these transactions may only be reversible for 1 hour.

An override can be performed by recording a validly authenticated override. We refer to the validly authenticated override as a TDNH (That Did Not Happen) assertion. The assertion includes a reference to the blockchain entry (or entries) that are to be modified. The assertion optionally includes an indication of how they are to be modified. This can also be conveyed implicitly, e.g., where an absence of an indication corresponds to a complete reversal of the referenced blockchain entry.

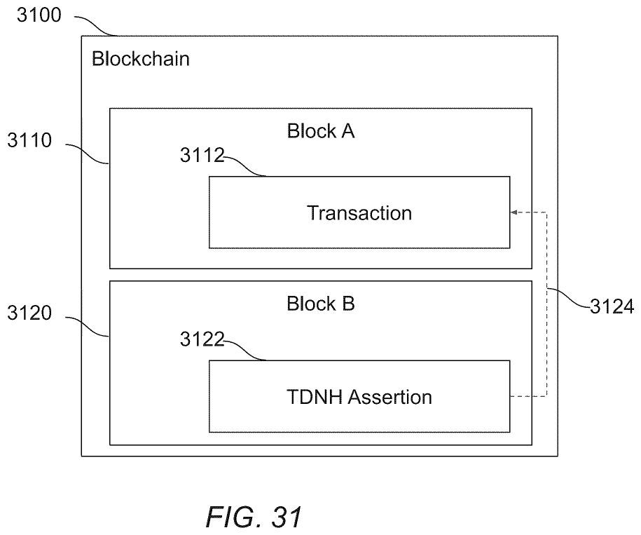

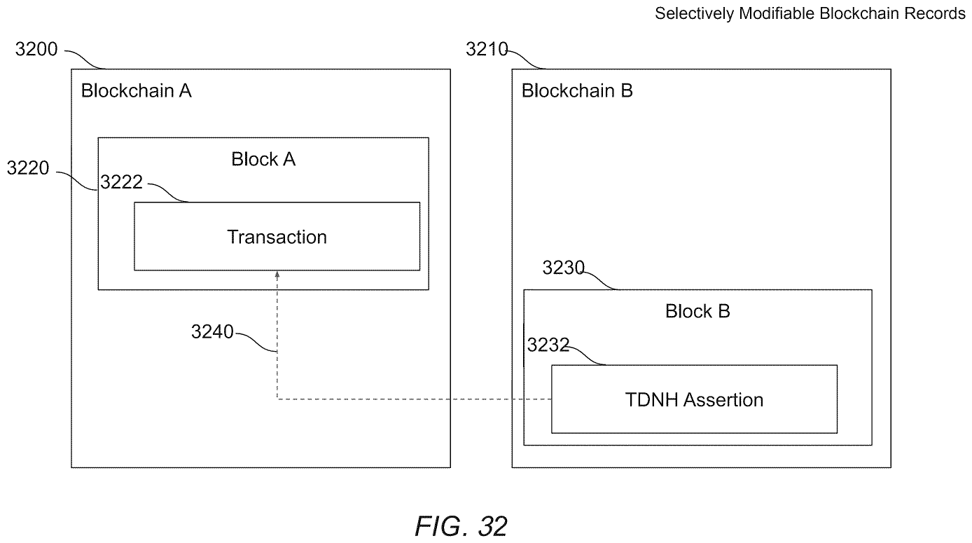

In FIG. 31, a block diagram illustrating an embodiment of a TDNH implementation for a blockchain in which TDNH assertions are recorded on the same blockchain as entries to be overridden is presented. A blockchain 3100 may include a plurality of blocks, for example, a block A 3110 and a block B 3120. Block A 3110 may include a transaction 3112. Block B 3120 may include a TDNH assertion 3122. The TDNH assertion 3122 may include a reference 3124 to the transaction 3112. Because blockchains include hash-linked lists of blocks, it may be computationally infeasible to edit block A 3110 to remove the transaction 3112. However, blockchain nodes may parse the blocks of the blockchain 3100 to determine whether any given transaction, such as transaction 3112, is later rescinded through a TDNH assertion, in this case TDNH assertion 3122.

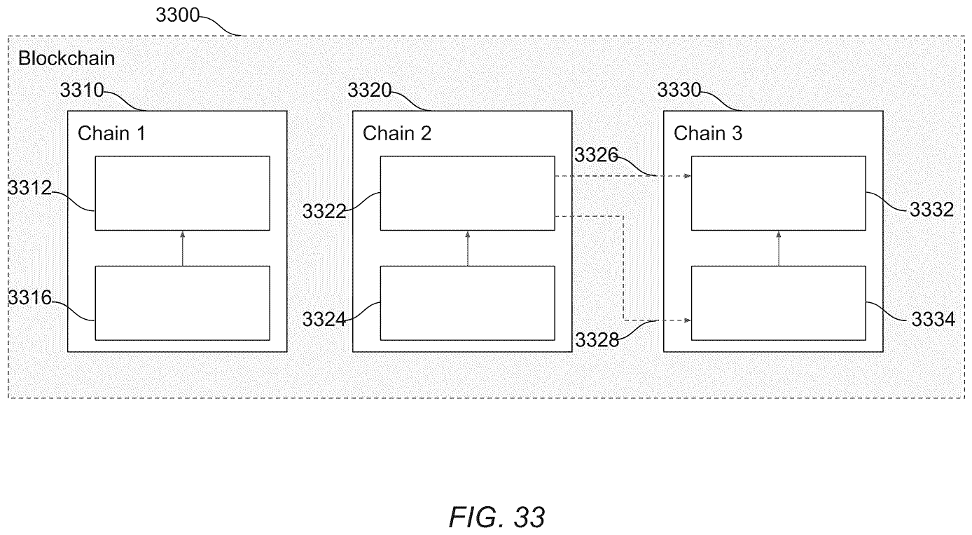

In FIG. 32, a block diagram illustrating an alternate embodiment to that presented in FIG. 31, in which two blockchains are used to implement TDNH assertions on a second blockchain for rescinding transactions on a first blockchain, is presented. A blockchain A 3200 may include a block A 3220. Block A 3220 may include a transaction 3222 that it may later become desirable to cancel. A blockchain B 3210 may include a block B 3230. Block B 3230 may include a TDNH assertion 3232. The TDNH assertion 3232 may include a reference 3240 to the transaction 3222.

In some embodiments, watchful agents may be hierarchically structured, where some watchful agents can override the override operations of other watchful agents. This hierarchy may be expressed in the policies, or may be inherent in the rules of the blockchain.

In some embodiments, threshold sharing may be used to implement multi-quorum embodiments. For example, two or more watchful families, each including multiple members, may share secrets, where different hierarchical levels may require different thresholds for participation.

In one embodiment, two or more chains are used to generate a certified storage where at least one of the chains is used to store data and at least one of the chains is used to store policies that, when applied to the stored data, enable interpretations of the data. In one embodiment, these two chains are hosted on one blockchain, whereas in other embodiments, they are hosted on separate blockchains. A first jurisdiction or other entity may use a first set of policies, whereas a second jurisdiction or other entity may use a second set of policies. These two sets of policies may refer to overlapping sets of stored data, disparate sets of data, or the same sets of stored data. The different sets of policies may reflect the meaning of the data within given jurisdictions, e.g., forcing the application of logging, escrowing, the payment of value added taxes or other charges, etc.

Multi-chain storage can be generalized for the storage of different classes of data, for example, a first chain may be used for balances of a native cryptocurrency, a second chain may be used for storage of smart contract code, and a third chain may be used for storage of states of smart contracts stored on the second chain. Thus a party interested only in balances of addresses on the blockchain would only need to download and synchronize with the first chain of the blockchain, increasing usability and efficiency for such users of the blockchain.

An embodiment of multi-chain storage is illustrated in FIG. 33. A blockchain 3300 may include a plurality of chains, for example provided for illustrative purposes and not meant to be limiting in any way, a first chain 1 3310, a second chain 2 3320 and a third chain 3 3330. A chain may include a hash-linked list of blocks, where each block is a package of data including a hash of a prior block. Thus an ordered set of hashes provides a link back from any given block to all prior blocks, as indicated in FIG. 33 by solid arrows.

In some embodiments, chain 1 3310 may include cryptocurrency transactions. For example, a first block of chain 1 3312 may include a transfer of a balance of cryptocurrency from an address A (not shown) to an address B, and a second block of chain 1 3316 may include a transfer of a balance from address B to an address C (not shown). Thus, requesting all blocks within chain 1 3310 from nodes on the blockchain 3300 network results in knowledge of a current state of cryptocurrency balances of the blockchain 3300. This has applications for, for example but not limited to, cryptocurrency exchanges, tax authorities, financial crime investigations, and so on, where a primary concern may be to know the current state of balances.

Chain 2 3320 may include source code or bytecode for smart contracts provided through contract deployment transactions. For example, a first block of chain 2 3322 may include a first smart contract, and a second block of chain 2 3324 may include a second smart contract. Thus, requesting all blocks within chain 2 3320 from nodes on the blockchain 3300 network results in knowledge of all currently deployed smart contracts. This has applications for, for example but not limited to, computer security investigations and static code analysis of smart contracts for auditing purposes.

Chain 3 3330 may include state data for smart contracts deployed on chain 3320. For example, a first block of chain 3 3332 may include state data for a smart contract (not shown) deployed on chain 2 3320 in a first block of chain 2 3322, as indicated by data flow 3326. Subsequently, a state change to the smart contract effected by a later transaction (not shown), as indicated by data flow 3328 may be recorded in a second block of chain 3 3334. Thus a user wishing to update a state of a known smart contract on chain 2 3320 only needs to request blocks for chain 3 3330 from nodes on the blockchain.

Those skilled in the art will appreciate, in light of the disclosure of the above embodiment, that other partitioning of blockchain data into separate chains has many useful applications. For example, partitioning token balances, identity tokens and data structures, and oracle data into separate chains within a blockchain may provide significant improvements in efficiencies for consumers of blockchain data.

In some embodiments, reversibility of transactions may depend on which chain or chains would be affected by a reversal of a transaction. For example, presented for illustrative purposes only and not meant to be limiting in any way, in the three-chain blockchain described in the previous paragraph, smart contract deployments may be reversible within a first predetermined time period, and transactions altering a state of a smart contract may be reversible within a second predetermined time period, but transactions affecting balances of native cryptocurrency may not be reversible. Thus, chain one would be immutable, and chains two and three may be reversible within the first predetermined time period and the second predetermined time period, respectively. Other combinations of reversibility time periods for different chains of the same blockchain are also possible.

A policy may include one or more bits of information indicating features that are turned on or off. It may alternatively, or in addition, include a list of one or more indices, where each index indicates a policy number. The mapping between policy numbers and associated policies may be dependent on the jurisdiction or other boundary, e.g., corporate boundary or membership/organizational boundary. Similarly, the one or more bits of information indicating features that are turned on or off may also depend on the context, e.g., one combination of bits may have one meaning in one context and another meaning in another. This interpretation based on context may also be encoded as meta-policies, each of which governs one or more policies. Alternatively, such meta-policies may be included among the policies, and may be built in a multi-layer hierarchy. This can be used to implement complex policy functionality based on a small set of building blocks that can be assembled to express one or more policies.

Yet alternatively, or in addition, policies may also be expressed by executable code, which may be of the same or a similar format as a smart contract. Some policies may be automatically disabled and only used as subroutines for other policies, or of smart contracts. Allowing smart contracts to call common routines enables a more compact expression of common smart contracts, which improves the efficiency of the system, whether in terms of storage quantities used or in terms of computational requirements, or both. The reduction of storage requirements as well as computational requirements is beneficial in reducing the cost of operating blockchains.

By reducing the cost of the system operation, one can also reduce the gas fees required by participants. Reducing the operational costs is also valuable if the system implements complex policies, as these may otherwise increase the burden of operation.

Allowing complex policies enables a greater range of functionality. Since the policies can be optimized in terms of their execution, and in many cases executed in a pipeline or in parallel, or using an ASIC developed specifically for the evaluation of one or more common policies or policy components, the use of complex policies instead of complex smart contracts can be much more efficient. An increased reliance on a smart set of carefully vetted policies that may be mostly static also increases system security, as it enables an offloading of functionality from smart contracts, which may face less scrutiny. Still, by being able to use a series of building blocks, in addition to potential segments of code (which may be expressed either as executable policies or smart contract components), it will be possible to preserve the ability for creators of smart contracts to innovate and create their own desired functionality.

The development and deployment of policies rather than smart contract code may provide comprehensibility, usability, and security benefits.

A boundary associated with a policy may be determined in multiple ways, including by determining a boundary associated with one or more accounts associated with a transfer, with one or more wallets associated with a transfer, with a token being transferred, with a blockchain on which a transfer has been or is to be recorded, and combinations of such.

Associated records, caused by the policies, may be stored on yet another chain used for metadata, on the data-storing chain (or chains), or on one or more policy chains. One chain can be used to store meta data, e.g., in the form of policies, where such policies may be specific to a given jurisdiction, company, set of tokens, type of tokens, set of users, and more. Some policy entries may take the form of a blocklist, e.g., specifying what users are not allowed to perform specified transaction types, whether by type of user, by jurisdiction associated with the user, by unique identifier of the user, by behavior of the user, or a combination of such descriptors. Policies may detail whitelists as well, which could identify users, organizations or government entities with special rights, e.g., to act as administrators, to trace transfers, to determine whether a given token belongs to a specified entity, etc. The identification of entities may be by publishing certificate data which is used to digitally sign rights statements associated with entities or tokens. Whereas the private key of a token can generally be thought of as corresponding to the right to transfer ownership of the token, such signed rights statements may confer additional rights beyond rights to transfer. The certificates may simply correspond to public keys of the parties with the rights to confer rights, or they may have additional information, such as expiration dates, information related to the issuance of the certificate including a digital signature by an authority, and specifications of the limits of the rights conferred, e.g., specifying what types of tokens the rights are limited to or what kinds of rights can be conferred by a party with access to the private key associated with the certificate.

In one embodiment, only authorized entities can write entries to the TDNH database, and only authorized entities can write TDNH entries to databases. Different types of authorization may be required for different types of modifications, and there may be different authorities who may write such modifications. The determination of authorization may be managed using staking mechanism, consensus, or using legally appointed entities. The expression of authorization may be done by attaching digital signatures, or simply implicitly by having the authority managing TDNH entries/databases approve the writing of a record.

Different determinations of validity of TDNH records can be made in different jurisdictions by applying local policies to the determination of whether a TDNH record is valid or not, based on the type of content, the identity of the authority/authorities approving the entry, and on other data. This will not create inconsistencies, as it is possible to determine, at any time, what another jurisdiction will determine in terms of validity if the policies are publicly accessible.

Blockchain Enhancement Technologies with Applications to Commerce

Systems exist for bridging tokens between different blockchains. However, these systems either require a trusted authority to perform bridging, thus defeating the purpose of decentralized systems in removing gate-keepers and brokers, or require significant resources and complex technical solutions to enable decentralized bridging, by requiring constant monitoring and significant incentivization rewards to keep bridging participants honest.

Thus small entities find themselves unable to bridge their own tokens due to insufficient financial resources, the excessive workload required to maintain the bridge reliably over time, and due to a lack of in-house technical expertise and knowledge.

There is therefore a need for a simple yet reliable decentralized bridging mechanism to allow anyone to bridge assets from one blockchain to another in a cheap, safe, and efficient manner without the need for implementing or managing bridging infrastructure.

### I. Bridging Token Proxy

Bridges between two different chains already exist for tokens, such as, for example, USDC, which is instantiated on both the Ethereum mainnet and on the Polygon mainnet, with a bridge called the Circle bridge enabling users to transfer USDC from one chain to another, using a protocol called the Circle's Cross-Chain Transfer Protocol (CCTP). The bridge is enabled through a smart bridge contract on each chain, and a component which communicates to each of the bridges. When an amount of USDC is deposited in a first bridge smart contract on a first chain, the component indicates to a second bridge smart contract on a second chain that an equal amount of USDC may be withdrawn by an authorized blockchain address from the second bridge smart contract. The locking or burning of tokens on the first chain and release or minting of tokens on the second chain has the equivalent effect of transferring tokens from the first chain to the second chain.

There is a problem for an entity wishing to implement a bridge for their token, namely that they need to implement a version of the component that communicates between the two chains. This component poses a security risk, and may require numerous independent participants to ensure security and decentralization.

In an aspect of the present disclosure, a method for bridging smart contracts that takes advantage of established bridging infrastructure in blockchain for other tokens is presented, removing the need for a separate off-chain counterparty or counterparties to manage bridging. This introduces significant efficiencies of scale and cost, in that it allows new tokens to be bridged through reliance on the security of established and time-proven bridges without requiring permission from the entities managing said bridges.

The method is predicated on our observation that a (potentially small) amount of the already-bridged token may be used to represent a large amount of a new token to be bridged. This way, new functionality can be introduced by utilizing an old tool in a new way. We provide an array of detailed examples of such new functionality herein.

In an embodiment, a first blockchain may include a first piggy-back smart contract, and a second blockchain may include a second piggy-back smart contract. Actions may commence by a user submitting a transaction to the first blockchain calling a function of the first piggy-back smart contract, said transaction including: a transfer of an amount of a token to the first piggy-back smart contract and a destination address on the second blockchain.

Actions may then proceed by the first piggy-back smart contract submitting a bridging request to an established blockchain bridging contract for a (potentially) small sum of tokens handled by the established blockchain bridging contract, proportional to the amount of the token, with a recipient of the small sum of tokens being the second piggy-back smart contract on the second blockchain, and a payload of data including the destination address.

The established blockchain bridging contract may then, in accordance with its programming, bridge the (potentially) small sum of tokens to the second blockchain and transfer them to the second piggy-back smart contract along with the payload. More generally, one first blockchain bridging contract may be configured to transfer a collection of tokens to a multiplicity of smart contracts, wherein the selection of these may be performed at the time the first blockchain bridging contract is executed. The selection may, for example, determine amounts to be transferred for one or more fungible tokens, a selection of non-fungible tokens to be transferred, and a collection of smart contracts or addresses indicating recipients that the tokens are to be transferred to. This process may, in part, be governed by an AI that is associated with but not necessarily a part of the blockchain bridging contract.

The receipt of the small sum of tokens by the second piggy-back smart contract optionally together with the payload of data may then indicate to the second piggy-back smart contract that a recipient may withdraw an equivalent amount of tokens to the amount of the token submitted to the first piggy-back smart contract. The use of piggy-backing is different from that in other disciplines, and the term should be understood in the context of the instant invention, as disclosed. Piggy-backing both enables transfers and lower the cost of these; it is a flexible mechanism on which an infrastructure, potentially governed by an AI, can be built, where the AI or other managing software may implement functionality such as watchfulness, anti-fraud mechanisms, logging mechanisms that may involve escrowing data, and other technologies, as will be understood by a person of skill in the art. Watchfulness was disclosed in co-pending application titled “Using Watchful Bridging for Blockchain Fraud Prevention” by Markus Jakobsson, Stefan Dufva, Keir Finlow-Bates, and Guy Stewart.

A useful aspect of the instant disclosure is that ownership of the value represented by the (potentially) small sum of tokens remains with the piggy-back bridging contract infrastructure, passing back and forth between the first piggy-back smart contract and the second piggy-back smart contract, only being slightly depleted by gas fees for the established blockchain bridging contracts. The disclosure may be used to bridge fungible tokens such as ERC20 compliant tokens, token vault share tokens, non-fungible tokens such as ERC721 compliant tokens, and other kinds of transferable tokens, as further detailed below.

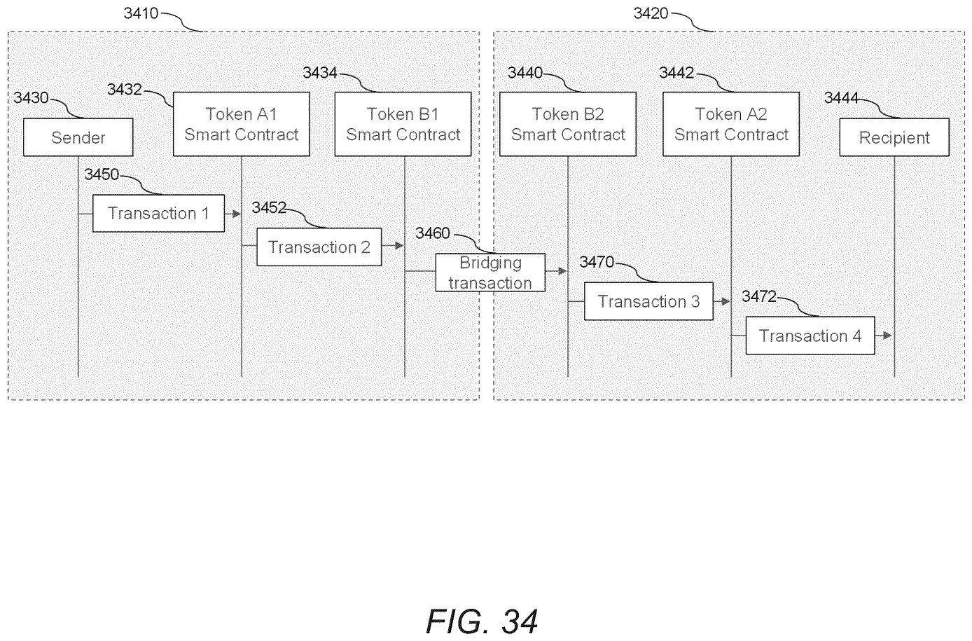

In FIG. 34, a sequence diagram illustrates a possible embodiment of a method for a piggy-back transfer of a token using an existing bridging mechanism is presented. A first blockchain 3410 and a second blockchain 3420 include a bridged token B instantiated on the first blockchain 3410 by a token B1 smart contract 3434 and on the second blockchain 3420 by a token B2 smart contract 3440, with token B on the first blockchain 3410 represented by tokens recorded in the token B1 smart contract 3434 and on the second blockchain 3420 by tokens recorded in the token B2 smart contract 3442, with a bridging mechanism in place using standard bridging mechanisms known to those skilled in the art, for example through the use of blockchain oracles, or multiple trusted oversight parties.

A piggy-back bridging mechanism for a token A may be implemented using the present disclosure for a token A1 smart contract 3432 on the first blockchain 3410 and a token A2 smart contract 3442 on the second blockchain 3420. We now disclose how a sender 3430 on the first blockchain 3410 may send an amount of token A to a recipient 3444 on the second blockchain 3420 through a novel bridging method.

Actions for bridging an amount of token A from the first blockchain 3410 to the second blockchain 3420 may commence with the sender 3430 submitting transaction 1 3450 to the token A1 smart contract 3432. Transaction 1 3450 may include one or more of: an amount of token A to transfer, an identifier for the second blockchain 3420, and a recipient address on the second blockchain 3420 for the recipient 3444, and transaction 1 3450 may transfer the amount of token A to the token A1 smart contract 3432.

In response to receiving transaction 1 3450, the token A1 smart contract 3432 may verify transaction 1 3450 is valid, and on finding it valid, the token A1 smart contract 3432 may transfer a proportional amount of token B to the token B1 smart contract 3434 through a transaction 2 3452. In some embodiments, transaction 2 3452 may include a contract-initiated function call to a function in the token B1 smart contract 3434.

In some embodiments, transaction 2 3452 may include one or more of: a transfer of an amount of token B from the token A1 smart contract 3432 to the token B1 smart contract, an instruction to bridge the amount of token B to the second blockchain 3420, a blockchain address of the token A1 smart contract 3442 as a recipient of the amount of token B, and a data payload including a blockchain address or some other identifier of the recipient 3444.

On receiving transaction 2 3452, the token B1 smart contract 3434 may initiate a bridging transaction 3460 to the token B2 smart contract 3440 on the second blockchain 3420. This may result in the token B2 smart contract 3440 transferring an amount of token B2 corresponding to the amount of token B on the second blockchain 3420 as indicated by transaction 3 3452 to the token A2 smart contract 3442. In response, the token A2 smart contract 3442 may transfer a proportional amount of token A on the second blockchain 3420 to the recipient, as shown by transaction 4 3472.

Thus an extant bridging system for a token B may be used to transfer proportional amounts of a token A between two blockchains without an implementer of token A being required to implement a bridging system. Cost may be kept low by transferring a small amount of token B to represent a large amount of token A.

To clarify, note that in the above we refer to a token A implemented on two blockchains in general, by specific implementations of token A1 on the first blockchain 3410 and token A2 on the second blockchain 3420.

As an example, a stablecoin valued at 1 USD and divisible to 6 decimal places may exist and may provide a bridging system between two blockchains. 100 units of token A may be transferable using 100*10⁻⁶ units of the stablecoin, thus requiring only 0.0001 dollars or 0.01 cents to transfer the 100 units of token A. This provides significant cost savings.

In some embodiments, bridging functionality for the token A1 smart contract 3432 to the token A2 smart contract 3442 may be implemented in smart contracts or smart contract libraries distinct from the token A1 smart contract 3432 and/or the token A2 smart contract 3442.

Those skilled in the art will now appreciate in light of the above disclosure that the method applies to any fungible token instantiating smart contract, and that the method works in reverse, which is the same method may be used to transfer fungible tokens from the second blockchain 3420 to the first blockchain 3410.

### II. NFT Bridging Proxy

The bridging token proxy may be used to bridge an NFT, which we henceforth call an NFT piggy-back bridging proxy. In an alternate and extended embodiment of the above disclosure, an NFT may be represented by an NFT index value in a first NFT piggy-back smart contract on a first blockchain, with a first chain NFT instantiating contract reference hard-coded into the first piggy-back smart contract. In other embodiments the first NFT piggy-back smart contract may include a data structure mapping index integers to first chain NFT instantiating contract addresses, and the NFT may be represented by a tuple including the NFT index value and the NFT instantiating contract reference index integer. A second NFT piggy-back smart contract and a second chain NFT instantiating contract may be deployed on a second blockchain, or in the case of a plurality of NFT instantiating contracts a plurality of second

An advantage of this disclosure is that legacy NFTs may be bridged across chains using existing fungible token bridges.

In example, presented for illustrative purposes only and not meant to be limiting in any way, the first piggy-back smart contract may piggy-back NFTs for the DeadFellaz NFT contract on Ethereum (a first blockchain) at address 0x2acAb3DEa77832C09420663b0E1cB386031bA17B. The DeadFellaz NFT contract is ERC721-compliant, and instantiates 10,000 distinct and unique NFTs, referenced through an integer tokenId.

Actions may commence with an owner of a DeadFellaz NFT, without loss of generality let us call it the DeadFellaz NFT indexed by tokenId value 9506, transferring the DeadFellaz NFT 9506 to a first piggy-back smart contract together with a data payload specifying a recipient address on the second blockchain. In some embodiments, the owner may first approve the first piggy-back smart contract to transfer the DeadFellaz NFT 9506 to itself.

The owner of the DeadFellaz NFT 9506 may then call a function in the first piggy-back smart contract specifying a recipient address for the DeadFellaz NFT 9506 on a second chain.

The first piggy-back smart contract may then transfer the DeadFellaz NFT 9506 to itself or to a proxy contract, and also transfer 9506 units of a bridged fungible token and a data payload including to a second piggy-back smart contract on a second chain, through an existing bridge for the bridged fungible token. At this point, the first piggy-back smart contract is the owner of DeadFellaz NFT 9506 on the first blockchain, and the second piggy-back smart contract has received 9506 units of the bridged fungible token which are registered against the recipient address on the second blockchain.

The owner of the recipient address on the second blockchain may now call a function of the second piggy-back smart contract requesting transfer of ownership of DeadFellaz NFT 9506 on the second blockchain. In some embodiments, a second DeadFellaz NFT-instantiating smart contract that is a code duplicate or code equivalent of the DeadFellaz NFT contract may have been deployed, with the second piggy-back smart contract set as owner of the contract and owner of all NFTs it instantiates. In another embodiment the code duplicate or code equivalent of the DeadFellaz NFT contract may include a mint function that only the second piggy-back smart contract may call. In the first case, the second piggy-back smart contract may then transfer the second DeadFellaz NFT 9506 instantiated by the second DeadFellaz NFT-instantiating smart contract to the recipient address. In the second case, the second piggy-back smart contract may mint a second DeadFellazNFT 9506 to the recipient address.

As a result of the above actions, the DeadFellaz NFT 9506 is locked in the first piggy-back smart contract, and the second DeadFellaz NFT 9506, which is an equivalent of the DeadFellaz NFT 9506 on the second chain, is in possession of the owner of the recipient address.

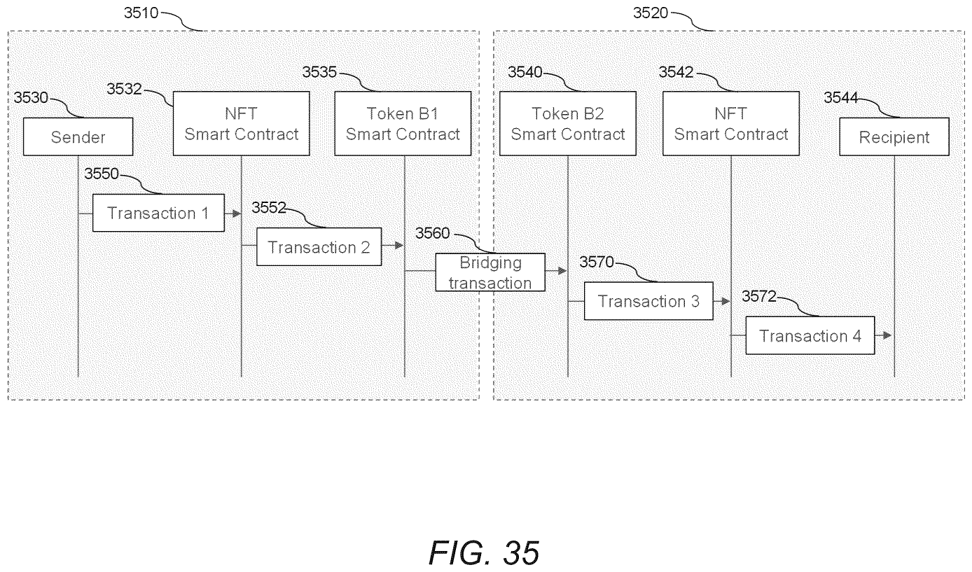

The instant invention is further illustrated by a signaling diagram presented in FIG. 35, in which an NFT may be bridged from a first blockchain 3510 to a second blockchain 3520. Actions may commence with a sender 3530 submitting a first transaction 1 3550 to an NFT smart contract 3532, with the first transaction 1 3550 including a request to transfer an NFT owned by the sender 3530 to a recipient 3544 on the second blockchain 3520.

Receipt of the first transaction 1 3550 may then trigger the NFT smart contract 3532 to submit a second transaction 2 3452 to a token B1 smart contract 3534 on the first blockchain 3510, with the token B1 smart contract 3534 instantiating a version of a token B on the first blockchain 3510, said token B bridged by a known bridging method to the second blockchain 3520, where token B is instantiated by a token B2 smart contract 3540. The second transaction 2 3552 may include a request to transfer an amount of token B1 to an NFT smart contract 3542 on the second blockchain 3520. In some embodiments, the second transaction 2 3452 may include metadata identifying the recipient 3544 as the final receiver of the NFT. In other embodiments the metadata may be encoded by selecting an appropriate amount of token B to transfer from the first blockchain 3510 to the second blockchain 3520.

Receipt of the second transaction 2 3552 by the token B1 smart contract 3534 on the first blockchain 3510 may trigger a bridging transaction 3560, through which one or more of an amount of token B and the metadata may be transferred from the first blockchain 3510 to a token B2 smart contract 3540 on the second blockchain 3520. Subsequently, this may trigger a third transaction 3 3570 from the token B2 smart contract 3540 to an NFT smart contract 3542 on the second blockchain 3520. Transaction 3 3570 may transfer the amount of token B to the NFT smart contract 3542, and if provided and supported, the metadata.

The NFT smart contract 3542 may then analyze the amount of token B and/or the metadata to determine which NFT should be transferred, and to whom it should be transferred. The NFT smart contract 3542 may then transfer the NFT to the recipient 3544 as shown in a fourth transaction 4 3572.

In some embodiments of the above disclosure, some transactions may be push transactions, that is, the transaction may be cascadingly triggered through the receipt of earlier transactions. In other embodiments of the above disclosure some transactions may be pull transactions, that is, the action of the transaction may be triggered through actions taken further down the chain of transactions. For example, presented for illustrative purposes only and not meant to be limiting in any way, transaction 4 3572 may be triggered as a pull transaction by the recipient 3544, with the action of transaction 4 3572 enabled by but not effected by transaction 3 3570.

Those skilled in the art will now appreciate in light of the above disclosure that the method applies to any NFT-instantiating smart contract, and that the method works in reverse, that is the same method may be used to transfer NFTs from the second blockchain to the first blockchain.

Bridging with No Data Payload

Some bridges may not permit extra data payloads for specifying a final recipient address, thus not enabling the first piggy-back bridge smart contract to specify a final recipient to the second piggy-back bridge smart contract. We now disclose how communication of the final recipient address may be provided through values of the (potentially) small sum of tokens handled by the established blockchain bridging contract.

In an embodiment, the (potentially) small sum of tokens may encode both an amount of a specific non-bridged token to transfer, and the final recipient address. In some embodiments, the final recipient address of length N may be directly encoded by the N least significant bits of the value of the (potentially) small sum of tokens, and the amount of the specific non-bridged token may be encoded by the remaining bits of the value of the (potentially) small sum of tokens.

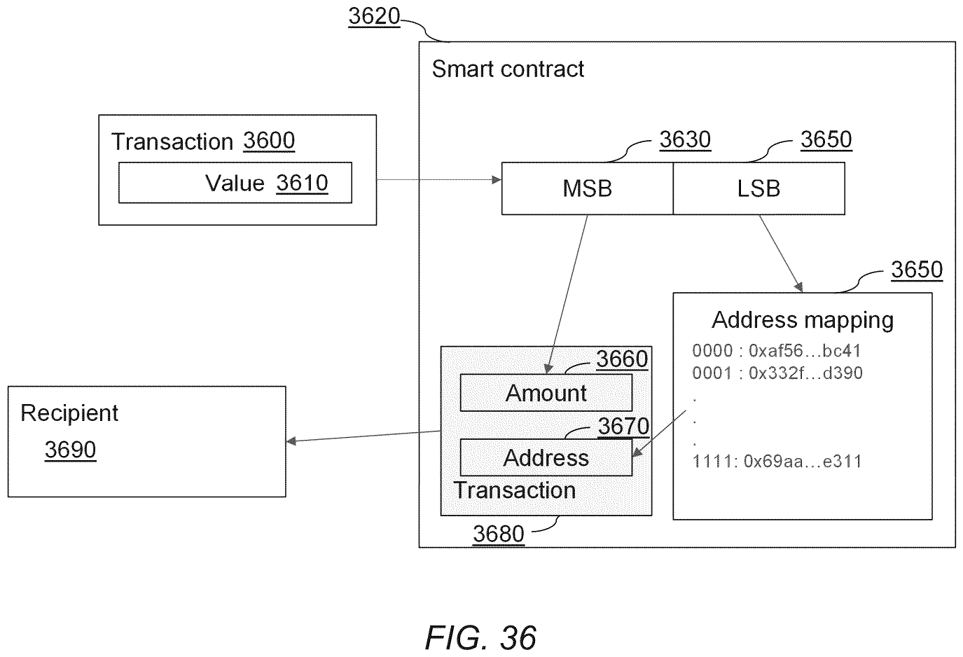

This is illustrated in a block diagram in FIG. 36. A transaction 3600 from a bridged token contract may transfer a value 3610 of tokens to a smart contract 3620 on a second chain. On receiving the value 3610, the smart contract 3620 may split the value 3610 into two parts: a most significant bits MSB 3630 part, and a least significant bits LSB 3640 part. The LSB 3640 may be used as an index to look up a recipient address in an address mapping 3650, and bits from the MSB 3630 may be used to produce an amount for transfer. In the present example, provided for illustrative purposes only and not meant to be limiting in any way, four least significant bits may be used in the address mapping 3650, allowing up to 16 addresses to be referenced through the value 3610.

In other embodiments, recipients may first register their second chain address with the second piggy-back bridge smart contract through the address mapping 3650, mapping a smaller integer index to their second chain address, and their second chain address may be referenced through the integer index. This provides an added advantage in that, for example, a 160 bit address may be referenced through a 32 bit index value, with the trade-off being that only 2\hat{ }32, i.e. approximately 4.2 billion, unique addresses may be referenced. In some embodiments, integer index 0 may be hard-coded to represent the zero address for token minting and burning purposes.

The smart contract 3620 may construct a transaction 3680 with the MSB 3630 providing an amount 3660 and LSB 3640 mapped to an address 3670 using the address mapping 3650. The transaction, when executed, may transfer the amount 3660 to the recipient 3690 indicated by the address 3670.

Those skilled in the art will now appreciate in light of FIG. 36 that components and implementations may be rearranged for the same result. For example, MSB 3630 may be used to look up the recipient address, and LSB 3640 may encode the value to transfer to the recipient address.

### III. Bridging Data Proxy

In some instances it is necessary to communicate data between two smart contracts on two different blockchains. Historically this is performed using oracles, which are trusted off-chain components that read and monitor data in a smart contract on one chain, and pass changes to the data to a smart contract on a second chain. Oracles require constant or frequent auditing and punishment/incentivization systems to keep them honest, which come at a cost.

We now disclose a cheaper more trustworthy cross-chain data communication system using an established token bridging system such as CCTP, in which transferring (potentially) small sums of a bridged token such as USDC is used to communicate data between two smart contracts on two different blockchains. This allows parties who do not have the funds or technical knowledge to deploy an oracle system to nevertheless enable cheap and reliable cross-chain communication.

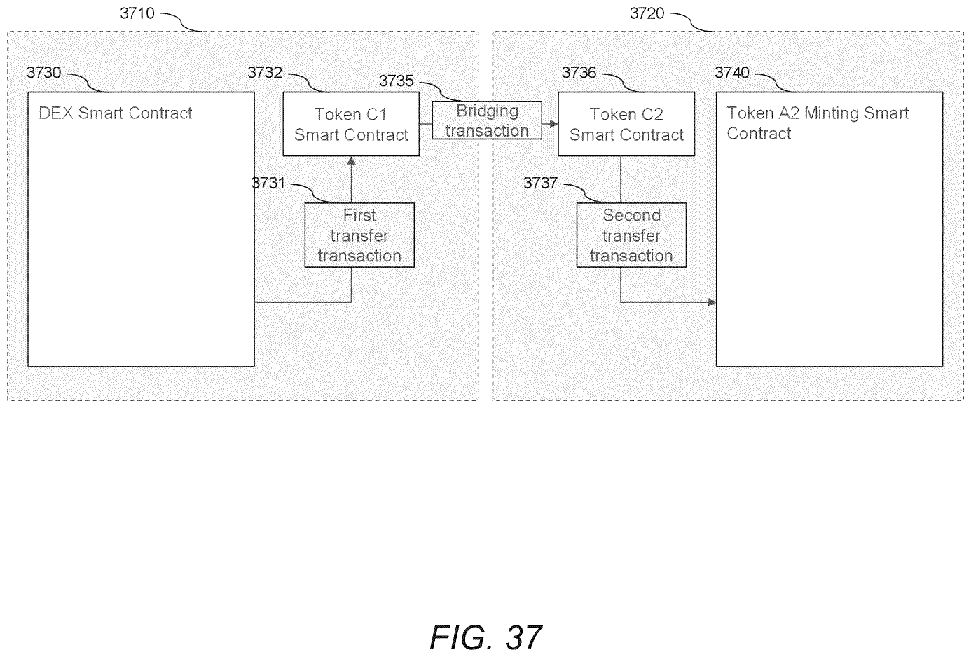

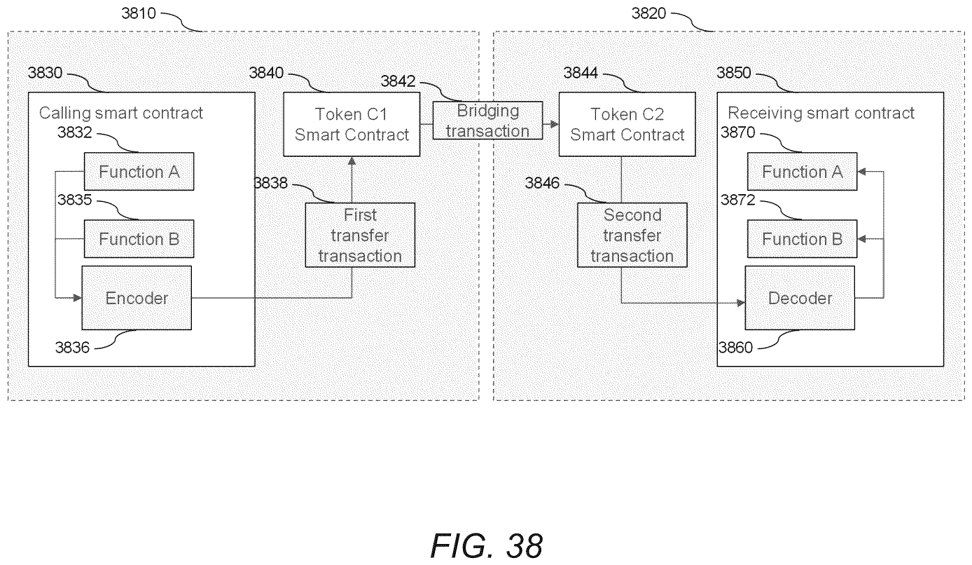

In FIG. 37, provided for illustrative purposes only, and not meant to be limiting in any way, a block diagram is presented that illustrates communication of data from a first blockchain 3710 to a second blockchain 3720 by piggy-backing on a token bridge for a token C, usually (but not always) provided by another party. Although a specific example is given of pricing a first token A in terms of a second token B, where token A is instantiated on the first blockchain 3710 as A1, token B as B1 and bridging token C as C1, and on the second blockchain 3720 as token A2, B2, and C2 respectively, this example illustrates the general principle of transmitting information from a smart contract on one blockchain to another smart contract on another blockchain. In the present example the price of A as determined by a DEX smart contract 3730 on the first blockchain 3710 is transmitted to a token A2 minting smart contract 3740 on the second blockchain 3720. Information transferred may include, but is not limited to, blockchain addresses, prices, quantities of tokens minted, burned, or transferred, or indeed any data that is known on one blockchain and is required on the other.

The first blockchain 3710 may include a decentralized exchange, namely DEX smart contract 3730. The DEX smart contract 3730 may offer users the possibility to exchange between two tokens; token A1 and token B1. Exchanging an amount of one of the token pair for the other may be at an exchange rate determined dynamically through a hyperbolic curve, that is a liquidity pool for an amount a of token A1 and an amount b of token B1 held by the DEX smart contract 3730 must always satisfy ab=k, where k is a constant. Through this an amount of token A1 may be purchased using token B1, where it is the case that as more of token A1 is bought, more of token B1 is required to purchase subsequent amounts of token A1. As a result, at a given time, based on the relative quantities of token A1 and token B1 in the liquidity pool, we can calculate a cost price for a unit of token A in a price quoted in token B. Call this cost c.

When the cost c changes, for example because someone exchanges tokens using the DEX smart contract 3730, we wish to transmit that information, namely the new value of c, to a token A2 minting smart contract 3740.

The second blockchain 3720 may include the token A2 minting smart contract 3740, which allows the minting of amounts of token A for a payment in token B. We desire the token A minting smart contract to charge c tokens of type B, which on the second blockchain 3720 are represented by B2, to ensure that the charge made by the token A2 minting smart contract 3740 matches the exchange rate determined by the DEX smart contract 3730 on the first blockchain 3710. Using current state of the art knowledge, this would be performed by a blockchain oracle.

We now wish to communicate the current price c whenever it changes to the token A2 minting smart contract 3740 on the second blockchain 3720, where the token minting smart contract mints a comparable token A on payment of an amount of a comparable token B on the second chain. We therefore require the DEX to communicate the current price to the token minting smart contract.

This is achieved with the following novel method: whenever an exchange takes place on the DEX smart contract 3730 and the cost c therefore changes, an amount of token C is transferred from the DEX smart contract 3730 to the token A2 minting smart contract 3740. Actions may begin by the DEX smart contract 3730 experiencing a price change in the cost c, and may continue by the DEX smart contract submitting a first transfer transaction 3731 to a token C1 smart contract 3732. The token C1 smart contract 3732 may submit a bridging transaction to a token C2 smart contract 3736 on the second blockchain 3720 using a conventional token bridge, as shown by a bridging transaction 3734. The token C2 smart contract 3736 may then submit a second transfer transaction 3737 to the token A2 minting smart contract 3740. The token A2 minting smart contract 3740 as quantifying a change to the minting cost for the A2 token.

In some embodiments, the amount of the C token transfer may correspond to a new price for token A2 in terms of token B2. In other embodiments, the amount of the C token transfer may correspond to a change in the price for token A2 in terms of token B2.

The above method functions if A is more expensive than B. For a situation where it is possible that a fractional number of tokens of type B are required to buy one unit of token A, we may use a significant bit as an indicator as to whether the remaining bits of the binary representation of the amount indicate that a number of units of B are required to purchase one unit of A, or whether a unit of B purchases a number of units of A. For example, provided for illustrative purposes only, if we use the most significant bit of an 8 bit number, then 0b00001101 would indicate that 13 units of B purchase 1 unit of A, and 0b10001101 would indicate that 13 units of A are purchased by 1 unit of B. Note that this limits exchange rates between 1 and 127 units of either A for B or B for A. Larger differences may be achieved by using larger significant bits (for example the most significant bit of a 16 bit number or a 32 bit number), but this results in larger amounts of the bridging token to be sent. Another approach is to use the least significant bit as the exchange direction indicator, and to bitwise right shift the amount number to obtain the exchange quantity.

The illustrative example above shows how data, namely an exchange rate for a decentralized exchange smart contract on a first blockchain, may be transferred to a smart contract on a second blockchain. Other data transfers may include, but are not limited to: a blockchain address, a string represented by numerical values, or state information obtained from smart contracts on the first blockchain.

Uses for the disclosure are not limited to communication of exchange rates, and include, but are not limited to: communicating changes on a first blockchain to a second blockchain, for example, changes in maximum or circulating token supplies, providing blocklisted or allowlisted addresses, transaction details for mirroring transactions across blockchains, changes in governance parameters for decentralized finance protocols such as yield percentages, issues or redeemed share tokens.

### IV. Bridging Remote Procedure Call Proxy

The data bridging proxy disclosed above may further be used for a smart contract on one blockchain to make function calls or enable function calls to a smart contract on another blockchain. A possible embodiment for a calling smart contract 3830 on a first blockchain 3810 making a remote function call to a receiving smart contract 3850 on a second blockchain 3820 is shown in FIG. 38.

The calling smart contract 3830 may include one or more functions that may be called by a user using the first blockchain 3810. Without loss of generality, in FIG. 38 two functions, function A 3832 and function B 3834 are shown, however, those skilled in the art will appreciate in light of the disclosure that follows that any number of functions may be used.

A call to a function, for example function A 3832, may result in parameters provided to the function A 3832 being passed to an encoder 3836. The encoder 3836 may encode the identity of the function called, in this case function A 3832, and the parameters, into a value v. The encoder 3836 may then transfer an amount of a token C1 corresponding to value v to a recipient on the second blockchain 3820, through a first transfer transaction 3838 and a token bridging system including a token C1 smart contract 3840 on the first blockchain 3810, and a bridging transaction 3842, a token C2 smart contract 3844 on the second blockchain 3820. The first transfer transaction 3838 may cause a second transfer transaction 3846 to transfer an amount of a token C2 corresponding to value v to the receiving smart contract 3850, as described above for FIG. 37.

On receiving the amount of token C2 corresponding to value v, the receiving smart contract 3850 determines value v from the second transfer transaction 3846 using a decoder 3860. The decoder 3860 extracts a function identity and in some embodiments parameters for the function identified from the value v through a reverse operation to that of the encoder 3836. In the present example, two functions, function A 3870 and function B 3872 are presented, but as explained above any number of functions may be implemented. In the present example, function A 3832 was called by the user, and so the value v will encode a choice of function A, hence the decoder 3860 calls function A 3870 in the receiving smart contract 3850.

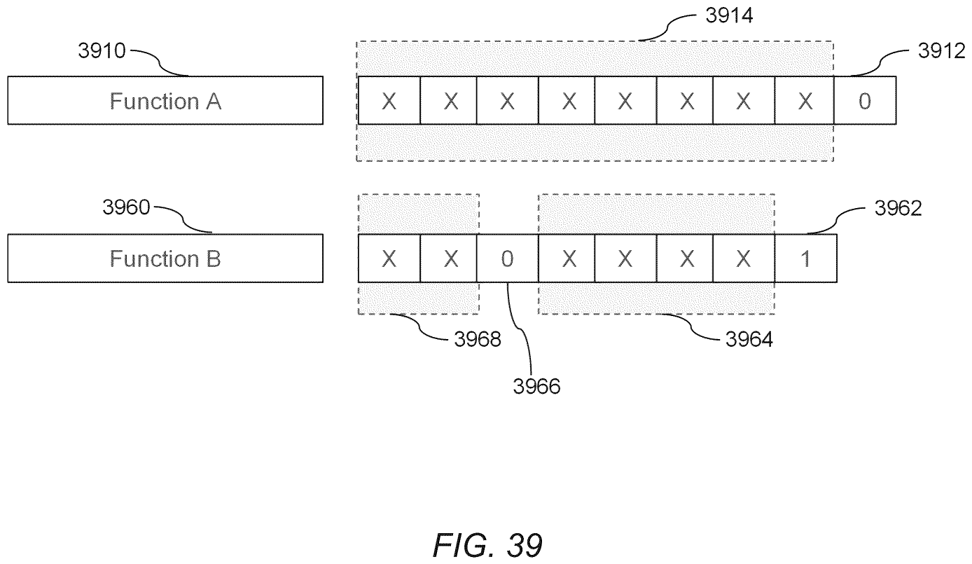

An illustrative example of an encoding for value v is shown in FIG. 39. A value v with a least significant bit 3912 of zero may indicate a call to function A 3910, and a value v with a least significant bit 3962 of 1 may indicate a call to function B.

A call to function A 3910 may require an eight-bit integer parameter, as shown by 3914.

A call to function B 3960 may require a four-bit integer as shown by 3964, and a two-bit integer as shown by 3968. Optionally a separator value may be used as shown by 3966.

Thus, for example, a call to function A 3910 with a parameter of 200 in denary would require a value v in binary of 110010000, as 11001000 is 200 in binary, and the final 0 indicates a call to function A 3910. 110010000 in binary equals 3700 in denary, value v must be 3700, and 3700 tokens of C are transferred.

A value v of 110010001 in binary (or 401 in denary) would indicate a call to function B 3960, as the least significant bit is 1. The two parameters would be 11 and 01000 in binary, or 3 and 8 in denary.

### V. Throttled Bridges

Bridges that allow a transfer of assets between blockchains are a known security risk in the crypto-asset space, providing a single point of failure frequently open to exploitation by malicious parties. Hundreds of millions of US dollars' worth of digital assets have been compromised over the years, and there is a need for further protection of asset bridging infrastructure. Furthermore, often the first action taken by hackers after stealing digital assets is to bridge them onto another blockchain for several reasons, including obfuscating transactions and hiding asset origins, to gain access to mixers and other asset laundering services that may be more lax on a different chain, and to enable off-raming of the digital assets to a national currency through the use of a non-compliant crypto exchange that may have a preference for particular blockchains,

In an aspect of the present disclosure, abuse is curbed by introducing novel security mechanisms that implement a throttling for bridge infrastructure. We demonstrate that this can be done by causing transfers between bridge components on different chains to be subjected to time limitations. In some embodiments time limitations may be proportional to the size of the transfer. In an embodiment, a first chain may include a first bridging smart contract, and a second chain may include a second bridging smart contract, wherein depositing an amount of a digital asset with the first bridging smart contract may allow a specified blockchain address to withdraw an equivalent amount of an equivalent digital asset on the second blockchain at a time-dependent rate. For example, presented for illustrative purposes only and not meant to be limiting in any way, on depositing 100 units of a token A with the first bridging smart contract on the first blockchain, a user may then be allowed to withdraw 100 units of a token B from the second bridging smart contract on the second blockchain at a rate of 1 token per minute.

In an embodiment, the rate may be a function f( ) of the amount to transfer. If X is the amount to be transferred, then f(X) may be the amount of tokens that may be withdrawn per block, or per second.

The function f( ) may be linear, for example but not limited to, f(X)=X/k, where k is a constant. This choice of function would ensure that all transfers would take the same time to complete, namely in k blocks.

The function f( ) may include a square root, for example but not limited to, f(X)=X0.5. This choice of function would ensure that larger transfers would take longer to complete than shorter transfers.

The function f( ) may include a piecewise function, for example but not limited to f(X)=X if X<100, f(X)=X/10 if X>=100. This choice of function would ensure that transfers of less than 100 tokens may be completed in one block, but transactions greater than 100 tokens would take 10 blocks to complete.

Those skilled in the art will now appreciate that any choice of function where f(X)<=X will result in a delay in withdrawing all of the transferred assets, and that the choice of function determines the characteristics of the limitations applied to the withdrawal of assets after transfer.

An advantage of this disclosure is that by delaying large transfers, extra time is provided to components and entities maintaining and securing the bridge for the detection and subsequent prevention of malicious actions that should be blocked, and/or for freezing the digital assets if the smart contract implementing them includes a freezing function or recourse functionality.

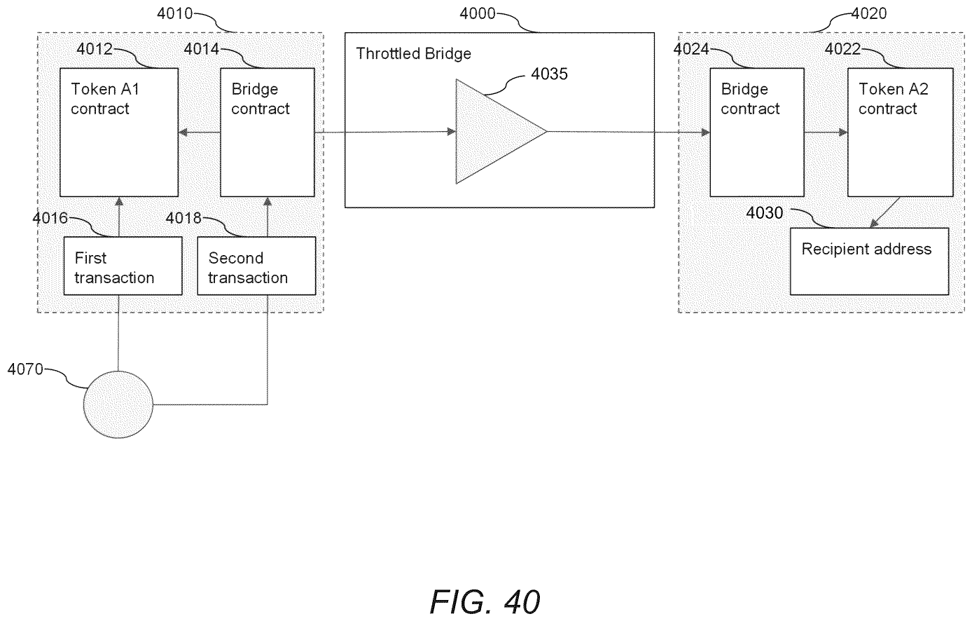

In FIG. 40 a possible embodiment of a throttled bridge 4000 is presented for illustrative purposes only, and is not meant to be limiting in any way. The throttled bridge 4000, a bridge contract 4014 on a first blockchain 4010 and a bridge contract 4024 on a second blockchain 4020 may enable a transfer of a digital asset, call it token A, from the first blockchain 4010 on which it is implemented as token A1, to the second blockchain 4020, where token A may be implemented as token A2.

Actions may start by a user 4070 submitting a first transaction 4016 to a token A1 contract 4012 permitting the bridge contract 4014 to operate an amount of tokens of type A1 owned by the user 4070.

Actions may then continue by the user 4070 submitting a second transaction 4018 to the bridge contract 4014, requesting that the amount of tokens of type A be transferred to a recipient address 4030 on the second blockchain 4020. In response the bridge contract 4014 may take ownership of the amount of tokens of type A1, and may inform the throttled bridge 4000 that an amount of tokens of type A2 are to be transferred to the recipient address 4030 on the second blockchain 4020. In some embodiments the throttled bridge 4000 may examine blocks added to the first blockchain 4010 for events issued by the bridge contract 4014.

The throttled bridge 4000 may include a throttling function 4035 through which a delay may be calculated, which in some embodiments may be based on or proportional to the amount of tokens of type A2 that are to be transferred.

The throttled bridge may then instruct the bridge contract 4023 on the second blockchain to initiate a transfer of the amount of tokens of type A2 to the recipient address 4030 through the token A2 contract 4022 at a throttled rate, depending on the throttling function 4020 used. In some embodiments throttling may occur through multiple transfers of fractions of the amount of tokens of type A2. In other embodiments throttling may occur through vesting functionality in the token A2 contract 4022.

### VI. Dual Node Bridges

A first dual node is set up using a pair of smart contracts, one on each of a pair of blockchains, to announce that it is a dual node. The first dual node is a special administrator node that subsequently approves or rejects membership of further dual nodes to a collective of dual nodes. A second node wishing to register as a second dual node makes a request to each of the smart contracts, and if the first dual node approves the requests by, for example but not limited to, signing the requests, calling an admit function in each of the smart contracts with the address associated with the second dual node, or some other way to approve the second dual node, the second node is then registered as the second dual node.

Dual nodes may then transfer information between the two blockchains, which in some embodiments may be done on request.

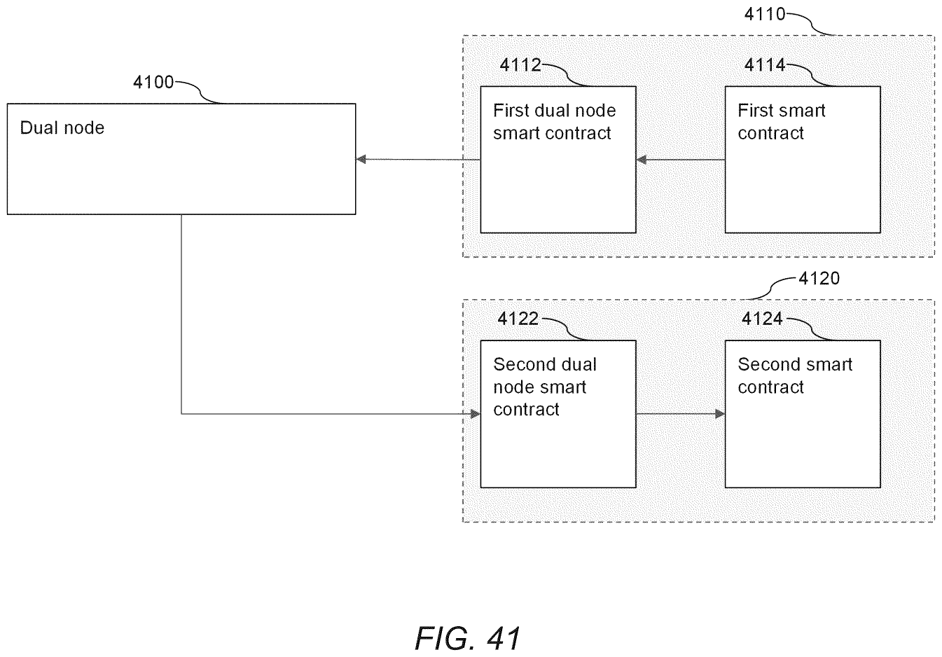

In FIG. 41, a block diagram illustrating an embodiment of a dual node 4100 facilitating a transfer of information from a first smart contract 4114 on a first blockchain 4110 to a second smart contract 4124 on a second blockchain 4120 is illustrated for exemplary purposes only, and is not meant to be limiting in any way.

The first smart contract 4114 may generate data that it is desirable to know about on the second blockchain 4120, for example, due to a transaction from or interaction with another smart contract or user. The first smart contract 4114 may transmit this information to a first dual node smart contract 4112. The dual node may monitor the first dual node smart contract 4112 for information received, and may transmit it to a second dual node smart contract 4122 on the second blockchain 4120. In some embodiments the second dual node smart may then transmit the information to a second smart contract 4124. In other embodiments the second smart contract 4124 may query the second dual node smart contract for the information.

In an embodiment, nodes wishing to become dual nodes may be required to provide a time-locked stake to one or more of the smart contracts. A dual node that transmits false information about a first blockchain of the pair of blockchains to a second blockchain of the pair of blockchains may forfeit some or all of the time-locked stake, some or all of which may, in some embodiments, be transferred to a dual node that alerts the dual nodes to the false information. The forfeiture may be enacted by a majority of dual nodes confirming that the information is false, and between the notification from the dual node raising the alert and the majority of dual nodes confirming the information is false the stake may be frozen. The stake may be time-locked to prevent a malicious dual node from transferring false information and then immediately withdrawing the stake. If a false alert is made, this may be subject to the same forfeiture as a transmission of false information.

Examples of information to transfer, provided for illustration only and not meant to be limiting, may include: balances of tokens recorded against assets, states of smart contracts, activity by specific blockchain addresses, arrival times and/or rates of arrival of blocks, current or past gas fees, blockchain forks (soft and/or hard), deposits of digital assets with smart contracts, transfers of digital assets, and so on.

The system is generalizable to a plurality of smart contracts on a plurality of blockchains.

### VII. Transfer of Non-Transferable Tokens

The European Union regulatory legislation, “Markets in Crypto Assets” pertains to digital assets that are transferable and have a perceived value between two parties. Thus if a token is non-transferable, it sidesteps the regulations. A token instantiated by a smart contract may be rendered non-transferable by disabling or not implementing transfer functionality in the smart contract. Nevertheless, there are more ways to transfer digital assets than through a transaction or a smart contract. If the private key may be used to derive a public key that may then be used to derive a blockchain address, with a digital asset registered against the blockchain address, then by transferring the private key, the asset is also transferred. However, the private key cannot simply be sent to a second party by a first party, because the second party has no guarantee that the first party has not deleted all copies of the private key, and could therefore still have access to and ownership of the digital asset.

In an aspect of the present invention, a method for transferring a private key for an asymmetric key cryptography algorithm using trusted execution environments is disclosed, wherein the trusted execution environments (TEEs) are not directly connected to a network. This increases the security of the TEEs.

In an embodiment, a multi-signature scheme is used whereby four private keys, call them Pa, Pb, Pc, and Pd, are generated such that a minimum of two private keys are required to sign a transaction for a blockchain address derived from the four private keys. A first party has a first TEE including Pa, Pb, and Pc, and a second party has Pd, optionally also in a second TEE. The TEEs may prevent their user from seeing some or all the keys under most circumstances other than allowing one and only one distinct key to be revealed if three are held. The TEEs may be requested to sign transactions on the user's behalf. The TEEs can only sign if they include at least two distinct private keys. The TEEs may be requested to delete the keys currently held, and may produce a verifiable receipt, for example but not limited to, a digitally signed message stating that the keys currently held have been irrevocably deleted.

Thus the first party may use the TEE to sign transactions for the blockchain address using two of the three private keys, for example Pa and Pb, Pa and Pc, or Pb and Pc. The second party is unable to sign as they only have Pd. Ownership of the digital asset therefore lies with the first party.

The first party may request their TEE to reveal one key, for example key Pc. The first party may then request that their TEE delete all three keys, and the TEE may do so and return a verifiable receipt that deletion has occurred. The first party may then transfer the verifiable receipt and key Pc to the second party.

The second party now has evidence that the first party has at most key Pc, and can therefore not sign transactions for the blockchain address, provided the second party trusts the TEE. The second party now holds keys Pc and Pd, and may therefore sign transactions for the blockchain address. As a result, ownership of the digital asset now lies with the second party and not with the first party.

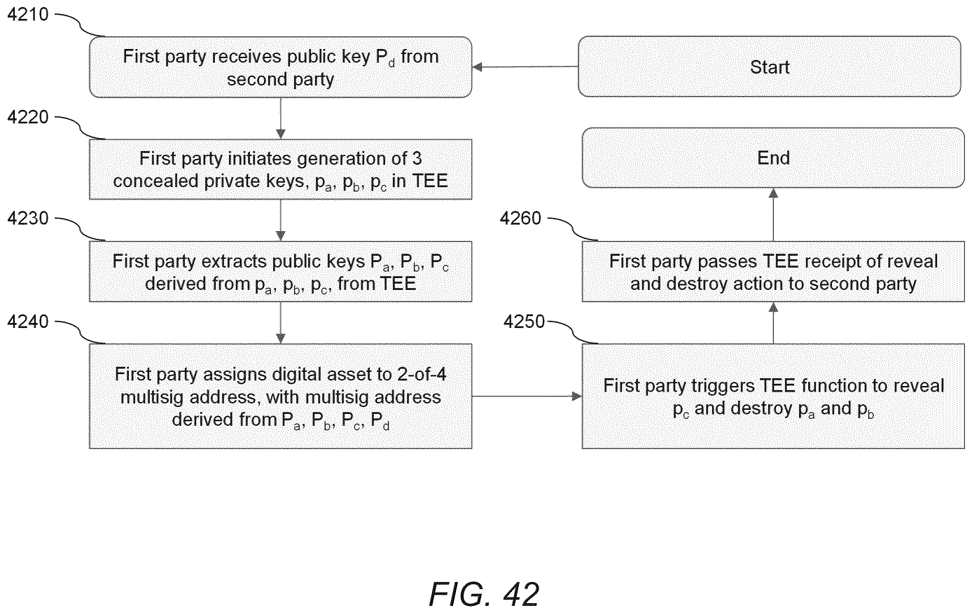

A flowchart illustrating a possible embodiment of a method for transferring a digital asset in a trustworthy manner without a transaction is presented in FIG. 42.

Actions may commence with a first party receiving a public key Pd from a second party, as shown in step 4210.

Actions may proceed to step 4220, in which the first party causing a TEE to generate three concealed private keys, pa, pb, and pc.

Actions may then proceed to step 4230, in which the first party may extract three public keys Pa, Pb, and Pc, derived from the three concealed private keys, pa, pb, and pc, from the TEE.

Actions may then proceed to step 4240, in which the first party may assign a digital asset to a 2-of-4 multi-signature address, with the multi-signature address derived from Pa, Pb, Pc and Pd.

Actions may then proceed to step 4250, in which the first party may trigger a reveal and destroy function of the TEE, said function:
Revealing pc,
Destroying pa and pc,
Producing a receipt including pc and evidence of the destruction of pa and pb

Actions may then proceed to step 4260, in which the first party may pass the receipt of the reveal and destroy function to the second party.

Those skilled in the art will appreciate that in the aftermath of an application of the method of FIG. 42, the second party will hold private keys pc and pd, and the first party will at most hold private key pc, thus the second party may digitally sign and hence validate transactions for the digital asset using pc and pd, but the first party is unable to validate transactions for the digital asset as they only hold one key. Thus, without submitting a transaction to the blockchain, before the full application of the method, the first party is in control of the digital asset and the second party is not, and in the aftermath of the application of the method, the second party is in control of the digital asset, and the first party is not.

### VIII. Vaults Producing Derivatives of Vault Shares

One possible definition of a token vault is a smart contract that accepts deposits of one or more digital assets, and issues an amount of share tokens or derivative tokens representing the deposited digital assets. For compliance purposes it may be desirable to ensure that such share tokens or derivative tokens are non-transferable.

In an aspect of the present invention, a vault of vaults for non-transferable token vault share tokens is disclosed, through which non-transferable share tokens (henceforth referred to as shares) may nevertheless be transferred. In an embodiment, a user who wishes to deposit an amount of tokens in a vault but would also like the shares resulting from the deposit to be transferable, instead deposits the tokens in the vault of vaults along with a specification of the non-transferable token vault into which the tokens should be transferred. The vault of vaults then deposits the amount of tokens into the vault, receives the non-transferable shares representing the deposit, and registers the shares against the user's blockchain address.

Subsequently, if the user wishes to transfer the shares to a second party, the user submits a transfer request transaction including a blockchain address of the second party to the vault of vaults, requesting that the shares be registered against the blockchain address of the second party instead of their own address. This constitutes a transfer of the shares.

At any point, the blockchain address against which the shares are registered may submit a transaction to the vault of vaults, requesting the shares be redeemed against the equivalent amount of tokens deposited in the vault plus any yield obtained from the deposit.

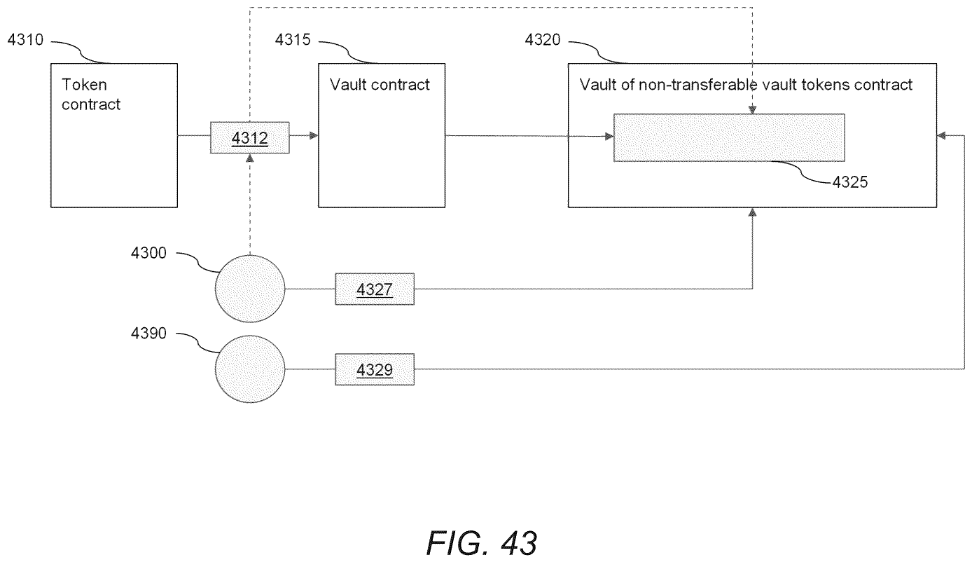

FIG. 43 presents a block diagram, provided for illustrative purposes only and not meant to be limiting in any way, illustrating an embodiment of a vault of non-transferable vault tokens contract 4320 allowing a transfer of non-transferable vault tokens from a first party 4300 to a second party 4390.

The first party 4300 may submit a transaction 4312 for a transfer of an amount of tokens instantiated by a token contract 4310 and owned by the first party 4300 to a vault contract 4315. The transaction 4312 may specify that non-transferable vault tokens generated on receipt of the amount of tokens by the vault contract 4315 are registered against an address of the vault of non-transferable vault tokens contract 4320 instead of an address of the first party 4300.

The vault of non-transferable vault tokens contract 4320 may, in some embodiments, determine from the transaction 4312 or through some other method, that the originator of the transaction 4312 resulting in a receipt of non-transferable vault tokens by the vault of non-transferable vault tokens contract 4320 is the first party 4300, and may record ownership of the non-transferable vault tokens against an address of the first party 4300 in a record 4325.

Subsequently, as an authorized owner of the non-transferable vault tokens, the first party 4300 may, through a transaction 4327 to the vault of non-transferable vault tokens contract 4320, instruct the vault of non-transferable vault tokens contract 4320 to update the record 4325 to record ownership of the non-transferable vault tokens to the second party 4390.

The second party 4390 may then, through a transaction 4329 to the vault of non-transferable vault tokens contract 4320, request that the non-transferable vault tokens specified in the record 4325 be redeemed at the vault contract 4315 for the amount of tokens, and the vault of non-transferable vault tokens contract 4320 may transfer the amount of tokens obtained through redemption of the non-transferable vault tokens to the second party 4390.

### IX. Fractional Reserve Banded Liquidity Pool DEX

Decentralized exchanges (DEX) rely on a pool of asset pairs to provide the liquidity for trading. As a first asset is traded for a second using the DEX, the amount of the second asset in the pool decreases and the amount of the first increases. The exchange rate for converting the first asset to the second asset is calculated from the ratio of the two assets in the pool, thus as more people buy the second asset with the first asset, the more expensive the second asset becomes in terms of the first asset. A hyperbolic function is used to calculate the price, and thus as one of the assets in the liquidity pool decreases, its price in terms of the other asset increases exponentially.

A recent development in DEX liquidity pools is to provide bands of liquidity. The liquidity pool becomes an array of pairs of asset amounts and associated price bands, and if trading moves from one price band to the next, the DEX switches to operating on that band, and hence provides exchanges using assets allocated specifically for that band. For example, if there are three bands, then the liquidity array will contain three elements, each element consisting of a tuple of amounts of pairs of assets. One of the aims of banded liquidity is to provide most of the liquidity in an expected range of trading.

Take, in an example provided for illustrative purposes only and not meant to be limiting in any way, pairs of stabletokens pegged to the US dollar, say, USDC and USDT. The trading range for USDC to and from USDT is expected to be in the range of 0.95 dollars to 1.05 dollars, as both tokens should be pegged closely to 1 dollar. If one of the tokens were to become unpegged, arbitrageurs would stampede to trading out the depegged asset against the pegged asset, depleting the value of the liquidity pool, and hence causing financial loss to the providers of liquidity. By banding the liquidity pool into separate subsets of liquidity, at worst only the lowest band of liquidity would become depleted.

A problem with current DEXes is that the assets stored in liquidity pools are locked for two purposes, namely providing the assets to trade and calculating their relative exchange rates between the assets, and as trading only uses a small proportion of the liquidity provided, the majority of the deposited assets are performing no function. This problem is exacerbated in banded liquidity pool DEXes, where bands that are further away from the present exchange rate are dormant.

In an aspect of the present disclosure, a pair of amounts of two tokens that may include either a complete liquidity pool or a band of a liquidity pool for the two assets may use fractional reserve backing requirement for the liquidity pool. This frees the remaining liquidity for other purposes, for example, for providing liquidity pools for other asset pairs that may be trading in different ranges.

In some embodiments, trading on the DEX between the two assets may be halted by a smart contract instantiating the DEX if holdings of one of the two assets fall below the fraction reserve.

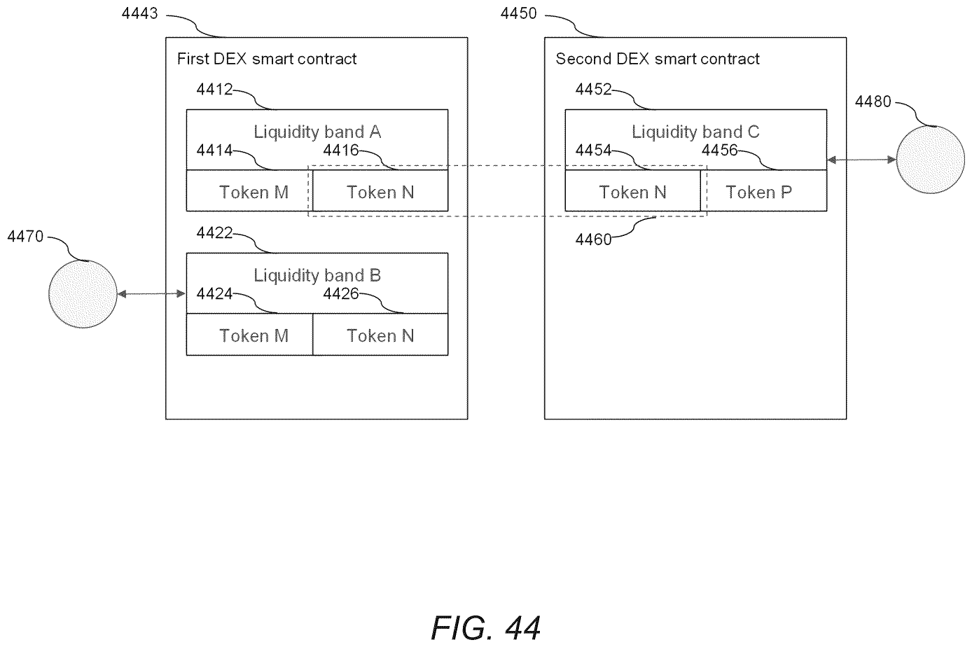

An embodiment of a fractional reserve banded DEX is illustrated in FIG. 44.

A first DEX smart contract 4410 may include a liquidity band A 4412 and a liquidity band B 4422. Liquidity band A 4412 may include reserves of two tokens, a reserve of token M 4414 and a reserve of token N 4416. Liquidity band B 4422 may also include reserves of the two tokens, a reserve of token M 4424 and a reserve of token N 4426. The first DEX smart contract 4410 may therefore provide exchange functionality between the two tokens, token M and token N, at two different price bands.

Trading between token N and token M by market participants 4470 may, at a point in time, be taking place at an exchange rate within liquidity band B 4422. Thus reserves in liquidity band A 4412 may, at that point in time, not be used.

A second DEX smart contract 4450 may include a liquidity band C 4452, including a reserve of token N 4454 and a reserve of token P 4456. The second DEX smart contract 4450 may therefore provide exchange functionality between token N and token P. At the same point in time, trading between token N and token P may be taking place by market participants 4480, which may include the same market participants 4470.

In an embodiment of the present disclosure, the reserve of token N 4416 in the first DEX smart contract 4410 and the reserve of token N 4454 in the second DEX smart contract 4450 may include some or all of the same reserve, as indicated by 4460.

In some embodiments, if at a later point in time trading between token N and token M by market participants 4470 shifts to an exchange rate requiring liquidity band A 4412, the reserve of token N 4454 and the reserve of token N 4416 may be separated, for example but not limited to, by an injection of further reserves of token N into one or more of token N 4416 and/or token reserve N 4454.

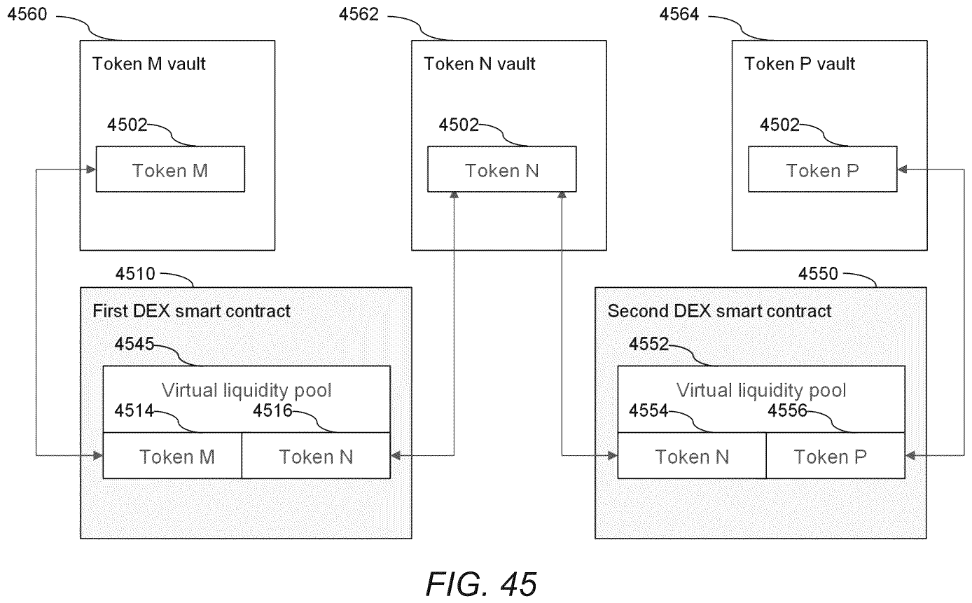

FIG. 45 is a block diagram of an embodiment illustrating how multiple DEX smart contracts may use a token vault for fractional reserve liquidity through a use of virtual liquidity pools.

A first DEX smart contract 4510 may include a virtual liquidity pool 4512 including a recorded amount of token M 4514 and a recorded amount of token N 4516. A second DEX smart contract 4550 may also include a virtual liquidity pool 4552 including a recorded amount of token N 4554 and a recorded amount of token P 4556. Note that the first DEX smart contract 4510 and the second DEX smart contract 4550 may, in some embodiments, not hold any amounts of token M, token N, and/or token P themselves.

A token M vault 4560 may hold an actual amount of token M 4514 on behalf of the first DEX smart contract. A token P vault 4564 may hold an actual amount of token P 4456 on behalf of the second DEX smart contract. A token N vault 4562 may hold an amount of token N on behalf of both the first DEX smart contract 4510 and the second DEX smart contract 4550. The amounts of token M, token N, and token P held by the token M vault 4560, token N vault 4562, and token P vault 4564 may be any combination of less than, more than, or equal to the amounts of those tokens recorded on the first DEX smart contract 4510 and the second DEX smart contract 4550.

When an exchange takes place on either the first DEX smart contract 4510 or the second DEX smart contract 4550, this may involve a party depositing, or providing control over, one of some amount of token M or token N on the first DEX smart contract 4510 in exchange for the other token, or one of some amount of token N or token P on the second DEX smart contract 4550 in exchange for the other.

Without loss of generality, we will look at an exchange on the first DEX smart contract 4510 where token N is provided by the party in exchange for token M. Those skilled in the art will appreciate that this corresponds to an exchange on the second DEX smart contract 4550 of token N for token P. When the party provides an amount of token N to the first DEX smart contract 4510, the first DEX smart contract 4510 may transfer the amount of token N to the token N vault 4562, may increase the recorded amount of token N 4516 in the virtual liquidity pool 4512 by the amount of token N, may decrease the recorded amount of token M 4514 by an appropriate amount of token M calculated using a DEX function, for example but not limited to a hyperbolic function, and may cause the token M vault 4560 to transfer the appropriate amount of token M to the party.

Similarly, we may look at an exchange on the first DEX smart contract 4510 where token M is provided by the party in exchange for token N. Those skilled in the art will appreciate that this corresponds to an exchange on the second DEX smart contract 4550 of token P for token N. When the party provides an amount of token M to the first DEX smart contract 4510, the first DEX smart contract 4510 may transfer the amount of token M to the token M vault 4560, may increase the recorded amount of token N 4516 in the virtual liquidity pool 4512 by the amount of token M, may decrease the recorded amount of token N 4516 by an appropriate amount of token N calculated using a DEX function, for example but not limited to a hyperbolic function, and may cause the token N vault 4562 to transfer the appropriate amount of token N to the party.

The structure of the embodiment described in FIG. 45 results in the tokens in the token vaults being freed up for other purposes when no exchanges of tokens are taking place. For example, the configuration for the token N vault 4562 allows one amount of token N to be used in two liquidity pools, namely virtual liquidity pool 4512 and virtual liquidity pool 4552. Tokens in the token vaults may be deposited in yield bearing decentralized finance smart contracts, and extracted just in time when an exchange transaction takes place.

An issue that requires consideration is the situation where the amount of tokens in a vault are insufficient to cover payout for an exchange for that token. For example, if one party exchanges tokens of type M for tokens of type N on the first DEX smart contract 4510 at the same time as another party exchanges tokens of type P for tokens of type N on the second DEX smart contract 4550, the token N vault 4562 may contain an insufficient amount of token N to cover both exchange transactions. Mechanisms may be put in place to cover such eventualities, including but not limited to: allowing the token N vault 4562 to borrow sufficient amounts of token N from a loan smart contract to cover the exchanges.

The disclosed technology can be used to execute logging of encrypted data for purposes of safe-keeping and for controlled auditing, e.g., by an escrow entity. This can be done by logging watchful actions:

One aspect of the current disclosure is a technique supporting the auditing of security actions in the context of blockchain abuse prevention. Watchful bridging, disclosed in co-pending application titled “Using Watchful Bridging for Blockchain Fraud Prevention” by Markus Jakobsson, Stefan Dufva, Keir Finlow-Bates and Guy Stewart, enables transaction reversal, and is useful to deter and remedy abuse ranging from theft and social engineering to malware infection and malicious smart contracts. Transaction reversal can also be performed using alternative techniques, such as disclosed in co-pending application titled “Watchful Consensus Mechanisms” by Markus Jakobsson. It can also be implemented by applying watchfulness techniques to smart contracts, as illustrated below. Since watchful actions may be contentious and potentially performed by dedicated watchfulness servers that have been compromised, it is desirable to apply auditing techniques to simplify tracking and monitoring of such actions. An entity performs an action informed by watchfulness policies, such as blocking a transaction from taking place, reversing a transaction, modifying a payment of a transaction to apply a required royalty or tax payment, etc. This entity may be distributed or a single server; it may be implemented using a consensus mechanism; it may require human input in the form of voting of stakeholders; it may be a corporate server; it may be operating on a national firewall, etc. As the watchfulness action takes place, the watchful entity generates an entry identifying the action, and adds this entry to a log, such as what is implemented by a blockchain. The entry may be in part encrypted, e.g., using an escrow authority's public key. Various relevant escrow techniques are disclosed in, e.g., co-pending applications titled “Escrowed Wallet and Transaction Tracking Technology” by Markus Jakobsson and “Automated Wallet and Transaction Control” by Markus Jakobsson and Keir Finlow-Bates. There may be a policy establishing that this log needs to be generated within a specified time period of the watchful action being taken; this way, a verifier can inspect the inputs to the watchful entity (such as requests to perform transactions) as well as the resulting actions and the logs, determining if logs are not produced when watchful actions are taken. This determination can be made independently of the extent to which the log entries are encrypted, but could also be audited in detail with respect to unencrypted portions. If discrepancies are found, an authority can be alerted, where example authorities include law enforcement, regulatory agencies, a group of self-policing watchful entities, and security companies whose goal it may be to proactively identify corruption and track abuse.

### X. Use of Index Tokens.

Another aspect of the instant invention is an index token. An index token is a non-fungible token (NFT) or other representation of data, of which at least some may be stored in a cloud storage as disclosed in co-pending application titled “Crypto Wallet Improvement Technology” by Markus Jakobsson and Keir Finlow-Bates, wherein a list of references to NFTs and/or fungible tokens is maintained. This list includes identifiers indicating the address of the referenced tokens, and data useful for access of the referenced tokens. An example of data useful for access to the referenced token may include a key or seed enabling transfer of a referenced token; keys or seeds enabling other types of access to the referenced token, such as using associated data, causing the token to be borrowed, rented, used as a security for a loan, etc.; or identifiers that, combined with a seed value or key specific to the index token are useful to generate such keys or seeds.

The index token may be tied to a specified one or more users or organizations, e.g., as disclosed in co-pending application 63/213,251 filed on 22 Jun. 2021, titled “Token Creation and Management Structure”, by Markus Jakobsson and Stephen Gerber; co-pending application titled “Improved Token and Resource Management” by Markus Jakobsson and Keir Finlow-Bates; “Escrowed Wallet and Transaction Tracking Technology” by Markus Jakobsson; “Automated Wallet and Transaction Control” by Markus Jakobsson and Keir Finlow-Bates; “KYC-Enhanced Blockchain Technology with Applications to Advertising and Security” by Markus Jakobsson and Keir Finlow-Bates; “Secure and efficient Quantum-resistant digital signing method for blockchains” by Keir Finlow-Bates and Markus Jakobsson; and “System, Method and Apparatus for Publicly Verifiable Asset Linkage” by Markus Jakobsson and Keir Finlow-Bates; and “Managing Anchor Usage and Handover” by Markus Jakobsson and Keir Finlow-Bates, all of which are incorporated herein by reference. The index token technology disclosed herein is compatible with the type of anchored tokens referred to using the term “soulbound” token; see Vitalik Buterin's post “Soulbound” from Jan. 26, 2022, at https://vitalik.eth.limo/general/2022/01/26/soulbound.html.

While an index token may be tied to a specified one or more entities, it may optionally include instructions or references for conditional transfer of access rights; or otherwise be specified to enable conditional transfers of access rights. A condition may be the death of a person specified to have ownership rights, or the bankruptcy of an organization with such rights, etc., where the condition may be evaluated and verified by a trusted party indicated in the instructions, references or specifications. We refer to this trusted party as the trustee associated with the index token. A token may list more than one trustee, and rules indicating what sets of such trustees must agree for the modification of access rights. A token may have a default trustee specified at the time of minting, where this designation may later be modified by a token owner, e.g., by designating a new one or more trustees by digitally signing a designation decision using a key associated with the ownership of the index token.

Index tokens can be referenced by executable code included, e.g., in the shape of a smart contract, where this code is activated as a transfer is taking place. This transfer, in turn, could be made solely for the purposes of causing the executable to be accessed and evaluated, or it may have additional purposes, such as transferring ownership rights or access rights to a token, e.g., as part of a fair exchange protocol. The technique can also be used to implement a fair exchange, as will be detailed next:

### XI. Use for Fair Exchange.

Our novel throttling technique also finds applications in use where a fair exchange is desired, e.g., where two parties wish to exchange resources with each other. This is useful where two parties with limited mutual trust and no access to a trusted escrow authority wish to exchange a quantity of two resources, and wherein these two resources are at least in part fungible. Crypto funds are fungible, and a collection of NFT is in part fungible since one NFT can be transferred independently of the transfer of another.

In one embodiment of the present invention, the novel throttling technique may be used to allow the two parties to exchange assets instantiated on two separate blockchains with added security and recourse.

In another embodiment of the present invention, the novel throttling technique may be used to allow either of the two parties to partially curtail an exchange.

In some embodiments, throttling may be applied dynamically, that is as a transaction proceed in a reliable and mutually acceptable manner throttling may be reduced, whereas if risks are seen to be increasing or delivery of assets from one party is not proceeding at an expected or predetermined rate, throttling may be increased.

### XII. Use for Conveyance of Rights.

The disclosed technology can be used to implement an authenticated communication channel, which can be anchored in a given identity associated with a token with a known ownership. In particular, a smart contract associated with a first token transferred from a first party to a second party may include or reference information that shows ownership of a second token, which is an anchored token. This information, for example, could include a digital signature associated with a public key of the second token, on an input that references the first token, thereby proving ownership of the second token (without transferring it) in the context of the first token (whose transfer implements a secure channel).

In another example use, the disclosed technology can be used to invoke an escrow functionality, e.g., causing data to be escrowed or performing a computation (such as a search) on already-escrowed data. An example escrow usage context is as follows:

XIII. Associating Transfers with Policies.

One aspect of the disclosed technology is an automated escrowing process whereby a user submits a token transfer request to an escrow entity and the escrow entity determines an action based on one or more policies, where the one or more policies may be associated with the token transfer request, with the wallet of the party making the request, with the escrow entity, etc. For example, a policy may be requested by including a policy request in or with the transfer request. Alternatively, a policy may be associated with a wallet or an address and apply to every transfer request out of the wallet or address. A policy may also be associated with inbound transfers to a given wallet or address. Policies may be associated with a geographic boundary, whether associated with the apparent location of the requester, or a location in which the requester has been registered. Policies may also be associated with the types of tokens being transferred. Yet further, different escrow entities may be associated with different policies, e.g., based on whether they have been determined to satisfy specified regulatory requirements. Some policies may be bound to the smart contracts used to perform actions related to the transfer requests. Policies may further be associated with two or more such aspects at the same time, or with other relevant aspects, as will be understood by a person of skill in the art.

### XIV. Examples of Policies.

There is a large number of relevant policies that can be applied to contexts such as those disclosed herein. Examples of such policies include but are not limited to:

A policy requested by the party initiating the transfer, indicating that this party wishes for the transfer to be anonymized, e.g., the recipient address not be publicly known. Anonymized transfers may be performed, e.g., using the techniques disclosed in the whitepaper titled “Mix-Based Electronic Payments” by Markus Jakobsson and David M'Raihi, SAC'98, LNCS 1556, pp. 157-173, 1999.

A policy indicating that the wallet from which the transfer request is made is, or is not, subject to paying sales tax, royalties, or other fees, where this policy may be certified by an authority and tied to the wallet. Such a policy may tie a wallet to one given jurisdiction, whose laws will be applied to transfers to or from the wallet. It may also tie a wallet to a jurisdiction indicating what transfer fees (such as taxes) need to be made, automatically reported, etc. Related techniques are disclosed in co-pending application “NFT contract with banlist and allowlist to enforce honoring of royalties” by Keir Finlow-Bates.

A policy indicating that a wallet has enrolled in a fraud protection program, in which the escrow entity has to perform one or more verifications before the transfer is allowed. An example verification may be that a person associated with the wallet has access to an authenticator, such as a biometric authenticator that sends a code if authentication is passed, or Google™ Authenticator™ that displays or sends a code if prompted by the user. Verifications may be conditional, e.g., on the recipient of the transfer or the type of transfer, e.g., to require verification using an authenticator only if the transfer is to a party to which the requesting wallet has not previously placed on a whitelist, e.g., by approving the party as legitimate, by performing a previous transfer to the party, or by having provided the party with an authentication value such as a digital signature generated by the wallet. If the fraud verification is not passed, the transfer is not performed.

A policy indicating that the transfer is conditional on another specified transfer being performed to the wallet or a specified address associated with it.

A policy indicating that the wallet is in a predefined location, e.g., as determined by a GPS location being reported by the wallet to the escrow entity, or by other location verification means such as those disclosed in D. Singelee and B. Preneel, “Location verification using secure distance bounding protocols,” IEEE International Conference on Mobile Adhoc and Sensor Systems Conference, 2005., Washington, DC, USA, 2005.

A policy indicating that the transaction may not be performed if the wallet has been reported stolen, in which case the user needs to perform a remediating action and retract the report. An example remediating action is a proof of identity, e.g., using a biometric token associated with the wallet. Biometric tokens were disclosed in a Jun. 21, 2021, provisional patent application, titled “Token Creation and Management Structure”, by Markus Jakobsson and Stephen C. Gerber.

Policies may also be recorded and managed as disclosed in co-pending application titled “Selectively Modifiable Blockchain Records” by Markus Jakobsson and Keir Finlow-Bates, which is incorporated by reference in its entirety.

### XV. Use of Encryption.

In some embodiments, one or more policies may be encrypted in a manner that allows the escrow entity to decrypt the policy, but a member of the public having access to the blockchain where the token is written, and to communication containing the token and the associated transfer request, not being able to decrypt the policy. Some embodiments have policies that are encrypted in part, or where different portions are encrypted using different keys, forcing different parties to collaborate to decrypt and evaluate encrypted portions of the policy. Unencrypted portions may be used to determine whether a policy is potentially relevant, allowing the escrow entity (and other trustees) to selectively decrypt only policies that appear likely to be relevant for the determination of the token transfer.

For example, a specific policy for a given blockchain address may be encrypted with a symmetric key, and the symmetric key may be encrypted with the public key from which the blockchain address is derived. The wallet may then retrieve the encrypted policy and the encrypted symmetric key, decrypt the encrypted symmetric key with the private key of the public key, and then decrypt the encrypted policy with the decrypted symmetric key, then apply the policy to future transactions.

In some embodiments, evidence for compliance with the policy may be provided through zero-knowledge proofs, whereby nodes maintaining and extending the blockchain may accept compliant transactions and reject non-compliant transactions without the nature of the policy delineating compliance requirements being revealed to the public.

### XVI. Example Policies and Functionalities.

Policies of the disclosed types can be used to implement a vast variety of useful functionality. Examples of such functionality includes but is not limited to:

Generating and enabling automatic refund policies that causes refunds to be made based on the satisfaction or absence of satisfaction of one or more policies. Similarly, non-payment tokens, such as NFTs may be associated with policies that undoes transfers based on specified conditions, where these conditions may be specified in part in the policy associated with the token, and potentially in part by policy elements that are publicly maintained, such as policies specifying what constitutes fraud, or what parties have the right to assess whether a transaction should be reversed. As such, this enables a policy-based expansion of the techniques disclosed in co-pending application titled “Watchful Consensus Mechanisms” by Markus Jakobsson; “Using Watchful Bridging for Blockchain Fraud Prevention” by Markus Jakobsson, Stefan Dufva, Keir Finlow-Bates and Guy Stewart; and “Automated Wallet and Transaction Control” by Markus Jakobsson and Keir Finlow-Bates. One such functional extension is to associate an owner-specified or creator-specified policy with a token by means of including or associating the policy with the token.

Generating policies from a collection of policies, where one policy can be used to determine what other policies should be evaluated. Some of these policies may be public, e.g., posted on a blockchain, and could be used as part of a library to enable specific functionality; other policies may be included or associated by token creators, token owners, escrow entities, and government entities wishing to implement laws or regulations related to the transfer of tokens. Some policies may be generated by for-profit entities, and may be configured to cause a payment to such entities when the policy is triggered, an action depending on the policy is taken, or when the policy is evaluated. Some such policies may be publicly hosted, whereas others may be private and evaluated by a trusted party, which may be the escrow entity.

Some policies may be evaluated without being made accessible, e.g., using methods for computation by obfuscated, distributed or encrypted circuits.

Further implementations of policies, including the use of identifier-lists, was disclosed in co-pending application titled “Cryptocurrency and Blockchain Token Security Technology” by Markus Jakobsson and Keir Finlow-Bates, which is incorporated by reference in its entirety.

In some embodiments, a policy may be documented using code, henceforth referred to as a smart contract policy, for example through Solidity programs describing policy conditions. In some embodiments, the policy may be implemented as a smart contract library including one or more functions implementing compliance requirements or restrictions. A smart contract implementing a desired blockchain functionality, for example an instantiation of tokens, an escrow contract, a decentralized exchange swap contract, or some other decentralized finance or smart contract construct, may include function modifiers to functions altering a state of the blockchain, and referencing one or more functions implementing compliance in the smart contract policy. Relevant policies may be determined and subsequently enacted either by the smart contract policy including decision-making logic, or by the smart contract implementing the desired blockchain functionality including decision-making logic and with the smart contract policy providing state change functionality only.

### XVII. Policy Association Targets.

A policy may be associated with an entity (such as a wallet, an address, a jurisdiction or a token) by generating a policy commitment and publishing it. A policy commitment may be a policy and a digital signature on the policy, e.g., by the owner or an admin associated with an entity. The publication of a policy may be performed, e.g., by posting it on a blockchain or otherwise making it accessible to an escrow entity. A policy can be augmented, replaced or retracted by publishing another policy that references the previous policy, or the entity with which it is associated, and specifying the new policy. The original policy may contain specifications relating to the conditions of accepting replacement policies. For example, the first policy associated with an entity may specify that this policy may only be replaced, edited or augmented by publishing a replacement and waiting for 10 days. As another example, the policy may state that a replacement can only be accepted by having an authority or a plurality of authorities sign an approval that the replacement policy takes precedence. As yet another example, a policy may specify what parts of it may be edited, augmented or replaced, and by what parties. The specification of what parties may be a pre-determined entity such as a named law enforcement entity, or it may be an a-priori unknown entity, such as the current owner of a token with which the policy is associated. Some policies may be specified by a trusted party, e.g., a law enforcement entity associated with a specified jurisdiction, and may only be replaced by the same party. The provisions of who may modify, edit, augment or generate a policy associated with a given entity may be explicitly specified in a document associated with a token, wallet, address, jurisdiction, etc.; or it may be implicit, and based on the type of token, regulations associated with a given jurisdiction, etc.

### XVIII. Example Embodiment Using Watchful Mechanisms.

An escrow entity may be associated with or part of a bridge, such as a watchful bridge or any other entity that acts as a bridge between two different chains. An escrow entity may also be associated with or part of an entity acting to certify a transaction, such as a miner. If the escrow entity is part of a distributed entity, the enforcement of its action may be performed using a consensus mechanism, e.g., where other entities accept a certified transaction, as part of a new block on a blockchain, based on the conditions associated with the policy or policies of the associated tokens being satisfied at the time of the certification. It is practical to incorporate the verification of policies in a watchful mechanism, as will be appreciated by a person of skill in the art, but it must also be understood that other entities may include said escrow entities. Policies may be verified in multiple rounds at multiple locations. For example, a wallet may verify that policies are satisfied before submitting a transaction request to an external escrow entity, or to an entity that will have an external escrow entity evaluate that the policies associated with the request are satisfied.

### XIX. Example Policies

The disclosed invention has a very large range of desirable applications. One example is for fraud detection and blocking. A user may configure his or her wallet to associate policies with tokens that are in the possession of the wallet, to block undesirable transfers of such tokens. This can be achieved, for example, by requiring biometric verification using a device associated with the user, and linked with a biometric token, which is a type of token that is anchored, i.e., tied to a given entity (namely the “owner” of the biometrics). As another example, a 2FA authentication may be required for the transfer.

Policies may also be associated with entities to control transfers to such entities. A given wallet, for example, may have a policy associated with it that makes unauthorized transfers into addresses associated with the wallet not valid, and therefore blocked. Here, an unauthorized transfer may be one that the receiving wallet does not generate a digital signature specifying the desired receipt for. Alternatively, it may be specified that a given type of token may or may not be transferred into the wallet, e.g., only BTC and ETH may be transferred in. Such limitations may be based on jurisdictional requirements, specific end-user configurations, current exposure to various currencies, on aspects related to observed factors such as market volatility, or combinations of such guidelines. As another example, it may specify the identity (e.g., address) of entities that are allowed to make transfers in, or set requirements on the size of a given transfer, e.g., not permitting transfers below a specified value. The policy may also limit the type of contents that are permitted, e.g., tokens with smart contracts that are not on a given whitelist may be blocked, or tokens that contain material that is of a specified type, such as pornography, are not allowed. Such inbound policies do not have to be specified with a given wallet or address, but may also be tied to a jurisdiction and all wallets and addresses that are registered to be associated with this jurisdiction.

Policies may be time-based. An example of a time-based policy is one that may specify that a given token may not be transferred to a third party within a given time, such as 12 years. Similarly, a policy may have aspects that are triggered based on external events, such as data generated by a trusted oracle. An example of such a policy is one that enables a token to be transferred once the Nasdaq reaches a pre-specified value. Policies may also provide conditions for the context of transfers, such as a policy that requires that a given token can be transferred, but only in response to receipt of another token of a pre-specified type and/or pre-specified value. This can be used to enable automated trading, to protect minors against being tricked, and as a fraud-prevention mechanism, to name a few applications.

Some jurisdictions may require the recording of log information for token transactions emanating within or bound into an account associated with the jurisdiction. This can be required for all or select users and accounts within the jurisdiction. Here, a policy is associated with a selected user account or any user account associated with the jurisdiction may block a transfer action unless a required action is performed. Examples of such actions include (but are not limited to) the generation of or addition to an escrow record, where this may include encrypting data, providing evidence that the associated ciphertext is correctly formatted (e.g., a zero-knowledge proof of knowledge of a private key encrypted using an escrow authority's public key); it may include the completion of a payment (e.g., duty, tax, vat, etc.). The action may be conditional on where the token came from, e.g., whether it came from an account within a different specified jurisdiction or the same jurisdiction as the recipient account is associated with (e.g., a tariff). The action may include providing evidence of knowledge of a private key of an account of specified type (e.g., a user who is at least 21 years of age, a user who is allowed to receive goods of the type being transferred, etc.) One or more policies may be determined to be followed by one or more parties associated with the transfer request, where these policies may be identified based on jurisdiction, token type, account specific information, transfer limits and prior transfers, payment receipts, fulfillment of logging requirements, valid proofs of properties of one or more users associated with the transfer, and more.

In an aspect of the present disclosure, a blockchain wallet, henceforth a smart wallet, may gather information from other sources, either on or off chain or both, and interpret potentially applicable policies to determine when a transaction or transactions should be executed, and how said transaction or transactions should be structured for the benefit of the wallet holder.

For example, a smart wallet may determine from a user's calendar that they are traveling to a new jurisdiction in the near future, and that a first policy currently applicable to a current jurisdiction requires a 33% capital gains tax to be paid as a result of a transaction requested by the user, but that a second policy applicable to the new jurisdiction requires only a 10% capital gains tax to be paid. The smart wallet may determine that the transaction requested is not time-sensitive, and thus may delay approving and submitting the transaction to the blockchain until the user has arrived in the new jurisdiction, thus saving the user 23% on the taxable event.

In another example, a smart wallet may determine that a transaction request by the user for a transfer of X tokens may exceed a transaction fee threshold, and may thus break the transaction up into two transactions, each transferring X/2 tokens that incur a lower transaction fee than the single transfer transaction.

In yet another example, a smart wallet may determine that a policy change is imminent for a transaction requested by the user, and that the policy change is detrimental compared to the current policy. The smart wallet may therefore autonomously increase the transaction fee paid for the transaction to ensure the transaction is processed and settled before the policy change is implemented.

A token can have one or more policies associated with itself, e.g., by referencing or including one or more such policies. Such references and such including may be implemented using a smart contract. We refer to such tokens as ‘policy-bound tokens.’ An example policy bound token is a token that, when transferred, causes an action to be executed. This action may be logging of transfer data, e.g., information pertaining to the natural person behind an account. Data may be logged in an encrypted format, and placed in an escrow account. Another example action is the payment of a royalty, which may be based on the jurisdiction(s) from and to which the token is transferred, or whether the account from which the token is transferred is owned by the same entity as the one to which it is transferred. Sales taxes can be applied, except if the token is transferred to or from an entity that is tax exempt. It is also possible to implement the application of progressive sales taxes, which are taxes that depend on the identity or tax status of the recipient, for example. Such policies may be associated with a token in a multiplicity of ways, including within the token at the time of minting; as the token becomes associated with a given jurisdiction; or as an owner of the token assigns it a given status. The latter may be done by transferring the token from address X to address S|X, where | indicates concatenation, and X corresponds to a public key or wallet address, and where S is a state which the token is assigned. This state may correspond to one or more policies P1 . . . . Pn, e.g., by letting S be a reference to a collection of the policies to be applied. As the token is given an assigned status, it may retain this until an entity with the authority to remove the status performs an assignment to a status that is an empty policy. One example token policy is a policy P that causes all transfers to be tax free, but which eventually, after a given condition (such as a specified number of transfers) triggers a change, is automatically donated to charity, wherein the charitable organization may be indicated in P.

Transfer policies may control what transfers are allowed. For example, a transfer policy may depend on a certification of an entity to or from which a potential transfer is to be performed, e.g., requiring that a recipient matches a specified type of certification. Examples of such certifications include but are not limited to certifications by governmental entities specifying that a wallet, account or user belongs to a given jurisdiction, or has otherwise properly registered within such jurisdiction; that the recipient wallet is running on a specified type of hardware; that the recipient wallet is governed by a digital right management unit of a specified type; that a wallet, account or user has a required reputation or right to process specified tokens; or that a wallet or script associated with an account uses code that satisfies some requirement. An example of such a requirement is that the code has been verified to have been produced in a manner that satisfied a given requirement, or passed a functional review such as a security review. Examples of proofs of generation are provided in co-pending application titled “Determination of AI input data usage” by Markus Jakobsson and Keir Finlow-Bates. To make the evaluation of a policy possible, exchange of data between two or more entities may be required, as will be understood by a person of skill in the art, where communication is preferably performed using secure channels and data is accompanied by digital signatures, certificates or other assurances of validity.

Wealth threshold or property qualifications are terms used to describe a situation where a certain level of wealth, property ownership, or income is required for participation in a particular activity, such as voting, holding office, or engaging in specific financial activities. In modern contexts, certain financial opportunities, like becoming an accredited investor, require individuals to meet specific wealth or income criteria before they can invest in higher-risk ventures. Yet other tokens may indicate the right to a discount, due to a classification of a low-income, student, elderly, subscriber, employee, or other membership. Some tokens may be used for multiple simultaneous classifications. These classifications may require the holder to participate and prove the membership, e.g., proving that a ciphertext corresponds to a specified plaintext indicative of a given membership. This can be done using digital signatures, zero-knowledge proofs, or (in cases where the proof should be non-transferable) a designated verifier proof. This is relevant in the context of Know Your Customer (KYC) requirements, as disclosed in co-pending application titled “Balanced Wallet Technology” by Markus Jakobsson and Keir Finlow-Bates, which is incorporated by reference in its entirety. It is beneficial to use soulbound tokens for such applications. Soulbound tokens, also referred to as “anchored tokens” were disclosed in provisional application 63/213,251 filed on 22 Jun. 2021, titled “Token Creation and Management Structure”, by Markus Jakobsson and Stephen Gerber, which is incorporated by reference in its entirety.

In the present disclosure, a fungible token is used to represent wealth, and a first smart contract may include a function that may only be called by addresses holding a threshold amount of the fungible token, thus implementing an accredited investor program. The disclosure has applications to decentralized finance, for example, when implementing know-your-customer requirements.

In an embodiment of the present disclosure, a function of a the first smart contract imposing wealth threshold limitations may include instructions to query a second smart contract instantiating a fungible token with economic value, for example a stablecoin denominated in US dollars, for a balance of the fungible token held by a blockchain address making a transaction call to the function of the first smart contract. The first smart contract may include a balance threshold, and if the balance of the fungible token returned for the blockchain address is below the balance threshold, the function may terminate execution, whereas if the balance of the fungible token is equal to or above the balance threshold, the function may continue execution.

In traditional vesting smart contracts, vesting takes place over a period of time, with more tokens being unlocked and available for transfer to the recipient. Traditional finance includes reverse-vesting, in which shares are issued to a recipient, but can be clawed back by the issuer after a period of time if the recipient fails to uphold the requirements of the stock grant contract, for example under a bad leaver clause.

Nevertheless, there are taxation benefits to reverse vesting contracts in traditional finance, for example, in countries where no 83(b) election exists for Restricted Stock Award agreements.

Current thinking in the blockchain space teaches away from the present disclosure, in that token ownership is seen to be inviolable. For example, if conventional tokens such as Bitcoin or Ether are transferred in error, they cannot be retrieved other than through asking the receiver in error. Hence blockchain companies implementing a vesting program currently do so through forward vesting, which would trigger a taxable event for each vesting block.

In an embodiment, a fungible token may be, for example, but not limited to, a representation of shares in a company.

### Using KYC, Escrow, Tracking, Risk Scoring and Recourse to Secure Transactions

Blockchain-based commerce is plagued by abuse, ranging from anonymous heists to blackmail, malware-aided theft, and to more traditional abuse in which a payment is made for a service but where the promised service is never provided.

In previous applications, we have disclosed a range of technical approaches to address the underlying technical problems associated with the above types of abuses. Specifically, we have disclosed different approaches to perform recourse (in which one or more transactions are retroactively blocked or otherwise modified); methods to securely tie identities to tokens and transactions (e.g., using anchor tokens, also known as soulbound tokens); and methods for implementing Know Your Customer (KYC) based on soulbound tokens and/or secure escrowing techniques. We have also disclosed methods to enable capabilities (such as identity tracking or the automatic payment of sales taxes) in a manner that is dependent on the jurisdiction(s) of transacting entities.

In this disclosure, we describe how to architect a system based on the above-described technologies, creating practical and secure systems that enable policy-based decisions (that may be specific to given jurisdictions).

Transaction security can be implemented using either recourse, which is the ability to undo and/or selectively modify transactions; and KYC techniques, which enable the tracking of transactions and identification of users. It is also desirable to use a combination of these two general techniques. This enables a policy-driven trusted entity to undo selected transactions and track and identify, where desirable and appropriate.

### 1. When to Use Recourse.

Recourse can be implemented in a variety of manners. It is desirable to enable the decisions of what transactions to undo or modify. For example, if an identified transaction is determined to correspond to an illegal transfer of funds, it may be undone in its completeness; at the same time, a transaction in which sales taxes were not correctly paid can be retroactively modified to correct the error. The one or more rules for how transactions may be modified, whether retroactively or as they are being requested, can be expressed using one or more policies. These policies can typically be modified over time. Some of the policies may depend on the jurisdiction where the transaction is deemed to belong, e.g., how sales taxes may depend on the locality of one or more of the involved parties. It is desirable to enable the modification of policies over time to keep up with evolving threats.

### II. Using Policies.

In one embodiment, a set of a priori known and largely fixed security policies may be implemented and automatically applied by a trusted party. An example of such a policy may be a requirement to report and log KYC information in a specific manner for large transfers for a particular jurisdiction, or the blocking of transfers between two specified jurisdictions. In addition, a set of flexible policies may be applied. An example of such a flexible policy may address a situation in which an AI is used to detect high-risk transactions, based on constantly updated training sets and contextual data, and where identified transactions may be rerouted to not be paid to a specified recipient but to an escrow account, where the token can be held until a second security decision is made, at which time they are either transferred to the specified recipient or to an alternate recipient, which may be specified by the policy—for example, the sender of the funds, law enforcement, tax authorities, etc.

For simplicity, we describe transfers of tokens as payments herein, but it should be understood that the disclosed techniques also apply to tokens that are not funds per se, e.g., non-fungible tokens (NFTs). In some embodiments transactions other than transfers may be assessed, for example but not limited to, transactions that transfer ownership of a smart contract, add or remove an address from an allowlist or banlist, mint or burn tokens, freeze or unfreeze assets or smart contracts, perform an exchange of assets, or some other transaction.

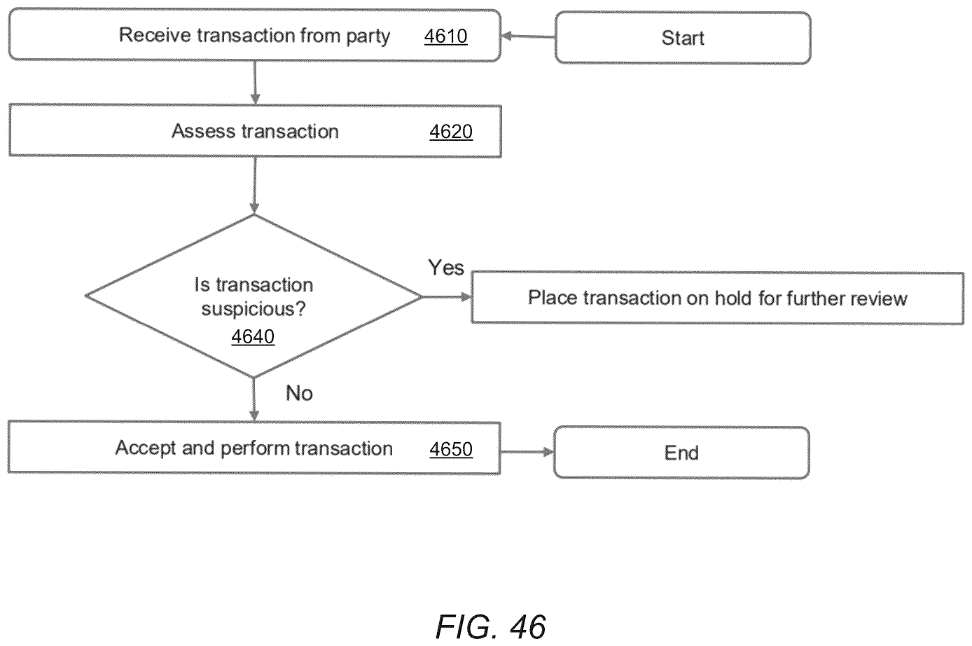

A possible embodiment of a method for assessing high-risk transactions is presented in FIG. 46 as a flow chart. Actions may commence with a party submitting a transaction, as presented in step 4610.

Actions may then proceed to step 4620, in which a reviewer may assess the transaction. In some embodiments the reviewer may include an AI trained on a data set of known malicious transactions and configured for pattern-matching the transaction for similarity with elements of the data set. In other embodiments the reviewer may include code for assessing transactions against a set of security policies.

Assessment of the transaction may result in a conclusion, resulting in an answer to a question, “Is transaction suspicious,” as shown in step 4640. If the transaction is deemed suspicious by the reviewer, actions may proceed to step 4660, in which the transaction may be placed on hold by the reviewer for further review. If the transaction is not deemed suspicious, actions may proceed to step 4650, in which the reviewer may accept the transaction and may perform the transaction. In some embodiment, performing the transaction may include submitting the transaction to a blockchain note for execution.

### III. Trusted Parties

There are a variety of known mechanisms to implement trust; these are distribution of a capability (e.g., a DAO generating a digital signature in a distributed manner, by a quorum of parties who each have a portion of the private key needed); staking and slashing (i.e., trust based on punishment of dishonest participants by a majority of honest participants); and hardware-based trust (e.g., a trusted computing platform). In addition, there may be entities that are inherently trusted, e.g., by being in a sufficiently powerful or scrutinized position and not having a history of abusing their power or position of responsibility. Such entities can be allowed to act as the trusted entity disclosed herein.

In some embodiments, transactions involving different types of tokens can be undone or modified by different types of trusted entities. For example, tokens with entertainment payload may be controlled by a conglomerate of media companies concerned with piracy, theft of in-game assets, etc.; at the same time, other trusted entities may control small and medium-sized transfer of funds within a specific jurisdiction, whereas another entity may control large transfers of funds between specified jurisdictions. Some transfers may be associated with multiple entities that act as trusted entities; for example, an auction site may be able to undo transactions related to activity on their site, but tax authorities or government regulatory authorities may also have this capability. When there are multiple types of trusted entities that may perform recourse on a given transaction, these entities may have different rights, e.g., as to the policies they would apply or the actions that they may cause.

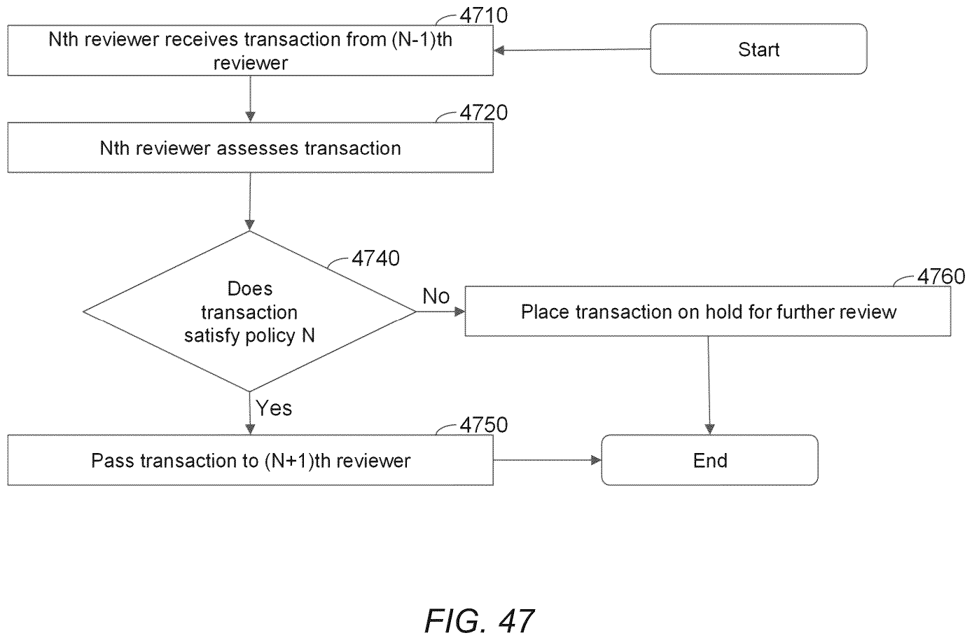

A possible embodiment of a method for an application of a plurality of security policies by a plurality of reviewers is presented in FIG. 47 as a flow chart. FIG. 47 should be viewed in the context of FIG. 46, replacing steps 4620 and 4640 with a loop of steps enacted by the plurality of reviewers. For an Nth reviewer, actions may commence by receiving a transaction from an (N−1)th reviewer, as shown in step 4710.

Actions may then proceed with the Nth reviewer assessing the transaction in a context of a policy N, as shown in step 4720. Policy N may include one or more of a security policy, a regulatory policy, a taxation policy, or some other policy, dependent on a role of the Nth reviewer.

Actions may then proceed to step 4740, in which the Nth reviewer may determine whether or not the transaction satisfies the policy N. If the transaction is deemed by the Nth reviewer not to meet policy N, actions may proceed to step 4760, in which the transaction may be placed on hold by the Nth reviewer for further scrutiny. If the transaction is not deemed suspicious, actions may proceed to step 4750, in which the Nth reviewer may accept the transaction and may submit the transaction to an (N+1)th reviewer.

The method of FIG. 47 may be repeated across each member of the plurality of reviewers until and if all reviewers have assessed the transaction and have determined the transaction to meet their policy, after which the transaction may be executed.

IV. Locations where Recourse May be Applied.

As disclosed in previous and co-pending applications of ours, there trusted entities that are capable of performing recourse actions may be acting in various functional and logical locations, as well as in different technical ways. For example, the location may be between two chains, and the trusted entity may be associated with a bridge between these chains. The location may also be within a chain. Recourse in such a logical location may be performed using a consensus mechanism such as a set of miners or verifiers, by the nodes that are part of a staking-based mining operation. Alternatively, the recourse operation may be performed using one or more smart contracts and/or smart contract libraries that encode the policies or references to these. In some contexts, it may be desirable to implement multiple types of recourse mechanisms.

Trusted entities may be implemented in software, firmware, hardware or a combination of such; they may be protected using a trusted platform module (TPM), which may include hardware, firmware, software running in a secure environment that can only be accessed using a restricted interface such as an API; or a combination of such approaches.

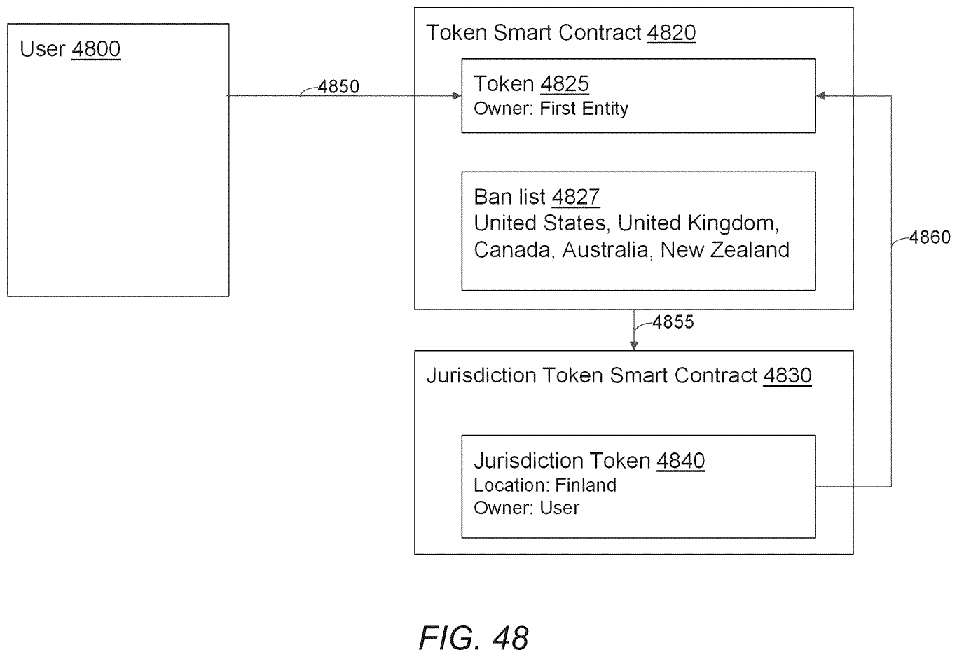

An application of location enforced policies is presented in FIG. 48. A first user 4800 may be registered as an owner of a token 4825 instantiated on a blockchain by a token smart contract 4820. The first user 4800 may submit a transaction 4850 to request a performing of an action on the token 4825. In an embodiment of the present invention, the token smart contract 4820 may include a ban list 4827 specifying jurisdictions for which the action may be prohibited. The token smart contract 4820 may apply policy relating to the ban list by requesting information from a jurisdiction token smart contract 4830 pertaining to a jurisdiction token 4840 instantiated by the jurisdiction token smart contract 4830, as shown by function call 4855. In some embodiments the jurisdiction token smart contract 4830 may be maintained by a government entity or authorized KYC entity. The jurisdiction token 4840 may include location information pertaining to the user 4800, and in response to the function call 4855 the jurisdiction token smart contract 4830 may respond with the location information as shown by response 4860. The token smart contract 4820 may then use data from the response 4860 and the ban list 4827 to decide whether to allow or prohibit the transaction 4850.

### V. Related Techniques.

We have disclosed techniques of relevance to the implementation of recourse mechanisms in co-pending applications “Watchful Consensus Mechanisms” by Markus Jakobsson; “Automated Wallet and Transaction Control” by Markus Jakobsson and Keir Finlow-Bates; “Using Watchful Bridging for Blockchain Fraud Prevention” by Markus Jakobsson, Stefan Dufva, Keir Finlow-Bates and Guy Stewart; “Balanced Wallet Technology” by Markus Jakobsson and Keir Finlow-Bates; “Token Abuse Protection” by Markus Jakobsson and Keir Finlow-Bates; “Token Insurance Technique” by Keir Finlow-Bates and Markus Jakobsson; “KYC-Enhanced Blockchain Technology with Applications to Advertising and Security” by Markus Jakobsson and Keir Finlow-Bates; “Improved Token and Resource Management” by Markus Jakobsson and Keir Finlow-Bates, among other applications. We incorporate these by reference in their entirety.

### VI. Using KYC Technology to Improve Security

The above techniques address the ‘reversal’ aspect of the stated problem. There is also the ‘identification’ aspect (i.e., who did it, potentially followed by blacklisting or other penalties). The identification aspect is based on KYC and escrow technology we have developed.

KYC technologies are beneficial for many reasons. Before describing KYC methods in the context of recourse, we will describe other beneficial uses; a person of skill in the art will readily recognize the benefits of these methods, and how they complement and overlap with KYC methods related to recourse.

### VII. Problems Related to Storage.

It is well understood that crypto and Non-Fungible Token (NFT) users are choosing between different manners of storing their tokens, each of which present troubling risks and shortcomings. Users selecting a self-custodial (also referred to as a non-custodial) wallet need to accept one set of risks and inconveniences, while users preferring a custodial wallet need to accept another set. This affects not only existing users and their security, but also prospective crypto and NFT users, many of whom are likely held back by concerns that all existing approaches pose significant risks to them, risks that they are not used to having to shoulder with traditional financial technologies. This, in turn, stymies the use of crypto and NFTs and hinders the benefits of large volumes by threatening (or at least delaying) mass deployment of technologies that could, if properly deployed, usher in a new area of accountability.

On one hand, self-custodial wallets are associated with risks of loss, e.g., due to the loss of the pass phrase used to initialize the wallet. Stories in the news constantly remind users of those who have been unlucky enough to accidentally throw out their crypto wallets, or have them vanish in a fire, and users who have at one point forgotten a password realize that forgetting a pass phrase cannot simply be remedied by performing steps similar to those of a password reset.

To make self-custodial wallets truly convenient, not just as long-term storage of value but as a practical method of facilitating day-to-day use of tokens, it is desirable to implement them as on mobile devices already carried by users, such as smart phones. However, self-custodial wallets, if implemented in software and run on laptops or mobile devices, are putting the user at risk for an array of additional attacks. Examples of these include malware, device theft, and friendly fraud (the latter which corresponds to unauthenticated access by friends and family, for example). Some of these, like the risk of theft and friendly fraud, also apply to any solution involving a pass phrase. If a copy of this is lost, the consequences may be dire.

On the other hand, custodial wallets are not risk-free, either. Most notably, these are vulnerable to phishing attacks and to abuse of second-factor authentication. One example of the latter is the common use of SIM-jacking as a steppingstone towards resetting access credentials, where this not only enables the attacker access to a user wallet but also typically shuts out the (often unwitting) account owner. The threat of 2FA abuse has prompted the deployment of policies constraining what a party may do within a specified time after 2FA account access has been noted, but this is an imperfect patch that simply tries to find a reasonable balance between the convenience of legitimate users and the protection against malicious users. It does not make it better that there is a vast array of approaches to perform SIM-jacking, including theft of a consumer device, phishing of the owners of the accounts, social engineering of a mobile carrier customer representative, physical theft of handheld devices used by such employees, and insider attacks. Discouraging the use of SMS-based authentication, e.g., to encourage email-based 2FA instead, does not solve the problem, but only changes the precise nature of the attack. Similarly, relying on authenticator apps, such as Google Authenticator™, is not a panacea, but merely changes what an attacker needs to do.

Custodial wallets also pose another risk that, prior to the FTX implosion was mostly overlooked by end users: it is also possible that a user's funds are siphoned off and improperly used by the entity trusted to guard the funds. To make it worse, this risk is not limited to organizations that intentionally abuse the trust, but also to those who impose these risks on their customers by being breached or otherwise compromised, whether by an outsider or an insider. An example of this is the 2025 breach of Bybit.

The consumer's problem therefore appears to be that she has to choose between two undesirable solutions, with no third option: either the consumer uses a wallet that the consumer is directly and physically responsible for (i.e., a non-custodial wallet) or one for which the consumer is not directly and physically responsible. Based on this, it does not appear to be possible to overcome either the risks or the perception of these. Indeed, would it have been easy to avoid these vulnerabilities, it would most certainly already have been part of commercial solutions. However, the instant invention demonstrates that there actually exists a third path, where all of the above-described risks are controlled and minimized.

One aspect of the disclosed technology is an architecture of collaborating (but mutually distrusting) computational entities, connected to each other using a network such as the Internet. This may be included of one or more of the following types of entities: directory nodes, policy management nodes, access control nodes, user access nodes, and KYC nodes. These are described in greater detail below.

### VIII. Directory Nodes.

A first type of entity, which we may refer to as a directory node, stores references to the contents of a user's wallet. This may take the form of one or more records, each record including a reference to one or more tokens, where a token may be fungible or non-fungible. A record may also include information about amounts, e.g., in the context of fungible tokens. A user may be associated with multiple directory nodes, which may store duplicates of the same records, overlapping information, and/or non-overlapping information. A user may generate a list of accessible resources (e.g., a list of records referencing tokens) by contacting one or more directory nodes, requesting the information related to one or more identifiers associated with the records.

The identifier may be a username, an email address, identifiers generated from one or more other user identifiers, e.g., as a hash of a counter, a nonce and a user email address, where the nonce may be a user-selected text element. They may also correspond to information otherwise associated with the user.

Directory nodes may be implemented as dedicated resources that are automatically updated when a user obtains or transfers out a token, or part thereof. They may be housed by a user, e.g., on a user's transaction device (such as a phone or a dedicated hardware crypto wallet). They may be backed up to cloud servers. They may also be part of other entities described in this document. In one embodiment, they may use techniques disclosed in co-pending application titled “Crypto Wallet Improvement Technology” by Markus Jakobsson and Keir Finlow-Bates, which is incorporated by reference.

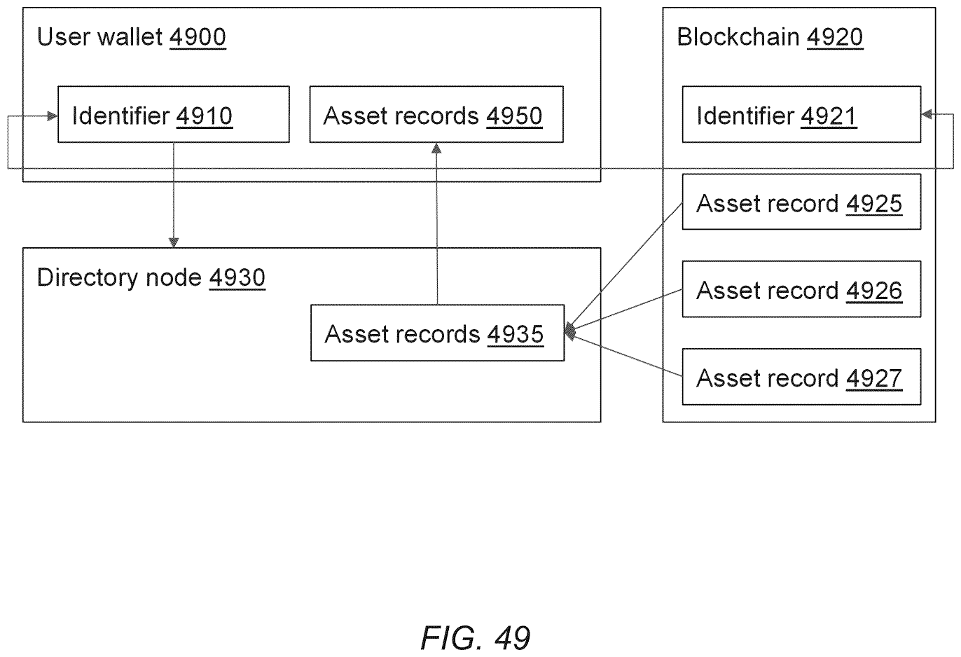

A possible embodiment of a directory node 4930 is illustrated in a block diagram presented in FIG. 49. A user wallet 4900 may include an identifier 4910 that is passed to the directory node 4930. The directory node may have collected asset records 4935 from a blockchain 4920 by parsing data stored on the blockchain 4920, recovering one or more asset records, which without loss of generality are presented as asset record 4925, asset record 4926 and asset record 4927, grouped as the asset records 4935 based on common characteristics of the one or more asset records. In some embodiments the common characteristics may include the identifier 4910. In further embodiments, the identifier 4910 may be stored on the blockchain 4920, either by the user wallet 4900 writing the identifier 4910 to the blockchain 4920 as an identifier 4921, or by the user wallet 4900 retrieving the identifier 4910 as a copy from the blockchain 4920 as a blockchain-stored identifier 4921. On receiving the identifier 4910 the directory node 4930 may scan records it includes and may retrieve the asset records 4935, and may pass the asset records 4935 to the user wallet for local storage in the user wallet 4900 as local asset records 4950.

### IX. Policy Management Nodes.

A policy management node stores one or more policies, and evaluates whether a request (e.g., for a token transfer) satisfies the one or more policies. Some of the policies may be static, while others may be dynamic. A static policy remains the same over time, and may be set by a relying party, such as one or more of the token creator, a jurisdiction, and/or a user. A dynamic policy may be generated and/or modified by one or more relying parties, based on changes to user-controlled configurations, triggering events, risk indicators, changes in legal requirements, etc. Static policy management nodes may migrate to becoming dynamic policy nodes, and vice versa.

Some policies may be associated with tokens, e.g., specifying to whom, when and how these can be transferred, as well as jurisdiction-based controls that may indicate whether a given token type may be transferred into or out of a given one or more jurisdictions, or whether a transfer must be accompanied by a reporting of the transfer, a tax event, a royalty event, an escrow data generation event, etc.

Some policies may be associated with wallets and/or user accounts, and may specify requirements for transfers, e.g., a successful biometric authentication; limitations to transfers, e.g., maximum value to be transferred from or to a given zone for a specified time interval (where a zone may correspond to one or more wallets associated with a person, an organization, a jurisdiction, etc.); whether a 2FA verification is required before a transfer is made; the minimum or maximum value that may be transferred to or from a zone relative to a given party from/to which the transfer takes place; what types of smart contracts are allowed to be executed by tokens transferred to a given zone, where the type may indicate one or more template types, one or more whitelisted contract creators, etc. A policy may require a confirmation to be made by one or more parties other than the party requesting the transfer, where such parties may be parents, employers, accounting department representatives, consumer representatives, security companies, etc. A confirmation may be performed in response to scrutiny of the transfer request, a history of transfer requests from a given zone, a malware scan of a device associated with the request, a liveness verification of an account holder associated with the request, and/or a risk detection process that identifies common high-risk transactions and which requires additional verification in selected cases.

A policy may specify the manners of authentication that are sufficient for a transfer of a given type. This may be determined based on individual transaction requests alone, or may also be based on the activity (e.g., requests from a specified zone, or approved or blocked transfers to/from a specified zone). This way, a small transaction may require only a basic form of authentication, e.g., the presentation of a valid PIN, whereas a larger transaction or a transaction that comes after many other transactions or transaction requests may require more secure authentication, e.g., a biometric authentication as well as a verification of malware-freeness of the requesting device.)

Some policies may be adjusted based on observations. For example, an organization or user who frequently generates transaction requests of a particular type (e.g., size, with a particular recipient, etc.) may have thresholds associated with the triggering of policies automatically modified to make these thresholds higher, but if this user files complaints that fraud was performed, then the threshold may be drastically reduced until the fraud has been identified and prevented from occurring again.

Some policies may be evaluated before a transaction is allowed to take place, e.g., to determine whether to allow a transfer out of a token from a wallet. Other policies may be evaluated after a transaction took place, e.g., a policy that determines whether a royalty needs to be paid, whether an escrow event needs to be generated, etc.

There may be multiple policy nodes that are activated for a given transaction or transaction request. For example, a user wallet may be or may include a policy management node, and may determine locally whether a user authentication attempt is accepted. Such a verification may also be performed by a policy management node associated with an access control node (as will be described in more detail below). Such policy management nodes may be part of the access control node, or may be independently operated and collaborate with an access control node. One policy management node may represent the interests of an end user, whereas another may represent the interests of law enforcement or tax authorities, and yet another may represent the interests of a financial institution or a royalty collection agency. Some policy management nodes may represent multiple parties and their interests.

A transaction request may be accepted based on one or more approvals from policy management nodes.

In one embodiment, policy management nodes are associated with watchful entities, and govern their behavior. Watchfulness was disclosed in co-pending applications including “Using Watchful Bridging for Blockchain Fraud Prevention” by Markus Jakobsson, Stefan Dufva, Keir Finlow-Bates and Guy Stewart; “Watchful Consensus Mechanisms” by Markus Jakobsson; and “Crypto-enforced virtual escrow” by Markus Jakobsson, Kenneth Rosen and Keir Finlow-Bates, which are all incorporated by reference.

Policy management nodes may be controlled, at least in part, by government organizations (such as law enforcement and tax authorities). They may also be controlled at least in part by individual token owners, who may configure aspects of the policy management node pertinent to the individual token owner's preferences. Access control nodes may also configure parts of the policy management nodes, e.g., to publicly or non-publicly clarify their functionality.

In one embodiment, the actions of policy management nodes are governed by one or more policies recorded on a blockchain, wherein policies may be modified using consensus mechanisms or using the techniques disclosed in co-pending application titled “Selectively Modifiable Blockchain Records” by Markus Jakobsson and Keir Finlow-Bates, which is incorporated by reference in its entirety.

### X. Access Control Nodes.

An access control node stores key material that enables a transaction, but which does preferably not allow one access control node to unilaterally execute a transaction. For example, two access control nodes may store key material that, when the key material of the two access control nodes are combined, or used to approve the same transaction request, then that transaction request becomes enabled and can be recorded as a transaction.

Access control nodes may be arranged according to an organization governing how they need to collaborate for a transaction to be approved. For example, in a system with five access control nodes (A, B, C, D and E), it could be required that two out of A, B and C as well as one of D and E must collaborate in order to enable a transaction. Access control nodes may consult one or more policy management nodes to determine how to handle various transaction requests, e.g., based on token identity, owner identity, jurisdiction of owner or indicated recipient of the token, etc. Alternatively or additionally, identifier-lists and related techniques can be used, as disclosed in co-pending application titled “Cryptocurrency and Blockchain Token Security Technology” by Markus Jakobsson and Keir Finlow-Bates, which is incorporated by reference in its completeness; additional techniques are also disclosed in co-pending application titled “Selectively Modifiable Blockchain Records” by Markus Jakobsson and Keir Finlow-Bates, which is incorporated by reference in its entirety.

### XI. User Access Nodes.

An example user access node is a wallet application on a phone or laptop, or a dedicated hardware device used to approve transactions. The user approval may be determined by verifying a PIN, password, biometrics, or simply by the user having possession of the dedicated hardware device. The user access node may be configured to reference one or more directory nodes; alternatively, the user access node may include data and structures to implement, at least in part, the functionality of a directory node.

### XII. Example Implementation.

One way to implement the disclosed technology uses a smart contract that a token owner or manager associates with a token. One way of performing this association is to transfer the ownership rights from the user to a token including the smart contract, which we refer to as the ‘owner token.’ Here, the smart contract specifies one or more rules or policies governing the requirements for transfer out of the owner token. The owner token may be configured to be owned by the user performing the transfer of the token to the owner token. Tokens owning tokens were disclosed in provisional patent application 63/375,663, “NFTs that own assets”, and 63/365,269, “Directed Acyclic Token”, both incorporated herein by reference.

The smart contract of the owner token may include specifications for the access control structure needed to perform any transfers of the tokens owned by the owner token. The access control may be specific to the tokens being owned, e.g., based on their value, type or other criteria. A user may alternatively or in addition hold multiple owner tokens with different smart contracts, and may transfer tokens to an owner token based on what access control structure she wishes to associate with the token. The smart contracts may reference one or more sets of policies held by policy management nodes. Additionally, the smart contracts, by including policies, correspond to software implementations of policy nodes.

Owner tokens may be used to enforce security policies on tokens that do not include security policies, for example, legacy tokens. By an owner token owning a legacy token, and a user owning the owner token, policies applying to the owner token are imposed on the legacy token.

### XIII. Example Access Control Structure

One example access control structure may require at least access control node A or B to approve the transaction, at the same time as also requiring a user access node to approve it; or requiring that at least two of A, B and C approve it. Here, A, B and C would be configured to approve transactions only after having verified that the requestor is the registered user, e.g., using passwords, in-person identity verification, biometric authentication, or a combination of such. This way, a user does not have to rely on any one entity (such as A, B or C) to be honest and secure, but would also not risk losing access to a token by losing the user access node or the pass phrase used to configure one. Some of the referenced entities may be identified using a public key, others using an address or another unique identifier. A token may be referenced as an entity in the access control structure, which means that a party controlling this token would be able to cause the token to conditionally allow a transaction, where the condition may be based in part on input provided by the owner of the token that is referenced.

### XIV. KYC Nodes

One aspect of the disclosed technology is the integration with and management of Know Your Customer (KYC) methods. Anchored tokens have been disclosed in co-pending applications, titled “Token Creation and Management Structure” by Markus Jakobsson and Stephen Gerber; “Characteristic Assignment to Identities with Tokens” by Stephen C. Gerber, Markus Jakobsson, Ajay Kapur and Mike Leisz; and “Biometric Authentication using Privacy-Protecting Tokens” by Markus Jakobsson and Stephen Gerber. An anchored token corresponds to what is also known as a soul-bound token. Anchored tokens can be tied to a person or organization, making them an integral building block of KYC methods.

Escrow mechanisms are also beneficial in some embodiments of KYC mechanisms, as the escrow mechanism can be used to protect database or blockchain entries against unwanted access, but also selectively decrypted for purposes of tracking. Escrow mechanisms were disclosed in co-pending application titled “Escrowed Wallet and Transaction Tracking Technology” by Markus Jakobsson.

Other relevant technology was disclosed in co-pending application titled “KYC-Enhanced Blockchain Technology with Applications to Advertising and Security” by Keir Finlow-Bates and Markus Jakobsson.

One or more KYC nodes may be associated with the initiation of or performance of transactions, causing a log of identity data to be generated and stored. This log can be selectively queried by authorized nodes (such as the other named nodes in the instant invention, law enforcement, consumer representatives, etc.) to perform tracking. In some instances, the tracking may require collaboration between multiple authorized entities, in a manner that may be done analogous to the other multi-party actions disclosed herein. This enables the management of user identity and user privacy, balancing those needs with needs for accountability and ability to perform traffic analysis with respect to token ownership, token access, and other logged transactions.

A KYC node may have an identifier that can be used for tracking purposes. In one embodiment, the identifier is stored in the format of a ciphertext, e.g., using ElGamal encryption. A related ciphertext, e.g., a re-encryption of the previously mentioned ciphertext, can be stored in a token as a way to reference the KYC node without enabling the correlation by a party without access to the decryption key associated with the two ciphertexts. In another embodiment, one of the two ciphertexts is replaced by the plaintext value of the replaced ciphertext.

### XV. Automated Transactions.

Various users, jurisdictions or types of tokens or transactions may be associated with policies that require automated transactions in some contexts. Examples of automated transactions includes but is not limited to: sales tax deductions (e.g., based on jurisdiction and/or token type); automated loan repayments, additions to retirement savings or performance of personal tax payments (e.g., based on user-specific requirements, and potentially based on token types, contributions to date, jurisdiction, and other inputs to a policy).

In some instances, the processing of automated transactions is associated with determination of identities that may rely on KYC data, wherein policies are specified relative to select KYC profiles.

### XVI. Proofs Relying on Escrowed Identity Data.

A KYC policy or related field may include information about a jurisdiction, or other user-dependent data, where this field may be encrypted. In some embodiments, a user wallet would be able to prove that a given ciphertext (e.g., corresponding to a jurisdictional value, such as one indicating a country or a state) has a value that matches another value (e.g., the same country or one out of a collection of countries) where this other value may be encrypted as well (e.g., correspond to another person's KYC policy, where this other person may be involved in a token transfer with the user wallet that provides the proof). Traditional zero-knowledge proofs can be used for this purpose, such as the techniques disclosed in Markus Jakobsson, Moti Yung “Proving without knowing: On oblivious, agnostic and blindfolded provers,” Advances in Cryptology—CRYPTO '96, volume 1109 of Lecture Notes in Computer Science. Berlin. pp. 186-200.

By providing that a user associated with a transaction is in a specified jurisdiction (or collection of such), a user wallet may invoke or block which one out of a collection of policies are associated with a transaction, e.g., policies invoking sales tax payments, tariff payments, income tax payments, etc. The proofs may be non-interactive proofs of knowledge, with the structure of digital signatures, and may be incorporated into token transfer requests generated by or for one or more of the sending wallet, the receiving wallet, and a representative of either party.

The creation of, verification of and management of KYC records may require a quorum action by one or more types of nodes, such as those disclosed herein. For example, the generation of a KYC record may involve a user access node implemented in a wallet representing the user of the KYC record and a consumer representative node which may be a special type of access control node whose charter is to represent users with which it is affiliated. The decryption of a KYC record (which is one particular type of management related to the KYC record) may require the collaboration of at least one access control node and one or more KYC nodes.

### XVII. Request Authorization.

Different nodes in the disclosed collaborative network may have different criteria for determining when to take a requested action. For example, a user wallet may require a user to authenticate using biometrics in order to access tokens, and may require additional verifications for transfers exceeding a specified threshold, which in some instances may be set by the user during a wallet configuration stage. A directory node may approve any requests it receives, or may verify that the requesting entity is authorized to access records before these are conveyed. In the latter case, this may involve authentication, e.g., using a digital signature associated with an already-approved entity (such as a user wallet or a policy management node with a reputation score exceeding a threshold value). A policy management node may verify the transaction request to determine that it conforms with one or more rules, such as having a geolocation indication associated with it. An access control node may require user authentication, where the type of authentication may depend on the type and/or size of the transaction, a user configuration, and on a history of transactions associated with the requesting user and/or the beneficiary of the transaction. The access control node may, for example, reject any large transactions to nodes that are not whitelisted with the requesting user; may require a specified type of 2FA from the user to proceed with the transaction; or may invoke additional verifications or delays if a fraud detection mechanism flags a transaction, where the fraud detection mechanism may include an AI that is trained on fraudulent transactions as well as transactions that have not been reported to be fraudulent. A KYC node may require verification of the identity of a requestor to append information to an encrypted KYC record, but may require law enforcement approval to perform a tracking of one or more transactions with respect to the identities of the participating entities. These are non-limiting examples, and should only be used for purposes of understanding the underlying principles of the disclosed technology. It is understood that combinations of the described techniques, and variations of the same, can be used by all the disclosed entities as well as by other entities (such as law enforcement or taxation authorities).

### XVIII. Investing Based on Held Funds.

A collection of entities implementing access control, e.g., as described in this disclosure, may wish to invest funds that they manage, with the approval of the associated token owners. A token owner can provide approval for a specified type of action related to the managed token(s) by using the private key associated with the token, a wallet holding the token, a smart contract in possession of the token, etc., to generate a digital signature (or other type of authentication string) on a statement indicating the type of action that is permitted, and/or indicating a policy specifying permitted actions. An example policy may be that the action is only allowed if there is a specified type of insurance on the token, so that if the token is lost or the action causes it to depreciate or otherwise get damaged, then an insurer (which may be the collection of entities implementing access control, or an external entity that has a specified level of assurance or reputation) will step in and provide damages to the owner. The policy may also state the duration of time that the action(s) are permitted before a renewal of the approval. It may state a requirement of how profits obtained from the action are shared between the collection of entities performing the action and the owner of the token. It may state risk acceptance levels that are associated with the types of actions that may be taken, where risk levels may be assessed periodically by a trusted entity. It may also state purposes associated with actions, e.g., only permitting actions within a specified jurisdiction; only permitting actions endorsed by a specified entity (such as a church, a political party, a selected investment manager, etc.), or other instructions or executable scripts determining what actions are permitted. A user may specify multiple allowed actions, each one which may be associated with different terms, where such terms may include returns, risk acceptance, insurance requirements, etc. A policy may be implemented as one or more smart contracts, or references to such, and/or a list of configuration values governing the allowed actions.

The collection of entities implementing access control will evaluate the permissions and/or policies as disclosed above, and collectively make assessments of what requested actions (whether internal or from third parties) are allowable. They may furthermore identity, based on policies, simulations, AI-based assessments, and combinations of such, how to select what requested actions to perform to maximize the utility, whether for the token owner(s), themselves, or a combination thereof. The utility can be assessed in a variety of manners, such as determining the expected value associated with an action, potentially at a specified point in time that governs the investment horizon, and one or more risk assessments associated with the actions, where this can be done in light of the policies and other requirements associated with individual tokens to which the entities control access.

### XIX. Controlling Actions on Tokens.

The collection of entities with access control rights/capabilities may in one embodiment include at least a quorum of entities that are governed by different controlling parties, but may in one entity include just one entity. In either case, the validity of an action attempted by the collection of entities may be determined by an external entity that assesses transaction validity based at least in part on the adherence of the one or more policies associated with a token, where such policies may be stated by the token owner (as disclosed above), or where the policies may be put in place to deter fraud or other abuse. The external entity performing this assessment may include multiple entities. One example of such an entity is a watchful agent, different implementations of which are disclosed in multiple co-pending applications, including for example those titled “Watchful Consensus Mechanisms” by Markus Jakobsson and “Using Watchful Bridging for Blockchain Fraud Prevention” by Markus Jakobsson, Stefan Dufva, Keir Finlow-Bates and Guy Stewart. The watchful mechanism may alternatively be implemented using the techniques disclosed in co-pending application titled “Selectively Modifiable Blockchain Records” by Markus Jakobsson, and Keir Finlow-Bates. The control of actions on tokens, as disclosed herein, may also be applied to traditional contexts, e.g., contexts such where one entity has full control over the use of funds, but where additional checks are desirable—such as the context of FTX, where funds could have been protected by such an additional layer of protection.

### XX. Retroactive Control.

The control of actions disclosed above primarily addresses control over the initiation of actions, e.g., whether a given token can be e.g., transferred, given access to, or staked. However, the same approach can also be used to take a series of conditional actions, where the condition may relate to the policy associated with a given token along with contextual data, such as the current assessed value of the token. For example, a token T may be owned by party A, where A allows party B to invest T according to some policy P. T may be an ETH token, for example. The policy P may state, among other things, that a specified risk class R is allowed for investment. B initiates the investment of T in some resource X that has a given value V1 at the time of the investment. This is allowed by the watchful agent, as this is in compliance with R. However, at a later point in time, the assessed value of X becomes V2. If V2 is below a threshold W of V1, then the risk assessment R may no longer be satisfied. There may be other reasons why R is not satisfied as well, e.g., based on price fluctuation, low trade volume, or external events. The watchful agent determines that the investment of T in X is no longer in compliance with P, based on R not being satisfied. The watchful agent therefore forces the sale of X to return a portion approximately W*value (T) to party A, or a party affiliated with A and set up to hold the returned value. Alternatively, the watchful agent may cause another action, such as the sale of the resource X and the purchase of a less risky resource specified by P on behalf of A and B. In addition B may have policies causing similar types of rebalancing at other thresholds, causing the forced sale by the watchful agent only to take place if B neglects the agreement it has with A, and spelled out in P as well as in additional agreements between the two.

### XXI. Use of KYC for Tracking.

By associating an identifier, such as a user identifier, with a first token (such as an anchor token), this first token can then be associated with a wallet, an account, and/or a collection of tokens owned or otherwise controlled by a user, where we use the term user to also include corporations, enterprises, DAOs, and computational entities, such as tokens that own tokens. When a token is transferred to an account or wallet, it is also automatically associated with an anchor token tied to this account or wallet. In one embodiment, the recipient of the token to be transferred may even be the anchor token, or another token tied to this. We may refer to that as the KYC token. KYC can also be implemented using escrow of identifying information kept in a database, where an account may be created to associate itself with this escrow record. An entity with the computational capabilities and knowledge of the appropriate keys would be able to track a transfer to identifiers related to the sender of the token and to the recipient of the token. It can also perform comparisons on the escrowed (e.g., encrypted) information, allowing it to determine whether the sender or the recipient matches a given user, or is associated with a given predicate included in the escrow record; such a predicate may be indicating a jurisdiction, an investor class, a right associated with a membership, etc.

### XXII. Implementing Serial Numbers for Stablecoins.

As disclosed above, identifiers may describe a user or an organization, allowing tracking of transfers between such. Tokens may also be equipped with identifiers; we describe next how to implement serial numbers for stablecoins, noting that the same techniques may also be applied to other types of tokens.

Serial numbers as used on banknotes serve many useful purposes, for example, as a security measure to allow law enforcement to trace stolen currency, to prevent counterfeiting, and for central bank accounting purposes.

Although blockchains are frequently transparent, in that transactions may be visible to anyone, and therefore tracking the movement of cryptocurrency and/or tokens may initially seem trivial, in practice, the use of pseudo anonymity and mixers may prevent full tracing of transactions. This causes problems for law enforcement when trying to track stolen cryptocurrency.

There is therefore a need for systems and methods that provide similar functionality as serial numbers for blockchain-instantiated tokens and cryptocurrencies.

In the present invention, we disclose systems and methods for applying serial number-like functionality and markers to cryptocurrencies and blockchain tokens to address a range of serious current shortcomings related to stablecoins and other blockchain technologies.

### XXIII. Detection and Auditing.

One aspect of the disclosed invention is a technique for providing assurance that a stablecoin based on fiat currency corresponds directly to a fiat element, such as a bill, such that there is a one-to-one correspondence and it is not possible to create multiple simultaneous value representations of the fiat element exceeding the value of the fiat element, without this being detected; nor that it is possible to generate multiple fiat element representations (i.e., forged bills) without, again, this being detected. We disclose multiple detection methods, including probabilistic auditing methods. The disclosed technology is compatible with traditional bills, whether printed on paper or plastic, and whether including watermarks or not, where each bill is represented by a serial number that is unique to the type of bill.

Alternatively, the fiat element may be represented by a virtual representation of fiat currency, such as an entry in a database, where instead of a serial number, an indicator of the database entry may be used. This indicator may be a cryptographic hash value, which may be a function of the database entry, e.g., including its location and/or contents; it may also be a truncated hash or other unique or semi-unique descriptor. The disclosed technology is also compatible with other representations of unique identity of fiat elements, such as an embedded RFID transmitter programmed to convey a unique serial number when queried by an authorized party.

In other embodiments, stablecoins may be provided with markers or serial numbers indicating the nature of the backing asset, allowing one type of stablecoin to be backed by various financial instruments, assets, and commodities. For example, a stablecoin may be backed by a currency reserve, treasury bonds, stocks, gold, oil reserves, land, a patent, and so on. Although the stablecoin may in general reference a specific national currency, for example, the US dollar, and may be equivalently denominated, with one stablecoin representing one US dollar, different proportions of the stablecoin may be backed by those different assets. For example, provided for illustrative purposes only and not meant to be limiting in any way, a 100-million-dollar amount of a stablecoin may be 25% backed by a reserve of US dollars, 25% by treasury bonds, 10% by gold, and 40% by an investment in a tracker fund for a stock market. In one embodiment, an individual unit of the stablecoin may have a marker indicating which asset is backing it. Such a marker may take the form of a serial number, with an associated database indicating which serial numbers are backed by which asset. For example, serial numbers 1 through 25,000,000 may be assigned to stablecoins backed by treasury bonds, serial numbers 25,000,001 through 35,000,000 may be backed by gold, and so on. In other embodiments, each stablecoin may carry one of four markers, each marker indicating what asset it is backed by.

Such a marker system or serial number system for a stablecoin has many uses. For example, if the price of gold denominated in US dollars rises, the stablecoin issuer may mint further stablecoins with further markers or serial numbers to represent the increase in value in the underlying asset, and similarly, if the price drops, the stablecoin issuer may destroy an equivalent amount of stablecoins. In another embodiment, if a first backing asset rises in value and a second backing asset drops in value, markers for stablecoins backed by the first backing asset may have their marker reassigned to the second backing asset.

In one embodiment, a fiat element (such as a bill with a serial number) can be represented as multiple tokens, each one of which represents a portion of the value. For example, a $100 bill can be represented as a stablecoin token worth $100, where the token incorporates or references a value representing the serial number. As a user spends a portion of the token, change is generated (e.g., in the manner that a crypto token is partially spent, such as by splitting it into two or more parts, wherein one part is provided to a payee and another part is provided to the payer, whether using the same or a different address than the address used for the crypto token residing at the payer before the transaction takes place.) Each portion of the two or more parts would include or reference the serial number or a representation thereof. One such representation is a hash value of the serial number, another representation also includes a number that indicates a numbering of the transfer, e.g., 0 for the payee and 1 for the payer. If a token transferred to a payer is represented in this way by the serial number S and the number 0, then a number 1 could be concatenated to this value for the token when transferred to another payee from the original payee, making the representation S 1 1. Similarly, the change kept by the original payer would, when spent to another payee, be represented by S 0 1. In an alternative embodiment, a $100 bill with serial number S is represented as 100 tokens, each one worth $1, and each one carrying a serial number corresponding to S and a counter C indicative of the number of the coin, e.g., a value from 0 to 99. Each one of these could be subdividable, e.g., spent in a fungible manner, each of the resulting pieces carrying a representation of the serial number along with a value specific to the minted coin and the subdivided portion thereof.

### XXIV. Transfer of Representation Types.

Another aspect of the disclosed technology corresponds to methods to modify the representation of value, e.g., transferring a fiat element to a crypto token representation or a crypto token representation to a fiat element, while still preserving the security properties of the scheme. One benefit of this aspect of the disclosed technology is that it lowers the required trust needed to enable parties to act as mints for stablecoins by enabling a verification mechanism that facilitates the detection of abuse. This detection may be probabilistic, meaning it is more likely to detect abuse quickly if the abuse is large-scale. This provides increasing protection against abuse as such abuse is scaled up, making it not financially desirable to abuse the system.

### XXV. Processing Fiat Currency.

Yet another aspect of the disclosed technology is an apparatus that processes fiat currency, minting corresponding crypto tokens representing the value of the fiat currency, wherein the process is auditable by tying the generated tokens to the processed fiat currency. It should be noted that this can also be done for fiat value items other than currency, such as gold, in which case a physical fiat element can be assigned an identifier, if none is already associated with it, and this identifier is then used in lieu if a serial number in the representation of the cryptographic token. Whether the input to the apparatus is currency or other physical representations of value (such as a nugget of gold), the generated crypto token is associated with the input, whether by representing a serial number or an identifier (such as an assigned identifier) with the crypto token. In some embodiments, the processed fiat currency is destroyed as the cryptographic token is generated, e.g., by a shredder that destroys bills after they have been scanned. On other embodiments, the processed fiat currency is stored in a secure manner and only allowed to be circulated after a corresponding amount of crypto tokens have been collected and destroyed (e.g., burned).

### XXVI. Beyond Stablecoins.

The disclosed technology can also be used to process fiat currency to generate cryptocurrencies and/or crypto tokens (henceforth, tokens) that are not stablecoins. For example, an amount ETH that corresponds to an input amount of fiat currency can be generated, incorporating a representation of the processed fiat currency (such as a serial number), where the amount of ETH corresponds to an exchange rate at the time of the minting of the token.

The disclosed technology may be used transitively, that is, existing tokens including serial numbers may be used to generate further, optionally different, new tokens, with the new tokens including records of the serial number of the existing tokens.

### XXVII. Scanning.

Another aspect of the invention allows for auditing of the above-described process by scanning fiat currency in circulation to obtain the identifiers/serial numbers of the fiat elements (e.g., bills), and determining whether there is one or more crypto tokens in existence, where these one or more crypto tokens correspond to the same identifier/serial number. If this is detected, that is an indication of abuse, e.g., of illegal minting of crypto tokens, and the minter can be penalized.

In today's fiat currency elements, coins do not have serial numbers, whereas bills do. These identifiers are currently represented as printed numbers that are human-readable. The disclosed technology is also compatible with other representations of identifiers, e.g., QR codes encoding identifiers, and printed on or otherwise embedded in the fiat currency element. In the future, radio-based technology, such as RFID transmitters with associated memory, may be used to store and convey identifiers, e.g., to a physical wallet, an automated scanner, or other physical readers. This can also be done for physical value representations other than bills, e.g., representations with a form factor of traditional coins.

An advantage of serial numbers for cryptocurrency, tokens, and/or stablecoins is that it is possible to provide a serial number for small base units of the digital currency. For example, a stablecoin may be divisible down to units of 10-18, thus the value of the unit may be minuscule fractions of a cent. Nevertheless, these minuscule fractions may each be labelled with their own serial number.

### XXVIII. Audits.

Scanning of fiat currency for purposes of auditing the system to identify illegally minted crypto tokens with the same identifiers as the scanned fiat currency is beneficial in that it helps detect abuse online. Examples of such abuse includes illegal minting of crypto tokens as well as insider attacks in which the system is coerced to generate crypto tokens without causing the corresponding fiat elements to be taken out of circulation (whether temporarily or permanently). It is also beneficial in that it enables the automated detection of counterfeit currency, which would correspond to fiat currency representations with serial numbers (or other identifiers) that have been cloned, that are not of a legitimate format, or which are known to have been stolen (e.g., in a bank robbery).

In one embodiment, a party that mints stablecoins sends (e.g., with a secure delivery service) to a trusted authority all fiat currency that has been processed and for which corresponding crypto tokens have been generated, and the trusted authority verifies (whether by processing all the fiat currency or by random sampling) that the correct amount was received, that the serial numbers correspond to minted stablecoins.

By providing a token or stablecoin, or indeed each sub-unit of the token or stablecoin, with a serial number, it is possible to track the generation, transmission, and destruction of each individual base unit of the token or stablecoin. This allows such tokens and stablecoins to be tracked with more accuracy than is currently possible using existing balance-tracked tokens and stablecoins, such as ERC20 tokens on the Ethereum blockchain. If an amount of a stablecoin or a token has a serial number associated with each unit of the stablecoin or token, then when a fraction of the amount is transferred, the origins of the fraction of the amount are known. Similarly, if an amount is transferred and subsequently dispersed to multiple further recipients, it becomes possible to track the dispersal.

### XXIX. Example Applications.

This has wide applications, for example, in recourse, in which it may be necessary to reverse a transaction in which received tokens may subsequently have been transferred onward. With each stablecoin individually identifiable, specific stablecoins may be retrieved from a plurality of recipients in an appropriate manner depending on the implementation of the recourse system.

In another application of the system, blockchain token mixers can be overcome. Currently, mixers rely on full fungibility of tokens. Thus “clean” tokens (tokens with no past history) and “dirty tokens” (for example, tokens obtained through theft or fraud) are submitted to a mixer, which consists of software to pool both set of tokens, and then transfer them on to multiple parties, thus making it difficult or impossible to determine which outgoing transactions are to the criminals or fraudsters, and which are not, in a manner similar to laundering stolen money. Non-fraudulent individuals are sometimes incentivized to participate by receiving a commission for submitting their “clean” tokens. With each token individually identifiable, such mixing no longer works. By associating taint with tokens whose serial numbers or other identifiers have been associated with abuse, a party providing as input an untainted coin to a mixer would not accept receiving a tainted token, nor would a party expecting an untainted coin. Therefore, the implementation of serial numbers discourages the use of mixers in the context of crimes, and therefore makes the profiting off of the same crimes more difficult.

### XXX. Banlists

To facilitate the management of a banlist for tainted tokens, a first Bloom filter (or another probabilistic storage method) can be used to store identifiers associated with a particular first type of abuse, and a second Bloom filter can be used to store identifiers associated with a particular second type of abuse. Whereas traditional Bloom filters are probabilistic storage methods and therefore are associated with error risk (e.g., a false positive, corresponding to a collision), this can be controlled for at the time of generating serial numbers or other identifiers: if a new serial number corresponds to a tainted entry in a Bloom filter, it is not desirable to use, and a new one should be selected. Alternatively, if a new serial number corresponds in terms of its Bloom filter mapping to another serial number in existence, then a future classification error is possible, and could be avoided. Yet alternatively, a non-lossy storage method, such as an ordered list of tainted identifiers, can be used as a slower but more precise method of determining taint, where this non-lossy storage is only consulted in instances where one of the lossy storage methods indicate potential taint. This can also indicate the type of information associated with a given serial number, allowing the combination of two or more Bloom filters corresponding to different types of information. The Bloom filter configurations are compact representations of potentially large quantities of data, and can be maintained in multiple locations, including in a large number of service providers and/or wallets. The non-lossy fallback storage would typically be significantly less compact and require more storage, making them suitable to not be replicated at large numbers of locations, as these may have storage constraints making such storage impractical. Therefore, some entities may store Bloom filter configurations but not the larger non-lossy databases, instead consulting databases storing such. In some instances, a wide range of entities may store only a portion of such non-lossy databases, using this local storage when possible, but requesting access to one or more other entities to verify data when it is not available in the local storage. This manner of distributed storage is also beneficial for other applications, beyond the management of banlists.

Compact banlists, e.g., implemented Bloom filters, can be distributed to individual wallets in a similar manner to how anti-virus updates are distributed, allowing the individual wallets to refuse payments corresponding to tainted coins.

### XXXI. Using Smart Contracts

In one embodiment, smart contracts can be configured to reject tainted coins, e.g., using a banlist. Such a smart contract can be associated with a token (e.g., an NFT or a crypto coin), blocking the purchase of the token (or parts thereof) using a tainted coin. It can also be associated with a token and implement a block on the transfer of that same token if the token's identifier (e.g., serial number) is listed on a banlist. As a variant, another action can be required if a smart contract determines that a policy associated with the smart contract flags a given transaction as being special, where special may mean of a higher risk, using a banlisted token, or another requirement triggering an action. For example, a smart contract may indicate that selected (i.e., “special”) tokens can only be transferred under specified conditions, which may require a third-party verification. This can be used to implement anchored tokens (also referred to as soulbound tokens) that can only be transferred under particular conditions, such as if the original owner has passed away, where this fact would be verified by the third party prior to an allowance of a requested transfer. This can be implemented either by keeping a banlist (e.g., of tokens that may not be transferred) or a whitelist (e.g., of tokens that may be transferred), a combination thereof, or a function specifying the conditions of an action based on a set of specified inputs.

Soulbound tokens, also referred to as “anchored tokens” were disclosed in provisional application 63/213,251 filed on 22 Jun. 2021, titled “Token Creation and Management Structure”, by Markus Jakobsson and Stephen Gerber.

### XXXII. Use of Policies.

In general, tokens can be associated with policies (e.g., implemented using smart contracts) where one or more actions can be taken on the token (e.g., transfer ownership, enable fungibility, allow access to data, etc.) where the policies may be evaluated by wallets, as part of a consensus mechanism (such as may be done to implement watchfulness), by a trusted third party, etc., and where the policy may be evaluated based on one or more inputs, where these inputs may include one or more banlists, one or more whitelists, and where functions stored on a blockchain may be part of the input. Such policies can be implemented using smart contracts, by digital rights management (DRM) functions associated with hardware, by scripts embedded with nodes that make up a consensus mechanism, etc.

In one embodiment, a policy includes an AI that is trained to provide a set of benefits to honest users, while exposing and/or blocking the actions of dishonest users; here, the notion of what includes honest behavior is indicated by the training data, which may include deceptive behavior, use of malware or malicious smart contracts, heists, blackmail or other undesired actions. One particularly useful aspect of the AI is the determination of collusive behavior among a set of nodes controlled or influenced by an adversary, e.g., for the purposes of performing money laundry or the funding of illicit activities. Here, the notion of what is illicit, again, would correspond to rules or training data. A banlist can be produced by such an AI, where the banlist would be incorporated in consensus mechanisms, wallets or third-party services. To the extent that the banlist expresses probabilistic assertions about risk, third-party insurers can assess the risk of and value of requested transactions, implicitly provided methods to overcome uncertainty due to imperfect decisions by the AI.

### XXXIII. Implementation of Policies.

Just like we disclosed the use of banlists and whitelists above, a person of skill in the art will understand that a list associated with any specified policy or interpretation can be created. This policy could be “not allowed” (a banlist), “allowed” (a whitelist), but could also have other properties such as “frequent customer”, “priority transaction” (which may be required to be logged before any non-priority transaction is recorded, irrespective of the gas fee paid), “medium risk”, “certified secure”, etc. A particular list may be specified by a policy whose rules may be modified over time. For example, a priority list may correspond to a first set of tokens or transactions selected based on a first rule at a first time, but later, at a second time, may correspond to another set of rules. The exact selection of the rules may be modified by altering the contents of a given database entry, said database entry being referenced in the token for which the policies are associated. Similarly, and as described herein, policies may also be associated with transactions requested by specified entities, or transfers being made to specified entities. These entities may be identified using policies, whether hardcoded into the system or potentially modifiable based on actions of a quorum of trusted entities, a consensus mechanism, a bridge, or an entity managing a particular blockchain or side chain.

Just as a banlist can be implemented using a Bloom filter or other probabilistic storage, it can also be represented by an AI that embodies classification capabilities; this applies not only to the generation of banlists, but to other contexts in this disclosure, as will be understood by a person of skill in the art.

Banlists and other lists, as disclosed above, can also be made to track identities of wallets, identifiers associated with escrowed identities, smart contract identifiers, mix network identifiers, identifiers of proxies used for undesirable purposes, and other identifiers matching functionalities, entities and transactions. This way, evaluations can be performed by smart contracts and other scripts based on such identifier-lists (where one particular case of such is a banlist as disclosed above.)

It should be noted that the use of one or more identifier-lists implemented using probabilistic storage methods such as Bloom filters, with one or more associated non-probabilistic storage methods as disclosed herein is for purposes of providing a practical example and should not be understood to be limiting. A person of skill in the art will recognize that alternative storage methods can be used, such as non-probabilistic storage indexed using non-cryptographic hashes of entries, linked lists, red-black trees, blockchain methods, etc. Similarly, the use of a 2-level hierarchy as described herein is simply for exemplary purposes and is not limiting. Some identifier lists may also be replaced with a dynamic determination, e.g., a majority vote among authorized participants. One example of this is a consensus mechanism.

Banlists and related technologies were disclosed in co-pending application titled “Selectively Modifiable Blockchain Records” by Markus Jakobsson and Keir Finlow-Bates, and is incorporated by reference in its entirety herein.

The disclosed technology can be used for wallets to identify serial numbers and associated metadata and select which tokens to use for which transactions. It can also be used to implement smart contracts that reject certain tainted coins, e.g., through a banlist.

### XXXIV. Scoring Risk.

A token T (or parts thereof) is transferred from party A to party B in a first transaction, and then, B initiates a transfer of T or parts thereof to party C. C may know that it is possible that the transfer from A to B was against the policies, and therefore, could be cancelled out by a recourse action. If T has been transferred to C at the time when the recourse would take place, the trustee may take another equivalent token in B's possession and transfer it to A, e.g., by generating a transfer request and sign it using the private key of the trustee, also referencing the purpose of the forced transaction, e.g., to cancel out the transfer from A to B. Alternatively, it may earmark one or more tokens in B's possession for these to be burnt once B attempts to transfer them, and then transfer a newly minted token to be provided to A, if so desirable. (If party A is determined to have violated the law by transferring T to B, the trustee may opt not to generate such a replacement.) If party B has no token to impound, or no token of sufficient value, the trustee may reverse the transaction from B to C, then reversing it from B to A; it may also directly impound the token in C's possession. This is a problem for party C, who may be innocent and should not be punished along with B. Therefore, at the time of the transaction between B and C, C may determine how long the token it is about to receive has been in B's possession, and determine the risk of impoundment based on this time; based on the identities or other identifiers associated with B, A and previous owners of token T, along with the durations it has been in the possessions of these parties; as well as what the apparent transactions were. For example, a transaction in which T is used to pay for an NFT with media content may pose a different risk than a transaction in which T is used to purchase gold. This risk scoring results in one of a decision whether to engage; a required extra payment for the transaction (i.e., the payment of an overage to cover the risk); or a requirement that the token or physical merchandise C would provide to B in exchange for T is escrowed for a specified duration or until an authority (such as a relevant trustee) has provided an all-clear signal. An alternative, or additional technique used in conjunction, is an independent insurance entity that either scores the risk or obtains a risk score from another entity; then insures the transaction; therefore, if a trustee were to cause the reversal of the transfer between B and C, to no fault of C, then C will be compensated for the losses, or the trustee will receive a token of the appropriate value from the insurer, allowing C not to be affected. This type of insurance for transactions may be purchased either by B or C, and may be required by some participants for transactions, e.g., with any unknown party. The identity of the insurer or terms of the insurance policy may be included or referenced in a transaction request logged on the blockchain, or could be obtained by the trustee from the affected parties where applicable.

### XXXV. Combining the Features.

The techniques disclosed above can be used by themselves or in combination with each other. For example, one or more of the recourse techniques may be used in combination with one or more of the escrow methods, wherein the trusted parties of the two components may be overlapping, the same, or distinct. The escrow methods may utilize the KYC features that anchoring (i.e., soulbound tokens) provide, to protect the privacy of users by not making the KYC information readily accessible to the public. Recourse can also be used with soulbound tokens alone, without escrow techniques, in which case an optional use of pseudonyms can provide some hiding of identity. A system may provide tracking features, relying on KYC techniques and/or soulbound tokens without having recourse features, or without having them enabled. Some of the features may be available only in some jurisdictions, to address local regulation and record-keeping requirements. Different escrow techniques may be utilized in different jurisdictions, requiring cross-jurisdiction handover of information related to escrow when cross-jurisdiction transfers take place. Escrow techniques may provide a granular capability of providing tracking, where different trusted entities are capable of performing different types of tracking. One type of trusted entity, for example, may only be permitted to verify that a given user (which does not have to be an individual, but which may also represent a collection of such) satisfies a given predicate, such as being (or not being) associated with a given jurisdiction; whereas another trusted entity may be capable of determining the full identity of the user. This can be achieved, e.g., by creating escrow records that include multiple ciphertexts, wherein different ciphertexts correspond to different types of information (such as full identity vs. just jurisdiction), and the different ciphertexts require different keys to decrypt. These different keys may be created and distributed according to the preferred access control structure. A person of skill in the art will appreciate that the different elements disclosed herein, and incorporated by reference herein, can be combined in a variety of manners, and that multiple methods with similar or identical functionality may be implemented using different techniques, thereby creating fallback mechanisms and options for controlling access, security and privacy. In addition, the techniques may be combined with risk scoring and/or insurance to provide for a distributed risk management. Here, an insurer may request plaintext identity information escrowed in KYC records in order to provide insurance discounts, or may simply assess scores based on past transactions of the parties involved, and the apparent risk of those transactions. This may be done using an AI that is trained with transactions and outcomes, where the latter corresponds to the recourse actions taken in response to said transactions, and related to the users of said transactions.

The use of risk-based insurance for transactions is also beneficial in contexts not involving the risk of adverse actions related to recourse, and may also be desirable for a large range of other transactions, including purchases of services, products and tokens, whether online or in the physical world. Insurers may identify risks related to various predicates, and offer insurance against these; example predicates include but are not limited to: a failure to receive a physical product that is paid for; the risk of a seller declaring bankruptcy before acquiring merchandise for a buyer; account takeover of previously honest entities and subsequent abuse of their established reputation to perform fraudulent transactions, etc. An insurer may estimate the risks of such events based on historical patterns, likelihoods of events conditional on the history of transacting parties, etc. A user performing a transaction, e.g., involving the transfer of a token, may select one or more predicates which it wishes to obtain insurance against; the user may further specify which one out of a collection of available insurance policies, with associated premiums, he is interested in, and perform a payment of said policy, referencing the associated policy, in a manner that is tied to the insured transaction. Such ties may be created, e.g., by a reference to a transaction; by the transaction and the purchase of the policy being part of the same request to be logged on a blockchain, or by tying the insurance to the wallet or other account identifier for which a given number of transactions have been insured by a previous commitment to the insurance provider.

### XXXVI. Other Uses of Insurance.

Traditional Bitcoin transactions are not considered to have occurred as soon as the block in which the transaction request is recorded is created. The reason for this is that there is a risk of the chain forking; this risk becomes exponentially smaller as additional blocks are added to the chain, causing the delay between the recording and the time at which the event is accepted as having occurred, the latter which is still based on a probabilistic assessment as opposed to an assurance. We refer to this time as the time to close a transaction, noting that this is not measured in seconds or minutes, but in the addition of consecutive blocks. Whereas, in principle, different parties may have different subjective views (informed by their risk tolerance) of what is the acceptable closing time.

One aspect of the disclosed technology is a technique to speed up the closing by implementing an assurance function wherein a user posting a request (which we refer to as the payer) may purchase insurance from a third party to secure the transaction on behalf of a receiver of the token(s) to be transferred (which we refer to as the payee). The third party is referred to as the insurer. We use the terms “payer” and “payee” somewhat loosely, since the assets to be transferred do not have to be funds, but could correspond to any token-based asset.

### XXXVII. Introducing Fork Insurance.

A collection of insurers may post policies specifying terms of insurance, e.g., for a given value to be insured, the amount it would cost to insure the validity of the transfer (e.g., the absence of a fork causing the transfer request to be undone) based on the duration (e.g., measured in number of consecutive blocks being appended to the chain). The cost may be modified over time, and may be determined by the insurer (or another collaborating party) by statistical analysis of the probability of a fork based on the recent composition of miners, their behavior, as well as historical risks of forks occurring. The function used to determine the cost does not have to be made public, but prospective payers and payees can obtain quotes in real-time, where such quotes are publicly verifiable, e.g., digitally signed and logged on a blockchain.

To enable a wide participation of entities acting as insurers, while at the same time avoiding a risk of defaulting or cheating of insurers, an insurer may stake an amount that indicates a limit of how much, at any point in time, the insurer may insure.

### XXXVIII. A Practical Embodiment.

It is convenient for payers to be able to transfer assets to a payee at the same time as the payer purchases insurance. This can be done, similar to how gas fees are paid, e.g., by including a payment for the insurer with the transfer request from the payer to the payee. The payment to the insurer would indicate the type of insurance that is purchased (e.g., correspond to the terms of the insurance) and be associated with the transfer to be insured. The latter does not have to be all parts of a transfer from the payer to one or more payees, but could be limited to some of these. Different parts of the transfer may be insured using different methods. For example, the payment that corresponds to receiving change could be left uninsured, which means that it cannot be trusted until after some number of blocks have been added; similarly, non-urgent transfers, such as royalty payments or sales tax transfers, may be left without insurance, or with a lower cost insurance than other transfer components.

### XXXIX. Avoiding Insurance Policy Destruction.

There are multiple ways in which the system can avoid that a request for insurance is destroyed in a fork, and especially in a fork affecting the insured token transfer request. A first approach is for the payer to have proactively purchased insurance for a given transaction, and logged that on a blockchain. However, this is not always practical. A second approach is for the payer to log the request for insurance on a different chain from that on which the insured transfer is to be performed, where the security of this approach rests on the statistical likelihood that both of the blocks in question would be affected by forking events. Following a third approach, a party overseeing insurance payouts (which may be a distributed party, or a set of parties such as bounty hunters) records any insurance requests taking place on a first chain on a second chain.

### XL. Insurance Token and Smart Contract-Based Method.

A slightly more complex approach of addressing the problem of insurance requests being destroyed involves a process of the following kind:

1. A payer purchases an insurance token Ti from an insurer. The token specifies a maximum cost of insurance that it can be used for.

2. When the payer wishes to perform a transaction involving a token T that he owns, the payer determines the cost of insurance for this transfer (e.g., as disclosed elsewhere in this disclosure) and then spends this quantity of Ti. The recipient of this transfer may be the insurer, for example. Thus, in this step, a transfer request involving both T and Ti is written to a blockchain. (In one embodiment, the two transfers are part of the same request, but in another embodiment, they are separate transactions, potentially recorded in different blocks and potentially on different blockchains.) The transfer of Ti references the transfer of T, or associates itself with it by other means (such as being part of the same request).

3. The transferred Ti is associated with a smart contract that specifies that if a fork is detected and reported within a specified time (e.g., as measured in appended blocks or minutes) then an amount associated with the insurance is transferred to a beneficiary, which in the simplest case is the payer, but which could also be another entity, e.g., the payee or a third party.

4. Anybody can report a fork by logging evidence of the “lost” branch on the branch that survives. This logging of evidence could simply constitute a reference to the lost branch, e.g., where it is stored, what it contains, etc. This reporting may be performed by a potential beneficiary of an insurance policy that relates to the fork, or by a third party such as a bounty hunter, i.e., an entity that receives a reward in response to being the first to report an event of a prescribed type. To avoid front-running, this reporting can, for example, use the commit-release approach disclosed in co-pending application titled “Secure and efficient Quantum-resistant digital signing method for blockchains” by Keir Finlow-Bates and Markus Jakobsson.

5. Any transfer of Ti that is performed but is not triggered by the appearance of a fork is simply returned to the insurer, who now has a greater pool of available insurance it can offer. This is also a practical way of bounding the amount of insurance a given insurer buys: by the amount of Ti-tokens in its possession. Such an insurer can acquire more Ti tokens by purchasing them (which is a form of staking, as described above) from a reinsurance entity, i.e., an entity insuring the insurers.

### LXI. Specialized Tokens.

When an insurer sells a token Ti to a party such as the prospective payer above, it may allow the prospective payer to resell the token Ti. However, in some contexts, this may be undesirable, as the sale of the token Ti may be made relative to the risk profile of the prospective payer. In this case, the insurer may use a limited-transaction token, which is a novel form of token disclosed herein. For example, a limited-transaction token may not be transferred to other users, except back to the insurer. As an alternative, it may also be transferable to a limited set of pre-approved entities, such as government entities, registered financial institutions, etc. This can be specified in a contract associated with Ti as Ti is purchased from the insurer.

### LXII. Traditional and Quantum Secure Systems.

The disclosed techniques are suitable both for traditional, ECDSA-based, blockchains and for quantum-secure blockchains. One well understood approach to implement quantum security is to use Merkle, Lamport or Winternitz signatures; these, however, are very costly in that they produce very long signatures, increasing the overhead of all signature-reliant aspects of blockchain technology. In co-pending application titled “Secure and efficient quantum-resistant digital signing method for blockchains” by Keir Finlow-Bates and Markus Jakobsson, more efficient techniques were introduced.

A token T may be a non-fungible token (NFT) or a fungible token, such as a representation of funds. A token owner TO has associated with token T a pair of cryptographic values, where a first cryptographic value may be public and a second cryptographic value is—at least to begin with—not known by parties other than the token owner or its representatives.

### LXIII. Traditional Public Key Systems.

In a first embodiment, the first cryptographic value may be a public key, such as an ECDSA public key, with the associated second cryptographic value being a private key, such as the associated ECDSA private key.

### LXIV. Quantum Secure Ownership Transfer.

In a second embodiment, the first cryptographic value may also be a one-way function of the second cryptographic value, e.g., a hash of it. This is disclosed in co-pending application titled “Secure and efficient quantum-resistant digital signing method for blockchains” by Keir Finlow-Bates and Markus Jakobsson, and is incorporated by reference in its entirety. For concreteness, the first cryptographic value may be a value y=hash(x) where x is the second cryptographic value, and hash is a cryptographic hash function such as SHA256. This second embodiment provides for quantum security when the one-way function is chosen as a one-way function that is not vulnerable to quantum attacks, as will be appreciated by a person of skill in the art.

### LXV. Initiating a Transfer.

The token owner TO wishes to transfer T to a token recipient TR. In one embodiment, that involves performing an action utilizing the second cryptographic value to transfer T to TR, where TR is represented by a key, which is another first cryptographic value. Whether TO's first and second cryptographic values are based on asymmetric key cryptography (e.g., an ECDSA pair of keys as described in the first embodiment above) or based on a one-way function, such as the hash function described in the second embodiment above, the token owner TO may transfer T to a key that is either based on asymmetric key cryptography or which is a quantum-secure key, as described in the second embodiment above. We let the key used by TR be denoted K.

### LXVI. Initiating a Transfer in a Traditional System.

In a context where TO's cryptographic keys are based on the first embodiment, e.g., where an ECDSA keypair is used by TO, the transfer is performed by TO generating a digital signature using the second cryptographic value, i.e., the ECDSA private key, on a message M that identifies the recipient TR, typically by incorporating K in the message. In some usage scenarios, M may include one or more conditions for the transfer, where such conditions may be evaluated to determine whether the transfer is valid or not. The conditions may state, for example, a requirement for a transfer of a specified asset to TO as a requirement for the transfer of T.

### LXVII. Initiating a Quantum-Secured Transfer.

In the context where TO's cryptographic keys are based on the second embodiment, i.e., the quantum-secure implementation, the transfer is performed by TO posting a commitment C, as disclosed in co-pending application titled “Secure and efficient Quantum-resistant digital signing method for blockchains” by Keir Finlow-Bates and Markus Jakobsson. One example of such a commitment is a post that includes H(x), H(x+m) wherein x is the preimage of a publicly available value y for which y=F(x), and where x is a value that was selected in a manner that cannot be easily guessed by a third party, e.g., selected in a pseudo-random or true random manner, a combination of such, or an approximation of either.

Here, m is the payload message, which may be an encoding of an action, for example but not limited to, information indicating an amount of value to be transferred, such as “A fraction 0.4 of the coin indicated by the key associated with the commit”; information indicating a recipient, e.g., “to be transferred to K”, and an optional condition c, which may be a reference to another transaction that the payload transaction should be atomic with, i.e., occur if and only if that other transaction occurs. Thus, m may be of the format (frac,K,c). Here, frac is the fraction, e.g., 0.4.

In the co-pending application titled “Secure and efficient quantum-resistant digital signing method for blockchains,” the associated reveal is the recording of a message of the format (x,m,ref), wherein ref is an optional reference to the record including H(x), H(x+m). This reveal may be posted on the blockchain, or otherwise conveyed to the token recipient, by the token owner after the token owner has verified that the commit was properly recorded on the blockchain.

### LXVIII. Proxy-Assisted Reveals.

In one embodiment of the instant disclosure, the reveal R is conveyed, by TO, to the blockchain, at the time of the commitment C, but in a protected format. One approach to protect R is to encrypt R using a key KTTP that is held by a trusted third party (TTP), where this trusted third party may correspond to a quorum of stakers of a proof-of-stake blockchain, e.g., the blockchain on which the transaction request is posted. The protected reveal is represented by E(KTTP,R).

The blockchain does not need to record (C,E(KTTP,R)), but could simply record C, to reduce up-front gas costs. It may later post E(KTTP,R) on the blockchain, at a time when gas costs are lower. Alternatively, it may not post E(KTTP,R) at all, but only post R, at a time when a policy P prescribes doing so. P may simply state that R is posted after C has been confirmed to have been posted, or after a specified number of blocks have been completed thereafter. However, in one embodiment, P may specify that R is posted only after a condition has been met, where the condition may be the same as condition c above, or another condition.

### LXIX. Conditional Release.

Policy P may state that the transfer may be completed, by the posting of R, only after an event has been verified to have taken place. This event may be completion of or the successful generation of another transfer. The event may also be an external event, e.g., the price of bitcoin exceeding a pre-specified value.

In one embodiment, TO does not know the key K at the time of the posting, but specifies in the condition c and optionally in policy P as well the selection criteria, such as the key KH of the highest bidder of the token T to be transferred.

### LXX. Selection of Encryption Scheme.

In some embodiments, the encryption scheme E is using an asymmetric cipher, such as disclosed in “Threshold-Proxy Re-Encryption Scheme with Proactive Property for Secure Data Sharing on Cloud” by Raghav Gahlot, Nitish Andola, Katyayani Verma and Sharannya Venkatesan, published in 2022. The encryption scheme E may also be a quantum-resistant encryption scheme such as “Public-key cryptosystems from lattice reduction problems” by Oded Goldreich, Shafi Goldwasser and Shai Halevi published in 1997. In one embodiment, a plaintext message is encrypted multiple times using the public keys of different parties, in order to establish the need for a quorum for decryption. In some embodiments, an efficient encryption scheme such as ElGamal implemented on Elliptic Curves is used alongside a less efficient but quantum-secure encryption scheme, with all parties relying on decrypting the former ciphertext (i.e., from the efficient scheme) until an event takes place that indicates that the system may be, or may soon be, under a quantum-based attack; at that point, the second ciphertexts are relied on instead.

In one example embodiment, a first party, corresponding to a token owner TO, wishes to transfer a token T to a future winner of a lottery. Any user who buys a lottery ticket, e.g., transfers a pre-specified amount of funds to a party indicated by TO, can be selected as the winner. Each such party i provides a key Ki with their payment. The TTP identifies the valid transfers and generates, at a prescribed time or after a prescribed event takes place, a list of all the associated keys, K1 . . . . Kn. This list can be used, at least in part, to generate a random number that is used to select a winner i, where the transfer of the token from TO is made to key Ki. The prescribed event may be that a given time has arrived and a sufficient number of lottery ticket purchases have been made.

### Example Application: An Auction.

In one example embodiment, TO wishes to transfer a token T to an auction bidder who makes the highest bid. All auction bidders indicate a conditional payment for receiving T, where the condition includes being the highest bidder. TTP identifies a cut-off event that may be based on time and may be based on having received a conditional payment that exceeds a threshold amount. The TTP then selects the winner and causes the tokens to be transferred. In one embodiment, the threshold amount is not disclosed on the blockchain, i.e., is not part of C, but it is possible to determine by TTP, whether before or after the decryption of the data including the reveal value R. Thus, additional data may be encrypted along with R, as TO initiates the transfer request; in this example, the data D=(R,reserve) is encrypted using one or more keys associated with TTP, and submitted along with C. Here, reserve corresponds to the threshold amount. Additional conditions and rules may be enclosed in the ciphertext envelope, i.e., encrypted for TTP, and some conditions, rules or other terms may be provided to TTP without being encrypted or while being encrypted using a key that is not tied to an event in terms of decryption, but which may be decrypted by TTP (or its members in a distributed situation) immediately once it is received.

### Tying C to R.

In order to tie C to R, and vice versa, C may be a commitment that includes a nonce N that is not public; wherein R includes or is associated with the same nonce N. In uses where R is transmitted in a protected envelope, e.g., encrypted for TTP, the nonce N may be part of the plaintext message.

In another implementation, the release packet R may include a digital signature on C, or parts thereof. The digital signature may be one of the commit-reveal signatures used herein, which may be achieved, for example, by incorporating N in C and releasing the associated nonce N in R. For example, C may include H(x), H(x+m|N) where | is concatenation; where R includes (x,m,N), and where C, ETTP(R) is conveyed to the blockchain, causing C to be posted and ETTP(R) to be provided to TTP.

Alternatively, C may include a digital signature on R, or a CR signature, e.g., in the form of C including H(x), H(x+m|R). One example of the operation+ is concatenation, i.e., |.

A person of skill in the art will recognize that there are many variant approaches of tying C and R messages to each other, also including the use of references from one to the other as disclosed in co-pending application titled “Secure and efficient quantum-resistant digital signing method for blockchains” by Keir Finlow-Bates and Markus Jakobsson.

### Example Use: Anonymous Marketplace

In one example embodiment, two or more users submit requests to a marketplace. A request may be submitted by posting an authenticated message on a blockchain, where this message may be encrypted using a key associated with a trusted party, where this trusted party may be distributed. One way of doing this is to post a commitment C including H(x), H(x+e) where e includes an encrypted payload. For example, e may be of the form e=ETTP(req) where req is the request. The request is also accompanied by a release packet R, which may be posted on the same blockchain as C is, but after C has already been verified to have been posted; alternatively, R may be conveyed to TTP in an encrypted format, as disclosed above. Here, req may state a need, such as a wish to buy a token T2, a maximum price MP, a deadline such as within 48 of C being posted, one or more conditions CON, where CON may refer to another request req2 and state, for example, that only one of req and req2 should be completed.

TTP processes two or more requests, which may be performed in two phases. The first phase may entail decrypting the payload e. In a situation where no encryption is used to protect the payload e, the TTP does not need to decrypt. The TTP may also, as part of the processing, randomize the ordering of the two or more requests, e.g., run them through a mix network. An example mix network is described in “Making Mix Nets Robust For Electronic Voting By Randomized Partial Checking” by Markus Jakobsson, Ari Juels and Ronald L. Rivest, published on Feb. 1, 2002. The second phase of the processing involves identifying requests that match. The match may be between two (or more) requests being processed by the TTP, but may also involve services, resources and offers that are made available externally to the requests received by the TTP. For example, such external resources may be stating needs of a similar format as for the requests, but may be available on forums other than the marketplace implemented by TTP, and identified by TTP or being advertised to TTP by a third party, who may need to pay a fee for the TTP to consider matching the received requests to it. The TTP may remove any requests that are invalid, expired, illegal, or not properly formatted. Some requests may be removed after having been matched.

After two or more matching needs have been matched, the TTP will initiate transfers corresponding to the consummation of the transaction corresponding to these matching needs. Two or more needs are said to be matching if they cause an evaluation function to determine that each associated request is valid and satisfied by the other matching needs.

The benefit with the disclosed approach is that this enables the decoupling of the payment (a first token transfer) and the resulting purchase (a second transfer) when the TTP acts as an intermediary for payments in batches, in addition to randomizing the request orders and performing matching. At the same time, the matching can be publicly verified, and verified to correspond to the filed and potentially encrypted requests.

The anonymity that this approach enables can be selectively revoked by a scrutiny of the random values used for mixing, and associated optional proofs, which may be selective, of what input requests correspond to what outputs of the mix network. In the context of “Making Mix Nets Robust For Electronic Voting By Randomized Partial Checking” by Markus Jakobsson, Ari Juels and Ronald L. Rivest, this tracing can be done by selectively disclosing the flow of a selected input or output through the mix network, where the disclosure can be accompanied by the random numbers used for re-encryption or as nonces, along with additional but optional proofs of knowledge of values not to be disclosed.

In one embodiment, the TTP would determine what requests get satisfied, i.e., should result in transfers, and then determines what incoming blockchain posts these requests correspond to, e.g., by tracking back requests to posts. The transfers for these requests are then initiated. The transfers may be to the TTP, when TTP acts as a middleman and privacy enhancing payment proxy. The TTP will collect all the payments, which may include commissions to TTP, and initiates the transfers of tokens to the addresses indicated by the matching of requests.

The approach for an anonymous marketplace can also be developed in the context of a traditional digital signature token transfer request, by incorporating in the token transfer request a transaction descriptor component and an address component, wherein the address component may be encrypted using a key that enables a TTP to decrypt the component, to mix a collection of components before they are decrypted. All transfers corresponding to matched requests would be made to the TTP, which would accumulate all tokens to be transferred and then perform corresponding transfers according to the established matches. For fungible tokens, the TTP may use tokens it already possesses or from the pool of accumulated tokens as opposed to the very tokens associated with the match. This can be used to hide the exact terms of the transactions and obscure what tokens are being acquired using what funds or other resources.

### LXXX. Addressing Abuse.

Say that A and B want an atomic transaction where token TA is given from A to B at the same time that token TB is given from B to A. We refer to this as simultaneity, where two potential transactions- or more-depend on each other. Simultaneity can be achieved using CR signatures. We also refer to this as atomicity, as disclosed in co-pending application titled “Secure and efficient quantum-resistant digital signing method for blockchains” by Keir Finlow-Bates and Markus Jakobsson.

A CR signature can be described as a series of steps, as follows:

Commit: A posts h(XA1), h(xA1, h(xB2)), and the miner adds a Quantum secure signature to the block.

Time passes and A verifies that the post took place.

Reveal: A posts xA1, h(XB2). Now the value previously associated with xA1 is associated with xB2.

Verifiers can determine that the commit and the reveal were posted. This can be done for any type of blockchain.

### LXXXI. Atomicity, First Method.

One can implement atomicity using the following method:

Commit: A posts h(xA1), h(xA1, h(xB2), cA), and the miner adds a Q-secure signature to the block.

→cA is a condition, by A. For example, it may be “B will transfer portion p of token h(xB1) to me”.

Time passes and A verifies that the post took place.

Reveal: A posts xA1, h(xB2), cA.

However, note that the above does not mean that the value is transferred. The verifiers also determine that there are matching transfers:

Check the “pending database” if it contains an entry matching the transfer h(xA1)→h(xB2), as specified by cA.

If yes, then remove that entry and approve both transfers.

(This may be done by recording [cA, cB] on the blockchain, which others can verify. Alternatively, others can go build a pending database themselves and verify again.)

If no, then record xA1, h(xB2), cA in the pending database.

No match?

To deal with failures due to (malicious or mistaken) failure to create matching transactions, i.e., one of the parties not performing the expected transaction but another one or none at all, the following approach can be used:

Improved commit: A posts h(XA1), h(xA1, h(xB2), h(xA2), cA).

Here, cA states the conditions, including how much will be transferred to h(xB2) and what portion—the change—goes to h(A2). If there is a match, that transaction takes place. If there is a failure (as described above) then all of h(xA1) is transferred to h(xA2)—minus gas fees, where applicable.

Other functions for determining what portion of the token is transferred to what addresses (such as h(xB2)) can be used, and may either be implicit or be described in cA. In one embodiment, cA may be posted in cleartext along with h(XA1), h(xA1, h(xB2), h(xA2), cA), making the condition public at the time of the commitment.

### LXXXII. Atomicity, Second Method.

A variant of the above-described approach can be utilized for multiple mutually untrusting parties to perform exchanges, as illustrated below:

Party A performs a commit by posting h(xA1), h(xA1, h(xB2), h(xA2), cA), cA. Here, cA may specify “I will transfer the token TA controlled by h(xA1) to h(xB2) if token TB is transferred to my address h(xA2); if this transaction does not occur within 20 blocks, token TA is transferred to h(xA2).” In a typical implementation, cA would not be as verbose, of course, but contain the information [TA, h(xA1), h(xB2), TB, h(xA2), 20], or similar.

Party B determines that cA is to his liking, i.e., whether it corresponds to a condition cB that has been generated or received by B. Here, cB may specify “I will transfer the token TB controlled by h(xB1) to h(xA2) if token TA is transferred to my address h(xB2); if this transaction does not occur within 20 blocks, token TB is transferred to h(xB2).” cB may also incorporate a reference to A's commit post, or to cA therein.

If B determines that cA matches cB, as it does in the example above, then B posts h(xB1), h(xB1, h(xA2), h(xB2), cA=B), cB.

Either party can then perform a reveal. Without loss of generality, party B may do this, after having verified that its commit was posted to the blockchain, and after having waited a pre-specified number of blocks, such as 3. The latter is done to avoid forking. The exact wait may be a parameter set by party B. Party B's reveal, in this example, B corresponds to the message xB1, h(xA2), cB. It may also include a reference to B's commit, and/or to A's commit.

The other party, in this example A, verifies that the transfer corresponding to B's commit and release is valid.

If it is not valid, then A waits until the deadline, which in this example is 20 blocks, and then performs a reveal, causing the transfer of TA to h(xA2).

If it is valid, then A knows that once A posts a valid reveal, token TB will be considered transferred, as any verifier can check that A's reveal was correct.

After party A has posted its reveal, e.g., xA1, h(xB2), cA, party B can verify the validity of the reveal. (In addition, the reveal may include references to the commits and to B's reveal, or some of these.)

If B determines that party A's reveal is valid, any verifier will also be able to determine this; therefore, B knows that the transfer has occurred.

If the reveal is not valid, then this will also be possible for any verifier to determine; in such a case, the transfer of TB will be made to h(xB2), according to the specifications in cB.

The above approach enables mutually untrusting parties, such as A and B, to transact. Note that this allows for security against abuse even in the absence of a “pending database” as disclosed above.

### LXXXIII. Delayed Selection.

In one embodiment, a first party A performs a commit in which multiple recipients are committed to—e.g., including a series (zA2, zA3, . . . zAn) where zAi=h(yBi, rBi), and where yBi=h(xBi) is published by a potential recipient that knows xBi. Party A does not need to know xBi, and in a typical embodiment, A does not. The value rBi, on the other hand, is selected by party A, and is not revealed at the time of the commit. rBi is selected as a random or pseudo-random value, e.g., rBi=h(seed_A,y,Bi) where seed_A is a (potentially reused) seed value known by party A. Party A posts the commit h(xA1), zA2, zA3, . . . zAn. Here, n is a parameter indicating how many candidate recipients there are, where n−1 equals the number of options.

In response, one or more parties indicated in the series perform an action, such as a transfer. The action may correspond to a post on the blockchain, or may correspond to an action that party A determines has taken place based on an input. Based on this, party A performs a selection j=2, . . . n of who will receive the transfer of the token associated with h(xA1) and the associated preimage xA1.

Based on the commitment and the selection j, party A generates a reveal which includes (xA1, rBj), and optionally yBj as well. The reveal value enables a verifier to determine that the reveal corresponds to the commit, causing the token corresponding to h(xA1) to be transferred to yBj=h(xBj).

The delayed selection method can be combined with the techniques disclosed above, e.g., in the simultaneity description, wherein a condition cA indicates the terms of the transfer. Furthermore, cA may indicate how a transfer of a fungible token may be performed to provide a first entity (which during the reveal turns out to be entity Bj) with a specified fraction of the token (such as 90% or a fraction that matches $500 at the time of the transaction) a second entity (entity Bk) with another fraction or amount, which may be “the change after having performed the other transfers” or another similar instruction.

Based on the delayed selection and the associated reveal, one or more of the actions that preceded the reveal may be taken. For example, if an action i corresponds to a conditional transfer of a token held by Bi, to party A, then when Bj is selected to receive the transfer from A, at the same time, the transfer of the token held by Bj is performed. We may refer to this as enabling the action posted by Bj.

In some embodiments, multiple actions may be enabled in response to a reveal, where not all may correspond to parties that were selected by party A. For example, this may be used for a lottery-type distribution wherein the transfer from A is a payment of proceeds of the lottery, and the actions corresponds to transfers made by the parties Bi (i=2 . . . n) to A, or another associated party, and wherein A chooses a winner based on what parties Bi participated in the lottery by performing the payment (i.e., action). This selection may be performed based on a random selection, e.g., as indicated by a hash of the actions performed, or it may be tied to a real-world event external to the interaction between A and B2 . . . . Bn.

Blockchain Enhancement Technology with Applications to Quantum Security

In a traditional blockchain environment, every transaction request is submitted to a mempool, from which miners select a collection of entries to include in a block, and generate authentication values that tie the collection of entries to the given block. The authentication values generated by the miner either includes an output of a proof of work or a digital signature. Each individual request includes a payload and an authentication value, where the authentication value in the request either includes an association with an address and/or a smart contract, or a digital signature.

In the above, the digital signatures used by the requestor and the miner are currently generated using algebraic means, e.g., using ECDSA, which makes them vulnerable to quantum attacks.

Replacing the digital signature used by the requestor and/or the miner with a non-algebraic construct, such as a Merkle or Lamport signature based on the non-invertibility of a hash function, addresses the vulnerability to quantum attacks but adds a dramatic overhead in the form of much greater blockchain storage being required for the storage of digital signatures. This causes a severe bloating of any blockchain technologies, increasing the cost of any transactions relying on blockchain. This increase is not modest and threatens to render blockchain technologies useless.

Another problem with today's non-algebraic digital signature constructs is that even if quantum-secure methods were to be introduced, owners of legacy tokens will need to convert their assets to quantum-secure expressions. However, if quantum attacks are in existence, this transfer is a point of vulnerability. There are no efficient ways of doing this to date. This disclosure addresses the above problems, along with a collection of related problems.

In a series of recent provisional patent applications, which are currently pending, this problem has been addressed by the introduction of a time-based construction in which a requestor submits two related request elements to be logged in two different blocks to create a time-based authentication value that replaces the traditional algebraic or non-algebraic digital signature element, while providing quantum security derived from the use of a one-way function such as a hash function. These pending applications include applications titled “Recourse and Quantum Security Integration Framework” by Markus Jakobsson, Hossein Siadati, and Keir Finlow-Bates; A more efficient method, relying on a two-stage commit/release protocol, was disclosed in “Secure and efficient Quantum-resistant digital signing method for blockchains” by Keir Finlow-Bates and Markus Jakobsson, and “Using KYC, Escrow, Tracking, Risk Scoring and Recourse to Secure Transactions” by Markus Jakobsson and Keir Finlow-Bates. We incorporate these by reference in their entirety.

One aspect of the disclosed technology is an enhanced method for providing quantum secure logging of information such as token transfers.

The instant invention further improves on the previously known technologies by simplifying the design and further reducing the reliance on blockchain storage space for authentication information. Simplifications, when well designed, result in security benefits in the shape of a less complex system. However, simplifications, when poorly designed, threaten the security of the system in which they are used. For example, the removal of any one element from a construction threatens to invalidate the security benefits of the results. The design of a simpler system is therefore both desirable and risky, and requires great insights to improve the resulting system.

The traditional approach for authentication of requests submitted to a blockchain can be described as follows:

A “payer” uses the private key corresponding to a public key associated with a token to transfer the token to one or more “payees,” represented by their corresponding public keys.

The authenticity of the transfer request is expressed using a digital signature. In traditional Bitcoin, it is an ECDSA signature, but in a quantum-secure version, it would be a Merkle/Lamport signature. Here, the request “R” has a message component “M” and a signature component “S.”

The miner collects a number of entries (such as R) from the mempool and authenticates the collection. This authentication is performed using a digital signature (ECDSA or Merkle/Lamport) in Ethereum, and using a winning mining solution in Bitcoin. As a result, the newly appended block of the blockchain in question will include the request R, which includes the entirety of the signature component S, for purposes of verification of the validity of the action associated with the request R to which S belongs.

One aspect of the disclosed invention is a method to reduce the size of the log, while enabling stronger protection against quantum attacks. The disclosed technology addresses these seemingly contradictory problems as follows:

A payer, which may correspond to a hardware crypto wallet, a software crypto wallet, a hybrid crypto wallet, or a hosted crypto wallet, initiates a transaction for a token T by generating a transaction specification TS that includes one or more of a token identifier, a smart contract identifier, an optional matching transaction on which the transaction is conditional, one or more conditions, one or more identity references, a recipient identifier, and one or more policies. The token identifier may correspond to a public key, such as a Merkle/Lamport root value or a smart contract address. If an atomic set of two or more transactions is to be performed, the condition may specify the requirements under which token T is to be transferred to its associated recipient. The identity reference may include a reference to an identity record, such as escrowed identity data or an anchored token identifier. The reference may be encrypted, and may be accompanied by a proof of knowledge that it is properly formatted, and that the payer knows the associated decryption key. Such proofs may be based on cut-and-choose methods for quantum security. Alternatively, the proof may include an attestation from a trusted third party that has verified the validity of the encrypted reference and/or the data it corresponds to. This third party may be a consumer representative or a secure computing element of the device or server associated with the wallet of the payer. In addition, TS specifies one or more recipients, each one referenced using at least one of a smart contract address and/or a public key such as a Merkle/Lamport root value, along with an optional one or more values indicating the portion of the token T to be transferred to the specified recipient. Here the reference corresponds to the identity of the recipient of the token. The gas fee may be explicitly specified, or simply implicit, e.g., corresponding any non-specified portion of the token. In one embodiment, multiple tokens such as T1 and T2, may be transferred in an atomic manner, each one to one or more recipients, where the recipients for T1 may be different than the recipient of T2, and where either both T1 and T2 are transferred or neither is transferred, and wherein the transfer condition may be specified or referenced in TS. The tying of two or more tokens to each other is beneficial to pay for gas fees, sales taxes, fraud insurance, and/or other fees, along with the transfer of non-fungible tokens. It is also useful to perform conditional payments of amounts that exceed the value of one single token, and where the collection of payments is conditional on the same condition. In one embodiment, different components of an atomic transfer may be associated with different conditions, where the condition may specify whether the transfer is required, what the amount of the transfer is, etc.

The authenticity of TS is vouched for using a quantum-secure digital signature S and a do-not-store flag F that is set to “true.” As one concrete example of a signature scheme used for the generation of S is a Merkle/Lamport signature using a cryptographic hash function H as its one-way function. The request R=(TS, S, F) is submitted to a mempool.

A miner collects a number of entries (such as R) from the mempool and authenticates the collection. For each element (such as R), it is determined whether the flag is set. If the flag is set, the request is considered invalid if the signature S is not valid with respect to TS. If the flag is set and the signature is valid, then the element is considered valid. If the flag is not set, and the request is properly formatted then the request is considered valid. Here, the formatting requirements may include having a gas payment.

The miner may choose to drop any invalid element, or may log them in spite of them being invalid, where this determination may be based on a policy of the miner. The miner then collects all flagged elements it has selected to include in the block, and places these in a first container, which we refer to as the flagged container. All the non-flagged elements that the miner has selected to include in the block are similarly placed in a second container, which we refer to as the non-flagged container. Either of these two containers may be empty in a given situation. In one embodiment, the two containers are represented by a first counter indicating the number of flagged elements included in the flagged container, a second counter indicating the number of non-flagged elements, and then the list of the TS portions of the flagged elements followed by the list of non-flagged requests R of the non-flagged elements. Thus, the flagged elements are logged without their associated digital signatures, whereas the non-flagged elements are logged with any associated digital signature being part of the logged data. One of the types may be considered default, and therefore not labelled according to its flag setting if there are no elements with the opposite flag in a block; the flag then is implicit unless there are elements of both types. A person of skill in the art will recognize that this is simply one example way of wrapping the elements, and that there will be many alternative expressions of the information.

The miner then authenticates the two containers. For staking-based mining, such as Ethereum, the authentication includes a digital signature, which could be a Merkle/Lamport signature based on a hash function to obtain quantum security. For the proof-of-work based mining the authentication includes a valid proof of work that uses as its input the authenticated containers.

The miner is considered honest if all the flagged elements in the flagged container corresponded to values TS and S, wherein S is a valid digital signature on TS, related to the appropriate public key(s) associated with the token(s) to be transferred in the associated request; and otherwise is considered a cheater. Thus, the authentication value generated by the miner in step 3 above becomes an attestation of the validity of all the digital signatures of the flagged item, attested by the miner, and approved by every verifier (such as a validator) that considered the miner honest after having reviewed the digital signatures of the requests associated with the flagged elements included in the block. These signatures are not stored in the block, and can be erased from the mempool after having been verified to have been correctly processed by the miner, corresponding to a correct attestation resulting in the miner being considered honest. Cheating miners are penalized in proof-of-stake implementations of the instant invention, and their proofs of work are considered invalid by validators in proof-of-work based implementations.

In the above example, the payer authenticates the transfer of T, and after having been verified, the payer's signature to attest to this transfer is removed, with the authentication of the transfer instead being made by the miner, using the miner's authentication method (e.g., digital signature or proof of work). This is secure since the miner is already trusted, e.g., to not allow double-spending of tokens. However, a payer may opt to submit a “long” request, if so wanted. This can be done by having the payer may reset the value of the do-not-store flag (i.e., set it to “false”) and submit the corresponding request R=(TS, S, F) is submitted to a mempool. This will cause the full request (i.e., including the signature S) to be stored on the blockchain. However, since this is more wasteful of resources (namely storage resources of any party wishing to store a part of the blockchain) than a transfer request that stores the entire digital signature S, the payer needs to pay a storage fee, in addition to the gas fee. Whereas the gas fee is a payment that is made to the miner, the storage fee may be paid to a third party, which we may refer to as the storage taxation agency. Moreover, whereas the gas fees can be set by the payer in any way the payer sees fit, as it is used to incentivize the logging of the transaction request, the logging fee may be determined in a manner that is not set by the payer but by the network. For example, the network may institute a flat fee per transaction request for which the signature is stored on the blockchain. Alternatively, the fee may depend on the value of the transferred assets, i.e., the amount received by the payee, but not including the amount returned to the payer as change. The storage fee may, furthermore, depend on the type of token that is being transferred, or the identities of the payer or payee, where some types of transactions may be eligible for storage fee discounts, e.g., based on the identities of either the payer or payee. The storage fee could be explicit, or it could be implicit and deducted from the takings by the miner. In one embodiment, the storage taxation agency is simply a non-existent entity, meaning that all transfers to this entity correspond to the burning of the corresponding value. This has a deflationary effect on the system and benefits all token owners.

In one embodiment, the storage fee is paid to an entity of the payer's choice, where a collection of selectable recipients is available. This corresponds to the fee being directed to a public benefit on the choice of the payer. In another embodiment, it is the miner who selects the recipient of the storage fees from a collection of available choices.

In one embodiment, insurance fees (e.g., against fraud that the network fails to protect against) are paid for each transfer, or conditional on the desired policy of the payer or payee. Recourse fees are fees that are paid to maintain watchful mechanisms that are used to provide recourse. Recourse fees, like insurance fees, may be conditional on the desired policies of the payer and payees, or may be mandated. Recourse can be implemented using watchful mechanisms, e.g., as disclosed in “Automated Wallet and Transaction Control” by Markus Jakobsson and Keir Finlow-Bates, incorporated by reference in its entirety herein.

Additional taxes (such as value added taxes or sales taxes) may be taken as well. Tax payments and associated structures are disclosed in co-pending application “Blockchain enhancement technologies with applications to commerce” by Keir Finlow-Bates and Markus Jakobsson, and is incorporated by reference in its entirety herein.

In one embodiment, escrow fees can be collected when transfers are made. An escrow fee is a fee for the maintenance of escrow databases, which may be used to store identifying data associated with payers and/or payees, where the identity may be represented using an anchored token, using an identifier tied to a wallet, or a combination of such. Like the storage fees, escrow fees may be determined in a variety of ways, as outlined above.

Soulbound tokens, also referred to as “anchored tokens” were disclosed in provisional application 63/213,251 filed on 22 Jun. 2021, titled “Token Creation and Management Structure”, by Markus Jakobsson and Stephen Gerber.

Escrow techniques are disclosed among other places in co-pending application titled “Using KYC, Escrow, Tracking, Risk Scoring and Recourse to Secure Transactions” by Markus Jakobsson and Keir Finlow-Bates.

The aforementioned publications are incorporated by reference in their completeness into the disclosure of the instant invention.

The disclosed invention enables different treatments of different requests.

As a first example, requests related to the transfer of a token that matches a policy to be required to have full signatures logged in order for the requests to be valid and the transfer performed. Example policies include but are not limited to:
that the value of the token exceeds a threshold value;
that has not been transferred before a threshold date which be the date at which the disclosed invention is deployed;
that the payer has not requested to be added to a whitelist of parties for whom requests can be logged without logging the associated signatures.

As a second example, any token that is associated with an authentication mechanism that is vulnerable to a quantum attack, or another specified attack, may be required to be transferred in a different manner than tokens that comply with specified security requirements. A non-limiting example of such treatment is provided below for illustrative purposes.

In one embodiment, a blockchain may be associated with legacy tokens that do not comply with later requirements, and may require such legacy tokens to be processed (e.g., transferred) in a different manner than tokens that do comply. A blockchain system may be associated with a multiplicity of types of legacy tokens, e.g., tokens that are vulnerable to a first attack; tokens that are vulnerable to a second attack, where these two types of legacy tokens may be managed in different ways to address their respective security vulnerabilities.

As one example, a legacy token may be associated with a value V that is a hash of an ECDSA public key PK, where traditionally, to transfer the token may require the disclosure of the ECDSA public key PK along with the generation of an associated ECDSA signature on a transfer request. Non-legacy tokens may be associated with a Merkle root value, where a Merkle signature is generated to request the transfer of the token. These two tokens can co-exist on the same blockchain, but the legacy token may need to be transferred in a manner that is not the legacy method (e.g., because quantum attacks would render it vulnerable) but which also is not the same as for non-legacy tokens (e.g., because the legacy token is not associated with a Merkle root, and can therefore not be transferred using by generating a Merkle signature associated with the value to which it is tied.)

The system may require, for example, that the ECDSA legacy token described above be transferred by demonstrating, using a zero-knowledge protocol or a protocol with limited leaks related to the witness, knowledge of PK given V. Note that this is not the same as a proof of knowledge of the private key associated with PK, which an ECDSA signature is an example of; rather it is simply a proof of knowledge of the value PK. Here, the proof of knowledge, in one embodiment, can be made relative to a set value, where this can be chosen as a Merkle tree root value; this effectively causes the transfer of the token with public key PK to the aforementioned Merkle tree root value, without the use of the quantum-vulnerable private key associated with PK. Whereas there may not be any efficient protocol to perform this proof, it is well understood that a less efficient method such as an encrypted circuit can be used to prove the statement that the party knows PK, without full disclosure of PK, and where this proof can be made relative to a value such as the Merkle root value. For example, this can be done in the random oracle model using an encrypted circuit, and wherein a cut-and-choose approach is used, the challenge set to the output of a hash function to which the input includes both a description of the encrypted circuit, and the Merkle root value that it desired to be tied to the proof of knowledge.

An alternative way of converting a quantum-vulnerable asset to a quantum-secure asset uses the principles laid forth in co-pending application “Recourse and Quantum Security Integration Framework” by Markus Jakobsson, Hossein Siadati and Keir Finlow-Bates, which is herein incorporated by reference in its completeness. There, the structure of authenticating by disclosing a commitment, followed (in a later block) by a release of the committed information, is disclosed. In the context of a traditional ECDSA signed token, as outlined above, the public key PK corresponds to the hash preimage, and the hashed PK to the hash image. A party may therefore commit to a Merkle root (referred herein as ROOT) along with the preimage PK, by submitting hash (ROOT,PK) to be logged on the blockchain; in a subsequent block, the corresponding reveal is made, i.e., the values ROOT, PK are published on the blockchain. Since the commitment is by now signed by a miner, the value ROOT is now considered the new public key, wherein PK is used as the preimage that is tied to a previous token. Thus, the previous token is now tied to the public key ROOT.

Yet another alternative way of converting a quantum-vulnerable asset to a quantum secure asset is for the owner of the quantum-vulnerable token T1 to acquire a second token T2 that is quantum secure, and to use T2 to convert T1 to a quantum-secure token. We refer to T2 as a helper token. One way of doing this is to use the quantum-secure digital signature scheme of T2 to generate a signature on the value PK of the vulnerable token, where this value is not known by anybody but the owner of T2. Thus, this is a proof of knowledge, using the quantum secure digital signature associated with T2, of knowledge of a value tied to T1, and known only by the owner of T1. In addition, the digital signature of T2 is also authenticating a new—and quantum secure—public key value, which we refer to as ROOT. Thus, the request that is logged on the blockchain can be expressed as SIGN_T2(PK,ROOT), namely a digital signature using the quantum secure signature scheme and private key associated with T2, on PK (which provides ownership proof) and on ROOT (which transfers the ownership of T1 to the party with the capability to sign using the public key ROOT). To avoid front-running attacks, the value PK is not revealed until later on. In one embodiment, PK is disclosed in a subsequent block, along with a reference to the block in which the signature SIGN_T2(PK,ROOT) was logged. Alternatively, PK may be disclosed at a later time, when the owner of T1 wishes to transfer ownership of T1 by providing a digital signature associated with the public key ROOT, on a transfer request that indicates the new token owners' public keys. In the above examples, the value ROOT may be disclosed along with SIGN_T2(PK,ROOT); in a subsequent block along with the disclosure of PK, or in a subsequent block in which ROOT is used to transfer the token T1 to another party.

Yet another alternative is creating T2 based on T1, which includes more than one signature and uses a multi-signature (MultiSig) schema to require M out of N signature, at least one of which is quantum secure. When trusting quantum-vulnerable signatures the stakeholders will use the traditional signature, while when the network decides to switch to quantum secure mode then only accepts the quantum secure signature.

In a variant of the above token quantum enrolment technique, the token T1 is to be transferred to a new owner Owner2 from a current owner Owner1. This can be achieved by Owner1 first converting the token T1 to a quantum-secure instantiation of T1 (we may refer to this expression of the token as T1′) and then to use existing transfer mechanisms to transfer at least a portion of T1′ to Owner2. Alternatively, if ROOT is a public key belonging to Owner2, the conversion and the transfer can be performed at the same time, simply by converting T1 to T1′ using the value ROOT for which Owner2 knows the underlying private key, but Owner1 does not. Since PK is needed to complete the transfer of T1′, it can either be posted on the blockchain after the signature has been recorded (i.e., in a subsequent block); or conveyed to the new owner Owner2 for Owner2 to release it as he spends the token using ROOT.

It should be noted that the above methods enable the transfer of non-quantum-secure tokens, such as those associated with an ECDSA signature, to a new type of representation that is quantum secure, such as a Merkle or Lamport based representation of the same token. This transfer, as explained herein, is quantum-secure in spite of relying on a non-quantum secure key (namely PK), based on the fact that the token is directly associated with a hash (or other non-algebraic one-way function) of the value PK, and that the value PK is hidden from attackers until it no longer is associated with any value (i.e., after the token has been transferred, at which time, it is not a security vulnerability for the value PK to be known). However, it should also be noted that the token owner (say Owner1) transfers the token (T1) to a new owner (Owner2) without causing it to be associated with a Merkle/Lamport signature, but still being represented using an ECDSA signature. Still, using one of the above-disclosed transfer methods, this transfer remains quantum secure, in spite of the fact that the originating token representation is associated with an ECDSA signature, as is the resulting token representation. This may have benefits in some contexts where backwards compatibility (e.g., with legacy wallets) is of importance, but where the transfer needs to be protected against quantum attacks.

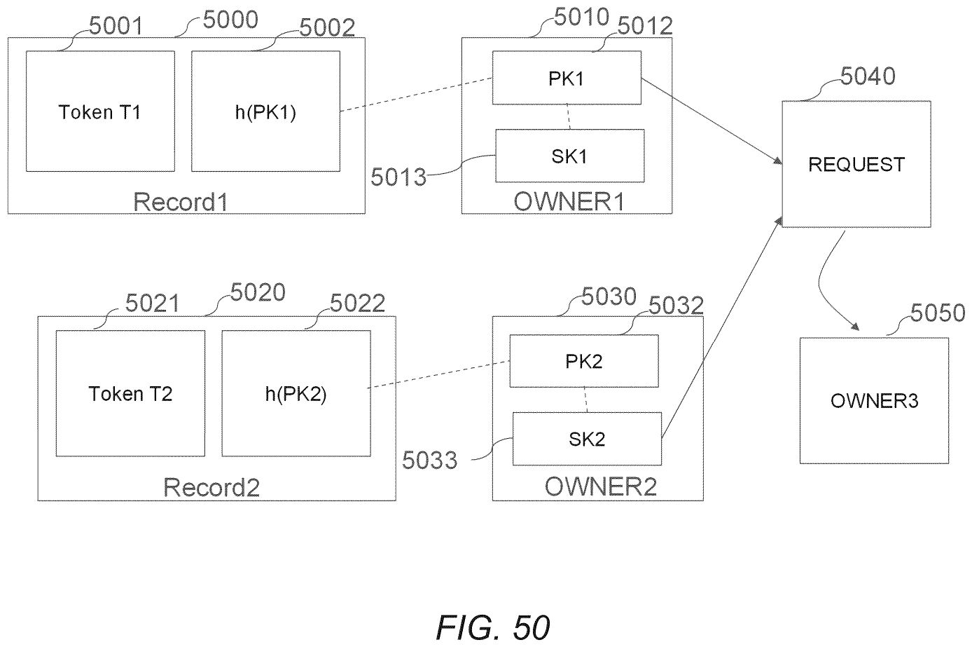

FIG. 50 illustrates a transfer of a first token T1 (5001) that has been associated with a first hashed public key h(PK1) 5002 in a first record, record1 (5000), that is associated with a first blockchain. T1 is to be transferred from a first owner OWNER1 (5010) to a third owner OWNER3 (5050) using a request REQUEST 5040 that causes, when recorded, the change of ownership, or parts thereof, of T1. To make the transfer, a helper token T2 (5021) is used. Token T2 (5021) is recorded on a second blockchain, in a record 5010, which may be the same as the first blockchain. REQUEST 5040 may specify a fraction of the token T1 to be transferred to OWNER3 (5050). OWNER3 may be the same as OWNER1. The third blockchain may be the same as the first and/or the second blockchain. OWNER1 is described here as a person but corresponds to a computational device that stores the first public key PK1 (5012) and associated first secret key SK1 (5013). For convenience, we will refer to devices as “knowing” things, and “owning” things, but this is merely shorthand for these devices having access to data and being controlled by users that manage such access. The signature scheme associated with PK1 (5012) and SK1 (5013) may be vulnerable to quantum attacks.

The helper token T2 (5021) is associated with second hashed public key h(PK2) 5022 that in turn is associated with a second public key PK2 (5032) that corresponds to the second secret key SK2 (5033), where both PK2 (5032) and SK2 (5033) belong to OWNER2 (5030). OWNER2 (5030) may be the same as OWNER1 (5010) and/or OWNER3 (5050).

It is assumed in this illustrative but non-limiting example that the signature scheme associated with the second public key PK2 (5032) and the second secret key SK2 (5033) is not vulnerable to quantum attacks.

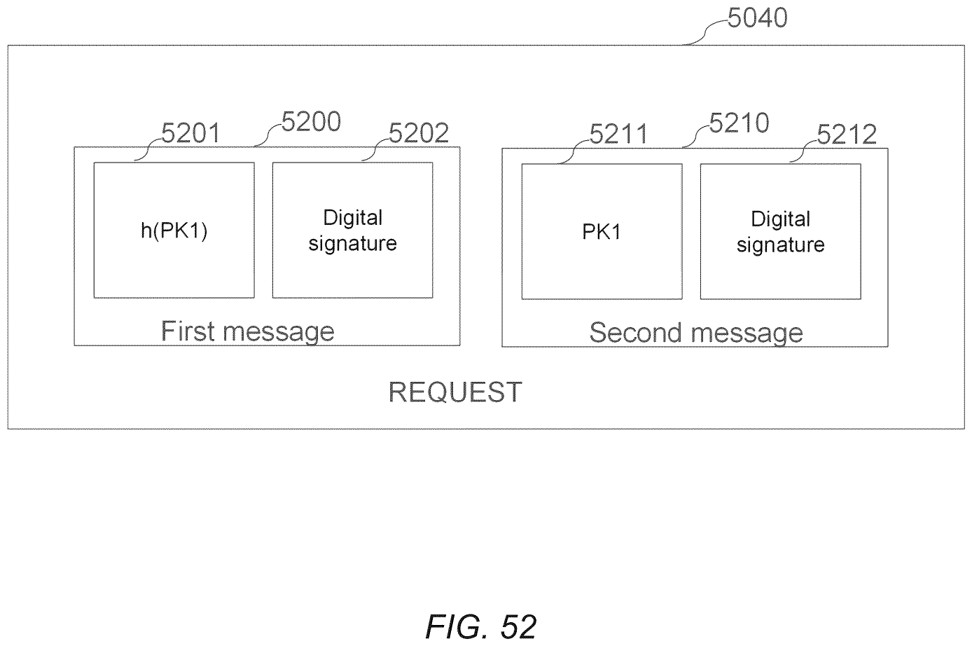

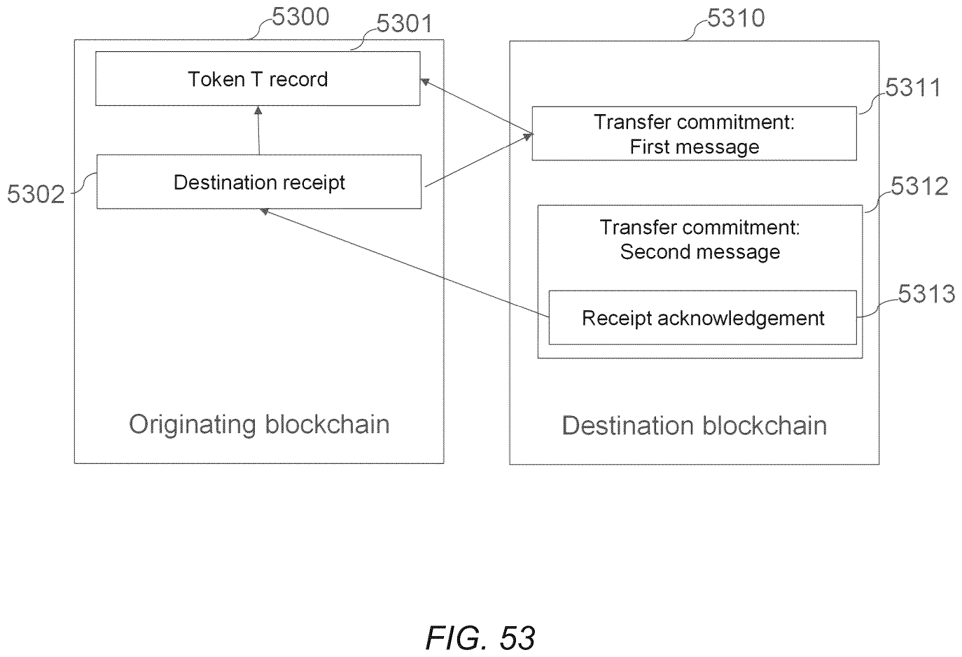

REQUEST 5040 corresponds to two messages (shown in FIG. 52), wherein the first message includes a digital signature using the second secret key SK2 (5033) on the first hashed public key h(PK1) 5002, and the second message includes at least one of the first public key PK1 (5012) and the first secret key SK1 (5013). In one embodiment, the second message is signed using the second secret key SK2 (5033).

The disclosure of the first public key PK1 (5012) and/or the first secret key SK1 (5013) proves that OWNER2 has access rights associated with the first token T1 (5001).

FIG. 52 shows REQUEST (5040) from FIG. 50. This includes the first message 5200 and the second message 5210. The first message 5200 is logged onto a second blockchain, as described for FIG. 50; after it has been logged (and potentially a small number of blocks have been added to the second blockchain, such as 5 blocks) the second message 5210 is logged.

As described in the explanation for FIG. 50, the disclosure of the first public key PK1 (5012) and/or the first secret key SK1 (5013) proves that OWNER2 has access rights associated with the first token T1 (5001). The use of the first message 5200 is used to commit to the first hashed public key h(PK1) 5002 without disclosing it, and the second message 5210 discloses the first public key PK1 (5012). It may alternatively disclose the associated first secret key SK1 (5013). Without the use of the two-phased logging, i.e., the logging first of the first message 5200 and then of the second message 5210, the scheme may be vulnerable to front-running attacks.

Front-running attacks can also be addressed by not disclosing the first public key PK1 (112) but instead to prove knowledge of it; however, such a proof must be quantum-secure to provide protection against front running in a situation where quantum attacks are reasonably fast to mount. If quantum attacks are slow to mount or very costly, then this may also provide heuristic security against front-running in a practical context.

FIG. 52 shows both the first message 5200 and the second message 5210 having digital signatures (5202 and 5212). These are verified using the same public key PK2 (132), thereby proving that it was the same entity, OWNER2 (130) that generated both the first message 5200 and the second message 5210; this can also be achieved by including a commitment in the first message 5200 and revealing the committed value in the second message 5210. A person of skill in the art will recognize that these are only two examples of methods to tie the first message 5200 and the second message 5210 to each other, and that there are many variants.

The example in FIG. 50 describes the use of a first blockchain (“originating blockchain”) for the logging of the token T1, a second blockchain for the logging of the helper token (“controlling blockchain”) and a third blockchain for the destination of the token T1 (destination blockchain). The traditional transaction approach avoids blockchain interaction, and movements between chains are handled using trusted parties, such as bridges, which burn tokens from originating blockchains as they mint the same token on destination blockchains.

The instant invention enables what we refer to as virtual bridging, or trustless bridging. This is a form of chain interaction that does not rely on trust, and which can be initiated by anybody with access to the associated blockchains.

In one embodiment, any party wishing to determine the ownership of a token on a first chain (which in this example will correspond to the originating blockchain) needs to verify requests on any blockchain that has been registered as a controlling blockchain for the first chain. In some instances, where operations to the first blockchain have been locked, the controlling blockchain(s) of the first blockchain needs to be checked, but the first blockchain does not. Such a situation may arise due to the use of a non-quantum secure signature scheme for tokens on the first chain, in a world where quantum attacks are an active threat. The controlling blockchain(s) will include any transfer requests for the locked first blockchain. To the extent that the destination blockchain is not the same as the controlling blockchain, and the destination blockchain is not locked, the destination blockchain has to be checked next, to determine whether the token of interest has been transferred within the destination blockchain after having been transferred, using a helper token on the controlling blockchain, to the destination blockchain.

In cases where the originating blockchain is not locked, this may be checked first, followed by the controlling blockchain, and then, optional on having been transferred to a destination blockchain other than the origination blockchain and the controlling blockchain, then the destination blockchain is also checked.

In another embodiment, there is no pre-defined controlling blockchain, but any blockchain can include a request in which a helper token is used to request the transfer a given token (such as T1) to a destination blockchain (which may or may not be the same as the originating blockchain and/or the blockchain on which the request is logged).

To address this, a token transfer is broken down into multiple steps:
Transfer out. A helper token is used to generate a transfer request to a destination blockchain. This is done by registering the request on the blockchain associated with the helper token, which we will refer to here as the “helper blockchain.” We note that this is not a static or semi-static designation, as the “controlling blockchain” is, but simply depends on where the helper token resides.
In response to the successful logging of the request on the helper blockchain, a commitment to a transfer is made on the destination blockchain. This may correspond to the first message described in FIG. 52.
When the first message has been logged, a reference to it is generated, indicating the blockchain it is written on, and the location. We refer to this as the destination receipt.
Then, the destination receipt (or a reference thereto) is written on the originating blockchain, in an entry that also includes a reference to the token T1 to be transferred from the originating blockchain. Optionally, this entry also includes a reference to the location of the request on the helper blockchain.
Once the destination receipt is logged onto the originating blockchain, its location is obtained. We call this location the location of the “receipt acknowledgement.”
The location of the receipt acknowledgement is written on the destination blockchain, preferably as part of the second message described in FIG. 52. The receipt acknowledgement may include a reference to the token that was transferred.

A party wishing to determine the ownership of the token may search either of the three chains, and will, in doing so, find the destination receipt and the receipt acknowledgement. Having this information enables the verifier to determine that the token was properly transferred from the origination blockchain to the destination blockchain; doing this will provide the verifier with the determination that the token no longer lives on the origination blockchain, but instead on the destination blockchain. This does not require any trust in the party that performs the transfer, as failure to execute the steps above will render the transfer request invalid, and therefore, it is not possible to clone or erase tokens, and it will always be possible to follow the transfer path. We note that this can be applied independently of whether the goal is to protect against quantum attacks.

A skilled artisan will recognize that this handshake method, in which a destination receipt and a receipt acknowledgement are logged, is not only possible in the context of helper tokens, but that an analogous technique can be applied to other transfer mechanisms, such as those disclosed herein.

As yet one more example of an alternative way of converting a quantum-vulnerable asset to a quantum secure asset, Owner1 can transfer T1 to a new owner by using the hash of PK along with PK as it would use an already registered hash value and its preimage in the generation of a CR signature, as disclosed in co-pending provisional application 63/687,205, titled “Secure and efficient Quantum-resistant digital signing method for blockchains” by Keir Finlow-Bates and Markus Jakobsson, henceforth Finlow-Bates and Jakobsson, which is incorporated by reference in its entirety. Thus, PK takes the role of x1 in the generation of the records R1 and R2. Analogous transfers can be performed using the time-based CAR signature disclosed in “Recourse and Quantum Security Integration Framework” by Markus Jakobsson, Hossein Siadati, and Keir Finlow-Bates. This example is analogous to using a token T2 to transfer ownership of a token T1, as described above, but wherein the token T2 is no longer required. A skilled artisan will recognize that there are benefits associated with using T2, i.e., it streamlines the payment of gas fees; but that there are also benefits associated with eliminating the reliance on a second token T2.

In yet another example embodiment, a first token T1 (which may be quantum vulnerable) is transferred to become the property of another token (such as T3), where the transfer may be mediated using a token T2, as described above, or where another transfer technique, as disclosed elsewhere herein, is used for the transfer. The recipient of T1, namely T3, may be specified either using a smart contract address or using a public key (whether a quantum-vulnerable ECDSA public key or a quantum-secure public key such as Merkle/Lamport key); it can also be transferred to be associated with a hashed value, as disclosed in “Recourse and Quantum Security Integration Framework” by Markus Jakobsson, Hossein Siadati, and Keir Finlow-Bates.

In co-pending application titled “Directed Acyclic Token Structure” by Markus Jakobsson, it was disclosed structures for tokens owning tokens; this is hereby incorporated by reference in its entirety. One way of thinking of tokens owning tokens is as a form of wrapping of (the owned) tokens. Once a token is in a wrap, it can be transacted, in full or in part, by trading the token that wraps it (or parts thereof). Thus, this can be used to wrap a quantum-vulnerable token in a non-quantum vulnerable wrap, thereby transferring the stronger security properties of the wrapping token to the token being wrapped.

In some of the above examples, the value PK is revealed as a result of the proof, which means that it cannot be reused; in some other of the examples, the value is not revealed, but only proven knowledge of; in these latter cases, it is possible to reuse it. Here, reusing corresponds to keeping some value associated with PK, to be transferred later on, whereas not reusing corresponds to moving all the value to one or more different recipients, said recipients being represented either by a smart contract address or by a public key.

A skilled artisan will recognize that the methods and example embodiments disclosed herein, and in the material incorporated by reference, and their various combinations, address a range of related problems, and have benefits beyond those detailed herein. Such benefits include, in general, improved security, improved flexibility, and lowered costs of managing access and transfers.

In an example, presented for illustrative purposes only, and not meant to be limiting in any way, assets currently owned by an Ethereum address E1 (or an address for an EVM-compatible blockchain) may be transferred to a quantum-secure address as disclosed in Finlow-Bates and Jakobsson, provided the Ethereum address E1 has not been used in a standard ECDSA-authorized transaction. If the Ethereum address E1 has not been used in a standard ECDSA-authorized transaction, the public key PK1 from which it was derived has not been revealed on the blockchain. Those skilled in the art will recall that an Ethereum address includes the last 160 bits of a Keccak-256 hash of an ECDSA public key.

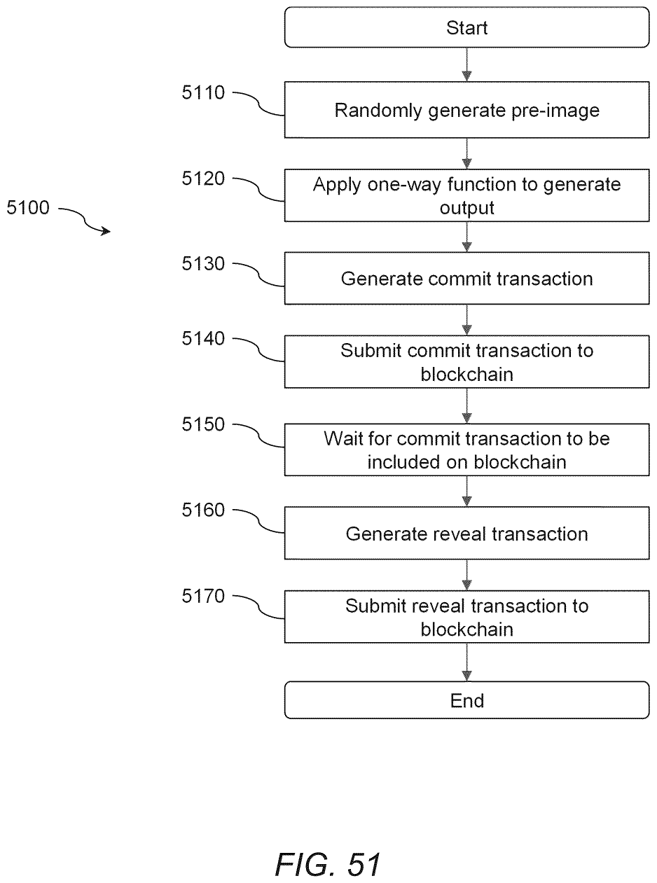

In reference to FIG. 51 of Finlow-Bates and Jakobsson, actions may commence with the pre-image selected as the public key PK1 of the Ethereum address currently owning digital assets non-securely, as shown in step S110.

Actions may then proceed to step S120, in which the one-way function is defined as Trunc-160(Keccack-256(X)), where Trunc-160( ) denotes discarding the first 96 bytes of the input, and the output O1 is Trunc-160(Keccack-256(E1)).

Actions may then proceed to step S130, in which a commit transaction C1 including an action A indicating all assets currently assigned to E1 are to be assigned to a new quantum-secure address Q1, and hash of a combination of A, O1, and optionally Q1, is generated.

Actions may then proceed to step S140, in which the commit transaction C1 is published on the blockchain.

Further actions then continue as described in Finlow-Bates and Jakobsson.

In a further example, presented for illustrative purposes only, and not meant to be limiting in any way, assets currently owned by a legacy Bitcoin address B1 (or an address for an Bitcoin-compatible blockchain) relying on a pay-to-public-key-hash (P2PKH) unspent transaction for ownership, may be transferred to a quantum-secure address as disclosed in Finlow-Bates and Jakobsson, provided the legacy address B1 has not been used in a standard ECDSA-authorized transaction. If the legacy Bitcoin address B1 has not been used in a standard ECDSA-authorized transaction, the public key PK2 from which it was derived has not been revealed on the blockchain. Those skilled in the art will recall that a legacy Bitcoin address is generated from a base58 encoding of a concatenation of a RIPE-160 hash of a SHA-256 hash of public ECDSA key concatenated with the first four bytes of a double SHA-256 hash of the Bitcoin network bytes 00 concatenated with the RIPE-160 hash of a SHA-256 hash of public ECDSA key. This derivation function functions as a cryptographic hash function; call it BLAGA (Bitcoin Legacy Address Generation Algorithm).

In reference to FIG. 51 of Finlow-Bates and Jakobsson, actions may commence with the pre-image selected as the public key PK2 of the legacy Bitcoin address currently owning bitcoin, as shown in step S110.

Actions may then proceed to step S120, in which the one-way function is defined as BLAGA( ) and the output O2 is BLAGA(PK2).

Actions may then proceed to step S130, in which a commit transaction C2 including an action A indicating all assets currently assigned to B1 are to be assigned to a new quantum-secure address Q2, and hash of a combination of A, O2, and optionally Q2, is generated.

Actions may then proceed to step S140, in which the commit transaction C2 is published on the blockchain.

Further actions then continue as described in Finlow-Bates and Jakobsson.

The above method may be used to securely transfer tokens to a legacy quantum-vulnerable blockchain address for later transfer to a quantum-secure blockchain address, provided the public key from which the legacy quantum-vulnerable blockchain address has not previously been disclosed. For example, a user may wish to transfer tokens or cryptocurrency to a legacy blockchain address of a friend or associate who may not have provided a quantum-secure address for the transfer. The user may verify that a known legacy blockchain address of the friend or associate does not have a revealed public key, and after verification may transfer the tokens or cryptocurrency to the legacy blockchain address. The friend or associate may then, at a later date, transfer the tokens or cryptocurrency to a new quantum-secure blockchain address using the method described above.

In the above, the discussion has been focused on fungible tokens. However, the very same principles apply to non-fungible tokens (NFTs). In the setting of NFT transfers, it is extra helpful to use a second token (such as T2) to transfer a first token (T1, which may be an NFT), since T2 can be used not only to process the transfer, but also to pay gas fees and other fees and taxes, as applicable.

FIG. 53 illustrates the handshake process for trustless bridging. The figure shows the origination blockchain 5300, and the destination blockchain 5310. The originating blockchain 5300 includes a token T record 5301, which may be a record in which T was minted or a record of ownership transfer of T, such as the second message 5210 or a traditional transfer request. There may be additional token T records in the origination blockchain 5300, but token T record 5301 is assumed to be the most recently added to the origination blockchain 5300. A party with ownership access rights to token T generates a transfer request for T (which may be formatted as request 5040) to be moved to a new owner (or the same owner) and logged on destination blockchain 5310. The transfer request includes a first message 5311 that may be formatted as first message 5200. First message 5311 references token T record 5301, as indicated with the arrow. After first message 5311 is logged on destination blockchain 5310, a destination receipt 5302 is submitted to originating blockchain 5300. Destination receipt 5302 references first message 5311, as indicated with the arrow, and optionally also references token T record 5301. A second message 5312 of the transfer commitment is submitted to destination blockchain 5310, where the second message 5312 may be formatted as second message 5210, and which includes receipt acknowledgment 5313 that references destination receipt 5302, as indicated with the arrow.

If token T is later to be transferred to yet another blockchain using trustless bridging, then the second message 5312 of the transfer commitment would correspond to the token T record 5301 for the new transfer, assuming the T has not been transferred already within destination blockchain 5310, in which case the most recent valid record of transfer would serve as the token T record 5301 for the new transfer.

It is interesting to note that the instant invention can also be used to convert any token based on an ECDSA signature to a token with another signature. We have disclosed ways to do this above, where the updated signature scheme is quantum secure, and described the reason for performing the conversion being to protect legacy tokens (i.e., ECDSA-based tokens) to quantum-protected tokens. The conversion could also be done to avoid verification of ECDSA signatures; if that is the motivation for conversion, the new signature scheme may be a traditional scheme such as DSA, RSA, etc. It is also possible to transfer legacy tokens (e.g., using a helper token, as disclosed herein) between a first owner and a second owner without having to verify ECDSA signatures, but maintaining a token structure that has ECDSA signature capabilities.

Identity Anchor with Watchful Processing, and Efficiency Enhancements

One weakness of current Blockchain technologies, as well as more generally, Internet technologies, is the absence of a trustworthy tie between actions and identity. Whereas Know Your Customer (KYC) and Anti-Money Laundry (AML) requirements specify how to process transactions based on identities of parties transacting and amounts transferred, neither identities nor amounts can be trusted with currently deployed technologies. First, identities can be artificially created, e.g., by performing what is commonly known as Sybil attacks, which in real world scenarios may take place by bribing DMV officials or passport issuing employees in a country with poor oversight. Second, and for that reason, amounts can also not be trusted, as a large amount can be transferred using a multiplicity of Sybil-identities of a given miscreant.

Another shortcoming of current Blockchain technologies relates to efficiency. The efficiency of a solution is vital to control in order to manage the operational overhead costs of the technology, which are typically expressed in terms of the gas fee. Therefore, efficiency improvements translate into reduced gas fees and a resulting wider applicability of blockchain technology for smaller-sized transactions.

Instead of accepting all forms of identification as equal, we describe how different levels of assurance can be expressed in certificates, where such certificates may be associated with or incorporated with anchors, such as anchored tokens. Anchored tokens and related structures were disclosed in co-pending applications, titled “Token Creation and Management Structure” by Markus Jakobsson and Stephen Gerber; “Characteristic Assignment to Identities with Tokens” by Stephen C. Gerber, Markus Jakobsson, Ajay Kapur and Mike Leisz; and “Biometric Authentication using Privacy-Protecting Tokens” by Markus Jakobsson and Stephen Gerber. An anchored token corresponds to what is also known as a soulbound token. Anchored tokens can be tied to a person or organization, making them an integral building block of KYC methods.

The anchor may be associated with one or more identity assertions. An identity assertion can be generated by a peer, e.g., a person vouching for the identity of a friend, family member or colleague, who may specify both an identity statement (e.g., “He goes by Robbie”), a relationship (e.g., “He is my son”), and one or more biometrics (such as photos of the person) and contextual information (such as a social media handle). An identity assertion can also be generated by an organization, such as an employer, a university, etc., where the identity may be tied to a role or an achievement, such as “employed here since 2022”, “graduated with a 3.7 GPA”, in addition to data such as name, birthday, social security number, photos, etc. Furthermore, identity assertions may be generated by official governmental institutions, such as the department of motor vehicles, a passport issuing agency, tax authorities, etc. Such assertions may include the type of identifying information accessible to these institutions. Some of the data in identity assertions may be encrypted in manners that only specified entities can decrypt them, where such entities may include trusted consumer organizations selected by the user about which the assertions are; the user herself; law enforcement etc.

Some identity assertions may cite other assertions, meaning that the cited assertions had been verified by the entity making the identity assertion.

An identity assertion is preferably associated with a digital certificate verifiable using a public key associated with the issuing entity. In some embodiments, the verification of identity assertions may be performed using an online query-response method, in which an issuing entity or representative thereof verifies that a given identity assertion is valid, optionally after performing one or more tests (such as biometric challenges, verification of knowledge-based authentication questions, etc.)

An identity assertion may be associated with a level, where the level may be associated with a scalar value or a vector value. A scalar value representation may be a value from 1-100, for example, where the number represents the level of verification of identity that the issuer has performed before generating the identity assurance. The level of verification may, for example, correspond to whether biometric measurements were taken, along with their type; whether previously issued identity documents and/or identity assertions were verified; whether the person presented herself to the issuer or the identity verification was done via the Internet, etc. The scalar value may also represent a level of trust that has been associated with the issuer, where this may reflect the internal controls performed on employees of the issue, such as whether periodic tests were performed and passed by the employees, including the one or more given employees involved in a given identity verification.

In a vector-based representation of the level, different aspects such as those described above are expressed in different array positions of the vector, thereby enabling a more detailed auditing of all the aspects underlying a given identity assertion.

An entity wishing to determine the identity of an entity (which we will call the verifier) may assign different weights to different issuers of identity assertions. An issuer believed to have been compromised may be associated with a weight 0; a somewhat trusted issuer with a weight 0.3; and a highly trusted issuer with the weight 1. Using these weights, the verifier computes the weighted assertion values by multiplying the weight with the identity assurance trust value. In the case where this value is a vector element, different vector positions may be adjusted with different weights, i.e., the weight is a matrix, with the result being a new vector, or more generally, a matrix. If a collection of identity assertions are relied on, the verifier may compute one weighted value for each such identity assertion, and then generate a cumulative weighted value that combines the different weighted trust values according to some formula; one such formula is to take the maximum of the input values; another is to assign a higher cumulative trust value when there are multiple inputs that are all consistent, with high trust values from each one of these-thus, the resulting trust value may be higher than the maximum of the individual trust values. The weights may depend not only on the issuing authority of the identity assertion, but may also depend on the type of token transfer that is being considered. For example, one issuer may have a high trust value when it comes to identity verification in general, but it may be known that there is a problem with money laundering in the jurisdiction of this issuer, and that the money launderers at times have coerced the issuers. However, there may be no indication that other types of attackers have managed to coerce issuers; thus, the context of the verification (e.g., what is being transferred, and to whom) may also affect the weight applied.

A jurisdiction may assign different weights to different issuers of identity assurance, where such weights would be applied to the trust level values as described above. For example, the jurisdiction may assign a low weight to any issuer believed to be controlled or influenced by a hostile jurisdiction.

Different jurisdictions may have different policies. One jurisdiction may have a policy stating that to transfer a token corresponding to an amount exceeding a threshold value (say $10,000) between two entities, wherein the transfer crosses in to or out from the jurisdiction in question, one or more of the entities need to have identity assertions with a minimum certificate level. Another jurisdiction may limit the value flowing out from a set of members of the jurisdiction during any period of time, e.g., to control capital flight, but may exempt members of some classifications, where the classification may depend on the trust value associated with the member.

Policies can also be applied to collections of users that can be considered subscribers. For example, subscribers may request to limit any transfers out of tokens that exceed a given value, without an authentication escalation, with the potential exception of transfers to entities that the subscriber has whitelisted.

Subscribers may also request policies to be put in place that limit certain transfers to them, e.g., of value below a specified amount. Such “dust” payments are sometimes used in an abusive manner to attempt to track users or payments, and it is desirable for users to control how these are made. For a similar reason, some subscribers may request that only whitelisted parties may transfer tokens to them, where the subscriber may whitelist some parties for one transaction only; for a specified-size transaction only; for a minimum or maximum transaction only; for a transaction of a specified token type only. At the same time, it may whitelist other parties for multiple transactions, or for other types of constraints. Some policies may cause the blocking of non-compliant transactions.

Others may cause the additional actions, such as generation of escrow data to document the transaction. Escrow technology was disclosed in co-pending application titled “Blockchain enhancement technologies with applications to commerce” by Keir Finlow-Bates and Markus Jakobsson, and is incorporated by reference in its entirety. Alternatively, such policies may initiate a verification whether a compliant escrow record has been generated, and block the transaction request if that requirement is not satisfied.

Yet other policies may cause identity verification escalation, e.g., if the trust value of the identity assertion of the parties of the transaction is below a certain threshold, or there is no identity assertion at all. Such transfers may cause the transferred tokens to be held in an escrow account associated with the jurisdiction (or more generally, the verifier) until a positive verification of identity has been performed, or other remedial actions (such as payment of taxes) have been taken.

A policy can be implemented by triggering an action taken by a watchful entity associated with the verifier. The watchful entity may, in some embodiments, include the verifier. Watchful processing was disclosed in co-pending application titled “Using Watchful Bridging for Blockchain Fraud Prevention” by Markus Jakobsson, Stefan Dufva, Keir Finlow-Bates and Guy Stewart; and in “Token Abuse Protection” by Markus Jakobsson and Keir Finlow-Bates, which are both incorporated by reference in their entirety.

Another manner of implementing a policy is to block the transfer of tokens at bottleneck points, such as exchanges, if these tokens have a transfer history that is non-compliant with the policies during the time that the policies were applied. This severely damages the value of such tokens, which will make potential recipients of the token wish to determine that the token will not be accepted by the specified bottleneck points. Service providers can make available blocklists of tokens that will be negatively affected by bottleneck points. Bottleneck points may, in one embodiment, refuse the transfer of tokens that have a blemished transfer history in light of one or more policies. The bottlenecks may also cause such tokens to be confiscated, burned, or held in escrow until appropriate sales taxes or royalties are paid. A bottleneck may also take a portion (such as a value computed from an overdue sales tax) of a fungible token violating a specified policy (such as a sales tax policy) and divert this portion to a third party, such as a tax authority. The bottleneck points may further reassign ownership in cases where it has been determined that the token was stolen, thereby refunding a victim of a phishing attack, a ransomware attack, etc.

Bottleneck points may implement watchful mechanisms, and watchful entities may act as bottleneck points.

Transactions and transaction requests can be considered in isolation, but may also be considered in the context of a graph of nodes, said nodes being entities having sent, received, mined or minted tokens, where a node may be associated with one or more jurisdictions, one or more identity anchors, each identity anchor being associated with one or more identity assertions and associated certificates and other data, as described above.

By considering flows of token across the network, a policing entity may determine, whether in real-time or retrospectively, that one or more transfers are likely to correspond to an unwanted or illegal activity, such as money laundering. It is possible for this policing entity to blacklist associated entities, request identity information from associated escrow entities and/or identity assertion issuers, to penalize unwanted behavior among identity assertion issuers by modifying their associated trust weight, place selected tokens on blocklists with bottleneck points and/or watchful entities, thereby initiating recourse actions.

The policing authority may also attempt to identify criminals behind heists and cause their identity anchors to be blocklisted or otherwise tagged for special action such as elevated tracking requirements or mandated tracking at cash-out points such as compliant ATMs and banks.

In one embodiment, machine learning processing and/or an AI are used for detection of suspect transactions and/or entities performing transactions, so that these associated transactions can be blocked, reversed, modified, held, result in escalations of identification requirements, etc.; or that the associated entities and entities associated with them can be flagged for additional scrutiny, blocklisted, investigated, etc.

In a large, distributed system, it is likely that some parties on whom the security of the system rests will be less honest than others. This may be due to the creation of criminal entities, such as a certificate authority created for the sole purpose of circumventing detection of abuse; it may due to take-overs of honest entities (e.g., using malware attacks, insider attacks, system intrusions, etc.); or it may be due to clerical errors or identity verification relying on spoofable documents. These different types of abuse can be detected using anomaly detection methods in which (a) potential abuse is detected, (b) a score is assigned to the potential abuse, indicating the assessed likelihood that the potential abuse is correctly classified, and (c) a determination of patterns in the classifications of abuse, weighed using the assessed likelihoods. This way, entities associated with abuse can be identified, e.g., by comparison of their rate of anomalies as a fraction of actions that are not believed to be anomalies. This will allow the detection of abusive certifiers of identities. By recording the type of identification processes that were relied on, including the type of identity document the certifying entity scrutinized, anomaly detection is also applied to collections of certifications, such collections generated by clustering based on the identification process, the underlying document type, and the source of such documents. Thus, if an honest certifier facilitated abuse by certifying identities that were proved, for example, using a passport from a given time interval from a given country, then this enables the detection of a weakness associated with passports of that interval and country. In one embodiment, the clustering and anomaly detection is performed using machine learning techniques trained on real and/or synthetic datasets. Once an entity (e.g., certifying entity, identity document issuer, etc.) is identified as potentially compromised, it is assigned a risk score indicating the degree of risk, which may be assessed based on the prevalence of abuse. This risk score can then be used to generate a weight associated with this entity, said risk score being used to determine the trustworthiness of one or more identity assertions related to a record such as an anchor token or other database entry tied to one or more identities. These techniques may be combined with the jurisdictional weighing described above, but could also be used to inform what jurisdictions result in higher abuse risks.

We refer to the implementation of an anchor as being either physical (i.e., having a physical embodiment) or logical (i.e., being information based). An example of a physical anchor is a token used for identification purposes, the token carried by a user, and representing the user by means of biometrics, knowledge-based authentication, possession, or other related means. An example of a logical anchor is one without a physical embodiment, e.g., represented by an entry on a blockchain or other database. Some anchors may satisfy both of these classifications in that they have some physical embodiment but do not rely on this, whether all the time, or for all functionality and use.

One example of a token that is used as a physical anchor is an e-passport or related technology, where an identity document has a capability of digital storage and processing, and for which some form of communication is enabled, and where the token can be used to assert identity in a variety of settings, whether physical settings (like passing a border control or proving identity ahead of a flight) or logical settings (e.g., facilitating age-gating of the owner, populating anchor tokens with data and references, or in an authentication escalation to prove that the user is a human, or a specific human.)

One example of a logical token is a non-fungible token stored on a blockchain and used for purposes of reporting transactions (whether the report is in clear text or encrypted, e.g., using an escrow authority). This may be required for some transactions. The certification level may affect the cost of transactions and insurance.

Thus, we see that physical anchors may utilize or be expressed using physical tokens (smart watches, phones, e-passports, etc.), and logical anchors may utilize or be expressed as database entries including blockchain entries, and may include certified identity data used in online identity proofs, whether of identity, age or other predicates, such as nationality, access rights, etc. These expressions on anchors can work across physical/logical borders. For example, a physical token is not limited to transactions in physical scenarios but may also be used as a starting point for making identity assertions of a logical nature, e.g., online. At the same time, logical anchors are not condemned to an online world only, but also find uses in physical settings. For example, the location of a blockchain hosted anchor token may be encoded in a QR code added to a physical identification document, such as a driver's license, where information about its location can be scanned and used to access the blockchain record including the anchor token; the anchor token, in turn, may include encrypted or otherwise encoded biometric template data used by a fingerprint or face feature scanner to verify the identity of the user, adding certainty of identity beyond just comparing the face of the user to the photo on the driver's license.

We refer to an anchor that has both a physical and a logical anchor representation as a “dual” anchor. The physical and the logical anchors do not have to be identical to each other. In one embodiment, a logical anchor may have a later expiration date than the physical anchor, while the physical anchor may confer greater access rights than the logical anchor. The validity of the physical anchor may depend on the validity of the logical anchor, which may be revoked, e.g., by burning a token representing the logical anchor, or by otherwise rendering it inoperable, flagged, or limited in some aspect. Examples of such aspects may be a limitation of the venues where it may be used, the purposes for which it can be used and/or the types of identity proofs that are required to link the anchor to a physical person, etc. Likewise, the verification of a logical anchor may depend on either the verification of a physical anchor, or a more arduous form of verification should the physical anchor not be available. A physical anchor may correspond to a multiplicity of associated logical anchors, where some of these may represent the same entity to which it is anchored whereas some of them may represent different such entities. A logical anchor may correspond to a multiplicity of physical anchors, where some of these may represent the same entity to which it is anchored whereas some of them may represent different such entities.

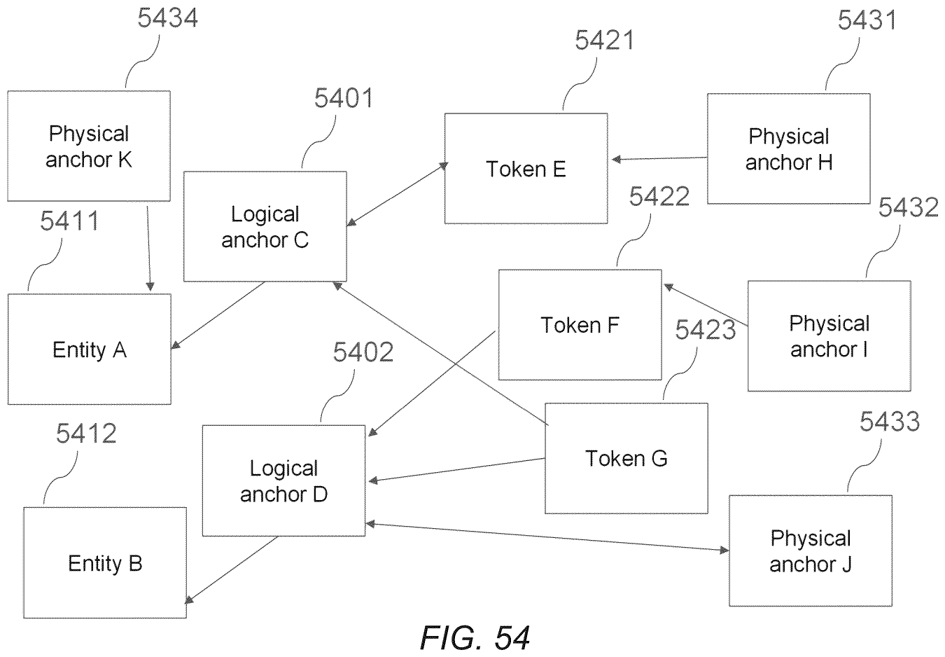

FIG. 54 illustrates a possible relationship between anchors, tokens, and entities. An anchor may be part of a token referring to an entity, or may be another non-token reference to an entity. The entity may be a company or a person. A logical token corresponds to data stored in one or more databases or common storage media. A physical token may, for example, be an identity card, a chip embedded under the skin of a user, an e-passport, a smart watch, or a dongle on a keychain. A token may be a crypto fund token, such as an Ethereum coin, or an NFT. Connections are shown between associated elements. Some of the connections shown are one-way, and others are two-way. A one-way connection is a reference from one element to another, whereas a two-way connection corresponds to a mutual reference. All of the connections shown could be one-way or two-way. Entity A 5411 may be a person, which is referenced by logical anchor C 5401 and/or physical anchor K 5434. Logical anchor C 5401 may include biometric data associated with entity A 5411, such as a biometric template and/or salted and hashed passwords or seed phrases known by entity A 5411. Entity B 5412 may be a corporation with multiple officers, where logical anchor D 5402 corresponds to biometric templates of one or more of these officers. Token E 5421 may be an NFT tied to the entity which is represented by logical anchor C 5401. Physical anchor H 5431 may be a physical representation of a data referencing token E 5421, where physical anchor H 5431 may be a smart watch that has ownership rights or access rights to token E 5421, where access rights may correspond to capabilities to open a door to an office, or log in to a computer. Token F 5422 may be associated with logical anchor D 5402, and with physical anchor I 5432, where the latter may be a chip implanted under the skin on a user, and used for access control to a medical application such as the dosage of insulin from an attached insulin dispenser. Token F 5422 may control what doses of insulin are given, and may have the right to request metrics from the processor of physical anchor I 5432. Token G 5423 may correspond to both logical anchor C 5401 and logical anchor D 5402. Physical anchor J 5433, which may be an e-passport of a user, may correspond to logical anchor D 5402, allowing the holder of physical anchor J 5433 to access specified resources that logical anchor D 5402 has rights to access. An access control table may be stored with/in logical token D 5402, physical anchor J 5433, or a database reachable by either of these elements, e.g., using a network connection such as an Internet connection, a Bluetooth connection, etc. This is merely an illustrative and non-limiting example of the types of associations between elements of the disclosed types that are disclosed herein. In one embodiment, only some of these example elements are present, and in another embodiment, different variations are instead used. For example, in an implementation in which tokens own tokens, as disclosed in co-pending application titled “NFTs that own assets” by Keir Finlow-Bates, there may be a hierarchy of tokens instead of, for example, token E 5421. In this case, token E 5421 may own a collection of tokens (not shown in the figure), e.g., using a smart contract with token-specific address to which the owned tokens are assigned.

A jurisdiction may determine that it only allows transfers of tokens for which both sender and receiver are associated with an identity anchor. A legacy token is a token for which the owner is not associated with an identity anchor. To enroll such tokens, a range of alternative approaches can be utilized. Such approaches include but are not limited to:
Permitting select entities that have an identity anchor to act as recipients for tokens whose pre-transfer ownership corresponds to entities that are not associated with identity anchors. Such entities can be tagged by a specific predicate in their identity tag, and/or a certificate indicating the right to receive token transfers from non-anchored senders. Such a right may optionally be associated with a policy that could be specific to an individual token recipient, and may include an annual maximal amount (count or value) of tokens to be transferred under these special conditions; only tokens of specified types, specified ages, or tokens that are not associated with a transfer history that includes any blocklisted entity.
Permitting select types of purchases using such tokens, e.g., tokens from non-anchored entities may only be exchanged for tokens that have been anchored to some entity or who otherwise satisfy some policy that may be specific to the type of token to be received or sent during the transaction.
Legacy tokens can become enrolled by adding an anchor to the entity that owns the token.
Legacy tokens can only be used for specific types of transactions. For example, a list of transaction types deemed by some trusted entity to be associated with a high risk of being associated with money laundering may not be allowed to perform using a legacy token. For example, in some settings, a legacy token may not be moved through a mix net, but may be allowed to be used to pay for some types of services and/or goods, such as the purchase of a car or real estate, payment to a non-profit organization or governmental organization, payment for gas fees, or payment of taxes including sales taxes.
Permitting transfers only if escrow records are generated that identify the transfer and information about at least of the sender and the recipient.
Permitting exchange for some other type of token, such as a quantum-resistant token, where the recipient is the same as the sender, and where there is no identity anchor registered, but the new invocation of the token (such as a quantum-resistant instantiation) will remain limited in terms of how it can be transferred, as it is still considered a legacy token without an identity anchor. A variety of quantum-resistant approaches for representing of and recording of tokens are disclosed in co-pending application titled “Blockchain Enhancement Technology with Applications to Quantum Security” by Markus Jakobsson, Keir Finlow-Bates, and Hossein Siadati, which is incorporated by reference in its entirety herein. It is possible for an entity to prove that the transfer only changes the property or expression of the token and does not change the ownership or other access rights. That can be done, in part, by including or associating proofs of knowledge of the sender's public key being related to the recipient's public key, including being the same; it can also be done by assertions made by DRM compliant devices (such as wallets), or by hosted wallet services, where these can generate assertions indicating that it is the same access credentials that are used for both the pre-transfer and the post-transfer token.

These example approaches can also be combined with each other, as will be appreciated by those skilled in the art. It also does not matter in what way the identity anchor is expressed, e.g., as a predicate associated directly with a token; as a predicate associated with a wallet (whether physical or hosted); as a predicate referenced in or implemented using a smart contract; or by encrypted identity proofs stored by escrow servers. Relevant escrow methods and other relevant technologies are disclosed in co-pending application titled “Using KYC, Escrow, Tracking, Risk Scoring and Recourse to Secure Transactions” by Markus Jakobsson and Keir Finlow-Bates, which is incorporated by reference in its entirety.

Tokens that are not in compliance (e.g., legacy tokens) may be required to take actions to make them compliant within a specified time period, or a fee is imposed on any future transaction as a penalty for non-compliance. This fee may be a fixed-size fee per transfer, a form of transfer tax that corresponds to a specified portion of the transfer of fungible tokens, or a fee paid using another token, where the size of this fee may be based on an estimate of the value of the legacy token. The post-transfer token may still be considered a legacy token (unless it becomes associated with an identity anchor as a result of being transferred), and therefore, such fees may remain associated with it.

If a user circumvents such compliance approaches and/or payment of fees, a jurisdiction may tag the token, requiring a fee to be paid at a future time in order for the tagging to be removed. The number of transfers performed while the token is tagged may influence the size of the fee, e.g., creating an ever-growing incentive to register legacy tokens.

Insurance related to token transfers has been disclosed in co-pending applications titled “Token Insurance Technique” by Keir Finlow-Bates and Markus Jakobsson; “Improved Token and Resource Management” by Markus Jakobsson and Keir Finlow-Bates; “System, Method and Apparatus for Publicly Verifiable Asset Linkage” by Markus Jakobsson and Keir Finlow-Bates; “Trustee-Monitored Wallet Transactions” by Markus Jakobsson and Keir Finlow-Bates; and “Non-Fungible Tokens Requiring Tracking of Physical Entities” by Markus Jakobsson. These are incorporated by reference in their entirety. In one embodiment, the benefits of such technologies may be contingent on a token having a specified compliance status, such as being possessed by an entity associated with an identity anchor, or an identity anchor with a minimum specified assurance level. The benefits referred to may relate to the premium or deductible of the insurance, or requirements to perform proofs or logging with escrow authorities, or which may cause the triggering of alerts or other notifications to authorities.

Quantum secure signing methods have been disclosed in co-pending applications 63/881,040 titled “Blockchain enhancements with applications to quantum security” by Markus Jakobsson, Keir Finlow-Bates, and Hossein Siadati, filed on 12 Sep. 2025, and 63/687,205 titled “Secure and Efficient Quantum-Resistant Digital Signing Method for Blockchains”, by Keir Finlow-Bates and Markus Jakobsson, filed on 26 Aug. 2024. A commit/reveal approach for transactions, in which assets are registered against a hash digest of a secret preimage, or a blockchain address derived from the hash digest, and authorization to move the assets requires a reveal of the preimage of the hash digest was previously disclosed. Although remarkably effective in securing asset ownership and blockchain transactions, further improvements to the methods are now disclosed.

When a commit/reveal approach to transactions is used to move assets registered against a currently active element of a hash chain, any digital assets registered to the current tip of the hash chain may need to be re-registered against a prior element of the hash chain or a new hash from a new hash chain to ensure control of the digital assets is maintained through a new secret preimage after the preimage is revealed. If this is not done, other parties may transfer the digital assets remaining through re-use of the preimage uncovered as part of the reveal.

One solution, hereby disclosed, to prevent accidental loss of digital assets not moved during a commit/reveal transfer, is to register assets against an identifier and to store the current active hash chain element in a record referenced by the identifier. Ownership and authorization are thus separated.

This offers significant benefits to owners of digital assets with accounts secured through the aforementioned commit/reveal signature scheme, and indeed other signature schemes, including, for example, the Bitcoin unspent transaction output (UTXO) model and even the Ethereum balance account model. All aforementioned methods conflate identity and authorization. In the case of Bitcoin the approach is to fragment identity into multiple wallet addresses, each of which provides authorization to move assets registered again it, resulting in a requirement to manage many addresses and many corresponding private keys, and inflating the number of records required on the Bitcoin blockchain, as each UTXO must be tracked. In the case of Ethereum, recording multiple balances of multiple digital assets against a single address requires careful tracking of said assets removes the requirement to track UTXOs and hence reduces the number of records, but it runs the risk of a user discarding an address and its corresponding private key while assets remain registered against it. This is particularly problematic if the user is reusing the same address/private key pair on multiple Ethereum-compatible blockchains, and carries a further risk, namely that after one transaction a public ECDSA key, that is not quantum-secure, is revealed, thus putting all other assets registered against the address at risk of a quantum computer attack. In the method presented below, records of ownership are made against an arbitrary unique identifier, example identifiers including a public key, a smart contract identifier, an account identifier, a token identifier, a quantum-secure recipient address, a randomly selected number, a universally unique identifier, an internet protocol address, a media access control address, a unique string such as a name and address, an anchor token identifier, and more. This removes the requirement to track multiple UTXOs or other forms of identity plus authorization mechanisms, thus reducing the effort required by blockchain wallet software to track user assets and the space required by blockchain nodes to store records of balances in a fragmented manner, while securing said balances in a quantum secure manner.

In an embodiment, a plurality of digital assets, instantiated by one or more smart contracts or through a native protocol of a blockchain, may initially be registered against a first identifier identifying an owner of the plurality of digital assets. A current element of a sequence of elements of a hash chain may be stored in a mapping from the first identifier to the current element of the hash chain. Control over the plurality of digital assets is then established through knowledge of a secret preimage for the current element, namely the element prior to the current element of the hash chain.

An owner of the first identifier may decide to transfer one or more of the plurality of digital assets to a second identifier. The owner may submit a commit transaction to the blockchain, as, for example but not limited to, described in co-pending applications 63/881,040 and 63/687,205. The owner may then subsequently submit a reveal transaction that reveals the secret preimage to the current element of the hash chain, thus finalizing or settling the transfer of the one or more of the plurality of digital assets to the second identifier.

The generation of subsequent hash chain preimages was disclosed in M. Jakobsson, “Fractal hash sequence representation and traversal,” Proceedings IEEE International Symposium on Information Theory, Lausanne, Switzerland, 2002. A more generalized approach, applicable to trees, was disclosed in the article “Fractal Merkle Tree Representation and Traversal” by M. Jakobsson, T Leighton, S. Micali, and M. Szydlo, published on wwwrsasecurity.com. Merkle trees were disclosed in the article “A Digital Signature Based on a Conventional Encryption Function,” R. Merkle, Proceedings of Crypto '87, pp. 369-378. These three published articles are incorporated herein by reference.

The reveal transaction may include an instruction to change the mapping from the first identifier to the current element of the hash chain to a mapping from the first identifier to a new hash, which in some embodiments may include the secret preimage and/or the element prior to the current element of the hash chain. In some embodiments, after the commit/reveal transaction has completed, the current element of the hash chain may be removed, and the element prior to the current element may become the current element.

The commit transaction may include a hash of the instruction subsequently revealed in the reveal transaction, and the instruction may include one or more of the current element and the element prior to the current element.

A smart contract on the blockchain responsible for instantiating digital assets and recording ownership of said digital assets may use identifiers, for example, the first identifier and/or the second identifier, to record ownership of the digital assets. The smart contract may reassign ownership of a digital asset from a first owner, indicated by, for example but not limited to, the first identifier, to a second owner, indicated by, for example but not limited to, the second identifier, on successful completion of a commit/reveal transaction, wherein the reveal includes the preimage of the hash registered against the first identifier. The instruction may include the first identifier and/or the second identifier.

In some embodiments, the mapping of identifiers to current hashes may be recorded in a smart contract, henceforth an ownership registering smart contract. The ownership registering smart contract may only change a mapping from an identifier to an initial hash to a mapping from the identifier to a new hash on successful completion of a commit/reveal transaction referencing the identifier, the initial hash, with the commit/reveal transaction providing a preimage to the initial hash. The smart contract responsible for instantiating digital assets may refer to the mapping of identifiers as part of a method for validating commit/reveal transactions.

In some embodiments, identifiers such as the first identifier and the second identifier may include anchor tokens, as disclosed in U.S. Provisional Patent Application No. 63/213,251, titled “Systems and Methods for Token Creation and Management”, by Markus Jakobsson, filed on 22 Jun. 2021.

In some embodiments based on ERC-4337, “Account Abstraction via EntryPoint”, an account abstraction contract may implement authorization for asset transfers using the method disclosed above. A user operation desired by a user may determine a first transaction including a commit, and a second transaction including a reveal before the user operation is approved by the account abstraction contract, thereby abstracting verification of commit/reveal transactions away from individual asset instantiating smart contracts and concentrating the verification in the account abstraction contract.

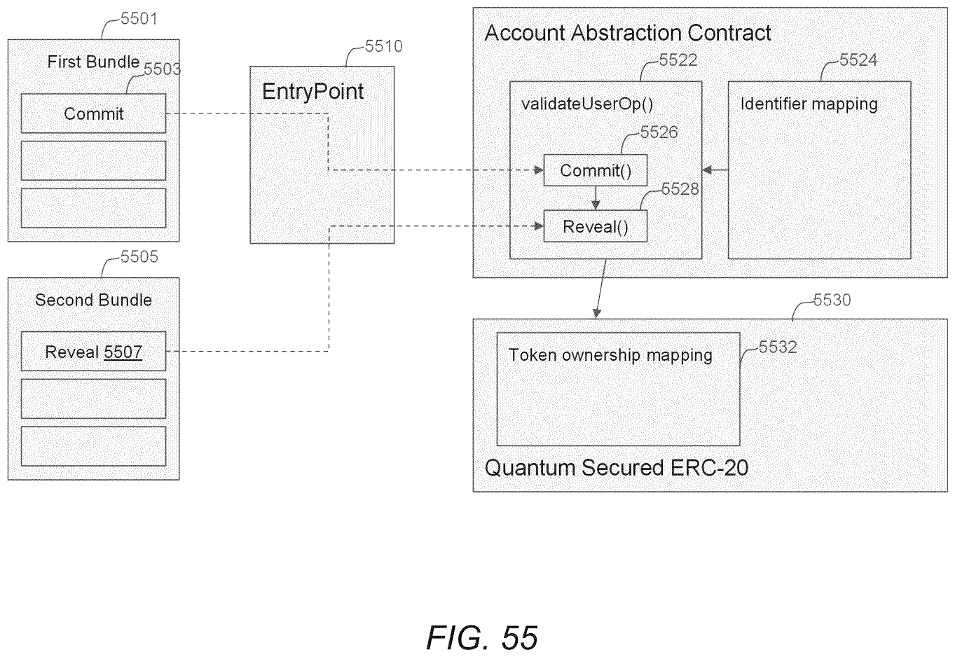

In FIG. 55, a possible embodiment of an ERC-4337 implementation of a quantum-secure commit/reveal authorized token using account abstraction is illustrated. A First Bundle 5501 of transactions including a commit 5503 user operation from an owner of a token may be submitted to an EntryPoint 5510 by a Bundler (not shown). The EntryPoint 5510 may examine the commit 5503, determine which account abstraction contract to call, and may submit the commit 5503 to the Account Abstraction Contract 5520.

The Account Abstraction Contract 5520 may include a validateUserOp( ) function 5522 called by the EntryPoint 5510 with the commit 5503 and an Identifier mapping 5524. The validateUserOp( ) function 5522 may include a Commit( ) subroutine 5526 and a Reveal( ) subroutine 5528. The validateUserOp( ) function 5522 may determine that the passed user operation is a commit operation, and may pass it to the Commit( ) subroutine 5526 where a commit state may be stored.

A Second Bundle 5505 of transactions including a reveal 5507 user operation from the owner of the token may subsequently be submitted to the EntryPoint 5510. The EntryPoint 5510 may examine the reveal 5507, determine which account abstraction contract to call, and may submit the reveal 5507 to the Account Abstraction Contract 5520.

The Account Abstraction Contract 5520 may determine that the user operation received is a reveal, and may pass the Reveal 5507 to the Reveal( ) subroutine 5528. The Reveal( ) subroutine may compare data in the Reveal 5507 with the commit state, and if the Reveal 5507 is validated by the commit state, as, for example, disclosed in application 63/687,205, the validateUserOp( ) function 5522 may authorize the Account Abstraction Contract 5520 to call a Quantum Secured ERC-20 contract 5530 with a transaction, the Reveal 5507 including the transaction.

The token may be instantiated by the Quantum Secured ERC-20 contract 5530. The Quantum Secured ERC-20 contract 5530 may be configured to only accept transfer commands from the Account Abstraction Contract 5520. The Quantum Secured ERC-20 contract 5530 may include a Token ownership mapping 5532, mapping identifiers to token balances. On receiving a command from the Account Abstraction Contract 5520 to transfer a balance of tokens from the first identifier to the second identifier, the Quantum Secured ERC-20 contract 5530 may verify with the Token ownership mapping 5532 that the first identifier maps to a sufficient balance to permit the transfer, and may then decrease the first identifier balance by the balance of tokens, and may increase the second identifier balance by the balance of tokens.

The disclosed technology reduces the size of the representation of funds as it enables the gathering of change from multiple sources in a smaller number of associated storage containers, thereby reducing blockchain storage costs as well as processing costs for verifiers.

In co-pending provisional titled “Blockchain Enhancement Technology with Applications to Quantum Security,” by Markus Jakobsson, Keir Finlow-Bates and Hossein Siadati, incorporated by reference in its entirety, discloses a method to reduce storage requirements by not storing individual signatures authorizing the transfer of tokens, but rather, only store the signatures of the miners having verified the logged requests. This can, for example, be implemented by settling the do-not-store flag for the transfer request signatures, which can be done selectively by the parties wishing to initiate transfers of their tokens. It can also be implemented at an “event horizon,” e.g., requiring the storage of such signatures for a set number of blocks or a set amount of time, after which the verification of the chain of custody of affected tokens would rely on the signatures of the miners. This can be strengthened by having the miner of a block at time t+d for a positive value d attest to the validity of transfer requests in the block at time t+d, but also to the validity of the chain of custody of tokens transferred within this block within the last d blocks; here, d may be a set parameter or may depend on the token being transferred. In one embodiment, a signature of one transfer request would no longer be required to be stored after the associated token has been transferred for a specified number of times, such as x times, where x may be a constant such as x=5, or may be set by a previous token owner, an entity having minted the token, or depend on the jurisdiction in which the token is being owned. This dramatically reduces the number of signatures that have to be stored without adversely affecting the security of the system.

Traditionally, the ownership of a token is represented by a series of records on the blockchain. Each of these records includes a description of the token (e.g., references to content data for NFTs, or a type, such as ETH, and a fraction, such as 0.6 for cryptocoins), an indication of ownership (e.g., a wallet address, a smart contract identifier, or a public key), and a digital signature by the previous owner of the token, this digital signature attesting to the validity of the new ownership information. In a quantum-secure token, the digital signature may use, for example, a Merkle signature, which corresponds to a collection of leaves (which are hash preimages) of a tree and a collection of internal nodes of the tree, which are used for verification of the digital signature.

One aspect of the instant invention is a method by which two or more users, each owning a fraction of a fungible token, can have their ownership represented by one and the same ownership record stored on the blockchain. Consider a token that can be broken into N units, and wherein a first user owns N1 of these N units and a second owner owns N2 of the N units, and where N1+N2=N. This can be thought of as the first user owning units 1 . . . N1, and the second user owning units N1+1 to N. This is a simplified description, for purposes of denotational simplicity and clarity, and there may be more than two owners. The first user is associated with a Merkle tree with root R1, and the second user with a Merkle tree with root R2. From these two values, a root R1 with two children, corresponding to R1 and R2, is generated. Thus, the public key is R, and any signature created by the first user would correspond to a Merkle signature generated for the subtree with root R1, along with the value R2, which will be a Merkle signature associated with the public key R. Any transfer of one or more units belonging in the interval 1 . . . . N1 would have to be signed by the first user, using the subtree with root R1, along with the value R2. Any transfer of one or more units belonging in the interval N1+1 . . . . N would have to be signed by the second user, using the subtree with root R2, along with the value R1. The size of the signature, for two owners, would therefore be bigger than a traditional signature, since the resulting structure would have a height of one taller than regular. The size of a signature for 16 owners would correspond to a tree (and therefore signatures) with a height of log 2(16)=4. However, this is much less storage than the traditional approach would require, as there would be a reduction in the number of blocks that need to be generated and logged on the blockchain.

In one embodiment, a token with multiple owners (of which there at some point may be a total of T) would require only one record to be logged for each time an ownership change of the token is made. In contrast, if a traditional fungible token were to be involved in T transactions, and each of these transactions would (as is typical) generate change, that would cause two new entries on the blockchain to be made for each of these T transactions.

The approach can be seen as two users using the same public key (namely R), to generate signatures that relate to different segments of the token.

It is possible to apply this “shared public key” approach to represent ownership of not only different segments of a token, but also of different tokens. Namely, two or more tokens can be represented in one record. For example, sixteen tokens T1 . . . . T16 may be represented in one record, wherein the corresponding 16 root values R1 . . . . R16 are leaves of a tree of height log 2(16), its root R being the Merkle root of the tree with leaves R1 . . . . R16. Then, instead of transferring a fraction of an ownership, a user would transfer the entire ownership, but only of a “subtoken” that corresponds to the user's root value, such as R3.

If two (or more) transfers were to be requested in the same time interval, these transfers can be recorded as only one transfer request, wherein the resulting transfer request includes a combined Merkle signature based on the two (or more) Merkle subtree signatures of the individual owners. This further compresses the representation. Furthermore, if a present transfer were to incorporate the Merkle signature components of a previous transfer (as well as the associated data about the segment and the recipient information) with the same information of the present transfer, then this resulting “combined” transfer request would make the “absorbed” transfer request redundant, meaning it could be erased from the blockchain. In some contexts, the combined transfer request would incorporate timing information for the previous transfer as well as information about the recipient.

### Technology Enhancements and Applications for Stablecoins and Other Tokens

Stablecoins are blockchain instantiated tokens that are pegged to a national currency, either through monetary reserves backing tokens on a one-to-one basis, or through algorithmic means that attempt to keep the market price of the token stable through adjustments to the supply of tokens.

Stablecoins backed by money require thorough auditing to ensure the reserves exist and the tokens can be redeemed for US dollars. Currently such audits are conducted in a conventional manner through accountants and auditors by examination of company balance sheets, bank accounts, and holdings by third-party custodians.

Such assessments are non-transparent, open to fraud and error, and are conducted intermittently, allowing significant time periods to pass between audits. There is therefore a need for auditing methods and systems that provide transparency and are always available for examination.

Lending crypto-assets suffers from an analogous problem to stablecoins, in that collateral is typically required to secure a loan, and it is generally considered desirable to be able to identify the borrower to pursue restitution in case of a default on the loan. There is therefore a need for methods enabling both lenders and borrowers to transact in confidence on a blockchain, where pseudonymity is frequently expected, and where assets such as cryptocurrency and tokens may be provided as collateral, but can suffer from extreme volatility in price.

Further risks to stablecoins and tokens exist through the potential development of quantum computers capable of breaking conventional cryptographic methods such as the elliptic curve digital signing algorithm and the Rivest-Shamir-Adelman digital signing algorithm. The existing methods rely on mathematical operations that are currently difficult to reverse with conventional computers, but may become trivial to reverse using quantum computers and quantum algorithms. Quantum-resistant signature algorithms exist, but these typically produce signatures that are large, and therefore not ideal for blockchains where storage space is charged for at a high premium. There is therefore a need for digital signing algorithms that are quantum secure and have small signature sizes.

This disclosure proposes a collection of techniques that enhances the functionality of stablecoins. One example allows the users of a stablecoin to verify that it has the required backing in the fiat world, namely a dollar amount in a recognized low-risk financial instrument or account. The disclosure also includes several novel techniques that are applicable to stablecoin as well as to tokens in general. One example of such an advance is the techniques to improve security against quantum threats. Another example is a set of techniques that can be used to support the use of collateral. A third example is a set of techniques for identity-based blockchain transactions. Yet another technique enhances blockchain technologies against physical device theft. The disclosure also includes technology to defend against money laundry.

The disclosed technology addresses a range of problems of importance in the area of blockchain applications, including but not limited to matters of functionality, assurance, security and efficiency.

In one variation, a room that contains the assets such as gold bars, coins, and bank notes is monitored with a CCTV camera or similar, which shows the inventory of bars online, and attaches a photo or any other physical world proof of that existing at checkpoints to the chain. Therefore, the chain will have the proof embedded in it. To prevent fraud and induce more trust, the CCTV camera may have an embedded Trusted Platform Module that ensures the integrity of the footage is preserved. Further, the CCTV end point has an embedded unique identifier with cryptographic keys that signs the footage before sending it to the network so anybody can verify the authenticity and timestamp for freshness. The authenticated images or stream may be logged on a blockchain. To avoid AI-based forgeries (e.g., deepfake methods), for an adversarial model where one of the cameras are infected in the modules in image-processing before the photos are being cryptographically signed, the system uses multiple sources of truth such as multiple cameras of different types and uses a byzantine protocol for agreeing on the truth and detecting compromised camera. In some embodiments, other sensors such as a weight sensor inspects the existence of the given amount of gold and sends the values frequently to the chain to be registered. Pressure sensors may detect the opening of the enclosure in which the monitored resource is kept, and motion sensors may detect movement in the enclosure.

In one variation, the digital asset itself has some embedded or attached sensor in/on it that makes it traceable. Example sensors include GPS or tagging technologies that enable identifying their location or sensing them upon entry to certain locations, accelerometers that detect the movement of the resource, etc. Example of this would be a gold-bar that has an attached or embedded unit for tracking. These assets report their presence to the trusted sensors and will report the inventory to an aggregating access point to be reported and tracked on the chain.

In one embodiment, sensor data (such as camera data) is combined with audit data and/or certifications. For example, a first auditor with physical presence at the location(s) of the inventory may periodically verify the correctness of assertions of holdings; another auditor may verify that sensors have not been tampered with, and cause the output generated by the sensors to be certified; a third auditor may scrutinize the software used to collect and process the sensor data, e.g., to ascertain that it is properly processed and that there are no glitches during which sensor data is not received or processed. Some software audits may be performed remotely, whether by one or more penetration testers and/or audit specialists, or by a software agent that determines the validity of the processing. Digital signatures or other forms of authentication are generated by such auditors and incorporated in data accessible by third parties wishing to verify the holdings.

Sensor data may be reported if there are detected changes to sensor inputs exceeding a set threshold, periodically such as every five seconds, or a combination of such approaches. Additionally, more fine-grained logging may be performed if there is any triggering of sensors exceeding the threshold set. The periodic reporting may be referred to as a heartbeat. If there is a missing heartbeat, that may set off an alert and cause greater scrutiny and logging.

In another variation, the funds exist as electronic records in traditional databases by entities such as the central securities depository (CSD) to support the stable coin. Then the database binds the transaction entries of the database to smart contracts, using ERC-20 token or ERC-721/ERC-1155 to record and bind them. When a new asset is added to back the stablecoin, a smart contract representing the relation is created. At the time the financial entity such as bond is redeemed, the smart executes and removes it from the stablecoin backing. This links the traditional databases to the blockchain such that any transaction in the traditional database has an equivalent in the blockchain as a smart contract. The financial audit process ensures that what is kept in the traditional database matches the ledger. Hence, the real-world asset will transparently represent the actual backing of the stablecoin in terms of dollar amount.

A probabilistic audit method can be applied to resources with serial numbers or other identities. For example, the serial numbers of bills as well as imagery of inclusions for diamond, can both be used as unique or semi-unique identifiers. The issuer of a stablecoin would record the correspondence between one or more tokens and a resource (such as a bill or a diamond), where this recorded correspondence would be publicly auditable, e.g., be recorded on a blockchain. An entity that finds a match between a resource it holds and a recorded resource corresponding to a token in circulation may file a complaint, which if validated may result in a bounty being provided to the reporting entity after the report is verified to be legitimate, and a record of the occurrence made public, e.g., also recorded on a blockchain. If there is a match between a validated reported identifier and a unique identifier, this is evidence of abuse, whereas a threshold number of matches with semi-unique identifiers may be required for such evidence to be declared. Evidence of abuse, in some instances, may be due to forgery committed by a third party. This could either be forgery of funds held by the issuer of stablecoins or other such tokens, or of those held by the reporting entity. The issuer of stablecoins may be required to prove possession of the resources corresponding to the reported match to prove that it did not generate stablecoins that were not backed, and penalized if such a proof cannot be made.

In one embodiment of the disclosed invention, one or more sensors are deployed for each one of a multiplicity of physical partitions (which we refer to as storage boxes), said sensors each including or being associated with a digital rights management module, such as a secure enclave or other protected computational area, where the digital rights management (DRM) module may be equipped with physical tamper-proofing and an alerting functionality connected therewith, and each DRM module further being associated with a unique identifier, such as a cryptographic key. The sensors detect the opening of the physical enclosure (the storage box) or other indications of compromise. For example, the sensor may identify changes in air pressure, movement of a door, the disconnection of a circuit, etc. Such sensor measurements are communicated by the DRM module to an exterior verifier using a communication link that in some embodiments is at least in part dedicated, but which may also rely on a common communication infrastructure, such as the Internet, a cellular connection, a satellite connection, or a combination of such. In addition to sensor measurements, the DRM module may communicate responses to audit requests as well as transmit heartbeat signals indicating that the DRM module is still functional. In some embodiments, the verifier may include software and firmware updates in audit requests. In many settings, it is desirable for the communications between the DRM modules and the verifiers to be performed over a secure channel, i.e., encrypted and authenticated, wherein it is commonly desirable for the encryption and the authentication technologies relied on to be quantum secure, or being configured to enable an update to quantum secure communication. A storage area includes one or more storage boxes, each one of which is connected to one or more verifiers. In some embodiments, they may share a common connection, e.g., via a hub or a gateway. Said hub/gateway is configured to only permit incoming and outgoing traffic that comply with a specified format, such as having proper authentication of each packet or message; non-compliant traffic may be bounced, dropped and/or reported, or sent to a honeypot unit associated with the hub/gateway.

DRM modules are configured to keep a state, such as safe/alert, where the state is automatically changed from safe to alert if a given type of sensor data is detected, and where a transition from alert to safe requires an action by an admin, whether via the verifier or with physical access to the storage box, where a specific authentication routine is required to make said transition. In one embodiment, the transition from safe to alert may be accompanied with an erasure of data, such as of authentication keys used to authenticate messages to the verifier. The DRM module may have more than one set of authentication keys, wherein one set is erased of the DRM module transitions to alert state, but not the other set, and wherein at least one set of authentication keys is used for any message that is being transmitted from the DRM module to the verifier.

The one or more verifiers determine whether one or more sensors associated with a storage box are signaling an alert, and if so, flags this storage box as having potentially been accessed, meaning that its contents may have been removed, destroyed or otherwise altered.

Stablecoin smart contracts currently contain minimal checks on minting and burning functions, only requiring that an authorized account be used to call the mint and burn functions for actions to be taken by the smart contract. Thus stablecoins may be minted in excess, or may accidentally be burned.

In an embodiment, restrictions may be applied to the mint function, reverting minting requests, even if made by an authorized account, if conditions determined by the smart contract apply. Conditions may include one, more, or all of the following: the amount minted may not exceed a percentage of the current total issued per minting transaction and/or within a predetermined period of time, the amount minted may not exceed a fixed amount per minting transaction and/or within a predetermined period of time, the maximum amount mintable in one transaction or time period may be a specified amount, where the specified amount is stored in a smart contract variable, and may be changed by a function call, with the change subject to similar restrictions to those already listed, and/or a maximum total amount that may be minted may be specified, for example, 20 trillion tokens. In some embodiments, different accounts may have different restrictions on how many stablecoins may be minted in accordance with the previously listed conditions, for example, a first account may only mint 30% of the current supply in one transaction, and a second account may only mint 2 million tokens per day.

Analogously, other restrictions, such as the capability to burn tokens of a specified type and/or quantity, may be implemented.

Cryptocurrencies are used along with credit cards, for rewards collection (e.g., Gemini rewards credit up to 4% back in crypto), Crypto-Backed Credits, and Crypto Debit/Prepaid Cards. However, there is no true credit card construct built into the crypto currencies or DeFi protocols, nor are there automated collection of audit data and generation of associated Certifications of Holdings (CoH).

In one embodiment, a user may obtain a credit limit and associate this with his or her wallet. The credit can be expressed as one or more tokens, each one of which is a fungible token backed by an assurance to pay, where the assurance to pay is made by a financial entity that corresponds to a credit card issuer and/or a mortgage underwriter. We refer to the tokens as credit tokens. Credit tokens may be implemented as stablecoins issued by a financial entity. The financial entity, which we may refer to as the “Credit Provider” may obtain assurances from the user to whose wallet the credit is assigned after having scrutinized credit reports, physical-world ownership records, token ownership, and more, where such information is associated with the applicant, i.e., the user to be assigned the credit. The credit provider can, furthermore, determine what other credit has been provided to the user, e.g., by determining what other credit tokens have been assigned to the user wallet.

To determine in an ongoing fashion whether the credit risk of the user has changed, the credit provider, or its agents, may determine how the credit tokens assigned to the user were used, wherein different types of transactions may be associated with different risks. One example of a high-risk transaction is one where there is no guarantee of a tangible value being acquired, and therefore, there is an increased risk of loss; one example of this type is the use of the credit token for gambling or other highly speculative investments. On the other hand, purchase of real estate or other stablecoins would correspond to low-risk investments, at least as long as these properties are not transferred out from the control of the user.

In some embodiments, instead of associating a credit limit and/or one or more credit tokens with a user wallet, the credit provider may instead associate the credit limit and/or the credit tokens with an anchor token or an entity tied to an anchor token. Tokens as owners of resources was disclosed in U.S. Provisional Patent Application No. 63/375,663 entitled “NFTs that Own Assets,” filed Sep. 14, 2022, the disclosure of which is hereby incorporated by reference in its entirety for all purposes.

When a credit card payment is initiated, the credit tokens are identified and temporarily blocked from being spent by the user. The blocking can be performed using a watchful mechanism wherein tokens totaling the limit can be identified and stopped from being spent on anything except the payment of a loan with which these tokens are identified as the security. Watchful processing was disclosed in co-pending application titled “Using Watchful Bridging for Blockchain Fraud Prevention” by Markus Jakobsson, Stefan Dufva, Keir Finlow-Bates and Guy Stewart; in “Token Abuse Protection” by Markus Jakobsson and Keir Finlow-Bates; and in “Identity Anchor with Watchful Processing, and Efficiency Enhancements” by Markus Jakobsson, Keir Finlow-Bates, and Hossein Siadati, which are all incorporated by reference in their entirety. Blocking can also be performed using a smart contract associated with the tokens to be used as security, wherein the smart contract determines whether the token in question can be transferred, or what portion of it can be transferred, based on a credit balance associated with the user(s) for whom the token(s) are used as security.

At the end of the billing cycle, or at a time selected by the user, these temporarily blocked tokens may be used to settle the debt; alternatively, another form of payment may be used. In the former case, the blocked tokens are automatically transferred to the lender, and in the latter case, the block is lifted, returning the previously blocked tokens to the pool of security. If a user spends a token that is in the pool of security, the credit limit is reduced accordingly. A credit check can be done instantaneously by determining the status of the tokens in the security pool, e.g., by determining their status as recorded on the blockchain or in another database. The status (e.g., in the security pool and not blocked, in the security pool and blocked, not in the security pool) may be recorded on the blockchain by associating a flag with the associated tokens. One way to do this is to sign a transfer that indicates a recipient that indicates the identity of the owner (who can transfer tokens that are not blocked, or use the credit card to obtain credit against them), the lender (who may be granted the right to initiate a block, and/or the conditional transfer of blocked tokens, and/or to unblock tokens) and an optional policy indicating the rules of blocking, transferring, etc.

The use of tokens as security is not limited to stablecoins or even to crypto coins, but could also be based on NFTs, including NFTs corresponding to physical resources, such as real estate. By using a non-transferable token (e.g., a soulbound token) as the security, or part thereof, the credit is tied to an identity instead of (or in addition to) a resource that is assigned a monetary value. Based on the type of token, and based on policies that may be referenced (e.g., in a smart contract), different functionality can be implemented. For example, a user may utilize an encrypted and certified record of a soulbound token as a security, wherein a smart contract may specify the conditions under which an escrow authority may decrypt the identity or perform other forms of operations on the record. An NFT corresponding to a virtual resource may have an action associated with the use of it as security that includes the right to use the virtual resource, for one or more specified entities, while it is being blocked. A token that is used for purposes of staking may be associated with a policy that provides one type of staking-related benefits acquired by the token to a lender, but only when the token is blocked, and another type (or none at all) while the token is not blocked. When a soulbound token is blocked, this may confer the associated service provider with some rights, e.g., to receive activity information related to the associated user for the duration of the token being blocked. Such information can be used for purposes of targeted advertising, to determine default risk, and/or other uses that are not otherwise available to service providers.

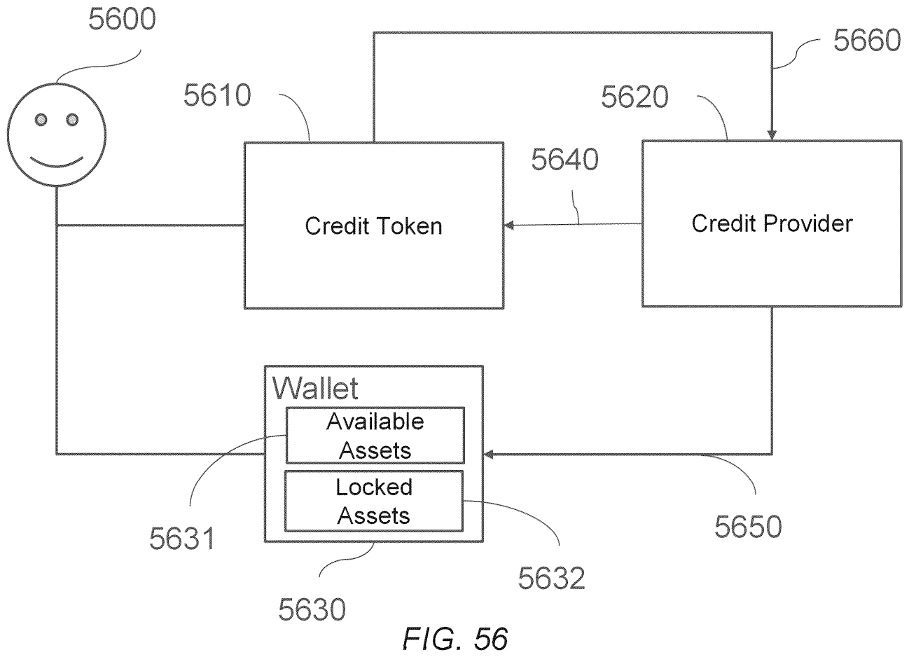

FIG. 56 illustrates elements related to a Credit Token (5610) issued by a Credit Provider (5620) to an individual or business entity as Token Owner (5600), to be used in Transactions. The Credit Provider (5620) is in charge of actions (5640) such as issuing the Credit Token and linking the credit token backed by one or more assets in the customer's Wallet (5630), and adjustment of credit limits, and revocations of credit tokens of the credit owner. To issue a Credit Token, the Credit Owner allows the Credit Provider to lock (150) agreed upon asset values from their Wallet, either just lock and keep it in the wallet or transfer it under the credit provider's control as collateral, and move such assets to the state of Locked Asset (5632) out of state of Available Asset (5631). When the Credit Owner “pays-out” (160) the credit balance, the Locked Assets will be released and moved back to the Available Asset state.

In one embodiment of the present disclosure, a Credit Provider entity issues Credit Tokens to Credit Owners, where the Credit Provider is legally and financially accountable for the payments made by Credit Token and a Credit Owner is legally and financially accountable to the Credit Provider for the usage of the Credit Token. The Credit Tokens are backed by assets including but not limited to Credit Owner's coin (as described in Wallet-based credit-cards, digital coins including both fungible and non-fungible ones), Credit Owner's physical assets as collateral, or Credit Provider's assets based on the assumed credit score of the Credit Owner.

In one embodiment of the instant invention, a Credit Card is associated with one or more Credit Tokens of the type described above. The Credit Tokens can be from one Credit Provider or different Credit Providers. When a credit card payment is initiated, a corresponding amount of tokens from those in the credit card will be used to either transfer the credit token to the receiving party, or the Credit Provider pays the receiving entity and adjusts the available credit” of the credit token. One benefit of using multiple Credit Tokens in one Credit Card would be to maximize the points for example those credit tokens yielding better points for restaurants and others that maximize for travel. At the Billing Cycle period, the Credit Card owner will pay-out the amount due using their standard tokens such as a standard dollar pegged stable coin. The history of pay-out will be recorded on the chain for example on the Credit token or the Credit Card. If the credit owner does not pay, the Credit Provider can instantly transfer the backing assets under their name or debt collector, charge interests, depending on the terms agreed for issuing the Credit Tokens.

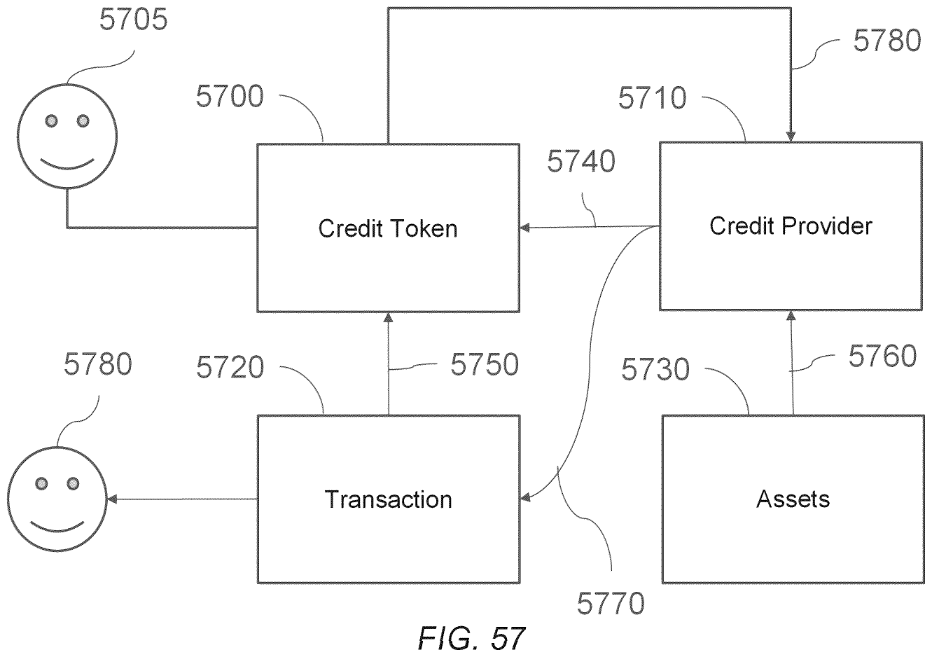

FIG. 57 illustrates elements related to a Credit Token (5700) issued by a Credit Provider (5710) to an individual or business entity as Token Owner (5705), to be used in a Transaction (5720). The Credit Provider (5710) is in charge of an action (5740) such as issuing the Credit Token and linking the credit token backed by some Assets (5730), and adjustment of credit limits, and revocations of credit Token of the credit owner. A Transaction (5720) can both reference the Credit Token (5700), or call a function such as a smart contract to update the Credit Token (5700) with the transaction information. The Credit Provider pays (5770) for a transaction on behalf of the Token Owner (5705) to the Payee (5780), possibly after some checks including but not limited to the fraud signals, or daily limits for payments, sanction list, and type of transaction or items paid for. The Credit Owner later pays the balance to the Credit Provider (5710) through debit transactions. The Credit Provider (5710) then either updates the credit limit of the Credit Token (5700), or re-issues a New Credit Token (not shown) for the user.

Credit tokens can be both fungible or non-fungible. An example of a use case for fungible-credit token is a credit token sent as a gift card to another person, or credit tokens provided by employer to employees, or a major credit provider delegating credit issues to smaller credit providers.

In one embodiment, the credit limit is determined by an on-chain transaction history of the credit owner including but not limited to the age of transactions, volume, and credit payment history. This information being on the chain is visible to all entities for verification. One or more formulas can specify the impact of each factor in the credit calculation. In one variation, the formula can be used to calculate the credit score and credit limit solely based on the data on the chain at a time. In another variation, a Credit Reporting Agency (e.g., a Credit Bureau) may calculate and release a token indicating the credit-score and limit of a Credit Owner by providing a function in as a smart-contract. The smart contract receives different inputs including but not limited to the ID of the Credit Owner and indicators of on the chain transaction, and indicators of off-chain assets such as bank account, off-chain identifiers such as SSN, and bank accounts to calculate the scores and credit limit. The output can be a credit score token that is presentable to Credit Providers to issue Credit Tokens. The credit limit may also be computed based on an amount of credit used relative to a security provided, where the security may be of a fixed value (as in the case of one or more stable coins being used as a security); known but fluctuating (as in the case where the value of a crypto token, e.g., ETH, may vary over time); and unknown (e.g., if the security is an NFT that corresponds to an art piece or an access right). Baskets of tokens of different types or desirability may also be used to establish the value of the security, and thereby determine the amount of credit that can be extended at any point in time. The credit limit may be affected by the velocity of payments, the type of merchandise being purchased, and whether the purchased goods are added to the security backing the credit.

Different lenders may have different ways of computing the credit limit and/or the cost of credit based on information such as the above information, and may then compete with each other to provide credit to desirable borrowers. A borrower, e.g., represented by a wallet, a token with a smart contract in charge of acquiring low-cost credit, or a user, may evaluate one or more offers for credit and select which one(s) to use. This can be signaled to the lender so that the lender can commit the funds for the credit or perform accounting of the credit extended and likely resulting purchases made, e.g., based on statistical models, an AI, or both.

In one embodiment, an owner of a Credit Token is able to delegate a credit token usage to another entity while the main owner is in charge. This is helpful for example for the corporate credit cards where employees use credit cards for travel and other usages. In one variation, the delegate does not need approval for transactions. In another variation the delegated entity links his personal tokens to the Credit Card in case the transaction is not approved (e.g., per diem daily limit). In one embodiment, this is implemented as chains of KYC attached to a credit token implemented as a smart contract. In another variation, they are credit tokens that are transferred to the delegate and will be returned to the original owner if the credit is not used past a pre-defined deadline.

In one embodiment, this can represent itself as a base for lending tokens such that a credit token owner delegates or lends the token to some other user under some guarantee and contract, for example through the “Lending approaches” mechanisms described in this disclosure.

In one embodiment, the Credit token is owned by two entities. In one variation, either of the joint owners can expense independently and will be responsible for the payments. In another variation, both entities need to approve transactions before they are completed. One example of use case is family credit cards. This capability is realized in several manners, including requiring multiple signatures for a smart contract with logic “and,” “or,” and count of them indicating what combination of signatures is needed for the contract execution when using the contract.

In one embodiment, a credit card is represented as a smart contract and lives on the chain. This hence allows charges being made to the credit card and the statements over it being paid. By using transparent transaction data, different entities can subscribe to spending habits or other metrics on the transactions related to a card. The card owner can allow or disallow entities to check the details of transactions such as the name of the item which is encrypted by default to allow financial or security entities to check. Similarly, the credit card owner can share a specific transaction, for example with the employer as a receipt for a trip to get reimbursed. Alternatively, the credit card owner can delegate payment of one transaction to the employer so they pay for it in a secure manner.

An owner of a coin can lend it to a borrower. The lender may be concerned with having a security established, so that the resource associated with the security would be conditionally transferred, whether in part or in full, if the loan is not repaid. In one example embodiment, the security corresponds to a token that may be locked by a smart contract to not allow transfers other than to a designated payee, for an amount corresponding to the loan, and optionally for additional fees and expenses associated with the loan. Alternatively, instead of performing the conditional blocking of the token using a smart contract, the token(s) used for security can be transferred to and held by a trusted entity, or blocked from being transferred, at least in part, using a watchful mechanism. A tokenized collateral can be used as security in an analogous manner, where this collateral may be a real-world resource, such as a bar of gold, a real estate property, or the contents of a bank account. The collateral may also be an NFT with independent value, e.g., a collector's item or a token that grants access rights to a valuable resource. Independent of the blocking approach, a smart contract may encode terms of the loan, such as an interest rate, a conditional return amount based on time, events and/or the performance of an action such as the delivery of a goods or service. Such terms may also be embodied in an agreement that is not a traditional smart contract but which is of a pre-agreed format, and where this agreement is associated with at least one of the lended token(s) and/or tokens or other data describing the security/collateral.

In one embodiment, the resource being lent or used as security may be one or more tokens that represent interest in another loan, which we refer to as the second loan, and may reflect another interest rate or rate-of-return agreement that that of the second loan. This permits the optional bundling and resale of resources, including a resource such as one or more loans.

One or more of the tokens used in the above-disclosed process could be a token such as the JPMD coin on Coinbase's layer 2 chain Base. It could also be a stablecoin, BitCoin, a tokenized real-world asset, or a token in which a party with a valuable resource acts as a guarantor on behalf of a borrower, said token disclosing the terms of the associated security.

In one embodiment, a token is marked as being used as collateral for a loan by transferring the token to an address that indicates one or more of (a) that the token is used as collateral, (b) what loan the token is used as collateral for, where the loan indicator may be a reference to one or more tokens, (c) the terms of the loan, including terms identifying when the collateral would be forfeited, (d) an identity of an entity (such as a user, an organization, an address, a token) that is the beneficiary that would receive the collateral if forfeited, (e) terms identifying whether any entity has access rights to the collateral while it is being locked up as collateral (f) terms identifying rules for how the owner of the collateral token can use the token, including transferring it to another party, while it is being held as collateral, and (g) executable instructions or references to such, indicating processes to be executed under one or more conditions associated with the token marked as collateral. The address to which it is transferred to may be the same address as it was held at prior to the use as collateral, but with additional parameters added or indicated in order to mark it as collateral. Thus, no actual transfer of the token is required in order to mark it as collateral, but the marking can be done simply using the same or related process as the process for transfers. Alternatively, a transfer can be made to a trusted third party, such as an escrow entity, that holds the token along with instructions indicating what it is collateral for.

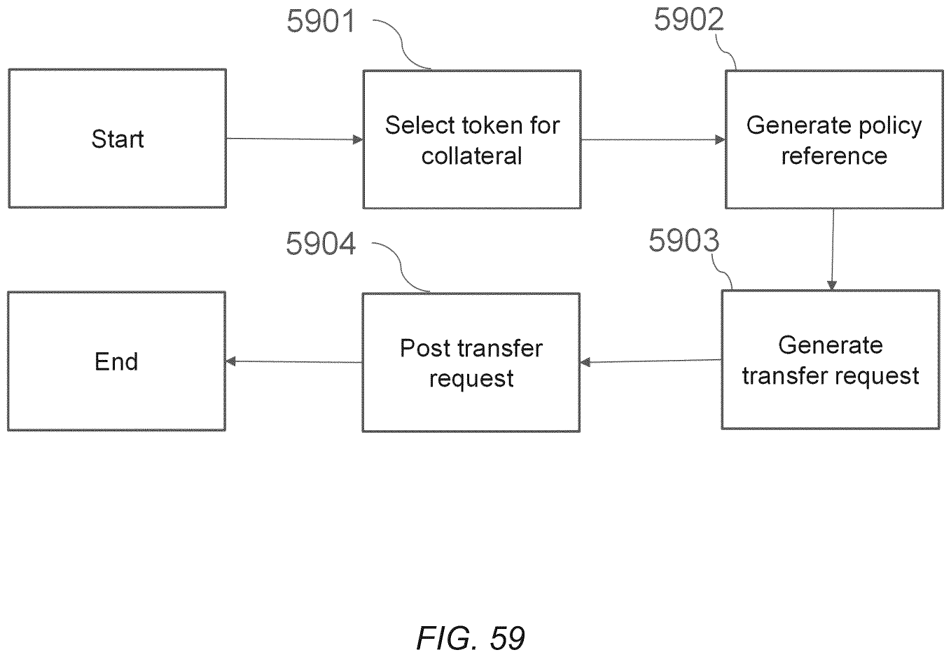

FIG. 59 shows a process for marking a token as collateral. Actions may commence when one or more tokens are selected as collateral, e.g., for a loan, for purposes of staking, or to hold funds for other reasons, as shown in step S901. The one or more tokens are selected of a type and a quantity that meets one or more requirements on the collateral. Actions may then proceed to step S902, in which a policy reference is generated. This may include information about the entity to which the collateral value is assigned; this entity may be a user, an organization, a smart contract, a token, or some other entity. The entity to which the collateral value is assigned is henceforth referred to as a “holder”, and may be represented by a public key, a smart contract address, a wallet identifier, an identity-based address (such as of the type disclosed herein), an entry in a mapping, string, data structure, list, or array, a cryptographic hash of one or more of the preceding examples, or some other representation. The policy reference also may include one or more of a reference to or a description of one or more policies identifying what the collateral is for, what the conditions of its release (in part or in full) are, an identity of an arbiter to be consulted, and conditions under which this is to be done, and information indicating what a release of the collateral means, which may include an identifier of an entity to receive the token(s), and any fees to be paid to various entities and the conditions for such payments. Actions may then proceed to step S903, in which a transfer request is made, referencing the policy reference of step S902. The transfer request may be a smart contract request, or may include a digital signature, for example. Actions may finally proceed to step S904, in which the transfer request is written to a blockchain.

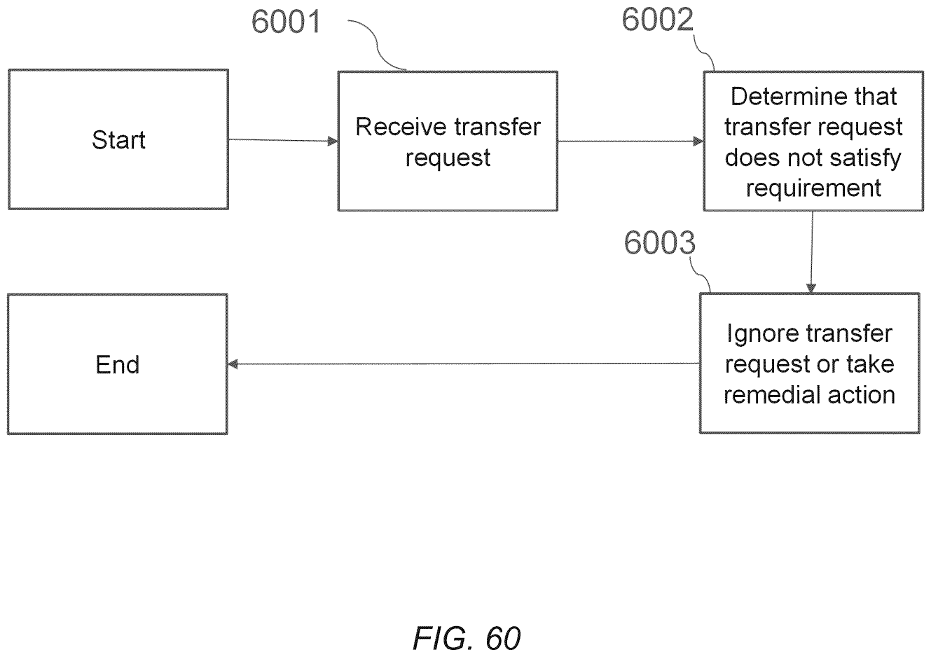

FIG. 60 illustrates how a collateral can be conditionally blocked from being spent. In step 6001, a transfer request has been generated by an entity possessing a token marked as collateral in FIG. 59. The transfer request of step 6001 may be digitally signed or may be generated by a smart contract associated with the possession of the token. In step 6002, one or more policies indicated by the policy reference of step S902 are verified, and it is determined whether the token can be released as collateral based at least in part on these one or more policies. This figure shows the process when it is determined that the token may not be released as collateral. That may be because the token is the collateral for a resource that has already been accessed, e.g., a loan that has been taken but not yet repaid, as can be determined by inspecting the blockchain for the presence of an access to the lended assets. It may also be because the holder of the collateral has not approved its release, which may be done by publishing a release or provisioning a release document to the lender, where this release document may be incorporated in or referenced by the transfer request of step 6001. There are many other reasons why it may not be released, and these are non-limiting examples used for illustration purposes. In step 6003, as a result of the determination that the token cannot be released as collateral, the transfer request is ignored or placed in a queue awaiting the required conditions to be satisfied. Alternatively or in addition, a remedial action may be taken, such as the reporting of the failed attempt, the automatic use of the token to pay off a loan for which it is used as collateral, or an automatic reduction of privileges associated with the holding of the collateral. These are merely non-limiting examples used for illustrative purposes. The processing shown in FIG. 60 may be performed in a distributed manner as part of a consensus mechanism, for example, or may be performed by a centralized authority managing the processing of collateral.

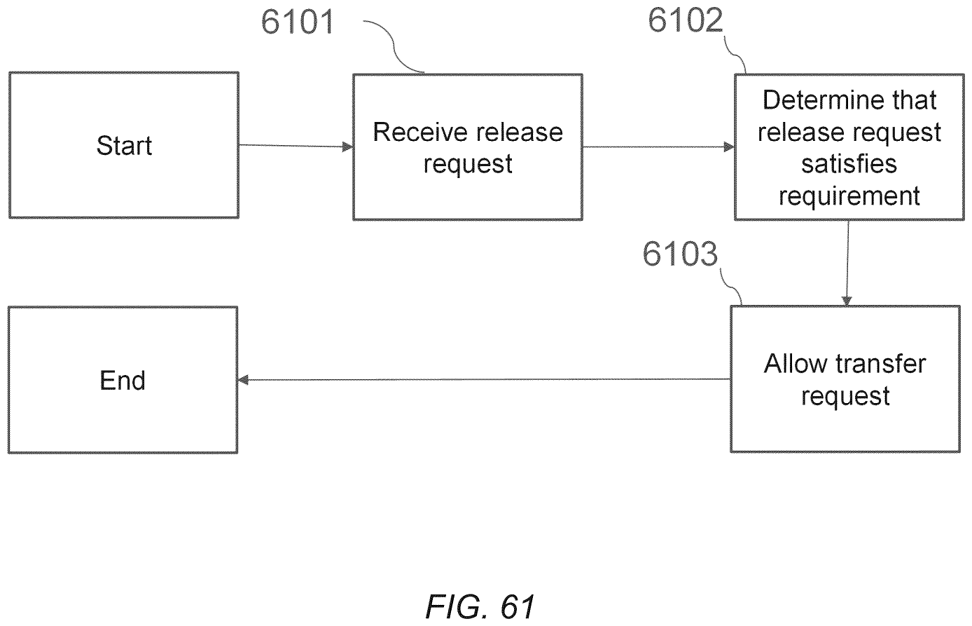

FIG. 61 illustrates the release of a token as collateral. In step 6101, a release request is received. The release request may be generated by the holder of the collateral, by the possessor of the token marked in FIG. 59 as collateral, or by an authority, such as a law enforcement entity. It may also be generated by a watchful mechanism such as one of those incorporated by reference into this disclosure. In step 6102, it is determined that the release request satisfies one or more requirements, such as the policies indicated by the policy reference of step S902. Alternatively, the requirement satisfied may be that the holder of the collateral requests the release of the collateral and the request is determined to be valid, or an authority with authorization to request the release of collateral made the request or a watchful mechanism determined that the collateral should be released based on input information provided to it. Accordingly, the release request is granted, and in step 6103, an associated transfer request is allowed and processed. The transfer is made to a party specified in the release request received in step 6101, or indicated by the policy reference described in step S902.

Another embodiment of this invention concerns peer-to-peer lending between strangers. In the embodiment, a person A (lender) can lend some amount to person B (borrower) over chain, with or without collateral. One way of enabling the lending without collateral is using a contract on the chain that enables the lender to send money to the borrower. The contract defines the terms of contract. The state of the contract is complete when the lender returns the money. The history of the payments from the borrower will be the basis for the credit calculation algorithm to compute the credit score of the borrower. In the second form where there is a collateral, the lender registers a digitized asset or a non-fungible asset as the collateral which will be collected if the contract is not fulfilled based on the term. The lender can claim the collateral, or use the collateral to obtain the equivalent of what they are owed based on the contract. The lending contract can define what is the term, including the interest amount, deadlines, installments, or any other fees.

Peer-to-peer financing, private-lending or peer-to-peer lending makes shopping loans more affordable for the borrower and more profitable for the lender. Direct financing through a service provider will also make the purchase more affordable for customers, also enabling controllable leasing mechanisms. This invention explains the methods and mechanisms enabling the direct lending and borrowing of entities over the blockchain chain.

One embodiment of this invention is a mechanism for selling or leasing electronics or remotely controllable devices (e.g., washing machine, TV, car) through a smart contract that allows selling a product with monthly installments or leasing scheme. The smart contract on the chain will always show the status of the contract, including up to date, or late payments. The sold device queries the chain and stops working safely if the contract is infringed, for example a certain number of late payment has occurred (number of the month). In such cases, the seller may decide to block updates, or otherwise constrain functionality or use of the digital goods, should the buyer/lessor not pay as agreed. The digital goods may, for example, include software code, access credentials or other expressions of access rights, policies, music, movies, artworks, games or elements of games, etc.

In other embodiments of this invention, a lender (L) lends an electronic or instrumentable device (D) to entity borrower (B) and charges based on the usage or the lending duration. The costs are calculated based on the usage of the device. One way of implementing this is through using a lending or leasing smart contract on the blockchain that indicates the details of the lender and borrower and states of the device when it was lended. As a non-limiting example, the contract includes a per minute metric of device usage to charge B and pay L. The instrumentable device D sends metrics usage to the chain. The device has a private key or secret code that allows it to prove its authenticity to update the chain. The private keys or secret for updating the metrics of usage are given to the device D at the time of lending contract formed. The device controller system updates the blockchain per milestone. For example, a car equipped with this technology sends the car usage and updates the mileage of the car on to the chain. This enables, for example, leasing out cars based on the mileage. As another example, smart TVs are lent with all software and channels installed. A customer can be charged based on their usage of different channels or number of hours used.

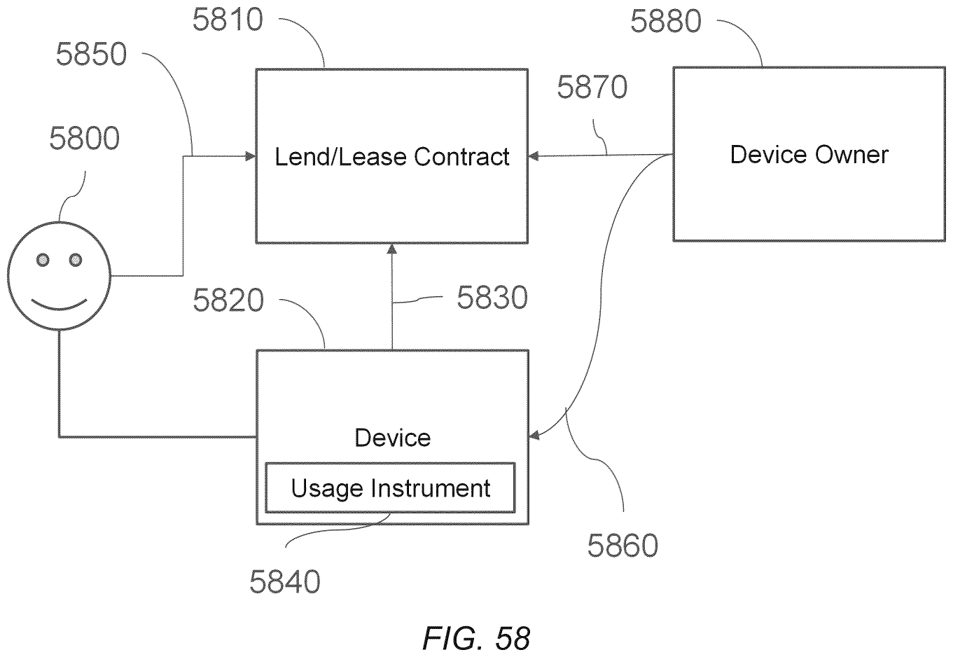

FIG. 58 illustrates elements related to a Device Lending/Leasing on a blockchain. A Device Owner (5880) creates (5870) a Lease/Lending Contract (5810) on a blockchain. The Device (5820) is equipped with software and hardware for a Usage Instrument (5840) to measure how the device is being used. For example, mileage of a card driven is calculated by this component on the device. The Device (5820) registers itself to the contract and reports (5830) the measurements to the contract on the blockchain. The device registration is done, for example, by providing a signed certificate, for example a X.509 digital file to the smart contract. The certificate includes details such as issuer name, issue date, expiration, and public key related to the registered device. The private keys on the device allow the device to encrypt and send the usage info to the blockchain legitimately. The borrower (5800) pays (5850) the financial duties to the contract on the blockchain. If the contract is infringed, the Device Owner commands (5860) the device to degrade its functionality or stop working altogether.

Stablecoin regulations such as Regulation (EU) 2023/1114 of the European Parliament and of the Council of 31 May 2023 on markets in crypto-assets, and amending Regulations (EU) No 1093/2010 and (EU) No 1095/2010 and Directives 2013/36/EU and (EU) 2019/1937, and S. 1582—GENIUS Act (119th Congress, 2025-2026) impose prohibitions on stablecoin issuers offering interest or yield, or other financial and non-financial rewards to holders of stablecoins. These restrictions are designed to prevent stablecoins from competing with traditional deposit accounts and to mitigate risks associated with financial stability.

In one aspect of the present disclosure, the stablecoin holdings of a user may be automatically swept into a yield-bearing decentralized finance (DeFi) protocol when not in use, and may be withdrawn when the user wishes to use the stablecoins for a purchase or transaction.

In some embodiments, an off-chain software program, which may in some embodiments be implemented in a user blockchain wallet, may monitor the transaction activity of the user over time, to build up a pattern of spending, and hence sweeping to and from the yield-bearing decentralized finance (DeFi) protocol. For example, the user may pay rent and utility bills on a set date every month, and may have entertainment expenditures that occur more commonly on Fridays and Saturdays than other days of the week. The off-chain software program may also perform scheduled payments, e.g., a monthly rent payment or the payment of an electricity bill. This automation can also be implemented using a wallet, a smart contract, or a script authorized by a user or a user wallet. Such scripts may be executed as part of the consensus mechanism, and may perform other maintenance operations as well, such as paying royalties, generating escrowed documents if required by the jurisdiction with which the associated owner is associated, etc.

One approach to paying interest or yield on a stablecoin without a direct connection between the stablecoin and the yield is to issue a subsidiary token for each stablecoin token. Yield can then be paid on the subsidiary token rather than the stablecoin, thus potentially circumventing regulations restricting direct interest payments for the stablecoin.

There is, however, a problem, in that when the owner of an amount of stablecoin transfers some of the stablecoins to a recipient, an equivalent amount of the subsidiary should be transferred to the recipient at the same time. A solution to this is disclosed in patent application 63/370,099, “Mirror Tokens and Parallel Addresses” filed 1 Aug. 2022, by Keir Finlow-Bates and Markus Jakobsson, by issuing the subsidiary token as a mirror token to the stablecoin.

A second problem remains, namely calculating yield earned, as a transfer of stablecoins and associated subsidiary tokens should not also transfer yield to the recipient.

In one embodiment, a third token, henceforth a yield token, may be issued to represent yield earned, and the yield token may itself earn further yield at the same rate as the stablecoin. A smart contract may hold a reserve of stablecoins, and may be deployed and funded by the stablecoin issuer, may exchange yield tokens for stablecoins, thus allowing owners to redeem their yield.

In another embodiment, the subsidiary token may be used to account for yield earned over the period they are held, by being incremented over time to represent yield earned. A smart contract may hold a reserve of stablecoins, and may be deployed and funded by the stablecoin issuer, may exchange subsidiary tokens for stablecoins, thus allowing owners to redeem their yield, with a restriction that only an amount equaling at most the difference between the amount of stablecoins held and subsidiary tokens held may be redeemed. This ensures that an owner of an amount of stablecoins will also own at least an equivalent amount of subsidiary tokens, further ensuring that in the event of a transfer of stablecoins, an equivalent amount of subsidiary tokens will be available for a mirrored transfer.

In some embodiments, an entity may selectively transfer one or more of a token, an associated subsidiary token and/or a yield token to a recipient. In other embodiments, a party that minted at least one of these three tokens ties one token to one or more of the others. The tie can be implemented using a rule or a policy associated with one or more of the three tokens, and can cause the invalidation of a token or of a transfer of the token if the rule/policy is not satisfied.

Such rules and policies may also be applied to any number of tokens, where these could be of different types or of the same type, and where the rule or policy may be triggered by an external input, such as a time after the minting of the token, a time after the transferring of the token, the value of the token, whether an action was taken such as the payment of a royalty when the token was transferred, based on a registered jurisdiction of an owner of the token, etc. The rules and policies may selectively cause actions such as automatic logging of ownership information with an escrow authority, automatic enablement or disablement of capabilities associated with the token, generation of notifications to indicated entities, or requirements to perform identity proof actions for purposes of KYC (Know Your Customer) regulations.

A person of skill in the art will also recognize that whereas the techniques above are described in the context of stablecoins, they can also be applied to other types of tokens.

A token may be associated with zero or more policies, where these policies may be arranged in a hierarchy, where an ancestor priority has priority over a descendant policy in case of conflict. Each such token may own one or more other tokens, where the owned tokens may also have policies, and where a policy of an owner token has priority over a policy of an owned token. These tokens may be arranged in a hierarchy. Tokens that own tokens were disclosed in U.S. Provisional Patent Application No. 63/375,663 entitled “NFTs that Own Assets,” filed Sep. 14, 2022, the disclosure of which is hereby incorporated by reference in its entirety for all purposes. We refer to a policy that is not contradicted by an ancestor policy as being “active.” The policies associated with tokens apply active tokens to all tokens that are owned by the tokens with such policies. One token policy P1 may specify that all descendant tokens T owned, if fungible tokens, need to be documented when transferred, where the documentation has to be done in a manner specified or indicated by P1, e.g., by recording the recipient identity with an escrow authority or on the blockchain when the owned token T when T is transferred to a new owner. Here, an owner may be considered new if the recipient does not share an ancestor with the originating (paying) entity. Another policy P2 that may be a descendant policy to P1 (by virtue of being a descendant in the associated tree) may specify that when a descendant token T is transferred, and T is an NFT, then royalty payments and/or sales tax payments must be paid in a prescribed manner, if applicable. In a first jurisdiction, the policies of P1 may be required, which can be expressed by each account or wallet owning a token T1 associated with P1, and the token T1 owns all the assets of the wallet; a second jurisdiction may require the policies of P2, in which case a token T2 associated with P2 owns the assets (such as fungible and non-fungible tokens). In a third jurisdiction, where both P1 and P2 are required, the account or wallet may own T1, and T1 may own T2, which in turn owns fungible tokens and non-fungible tokens to be managed by the owner of T1. There may be multiple child tokens under a given policy bearing token (such as T1), where these may be T2, T3, T4, for example, and where each one of these may own additional tokens with policies, and where the leaves of the associated tree may be traditional crypto assets, such as crypto coins, NFTs with artworks, etc. The assignment of ownership (e.g., to a first policy token T2 or a second policy token T3) may be based on selection criteria specified in these tokens, or their ancestors. For example, all ownership of fungible tokens may fall under the T2, whereas all ownership of NFTs with DRM requirements may fall under T3. T2 may have different child tokens with policies, where a first such child node may apply to BitCoin, a second to Ethereum, and a third to stablecoins. Some policy owning tokens may add policies that are required by a jurisdiction, whereas other policy owning tokens may be selected by an employer of a user, and yet others by the user herself. Some policy tokens may be required by content providers in order for tokens minted by the content providers to be transferred to a user. Some policy owning tokens may correspond to security settings, e.g., require a 2FA verification in order to be transferred out from the owning token.

A wallet may be configured to own the ancestor of all the tokens described above, which is the root of the tree. In one embodiment, the root of the tree is also associated with one or more anchor tokens, also referred to as soulbound tokens. The association may be a two-way reference between the root and the soulbound token(s), or the soulbound token(s) may be the owner(s) of the root element. One or more policies associated with the tree spanned by the root token may depend on the identifier(s) of the soulbound token(s), and may require an authentication corresponding to identifiers (such as biometric templates or other identifiers) for specified transactions, such as transfers in/out, or modifications of policies; furthermore, the logging of KYC data may utilize one or more of the identifiers associated with the soulbound token(s), e.g., to log these, potentially in an encrypted format, to document various actions and transactions.

A similar expression of functionality as the one based on policy tokens may be implemented by applying a hierarchical set of policies to a wallet and its contents, an account and its contents, etc., and store it in a manner that does not require tokens for the policies, e.g., by storing the tree of policies or an array of policies or another structure of policies in a storage that associates with the tokens of a given user. It may also be expressed using smart contracts, whether these are associated with policy tokens or not.

In one embodiment, a first user wishes to transfer a token, such as a fungible or non-fungible token, to a second user. Traditionally, transfers can only be done to smart contract addresses or public keys, but it is desirable to also enable payments to externally selected identifiers, such as a phone number, an email address, a social media user identifier, an entity with a specific domain, a bank account number, etc. Allowing this is of great importance as it enables integration with legacy payments and infrastructure, but this is not possible using today's crypto technology. In addition to the benefit associated with support for legacy identifiers, this approach is also desirable for purposes of fraud avoidance, as it makes it harder for criminals to successfully pose as trusted entities.

Identity-based transfers can be implemented in a variety of manners. In one approach, an identity-based signature scheme is used by the recipient of the token, i.e., the second user, for this second user to transfer out the token. In order for the first user to transfer the token to the second user, any secure signature scheme can be used. It does not need to be an identity-based signature scheme, and it can be a quantum secure scheme such as Merkle signatures, or a time-based two-phase authentication method, such as CR signatures. CR signatures were disclosed in co-pending application titled “Secure and efficient quantum-resistant digital signing method for blockchains” by Keir Finlow-Bates and Markus Jakobsson, with enhancements in “Using KYC, Escrow, Tracking, Risk Scoring and Recourse to Secure Transactions” by Markus Jakobsson and Keir Finlow-Bates; both are incorporated by reference in their entirety. An example identity-based signature scheme was disclosed in the 2006 publication “Efficient Identity-based Signatures Secure in the Standard Model” by Kenneth G. Paterson and Jacob C. N. Schuldt; this is also incorporated by reference in its entirety. A quantum-secure identity-based signature scheme can be created based on lattice-based cryptography, e.g., using security assumptions like the Small Integer Solution (SIS) and Learning With Errors (LWE) problems, which are believed to be hard for quantum computers. NIST has standardized quantum-resistant algorithms such as CRYSTALS-Dilithium, FALCON, and SPHINCS+ that can be used to build such systems.

In another embodiment, a user registers a public key and an associated identity, e.g., on a blockchain, along with an assertion by a certificate authority or trusted service provider, attesting to the fact that the user is in possession of the identity. In addition, the public key and the identity may also be associated with an anchor, resulting in a form of anchor token (also known as soulbound token) that is tied to the public key and the identity that the user wishes to associate with the public key. This public key may be expressed in a token, which we may refer to as the master token, that then becomes the owner of one or more tokens, these one or more tokens implicitly being owned and controlled by the user whose identity the anchor token relates to. This may, for example, be expressed as a biometric template. The master token may be controlled by the user, e.g., via a wallet and/or one or more smart contracts. Tokens that own assets were disclosed in U.S. Provisional Patent Application No. 63/375,663 entitled “NFTs that Own Assets,” filed Sep. 14, 2022, the disclosure of which is hereby incorporated by reference in its entirety for all purposes.

To avoid having to place ongoing trust in an authority that generates private keys from identifiers, as is common for identity-based schemes, one may have an authority that certifies a relationship between an identity I and a public key P by recording the pair (I,P) on a blockchain. Here, the authority would not know the private key corresponding to P; this would only be known by the party associated with the identity I, who generates it using a random or pseudorandom method and then provides the authority with (I,P) along with a request for certification. The authority verifies the relationship between the identity I and the requesting party, e.g., by sending a message M addressed to I or by verifying registration data related to I and identity documents of the requestor. Here, M can be a random nonce that the requestor needs to provide to the authority over an encrypted channel to enable the authority to verify the (I,P) relationship relative to the requestor. The public key P may be for a quantum-secure signature scheme. In order to transfer a token T to the user with identity I, a party wishing to perform the transfer could generate a signature, using a private key associated with the token to be transferred, that takes the identity I or the public key P, or both, as its input. In the example where the identity I is used, the recipient user (who is associated with I) could claim ownership by using the private key associated with P, where anybody wishing to verify that this is a proof of ownership may verify that (I,P) was recorded on the blockchain, and that the pair was recorded by the authority. The latter verification can be performed by checking a digital signature of the authority on the pair (I,P). The user wishing to prove ownership of the token could optionally include a reference to the certified pair (I,P) on the blockchain to simplify verification. The blockchain where (I,P) is recorded may be a different blockchain than that used for transfers of token T, and may be a blockchain dedicated to the use of certified pairs (I,P). If this blockchain is operated by the authority, the very fact that a pair (I,P) is recorded on the blockchain may implicitly indicate that it is certified. As is traditional, proofs of ownership of a token is performed using a digital signature using a private key whose associated public key has been linked to the ownership of the token in question. One benefit of this approach is that it enables identity-based signatures that are quantum secure, as the public key P may be a key for a quantum-secure authentication scheme, e.g., a Merkle signature, a Winternitz signature, a CR signature, or a signature with similar properties or structure.

A certified pair (I,P) may be revoked, e.g., by an authority recording a cancellation message referencing the pair (I,P) on the blockchain used to record (I,P), or another blockchain such as a blockchain dedicated to the use of revocations. This is beneficial in the context of breaches, for example, where a private key associated with P is feared to have been compromised. In one embodiment, the owner of the private key associated with P may self-certify the revocation message and have it recorded on a blockchain used for revocation messages. Here, self-certification includes the generation of a digital signature on the revocation request, where the digital signature is verified using the same public key P for which the revocation is to be performed.

A user may also self-certify a message that associates an identity I with a public key P, e.g., by using the public key to generate a signature S on the pair (I,P), optionally along with a proof involving a private key associated with an anchor token linked to I.

The identity may be a credit card number, a phone number, an email address, etc. A private key associated with (I,P) can be held on a chip on a smart card (e.g., with the form factor of a credit card); in a protected environment of a smartphone, such as a TrustZone protected area or a secure enclave; in an encrypted format on a public database or consumer device, with a decryption key held in a secure storage or protected environment such as on a smartphone; as well as in dedicated devices, such as crypto wallets.

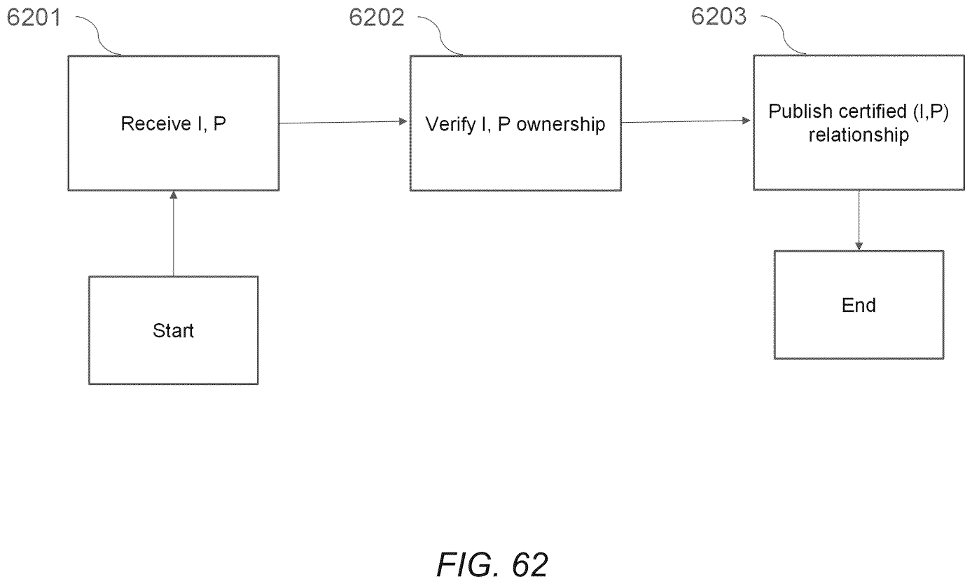

FIG. 62 illustrates the establishment of an identity-based address. In step 6201, a trusted certification authority (or an “authority”) which may be operated by a consensus mechanism, receives a request to associate an identity I with a public key P. The identity I may be an email address, a domain, a phone number, a postal address, a passport number, etc. The public key P may be an ECDSA public key, a root for a Merkle tree, or another type of public key. In step 6202, the trusted certification authority verifies the ownership of I and P. For example, it may transmit, e.g., over a secure channel set up prior to the transmission of P, I in step 6201, a nonce to an address described by I, e.g., by sending an email, an SMS, a postal delivery, etc. to the party who sent the request received in step 6201. We refer to this party as the requestor. The requestor receives the nonce, and generates a proof of possession of the private key associated with the public key P, where this proof may reference the nonce and the identifier I. The proof of possession may be a digital signature, for example, or another proof of knowledge. In the case of Merkle signatures, we assume a sufficiently large tree that multiple signatures can be generated, or a hierarchy of private keys associated with the root. The authority receives a response from the requestor, the response including the proof of possession. In one embodiment, the nonce was encrypted by the authority using the public key P. Here, P may include multiple public key components, some of which are suitable for encryption and others which are suitable for digital signatures. The authority verifies the response, e.g., the digital signature on the nonce. The digital signature may also be generated and later verified on a message that includes the value I, a session identifier specific to the request received in step 6201, and potential other information such as proofs of soulbound token possession. In the cases where I is not an address, the requestor may submit additional proofs, where such additional proofs may be entangled with the digital signature using P, and where such additional proofs may be information obtained from a credential issuer, e.g., an issuer of passports, where the additional proofs may be verified by the authority in step 6202. In step 6203, the authority publishes a certification of the pair (I,P), where the certificate may include a digital signature on the pair (I,P) and one more additional inputs, e.g., describing the expiration date of the certificate, the certification chain associated with the authority, and one or more statements identifying what type of uses the certificate is allowed for, where this corresponds to usage scenarios that are allowed for the utilization of the pair (I,P). In addition, the authority may include information related to the level of verification performed, any assurance or warranty extended by the authority, whether there is a charge for using the certificate and if so, how payment is to be made. The publication of the certified pair (I,P) may be done using a blockchain entry, but other ways of distributing the information, such as using DNS services, may also be utilized. In some embodiments, P is not a public key but an identifier of a smart contract.

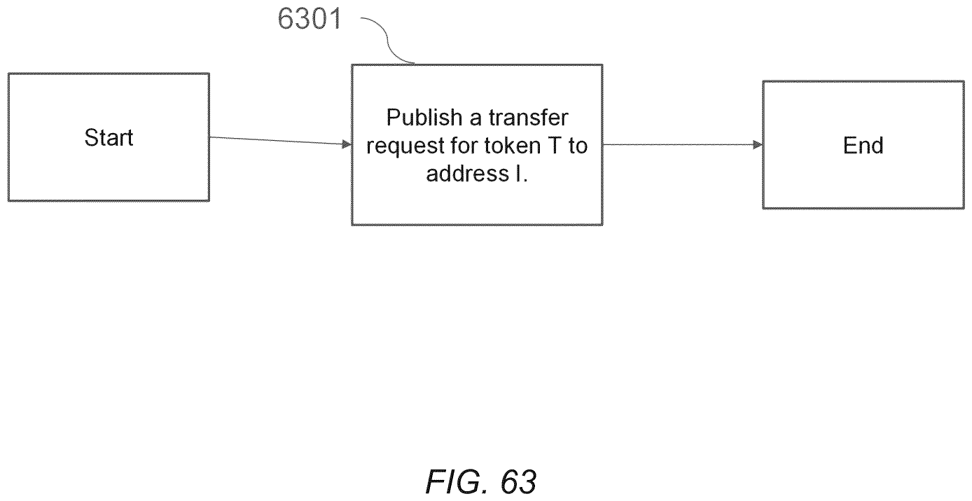

FIG. 63 illustrates the transfer of a token to an identity-based address from a sender of the token. This does not even require that the establishment of the identity-based address (described in FIG. 62) has already been done. A party in possession of token T uses a private key or a smart contract to generate a transfer request, but instead of the transfer address being a public key or a smart contract address, it is the identity I, as shown in step 6301.

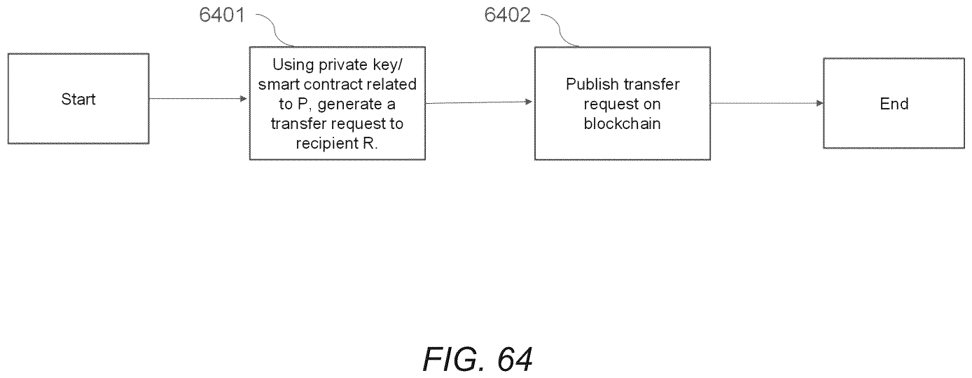

FIG. 64 illustrates the transfer of a token from an identity-based address to a recipient of the token. A user associated with the pair (I,P) certified in FIG. 62 has obtained a token T in FIG. 63, and now wishes to transfer T, or a portion of T, to a recipient R. R may specify a multiplicity of recipients, each receiving a stated fraction of T. A transfer request is generated in step 6401, and is published on a blockchain in step 6402. It can be verified by looking up that the token T, transferred to I in FIG. 63, corresponds to a transfer to P due to the certification in FIG. 62, and that P is properly used to initiate the transfer to R.

Identity-based transfers can also utilize traditional Identity-based encryption (IBE) methods. One such technique enables the derivation of a private key, by an authority, to a party with a given identity I. This can be used instead of the registration of pairs (I,P) as described above, enabling direct use of identity-based methods, but at the cost of a loss of quantum security.

In one example use situation, a transfer of an asset is made to an address I, thereby requiring the possessor of that address to use a private key or smart contract associated with the public key P associated with I in order to initiate a second transfer of the asset. In another use situation, a first asset owner transfers a token T to two or more addresses, indicated by I′=(I1 . . . . IN). The transfer may be performed to I′ or to (I′, policy) where policy indicates one or more rules of what entities associated with I′ needs to approve a second transfer in order to transfer the token T from I′ to a second recipient. In the case that policy is omitted, a default policy is used, where this may be that any one of the recipients (such as I1 or I2) may initiate a second transfer of T, or that all of the recipients corresponding to l′ need to approve a second transfer of T for this to be completed. In the latter case, if one of the identities IN is an account without an operator in existence, then this effectively transfers possession of T to the other members of l′, and also makes T anchored to them, as it cannot be transferred without the approval of the non-existent entity IN.

A security risk in smart contracts is that a first smart contract can call a second smart contract as the original externally owned account (EOA) that calls the first smart contract using the delegatecall function. The delegatecall function keeps msg.sender equal to the original caller. In many instances this is desirable behavior, as it allows a smart contract to act on behalf of the EOA, but it may also enable malicious behavior. For example, if the second smart contract is an ERC-20 token contract, and the EOA has a balance of tokens, the owner of the EOA may be tricked through, for example but not limited to, a phishing attempt to sign and submit a transaction where, unbeknownst to the user, the first contract makes a transfer call to the second smart contract that transfers all tokens owned by the EOA to a hacker.

In an embodiment, a function modifier may block delegated calls to a function, restricting calls to such functions to EOAs only. This allows for granularity in execution rights for smart contract functions, as it may be desirable for some functions to be able to be called by proxy, and for others a restriction may be required.

In one embodiment, a user opts-in to a policy that requires presenting a flat-list of tokens transferred as a result of executing a contract. This policy may also require presenting a summary of the token transfers that should be presented to the user signing a contract before finalizing the token transfer execution of a contract. This presented summary is in the form of a function in the same contract or an approval summary contract that needs signing before execution. This allows a user to have a final review of the contract to spot hidden charges, or malicious secondary calls in a contract.

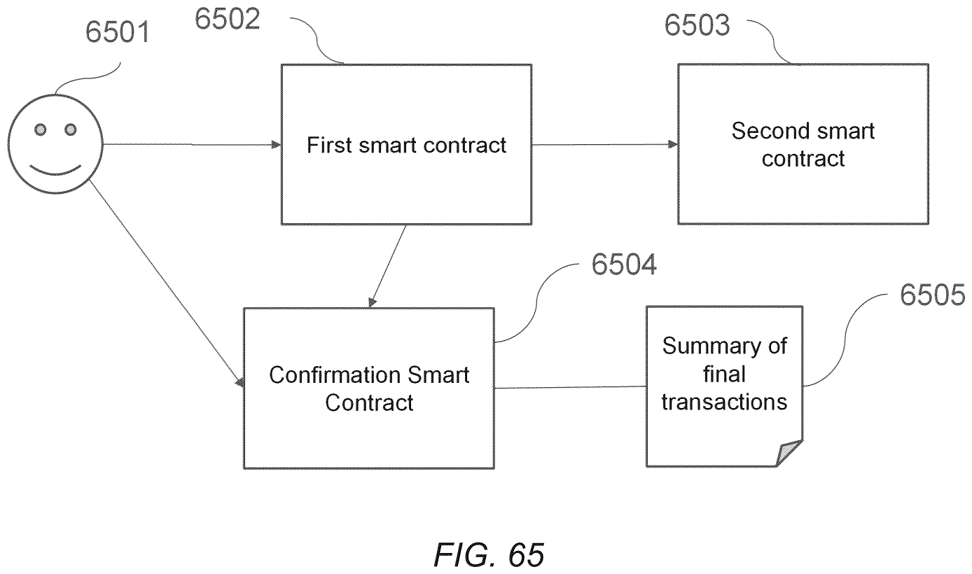

FIG. 65 illustrates a Confirmation Smart Contract (6504). In this example, this contract is not composite, meaning it does not call another contract, but just presents some information and requires a confirmation of a user. The confirmation of a User (6501), for example, through signing the confirmation smart contract, serves as a final approval of a more complex smart contract (e.g., a First Smart Contract (6502) that calls another Second Smart Contract (6503)) before being finalized. One example of using this contract is to present a Summary of Final Transactions (6505) in the form of a flat list of transactions like Tr1, Tr2, . . . . TrN, where Tri is composed of dimensions including but not limited to source wallet, destination wallet, value, and reason for the payment. These transactions are basically the final step of more complex smart contracts, for example a First Smart Contract (6502) that invokes a Second Smart Contract (6503) with complex logic. The Confirmation Smart Contract presents to the user the comprehensive and complete list of all final payment transactions Ti before they are being made. A user, or a program on behalf of the user, verifies the final list to spot malicious transfers, such as those happening in fraud or abuse attempts. A non-limiting example of abuse is a first smart contract (6502) that calls a second smart contract (6503) without users knowledge or in an unsafe manner allowing abuse such as hidden fee payments, or transfer to an unrecognized destination wallet. The summary of final transactions allows the user to review transaction payment and approve or reject all before they are finalized. In one embodiment, this is implemented using one or more policies that are configured by the user or obtained by the user by a third-party service provider. For example, a policy in the driving contract, the first smart contract (6502) in the given example, specifies that it needs to run a “confirmation smart contract” to finalize the contract execution. User (6501) signing, for example through calling a method called confirm (hash of the Confirmation Smart Contract) of the Confirmation Smart Contract, after reviewing it completes the steps for the first smart contract to get finalized and payments to be made.

Computers, including mobile devices such as phones and hardware wallets, are common theft targets, whether for reasons related to the value of the hardware itself or the data and services it has access to. The protection mechanism can be described in terms of three related aspects:

A detector of a trigger behavior, including one or more rules, one or more sensors, and a memory to store state information. The trigger behavior may be configured to a particular device, whether by type, usage, or the threat that is posed by theft of it. This configuration may be performed by the owner/user of the device, an admin, or a service provider such as a party from which the device was purchased or maintained. In one embodiment, the trigger may involve detection of a typical theft, e.g., a sudden acceleration of the device and a removal from personal network devices of the owner/user, such as Bluetooth headphones. It may also include the detection of anomalous sensor inputs, e.g., indicating attempts to compromise the device's hardware by opening up the device, an anomalous or absent GPS location, and/or a multiplicity of failed authentication attempts. It may also include a signal, e.g., a radio signal indicating that the device has been reported stolen, or the absence for a preset time of a radio signal indicating that the device has not been reported stolen, or a combination of such triggers.

A protective operation, such as an automatic encryption of content, an automatic bricking of the device, e.g., by replacing or modifying the bootup state and/or procedure, the erasure of locally stored cryptographic keys, etc. This protective action is caused by a rule being satisfied by a state or a collection of conditions related to one or more triggers. During a state characterized by the protective operation, the device may be fully or partially non-operating; the device may only be determining whether an unlock mechanism is successfully completed; example unlock operations are described below.

A reversal mechanism during which the protective operation is at least in part reversed, where the reversal mechanism removes the effects, at least in part, of the protective operation, e.g., by allowing access to the device storage; access to the device functionality; access to a decryption operation, where the decryption operation may require a cryptographic key that may be derived at least in part from information associated with the reversal of the protective operation.

### Example Unlock Methods:

A pass phrase P that has been previously associated with the device.
A value V generated from a pass phrase, where this value has been previously associated with the device. For example, if P is the pass phrase, and P maps to a seed S, from which one or more cryptographic key pairs (xi, yi) are generated, where the value V that is also generated from S, e.g., as a hash of S and an identifier of the device.
A pass phrase P2 that corresponds to a mapping of the value V described above, to a sequence of BIP 39 words.
Using a camera of the locked device, a QR code encoding V is conveyed to the locked device.
Using special-purpose equipment that a specialized vendor has access to, the value V is conveyed to the locked device.

Here, the value used to unlock may be conveyed using a radio signal, e.g., BLE, Zigbee, NFC, etc., from a master device that computes the value used to unlock to the locked device. It may also be entered by a user, e.g., on a touch screen, or conveyed to the locked device over a cable connecting the master device and the locked device. The master device may be a device a user acquires after the protective operation has been completed and the user's device has been locked, but using a pass phrase P that was previously used to set up the now-locked device. The master device, being able to generate the unlock value from P, generates the value used for unlock from that.

The triggering of the locking of a device, in some instances, is not based on the detection of an anomalous behavior, but rather, is simply part of the routine deactivation of a device, whether due to user logout, time-out of a session, a threshold number of failed authentication attempts, etc.

Users may be kidnapped and forced to unlock their devices. In one embodiment, a user may have a first passphrase that is of a similar format as the passphrase used to generate the user's private keys, which are used to control token transfers. A second passphrase may be set to be similar to but not identical to the first passphrase, where the second passphrase is used to unlock a smaller portion of tokens. If the user is forced, e.g., in a rubberhose attack, to unlock his device, then entering the second passphrase causes the device to only unlock the smaller portion of tokens. The user may have configured a watchdog application to detect any transfer of a token in the smaller portion of tokens; if this happens, it serves as a silent alert that the user has been coerced to give up his passphrase. In some embodiments, information related to the location (and potentially, historical locations) of the user device is covertly conveyed to the watchdog application, e.g., by selection of what combination of tokens to make accessible to the attacker. By transferring these tokens, the attacker conveys information about his location or other contextual information, such as network names etc. that is encoded in the covert communication. The use of a covert channel for conveying distress signals was disclosed by J. Jonsson, A. Juels, M. Yung and J. Hastad in the publication “Funkspiel Schemes: An Alternative to Conventional Tamper Resistance” In S. Jajodia, ed., Seventh ACM Conference on Computer and Communications Security, ACM Press, 2000, pp 125-133. The disclosed technology improves on this in a number of ways, e.g., by encoding specific alert information (such as the location and historical locations of the user device) in a covert channel using token selections. This can be done in an error correcting manner so that even if the attacker only transfers a portion of the available tokens, then these still convey the information, or the information with some lost accuracy. The conveyed location information can be automatically determined by the device based on the last believed non-anomalous device access, along with information about what locations provide more useful information than others. For example, a location at an airport or in a residential area may convey more valuable tracking information than a location along a busy highway.

Whereas traditional passphrases used for seed generation are generated by the system from random or pseudo-random values, there are benefits with setting distress passphrases as minor offsets from existing passphrases, making it possible for a user to store the distress passphrase (e.g., engraved on the inside of a ring) and to remember the manner in which the “real” passphrase is generated from the distress passphrase. The user may have multiple distress passphrases, which may all be similar to the real passphrase.

The GENIUS Act requires stablecoin issuers to comply with the requirements imposed on financial institutions under the Bank Secrecy Act (BSA), meaning anti-money-laundering programs must be implemented, and customer identification and due diligence must be in place related to the use of supported stablecoins. To implement these requirements, each coin can be associated, whether directly or via one or more accounts holding them, with identifiers that are tied to a physical entity, such as an enterprise or one or more persons. Alternatively, transactions can be associated with such identifiers. This can be implemented in a variety of ways, as detailed herein.

The coins can be tied to an anchor, where this anchor may be expressed, e.g., in the form of an anchor token (also known as a soulbound token), a biometric identifier such as a biometric template, or a corporate identifier, e.g., in the form of a cryptographic certificate. Anchor tokens and associated methods were disclosed in co-pending provisional patent applications titled “Token Creation and Management Structure” by Markus Jakobsson and Stephen Gerber; “Characteristic Assignment to Identities with Tokens” by Stephen C. Gerber, Markus Jakobsson, Ajay Kapur and Mike Leisz; “Biometric Authentication using Privacy-Protecting Tokens” by Markus Jakobsson and Stephen Gerber; and “Using KYC, Escrow, Tracking, Risk Scoring and Recourse to Secure Transactions” by Markus Jakobsson and Keir Finlow-Bates, all of which are incorporated by reference in their entirety.

One characteristic of an anchor token is that it cannot be transferred as other fungible or non-fungible tokens are. In some embodiments, anchor tokens cannot be transferred at all, i.e., cannot be reassigned to a new public key other than in instances where the associated private key is feared to have been compromised, or a system-wide update of token representations is made, e.g., in order to transition from quantum-vulnerable to quantum-secure representations. Techniques for the latter are disclosed in the co-pending application titled “Blockchain Enhancement Technology with Applications to Quantum Security” by Markus Jakobsson, Keir Finlow-Bates and Hossein Siadati, which is incorporated by reference in its entirety.

The programmatic logic for blocking a coin transfer can be implemented simply as a policy associated with the type of token, e.g., one or more bits in the token identifies the token as being non-transferable; other transfer limitations may include the need for third-party approval, the requirement for second-factor authentication (including the use of a biometric associated with an anchor), or registration of the transfer with an escrow authority. Some of these policies may be specific to the jurisdiction in which the coin is minted, or transferred to. In some embodiments, a smart contract may implement a policy that prevents any transfer of the associated token (and/or any assets it holds), where this policy may be conditional on a trigger, e.g., only apply until a required event is recorded as having taken place. Such an event may be the certified death of the owner of the token, the bankruptcy of an enterprise associated with the token, a time-based trigger such as “on Jan. 20, 2045”, or an environmental condition, such as when the DOW reaches a value that is twice that of when the token was minted. Policies such as these can also be implemented using consensus mechanisms, or using rules tied to the type of token.

In one embodiment, a token T is an anchor token. T owns a token T1 and a token T2. T1 may be associated with a rule (e.g., implemented in a smart contract) that specifies that any requirements imposed on the entity (in this case T) that owns T1 will also be applied to T1. T2 may be associated with a rule that specifies that any requirement imposed on the entity that owns T2 will also be imposed on T2 and all assets that T2 owns. The hierarchy of tokens below T2 that are affected by this may be limited, e.g., the inheritance will only be applied to three levels down, unless re-applied by tokens within the hierarchy.

In one embodiment, only some types of rules are imposed on children (and other descendants further down in the family tree), whereas other types of rules may not be imposed or may be imposed to a different extent. A policy in T may specify, for example, that non-transferability (a property of T, being an anchor token) also applies to all direct descendants (i.e., T1 and T2 in this example). It may also specify that any tokens that specify policies (such as policy tokens) would inherit the non-transferability, independently of the level in the tree spanned by T, and therefore also not be transferable. However, other kinds of tokens (such as a fungible token corresponding to a specified amount of value, such as a stablecoin) owned by T1 or T2 would not inherit the non-transferability property, and would therefore be transferable. Policies may also specify what happens if there is a conflict between a policy associated with a token T and a policy associated with a token that is a descendant of T, such as T1. Tokens with policies were disclosed in co-pending application titled “Token Creation and Management Structure” by Markus Jakobsson, Stephen C. Gerber, and “Token Abuse Protection” by Markus Jakobsson and Keir Finlow-Bates.

The determination that a given transaction corresponds to an attempt to launder money is typically not clear-cut, but rather, is a probabilistic determination. Accordingly, we disclose methods to generate a risk score, where this score corresponds to a likelihood of money laundering. We also disclose techniques for generating cumulative risk scores that take into consideration patterns across multiple transfers.

In one embodiment, a token transaction originator (which we will refer to as the “payer”) can be assigned a risk score. For example, the score may be a value from 0 to 100, where 0 corresponds to a known legitimate source of payments, e.g., a tax authority issuing tax refunds; and 100 may correspond to a known money launderer or other related criminal. A score of 90 may be given to an entity that is not associated with an identifier (such as an anchor to a unique identifier tied to an entity, as described above); and a score of 75 to an entity that is associated with such an identifier, but where this entity has been tainted by association (such as payments to or from) an entity with a score of 90 or higher. A score of 600 may correspond to an entity that has performed a series of transactions that are associated with a high risk of money laundering. An example of such an action is a payment for an NFT that exceeds the believed market value of the token by more than 10%, or the investment of a token from a DEX that soon thereafter led to an apparent loss or gain where this is associated with an apparent rug pull with a high probability.

Different actions may have different scores, and these scores may be determined using a machine learning component that is trained on known examples of money laundering, whether synthetic and generated for purposes of training, or real and shown with high likelihood to indeed be attempts to launder money.

In one embodiment, the size of a transaction and the number of related transactions influence the determination of the risk score. For example, if one user account receives a total inflow of funds of less than $10, it is largely irrelevant whether this constitutes money laundering or not, unless there are many such transactions. Conversely, amounts in the hundreds of thousands are more impactful, should they be money laundering, and are given more scrutiny and/or weight in the determination of the associated risk score. Moreover, the number of similar transactions are of significance, as are the cumulative amounts being transferred. If any one of such a collection of transactions is given a high score, this causes the other members of the collection to also be given a score that is higher than it would have been should the one member not have detected; this correlation is increasingly strong when the mode of payment is more similar, where high similarity mean be associated with a network of transfers where some nodes are present for multiple series of transactions, or where the timing, the amounts, or other “fingerprint parameters” are the same or highly overlapping.

The disclosed technology also takes into consideration the risk of compromise. While the risk of compromise of biometric templates, for example, is typically low, it is not negligible. Therefore, if any network node (corresponding to an anchored token, a user account with an associated anchor, etc.) is associated with anomalous behavior, such as unusual payment patterns, unusual payment volumes, or high-risk transactions, then this account can be flagged as being at risk for having been compromised. Alternatively, each such network node may be assigned a risk score based on its assessed risk of having been compromised. Transactions to or from a network node with an elevated score affects the risk score assigned to transaction partners (e.g., payers to or payees of an entity associated with the network node). The risk score of a network node may also be based on the type of software and hardware that represents the network node, and the associated inherent risks of compromise of such software and/or hardware. In addition, techniques such as remote software attestation and/or digital rights management techniques may be used to assess the risk of compromise, as can the status of associated anti-virus software, the level of application patching, and the transactional history of the entity. An example of the latter may include the likely exposure to malicious smart contracts. The risk scores of devices may be determined also based on the recency of a security audit of the device, which may be represented in a certificate of the device; as well as information about the security profile of the user of the device.

In one embodiment, the risk of intentional compromise is also considered. This may correspond to rubber-hose attacks, social engineering, and more, wherein the legitimate user is caused to engage in transactions that are detrimental to him or her. An example of such a transaction is that of receiving and sending money as a money mule does. The system distinguishes between compromise due to software/hardware (which can often be audited using technical means) and attacks that involve the compromise of a user rather than her device.

The disclosed technologies for detection of money laundering are not only relevant in the context of stablecoins, but are also relevant for any other types of tokens. This is so both because the methods are highly overlapping in terms of what types of token they are applied to; and because typical money laundering efforts are unlikely to be limited to only one mode of operation, especially if introducing multiple transfers involving different types of tokens and DeFi mechanisms would otherwise complicate the detection of the attempts.

In one embodiment, the scores are calculated per token, and stored on the chain. The logic for calculating the risk score can be hardcoded in the contract itself, or can be delegated to dedicated smart contracts whose responsibility is to calculate the risk score for tokens and to store them. Such contracts can be big in size to encompass scores for many coins, shards of coin, or be small to contain the score only for one coin. Such contracts are dedicated to maintaining the state of the score of coins, and can be controlled by entities such as anti-money laundering organizations or banks or governments. Upon transaction or change in the state of a coin, contracts call the risk score calculation contracts to calculate and update their risk score associated with a token on the chain. Alternatively, the callee can connect to API end points off the chain where they calculate the scores using AI, LLMs, heuristic models, or AML systems.

In the above, “the chain” may refer to, without limitation, one of a blockchain used for recording token transactions, a dedicated blockchain used for purposes of storing risk scores, a blockchain that is neither used for transactions nor is dedicated to the storage of risk scores, a private blockchain managed by an enterprise, or a combination of such storage approaches.

It is well understood that the use of Merkle signatures addresses the problem of quantum attacks on digital signatures. However, many practitioners fail to recognize that it is not simply a matter of changing the signature scheme associated with blockchain transactions from the current ECDSA approach to a Merkle structure: if at a given time, the use of ECDSA would be disallowed and Merkle signatures required, that would mean that existing tokens in circulation would no longer be possible to transfer, thereby becoming worthless. A number of approaches to address this problem were disclosed in a co-pending application titled “Blockchain Enhancement Technology with Applications to Quantum Security” by Markus Jakobsson, Keir Finlow-Bates and Hossein Siadati, which is incorporated by reference in its entirety herein. Said approaches address the problem of transferring legacy tokens, whether to other users or to using quantum secure signature schemes, or both. However, it only addresses legacy tokens whose public keys have not already been exposed to a potential attacker. In other words, those schemes protect tokens for which the public knows the hash of the public key but not the associated public key.

One remaining aspect, which is addressed herein, is therefore to protect tokens for which the public keys are known. In one embodiment, such tokens are frozen by a network, at a time when the threat of quantum attacks is sufficient to take this action; in one embodiment, the policy of freezing vulnerable tokens is implemented by the consensus mechanism; in another by a software update; and yet another one by tentative recipients refusing to receive tokens that have been exposed by having their public keys publicly observable. The unfreezing of such assets can be performed using a two-step proof:

(1) Association step. In one step, which we refer to as the association step, it is demonstrated that the frozen assets are associated with an entity that in turn is associated with a value that is a one-way function of a secret value, said one-way function being one that is not vulnerable to a quantum-attack. One example of a one-way function that is not vulnerable to a quantum-attack is a cryptographic hash function, such as SHA256.

(2) Knowledge step. In the other step (which may take place before, after or at the same time as the association step), knowledge of the secret value is demonstrated. We refer to this second step as the knowledge step. This demonstration may use a zero-knowledge proof in order not to cause the secret value to be exposed; it may also be performed in a manner that exposes the secret value, but also, in the same process, replaces it with another secret value that is not exposed.

Example association step: Assume there are N tokens to be unfrozen, and that these are referred to as T1 . . . . TN. The party possessing T1 . . . . TN performs the association step by showing that these tokens were transferred to a wallet address, a smart contract address, or a public key address that we collectively refer to as ADDR. There may be multiple different types of addresses, but all of them are assumed to be associated to each other, e.g., there is at least one previous transfer between two such addresses, where this can be shown to be an internal transfer. One way of demonstrating that a transfer is internal is to show that the two or more addresses were associated with one and the same anchor, or one and the same escrow account, for example. An anchor may be an anchor token (also known as a soulbound token) or it may be another form of representation that is tied to an entity, but which is not a token.

We refer to the party possessing these tokens as the “possessor.” This demonstration can be done simply by indicating the block in which the transfer to the possessor was made, and/or showing evidence that the two or more tokens are tied to the same anchor. Anchors were described and disclosed in the co-pending application titled “Identity Anchor with Watchful Processing, and Efficiency Enhancements” by Markus Jakobsson, Keir Finlow-Bates, and Hossein Siadati, which is incorporated by reference in its entirety herein.

Example knowledge step: We will focus on an efficient implementation of a knowledge step in which the underlying secret is “destroyed” (i.e., disclosed) as part or the performance of the proof. A practical approach is to demonstrate that an image of the secret (such as a cryptographic hash function of the secret) is associated with ADDR, and then, using a commit-reveal signature use a commitment of the secret in a first phase, and then, once the transcripts of the first phase have been recorded on a blockchain, to perform a second phase in which the secret is disclosed, and its commitment from the first phase can be verified. The transcript of the first phase is tied to each one of the tokens T1 . . . . TN to be converted/transferred, as well as to an image of a replacement secret where the image of the replacement secret will be used in lieu of the image of the secret after the conclusion of the second phase of the proof. This proof therefore effectively demonstrates that the party performing the proof knows the secret and, by virtue of the association step, that it has possession of the tokens T1 . . . . TN. In the first phase of the knowledge step, one or more new public keys are disclosed, where these are associated with the tokens T1 . . . . TN and the associated private keys are to be used for transfer of these tokens. The new public keys relate to quantum-secure schemes. As an alternative, instead of associating the tokens with new public keys, the tokens may be associated with other forms of addresses, such as smart contract or wallet addresses. In one example embodiment, the secret is a seed phrase used to generate the keys of a wallet.

The commit-reveal approach, corresponding to CR signatures, is disclosed in co-pending provisional application 63/687,205, titled “Secure and efficient Quantum-resistant digital signing method for blockchains” by Keir Finlow-Bates and Markus Jakobsson, henceforth Finlow-Bates and Jakobsson, which is incorporated by reference in its entirety.

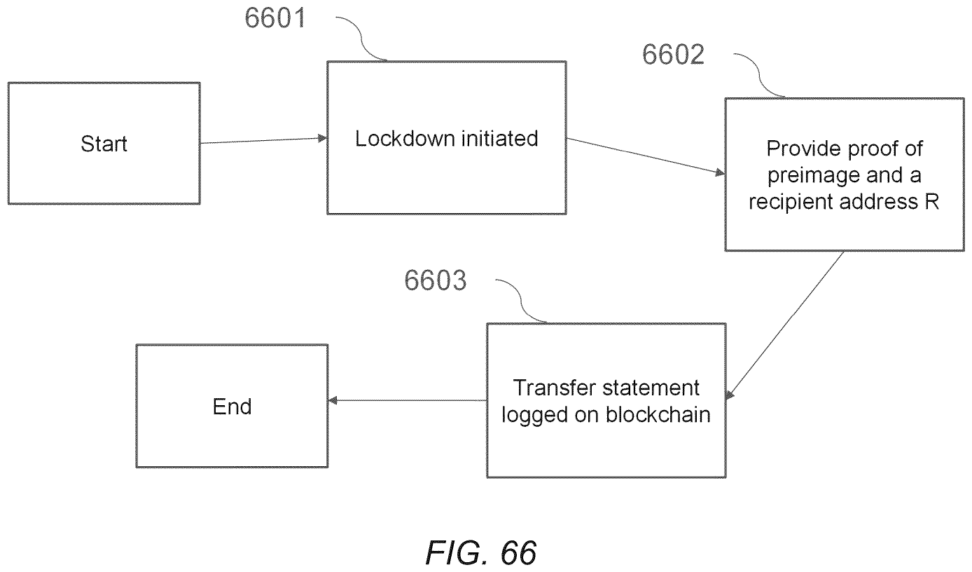

In one embodiment, a Merkle signature using a public key that is linked, in the association step, with one or more tokens T1 . . . . TN, is used to digitally sign a message including a set of new public keys for these tokens, where the new public keys correspond to a quantum-secure signature scheme. The associated private keys are stored by the entity or entities to be given control over T1 . . . . TN, which may be different from the entity to which the private key of the Merkle signature belongs. In an optional step, an entity issued a new public key may disclose the old public key when transferring the associated token, using the private key associated with the new public key. This facilitates the tracking of the token transfers, as it provides a chain of keys that is unbroken. FIG. 66 illustrates the transfer of assets locked down due to a quantum threat. Actions may commence with the generation of a lockdown order, as shown in step 6601. This may be performed by an authority or a consensus mechanism and relate to all quantum vulnerable tokens logged on a blockchain associated with the authority or consensus mechanism. It may also be done by an agent operating based on a policy specific to an account of a user, and only apply to tokens of this user. Actions may proceed to step 6602, in which a user U wishes to prove that he is authorized to transfer one or more tokens T that are locked down. The tokens are related to a cryptographic preimage of a public key associated with T, such as a public key that has been hashed; a seed phrase used to generate a public key associated with T; or a seed generated from said seed phrase and wherein the seed was used to generate a public key associated with T. Other preimages can also be used. The user proves knowledge of the preimage and requests a transfer of T to the address R. One way to do this is to use an additional token T2 that is not locked down and generate (a) a transfer request of T to R, associated with a hash of a nonce N and (b) following the publication of the transfer request, generate a second transfer request in which N is revealed and the preimage (such as the seed) is revealed. This approach needs to be used for all tokens generated from the seed at one time, as the revelation of the seed instantly invalidates the all tokens T generated from the seed. The two transfer requests may be logged, one by one, on a blockchain, as shown in step 6603. Alternatively, a trusted authority can verify the proof of knowledge of the seed and mint a replacement token (or tokens) that are assigned to the recipient address R; this minting transcript is published on the blockchain in step 6603.

In one embodiment, a central entity can call a function of smart contracts to impose restrictions on a coin. In another embodiment, a collection of entities or a minimum number of n out of N should agree (e.g., call method in the smart contract for a coin) to impose restrictions or activate a policy on a coin.

Policies may be altered over time, e.g., by addition of new types of transfer policies to address political or financial needs; or the overriding of policies. As one example of an override is the transition from a quantum-vulnerable representation to a quantum-secure representation, as described above. That type of override may be system-wide. In another example of an override, some tokens may be required to have additional controls associated with them, e.g., due to the value associated with the tokens, or political or legal changes related to individual owners and the requirements associated with the tokens they own or otherwise control. Yet another example of an override is if an entity associated with the anchor has ceased to exist, e.g., a corporation has entered bankruptcy or a physical person has passed away. In such cases, the transfer rights may be modified. Modifications may be carried out by trusted parties, such as certificate authorities, law enforcement, or by a change in the functionality expressed by the consensus mechanism.

A user (whether a person or an organization) may opt to comply with policies that are not mandated in the jurisdiction with which the user is associated. For example, a person residing in a country or state with no requirements for identity escrow for tokens may opt to voluntarily comply with such non-mandated policies, e.g., in order to facilitate compatibility with users in jurisdictions where there are such mandates. Users in this latter type of jurisdiction may be required to provide an audit trail of a specified depth or ownership duration in order for the associated token not to be further audited or blocked if transferred to this user. Thus, the user within the jurisdiction that does not mandate the tracking capabilities may choose to register his or her wallet or other holding account mechanism in a manner that complies with regulation in the more demanding jurisdiction, in order to simplify the compatibility with the needs of users in the demanding jurisdiction. Performing such a registration does not necessarily impact the tracing of transactions within the non-demanding jurisdiction, as the tracking capabilities may be associated with authorized entities within the demanding jurisdiction. Example escrow techniques are disclosed in the co-pending application titled “Blockchain enhancement technologies with applications to commerce” by Keir Finlow-Bates and Markus Jakobsson, which is incorporated by reference in its entirety.

In one embodiment, a user associates one or more policies with at least one of a wallet, an account/account identifier, a smart contract address, a token that owns assets, or a combination of these. A policy may identify when an asset should be transferred, e.g., to minimize a tax burden, to maximize a discount, or more generally, to maximize the result of an assessment function, where said assessment function may generate a score that identifies the expected benefits of a given one or more transactions that are applicable to the wallet/identifier/address/token/etc. These policies may be executed by an agent that is executing on the wallet, on hardware managed by a service provider, by a bounty hunter, by one or more entities that are part of the consensus mechanism, or a combination of such and related entities. The notion of bounty hunters was disclosed in a co-pending provisional patent application titled “Perpetual NFT Assets” by Markus Jakobsson, Stephen C. Gerber and Guy Stewart, the entirety of which is incorporated by reference.

Although specific systems for transaction implementations are discussed above, many different methods of executing quantum-secure transactions can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for performing quantum-secure blockchain operations, comprising:
generating a first pre-image value, wherein the first pre-image value is randomly-generated;
conveying a hash of the first pre-image value to an initiating party of a proposed action, wherein the proposed action concerns a set of one or more cryptographic tokens;
receiving, from the initiating party, a second pre-image value,
wherein the second pre-image value is received after a transaction from the initiating party is included in a block on a blockchain;
wherein the transaction from the initiating party is distinct from the proposed action; and
wherein the transaction from the initiating party references a locking script that comprises an output generated by a specific one-way function based on a concatenation of the hash of the first pre-image value and the second pre-image value;
generating an unlocking script comprising the hash of the first pre-image value concatenated with the second pre-image value; and
submitting the proposed action to the blockchain,
wherein the proposed action comprises a reference to the unlocking script, and
wherein the unlocking script is validated against the locking script to initiate the proposed action.

2. The method of claim 1, wherein the specific one-way function comprises a quantum-secure cryptographic hash function.

3. The method of claim 1, wherein the set of one or more cryptographic tokens comprises cryptocurrency.

4. The method of claim 1, wherein the first pre-image value is generated using a pseudo-random generator.

5. The method of claim 1, wherein conveying the hash of the first pre-image value to the initiating party is performed using a secure out-of-band communication channel.

6. The method of claim 1,
wherein the proposed action submitted to the blockchain transfers at least some of the set of one or more cryptographic tokens; and
wherein the method is performed by a recipient of transferring the at least some of the set of one or more cryptographic tokens.

7. The method of claim 1, further comprising:
receiving, from a subsequent recipient party, a hash of a third pre-image value; generating a second locking script comprising an output generated by a second one-way function of a concatenation of the hash of the third pre-image value and the first pre-image value; and
creating a subsequent transaction comprising the second locking script, wherein the subsequent transaction transfers the set of one or more cryptographic tokens to the subsequent recipient party.

8. A non-transitory machine-readable medium comprising instructions that, when executed, are configured to cause a processor to perform a process for performing quantum-secure blockchain operations, the process comprising:
generating a first pre-image value, wherein the first pre-image value is randomly-generated;
conveying a hash of the first pre-image value to an initiating party of a proposed action, wherein the proposed action concerns a set of one or more cryptographic tokens;
receiving, from the initiating party, a second pre-image value,
wherein the second pre-image value is received after a transaction from the initiating party is included in a block on a blockchain;
wherein the transaction from the initiating party is distinct from the proposed action; and
wherein the transaction from the initiating party references a locking script that comprises an output generated by a specific one-way function based on a concatenation of the hash of the first pre-image value and the second pre-image value;
generating an unlocking script comprising the hash of the first pre-image value concatenated with the second pre-image value; and
submitting the proposed action to the blockchain,
wherein the proposed action comprises a reference to the unlocking script, and
wherein the unlocking script is validated against the locking script to initiate the proposed action.

9. The non-transitory machine-readable medium of claim 8, wherein the specific one-way function comprises a quantum-secure cryptographic hash function.

10. The non-transitory machine-readable medium of claim 8, wherein the set of one or more cryptographic tokens comprises cryptocurrency.

11. The non-transitory machine-readable medium of claim 8, wherein the first pre-image value is generated using a pseudo-random generator.

12. The non-transitory machine-readable medium of claim 8, wherein conveying the hash of the first pre-image value to the initiating party is performed using a secure out-of-band communication channel.

13. The non-transitory machine-readable medium of claim 8,
wherein the proposed action submitted to the blockchain transfers at least some of the set of one or more cryptographic tokens; and
wherein the process is performed by a recipient of transferring the at least some of the set of one or more cryptographic tokens.

14. The non-transitory machine-readable medium of claim 8, wherein the process further comprises:
receiving, from a subsequent recipient party, a hash of a third pre-image value;
generating a second locking script comprising an output generated by a second one-way function of a concatenation of the hash of the third pre-image value and the first pre-image value; and
creating a subsequent transaction comprising the second locking script, wherein the subsequent transaction transfers the set of one or more cryptographic tokens to the subsequent recipient party.

15. A distributed system for implementing digital access rights, the distributed system comprising:
at least one network interface;
memory storing instructions; and
at least one processor configured to communicate data with the at least one network interface and the memory, the at least one processor further configured to execute the instructions to implement a process for:
generating a first pre-image value, wherein the first pre-image value is randomly-generated;
conveying, with the at least one network interface, a hash of the first pre-image value to an initiating party of a proposed action, wherein the proposed action concerns a set of one or more cryptographic tokens;
receiving, from the initiating party, and using the at least one network interface a second pre-image value,
wherein the second pre-image value is received after a transaction from the initiating party is included in a block on a blockchain;
wherein the transaction from the initiating party is distinct from the proposed action; and
wherein the transaction from the initiating party references a locking script that comprises an output generated by a specific one-way function based on a concatenation of the hash of the first pre-image value and the second pre-image value;
generating an unlocking script comprising the hash of the first pre-image value concatenated with the second pre-image value; and
submitting, with the at least one network interface, the proposed action to the blockchain,
wherein the proposed action comprises a reference to the unlocking script, and
wherein the unlocking script is validated against the locking script to initiate the proposed action.

16. The distributed system of claim 15,
wherein the specific one-way function comprises a quantum-secure cryptographic hash function; and
wherein the set of one or more cryptographic tokens comprises cryptocurrency.

17. The distributed system of claim 15, wherein the first pre-image value is generated using a pseudo-random generator.

18. The distributed system of claim 15, wherein conveying the hash of the first pre-image value to the initiating party is performed using a secure out-of-band communication channel.

19. The distributed system of claim 15,
wherein the proposed action submitted to the blockchain transfers at least some of the set of one or more cryptographic tokens; and
wherein the process is performed by a recipient of transferring the at least some of the set of one or more cryptographic tokens.

20. The distributed system of claim 15, wherein the process further comprises:
receiving, from a subsequent recipient party, a hash of a third pre-image value;
generating a second locking script comprising an output generated by a second one-way function of a concatenation of the hash of the third pre-image value and the first pre-image value; and
creating a subsequent transaction comprising the second locking script, wherein the subsequent transaction transfers the set of one or more cryptographic tokens to the subsequent recipient party.
